(19) United States
(12) Patent Application Publication
(10) Pub. No.: US 2005/0032029 A1
(43) Pub. Date: Feb. 10, 2005

(54) Method of multi-dimensional analysis of viscoelastic materials for stress, strain, and deformation

(76) Inventor: Frank J. Trunk, Houston, TX (US)

Correspondence Address: Mr. Frank J. Trunk, 6436 Kentwick, Houston, TX, 77084, US

(21) Appl. No.: 09/915,388

(22) Filed: Jul. 26, 2001

Related U.S. Application Data
(63) Continuation-in-part of application No. 09/438,120, filed on Nov. 10, 1999, now abandoned.

(51) Int. Cl. G09B 23/06

(52) U.S. Cl. 434/300

(57) ABSTRACT

A method for solving any arbitrary multi-dimensional scientific or engineering design problem requiring solutions for stress, strain and deformation, and which therefore demands the incorporation of a material constitutive equation into the mathematical solution and wherein that constitutive equation, which quantitatively defines the relationship between stress and strain, incorporates independent tensor valued coefficients and a scalar valued constitutive function/s, and where the values of the tensor valued coefficients and the form of the constitutive function/s is specific to any particular material under consideration.

### FIELD OF THE INVENTION

This invention relates to the methods and processes of multi-dimensional analysis of material properties, and the methods and processes of solving any arbitrary multi-dimensional scientific or engineering design problem requiring solutions for stress, strain and deformation which demand incorporation of a material ‘constitutive function’ into the solution, wherein the solution for that constitutive function, which defines the relationship between stress and strain in solids, and stress and rate of deformation in fluids, incorporates tensor valued coefficients and scalar valued constitutive functions, where the tensor valued coefficients and the constitutive functions are material specific.

### BACKGROUND OF THE INVENTION

The Need for the Higher Order Multi-Dimensional Constitutive Functions of Viscoelastic Materials

Hooke's law of linear elasticity and the Navier-Poisson equations of Newtonian fluids represent idealized limits of the more generalized and more complex theory of material behavior known as ‘viscoelasticity’.

Viscoelastic constitutive functions are time dependent, where the one dimensional relationships between static stress σ and a resulting strain rate ε(t), or a static strain ε and the internal state of stress σ(t) are,
σ(t)=f(t,ε) ε(t)=f*(t,σ)
Idealized one dimensional linear models for these materials were first introduced in the last half of the 19th century by Maxwell, Meyer, Kelvin, Voigt, and others (c. 1868-1889).

The most generalized form of a three dimensional linear constitutive equation for static loading or deformation may be written as,
σ(t)ᵢⱼ=fᵢⱼₖₗ(tₖₗ, εₖₗ), ε(t)ᵢⱼ=f*ᵢⱼₖₗ(tₖₗ, σₖₗ)
where the f*(tₖₗ,σₖₗ)ᵢⱼₖₗ and f(tₖₗ,εₖₗ)ᵢⱼₖₗ are highly non-linear functions, generally assumed to be independent. However, these functions can not be independent, because of chemical bonding and the number of independent functions associated with various degrees of material symmetry have not been determined. Because multi-dimensional behavior is not well understood theoretically, scientific and engineering applications for these types of materials have been constrained and the characterization of material properties more of an art than a science.

Experimental work conducted on a limited number of linear viscoelastic solids has shown that the matrix of functions, the f*(tₖₗ)ᵢⱼₖₗ and f(tₖₗ)ᵢⱼₖₗ, may occasionally be approximated by a matrix of independent coefficients and a single scalar valued creep compliance or relaxation modulus function,
f*(t)ᵢⱼₖₗ=>[kᵢⱼ]f*(t), f(t)ᵢⱼₖₗ=>[dᵢⱼ]f(t)
Unfortunately, these experimental data are in direct conflict with published theory and experimental data for other viscoelastic materials. For example, experimental and theoretical solutions for simple isotropic viscoelastic solids allow for the existence of two creep compliance or relaxation modulus functions. As a consequence, the above approximations are application and material specific, and of limited interest.

In the last 100 odd years closed-form solutions to a host of one, two, and three dimensional engineering design and scientific problems have been obtained using the theory of linear elasticity. Two and three dimensional solutions incorporating viscoelastic constitutive behavior have been far more difficult to handle because of the necessity of dealing with the f*ᵢⱼₖₗ(tₖₗ,σₖₗ) or fᵢⱼₖₗ(tₖₗ,σₖₗ). The differences between the generalized mathematical formulations and material specific solutions inferred from experimental data have also led to complications and confusion.

The purpose of this document is to clarify the physics of material deformation and present a method for developing the simplest possible solutions for three dimensional constitutive equations of viscoelastic materials. Methods of application will also be illustrated.

The three dimensional solutions may always be expressed in terms of tensor valued coefficients and a single scalar valued material dependent function, where the constitutive function has two independent responses, one time dependent and one time independent. The solutions for these constitutive functions represent a continuum in material behavior that also includes the theory of linear elasticity. Under the appropriate limiting conditions the generalized viscoelastic constitutive equations will degenerate into the linear elastic functions.

Obtaining linear viscoelastic equivalents for two and three dimensional solutions defined in terms of linear elastic solids is now a relatively straight-forward process. For example, all solutions developed for the linear elastic solids may be adapted to obtain solutions for the linear viscoelastic materials, regardless of the degree of material symmetry, and at least for static loading conditions. Additionally, quantification of constitutive functions is based upon experimental data obtained for each material of interest. Understanding the correct form of the equations greatly simplifies this task, reducing the time involved and associated costs.

### SUMMARY

This document presents a method for solving arbitrary multi-dimensional scientific and engineering design problems requiring solutions for stress, strain and deformation, and which therefore demand the incorporation of a material constitutive equation into the mathematical solution, and wherein the constitutive equation for solids, which quantitatively defines the relationship between stress and strain, incorporates two coefficient matrices of independent tensor valued coefficients and a scalar valued constitutive function, and where the values of the tensor valued coefficients and the mathematical form of the constitutive function is specific to any particular material under consideration and the magnitude of deformation.

### BRIEF DESCRIPTION OF THE DRAWINGS:

So that the manner in which the above recited features, advantages and objects of the present invention are attained and can be understood in detail, a more particular description of the invention, briefly summarized above, may be had by reference to the schematic illustrations which are illustrated in the appended drawings.

It is to be noted, however, that the appended drawings are conceptual illustrations of this invention and are therefore not to be considered limiting of its scope, for the invention may admit to other equally effective embodiments.

In the drawings:

FIG. 1.1—Molecular model of the bonded lattice structure of a solid material in undeformed and deformed configurations, and the coupling between the various components of an applied stress, σ, and a resulting strain, ε.

FIG. 1.2—The impulse elastic stress-strain and stress-ultimate strain curves a), and the strain energy associated with ultimate strain b).

FIG. 1.3—Idealized hypothetical stress-ultimate strain response of a solid material subjected to both elastic and inelastic deformation. So long as the material remains intact the constitutive equations are always characterized in terms of scalar valued constitutive functions, regardless of the state of strain.

FIG. 1.4—Coincident reference frames xᵢ and zᵢ a), and the reversal in the direction of action of shear stresses acting about the x₁-x₃ and z₂-z₃ axial planes caused by a 180 degree rotation of the z₃ reference axis with respect to the x₃ reference axis b).

FIG. 1.5—The strain history of a viscoelastic material is directly dependent upon the stress history σ₁(t), and controlled by the material functions f*(t) or f(t).

FIG. 1.6—Any arbitrary stress function σ(t) can be expressed in terms of some initial stress σ(0+) applied at time t=0+, and a host of incremental increases in stress, the δσⱼ, applied at the various interval times, the δt′.

FIG. 2.1—Piece-wise continuous linear approximations to non-linear behavior are often reasonable approximations provided the range in stress and/or strain is appropriately restricted a). As with linear materials, the stress-strain curve defines the components of elastic strain energy b).

FIG. 2.2—A differential element of material loaded with the nine surface tractions, the σᵢⱼ. The three surface tractions on each face may the be resolved into a single resultant traction, the tᵢ.

FIG. 2.3—As the volume of a differential element approaches zero, Δx·Δy·Δz->0, each of the surface tractions, the σᵢⱼ, and the resultants of those surface traction, the tᵢ, represent stress at a point. The σᵢⱼ and the tᵢ, may then be resolved into a single stress vector, σₛ, the state of stress at a point.

FIG. 2.4—An orthogonal reference frame may be oriented with respect to the stress state vector, σₛ, such that one axis is collinear with σₛ, and σₛ is normal to the plane defined by the other two axes.

FIG. 2.5—The stress vector, σ*₁, operates coincident with the z₁ axis, and normal to the plane defined by the z₂ and z₃ axes. This stress vector is the solution for the state of stress in the zᵢ reference frame a). The state of stress solution, σ*₁, for the zᵢ reference frame may represent the stress condition in the xᵢ frame, defined by the stress vectors σ₁ and σ₂b).

FIG. 2.6—As a consequence of an applied σ*₁, there is an associated set of strains, the ε*ⱼ₁, in the zᵢ and xᵢ reference frames.

FIG. 2.7—The stress state vector may also be defined by the σᵢ vectors of the xᵢ reference frame, and the direction cosines α, δ, and φ.

FIG. 2.8—The relative contributions of non-linear strain ε associated with any given applied stress σ a) may be broken into a linear, ε_{L}, and non-linear component, ε_{NL}. The relative contributions of a non-linear strain solution for stress σ b) may be broken into a linear, σ_{L}, and non-linear component, σ_{NL}, for a given magnitude of strain, ε.

FIG. 3.1—While the delayed elasticity functions f*^{D}(σ,t) and f^{D}(ε,t) are always non-linear functions of time, the ultimate strain solution may be either linear or non-linear a). The non-linear elastic impulse response, ε^{E}, and the delayed elasticity response, ε^{D}, may always be approximated by linear functions at time t->∞, over an appropriately limited stress-strain domain b). However, these approximations will not necessarily be valid for any time t.

FIG. 3.2—The non-linear impulse response function and the ultimate delayed elasticity response functions may be described in terms of the sum of a linear component and a non-linear component.

FIG. 3.3—The delayed elasticity response of linear viscoelastic materials show strains, strain rates, and ultimate strains a) that are always proportional to the applied load c). At time t=∞ the stress-strain curve is always linear. One possible subset solution for the delayed elasticity response of non-linear viscoelastic materials b) is a function that is proportional to some function of stress. ε^{D}(σ,t) then takes the form of ε^{D}(σ,t)=f*^{D}(t)·g(σ), where g(σ) is a scalar valued function of the state of stress. At time t=∞ the stress-strain curve is then always non-linear.

FIG. 4.1—The cubic crystal lattice system of sodium chloride, NaCl, and lead sulfide, PbS. Bonding is orthogonal and equivalent in all three axial directions.

FIG. 4.2—In additional to the cubic lattice structure a), orthorhombic lattices b) also have orthogonal bonding arrangements. The constitutive responses of the bonds in both lattice structures, the f*ᵢ(t), may vary in each axial direction.

FIG. 4.3—The ‘S’ electron orbital is spherical shaped. The ‘P’ orbital shell is dumbbell shaped, and there are 3 possible ‘P’ orbital directions, all of which are orthogonal.

FIG. 4.4—Chemical bonding commonly occurs through interaction of ‘S’ orbitals. However, if the ‘S’ orbitals are full they may act to repel each other and form anti-bonding orbitals a). Bonding produces a shared orbital shell b).

FIG. 4.5—‘P’ orbitals are more complex that ‘S’ orbitals, and there are correspondingly more bonding and anti-bonding configurations for these orbitals. ‘P’ and ‘S’ orbitals will also combine to form hybrid bonding orbitals.

FIG. 4.6—Shear stress, σ₁₂, within a plane of bonding a) may also be expressed as the single normal stress, σ′₁₁, if the reference frame is rotated 45 degrees. The racking of the lattice structure b) puts into play the forces associated with the stretching of the bonds, f₁ and f₂; the forces between the bonding and non-bonding/anti-bonding orbitals resulting from angular distortion, f₃; and the reactive forces between the positively charged nuclei, f₄. These forces all act simultaneously to produce a coupled response.

FIG. 4.7—If a force, σ′₂, applied to an orthogonal lattice racks the lattice in all axial directions, then all reactive forces operating between the bonds and nuclei come into play simultaneously.

FIG. 4.8—A hypothetical bonding arrangement where the orthogonal bonds, between the atoms A-B and C-D, are connected via an intermediate set of bonds. The labeled arrows indicate the reactive forces produced by the electromagnetic fields and induced by deformation of the lattice.

FIG. 4.9—Many metal and metal alloys are characterized by face centered cubic packing of the atoms. Gold, silver, copper, lead, and many iron alloys have this bonding arrangement. This bonding arrangement produces symmetry in material properties in three orthogonal axial directions, the condition of orthotropy.

FIG. 4.10—Graphite, pure carbon, is characterized by stacked layers of hexagonally bonded carbon atoms a). The layers of covalently bonded carbon atoms are connected by weak van der Waals bonds that act normal to the plane of each layer b). Each layer has a hexagonal lattice structure of interconnected benzene rings.

FIG. 4.11—The benzene ring is a hexagonal structure of six carbon atoms bonded by a resonating double-single covalent carbon-carbon bond. The plane formed by the ring has three axes of symmetry, where these axes are spaced 60 degrees apart. This particular degree of symmetry yields isotropic constitutive behavior in the plane of the ring.

FIG. 4.12—The body centered cubic crystal lattice system of metallic iron. While all the bonds between the iron atoms are identical, none is orthogonal.

FIG. 4.13.—Woven material with a 90 degree weave to the individual fibers.

FIG. 5.1—Newtonian fluids have a linear constitutive relationship, while the constitutive functions for shear thinning and shear thickening fluids are non-linear.

FIG. 5.2—The pressure forces, P, and viscous stresses, Tₓₓ, acting in the x-direction on a differential reference volume through which fluid is flowing at velocity vₓ.

FIG. 5.3—The velocity profile of steady state fluid flow in a confining channel a), as well as the stress equilibrium condition for the static hydrostatic stress condition b).

FIG. 5.4—A linear creep compliance and subsequent relaxation response of a uncross-linked polymer subject to a static stress a). Only the deviatoric response shows unconstrained deformation under loading. b) illustrates the deviatoric constitutive behavior of a Bingham material, defined in terms of applied shear stress and rate of deformation or strain rate.

FIG. 6.1—A cross-sectional surface schematic of a beam a) and the forces, the Fᵢⱼ, and bending moments, the Mᵢⱼ, acting within the beam b).

FIG. 6.2—The moments and shear forces acting about a differential element of a beam, a) and b), as well as the total differential resultant load, p·dx acting about the mass centroid of the beam, O, c).

FIG. 6.3—Plane sections, defined by cross-sections A, B, and C a) remain plane during deformation b). The resulting geometries of deformation are then used to define the curvature of the beam c).

FIG. 6.4—Two line positions a) within a beam retain the same relative separation during deformation b). From the relative changes in lengths of these line segments the resulting strain solution may be quantified as function of the distance y above or below the neutral axis.

FIG. 6.5—The symmetric distribution of the longitudinal loading function Fₓ a), and the differential distribution of that force b) which produces the resultant longitudinal force Fₓₓ and the bending moment M_{xz} c).

FIG. 6.6—The geometric relationship between the displacement w a) and the slope of the neutral axis that occurs as a resulting of bending b).

FIG. 6.7—A loaded cantilever beam a), the location of reaction force Rₒ needed to support the beam b), the location and direction of action of the maximum internal bending moment M_{xz} and shearing force F_{xy} c), as well as the distributed internal bending moment and shearing force d).

FIG. 6.8—Woven material with a 90 degree weave to the individual fibers.

FIG. 8.1—An arbitrary time dependent stress σ(t) and an associated delayed elasticity strain f*^{D}(t) function.

FIG. 8.2—The accuracy of any approximation for a historical delayed elasticity response is directly related to the time intervals between the incremental stresses approximations (see FIG. 8.3).

FIG. 8.3—The accuracy of an approximation for a stress history function, a) vs b), has a direct bearing on the accuracy of the strain history solution (FIG. 8.2). The better the stress history approximation the more accurate the solution for strain history.

FIG. 8.4—For real materials a static stress, δ₁σ, produces a time independent elastic impulse strain, ε₁^{E}, and a time dependent delayed elasticity strain, ε₁^{D}.

FIG. 8.5—For linear materials the incrementally applied static stresses, δₙσ, produce linearly additive time independent elastic impulse strains, the εₙ^{E}. The time dependent delayed elasticity strains, εₙ^{D}, are also linearly additive. All components of strain add linearly to give the total strain response as a function of time.

### DETAILED DESCRIPTION OF PREFERRED EMBODIMENT

### Section 1

Linear 3-D Viscoelastic Constitutive Functions

One dimensional constitutive functions for linear viscoelastic solid materials may be written in the form of,
σ(t)=1·f(t) ε, ε(t)=1·f*(t)σ 1.1
where ‘1’ is the unit vector and σ and ε are the magnitudes of an applied static stress or strain respectively. The relaxation modulus function, f(t), and the creep compliance function, f*(t), are scalar valued time dependent functions. σ(t) and ε(t) are the resulting time dependent stress and strain functions. The most generalized three dimensional Cartesian expressions for equations 1.1, may be written as,
σ(t)ᵢⱼ=fᵢⱼₖₗ(t_{kl)ε}ₖₗ, ε(t)ᵢⱼ=f*ᵢⱼₖₗ(tₖₗ)σₖₗ 1.2
and imply complete independence for each of the scalar valued fᵢⱼₖₗ(tₖₗ) and f*ᵢⱼₖₗ(tₖₗ) functions. These functions are analogous in form to the three dimensional linear elastic constitutive equations, i.e, εᵢⱼ=Dᵢⱼₖₗ·σₖₗ, etc.

For very small strain conditions the stress and strain functions of equations 1.2 may be defined in terms of either material or spatial coordinates, with little loss in accuracy. For convenience, and conforming to convention, we choose spatial coordinates.

1.1 Notation, Mechanical Coupling and Generalized 3-D Constitutive Functions

Limiting interest to small infinitesimal strains, as in the theory of linear elasticity, εⱼ and σⱼ may be defined in reduced indicial notation as,
σ₁=σ₁₁, σ₂=σ₂₂, σ₃=σ₃₃
σ₄=σ₁₃, σ₅=σ₂₃, σ₆=σ₁₂
σ₇=σ₃₁, σ₈=σ₃₂, σ₉=σ₂₁ 1.3
and
ε₁=ε₁₁, ε₂=ε₂₂, ε₃=ε₃₃
ε₄=2ε₁₃, ε₅=2 ε₃₂, ε₆=2ε₁₂
ε₇=2ε₃₁, ε₈=2ε₂₃, ε₉=2ε₂₁ 1.4
Expanding the second of equations 1.2 into a matrix format using reduced indicial notation yields,

$$\vert \begin{matrix}{ε}_{1} ( t ) \\ {ε}_{2} ( t ) \\ … \\ {ε}_{9} ( t )\end{matrix} \vert = \vert \begin{matrix}f {*}_{11} ( {t}_{1} ) & f {*}_{12} ( {t}_{2} ) & … & f {*}_{19} ( {t}_{9} ) \\ f {*}_{21} ( {t}_{1} ) & f {*}_{22} ( {t}_{2} ) & … & f {*}_{29} ( {t}_{9} ) \\ … & … & … & … \\ f {*}_{91} ( {t}_{1} ) & f {*}_{92} ( {t}_{2} ) & … & f {*}_{99} ( {t}_{9} )\end{matrix} \vert \vert \begin{matrix}{σ}_{1} \\ {σ}_{2} \\ … \\ {σ}_{9}\end{matrix} \vert \qquad 1.5$$

where the 81 creep compliance functions, the f*ᵢⱼ(tⱼ), are assumed to be completely independent and are functions of only when in time, the tⱼ, each σⱼ is applied.
Coupling

The assumed complete independence in the constitutive functions of equations 1.2 and 1.5 precludes reduction of the number of constitutive equations from nine to six since there can be no obvious symmetry in the assumed independent f*ᵢⱼ(tⱼ) or fᵢⱼ(tⱼ). Likewise, there can be no corresponding symmetry in the solutions for the shear strains or shear stresses. Assumed independence in the constitutive functions therefore produces solutions for εⱼ(t) and σⱼ(t) that are incompatible with established stress and strain theories, and which independently establish symmetry in both the shear stresses and in the shear strains. The assumed independence in the constitutive functions also violates the requirement for continuity in both the strain and displacements fields imposed by strain theory. As a consequence, the compatibility conditions, which demand coupling between strain responses, are likewise violated. The compatibility equations for small strain theory are,

$$\begin{matrix}\frac{{\partial }^{2} {ε}_{22}}{\partial {x}_{1}^{2}} + \frac{{\partial }^{2} {ε}_{11}}{\partial {x}_{2}^{2}} = 2 \frac{{\partial }^{2} {ε}_{12}}{\partial {x}_{1} \partial {x}_{2}} \\ \frac{{\partial }^{2} {ε}_{33}}{\partial {x}_{1}^{2}} + \frac{{\partial }^{2} {ε}_{11}}{\partial {x}_{2}^{2}} = 2 \frac{{\partial }^{2} {ε}_{13}}{\partial {x}_{1} \partial {x}_{3}} \\ \frac{{\partial }^{2} {ε}_{33}}{\partial {x}_{2}^{2}} + \frac{{\partial }^{2} {ε}_{22}}{\partial {x}_{3}^{2}} = 2 \frac{{\partial }^{2} {ε}_{23}}{\partial {x}_{2} \partial {x}_{3}} and & 1.6 \\ \frac{{\partial }^{2} {ε}_{33}}{\partial {x}_{1} \partial {x}_{2}} + \frac{{\partial }^{2} {ε}_{12}}{\partial {x}_{3}^{2}} = \frac{{\partial }^{2} {ε}_{23}}{\partial {x}_{1} \partial {x}_{3}} + \frac{{\partial }^{2} {ε}_{31}}{\partial {x}_{2} \partial {x}_{3}} \\ \frac{{\partial }^{2} {ε}_{22}}{\partial {x}_{1} \partial {x}_{3}} + \frac{{\partial }^{2} {ε}_{13}}{\partial {x}_{2}^{2}} = \frac{{\partial }^{2} {ε}_{12}}{\partial {x}_{2} \partial {x}_{3}} + \frac{{\partial }^{2} {ε}_{23}}{\partial {x}_{2} \partial {x}_{1}} \\ \frac{{\partial }^{2} {ε}_{11}}{\partial {x}_{2} \partial {x}_{3}} + \frac{{\partial }^{2} {ε}_{23}}{\partial {x}_{1}^{2}} = \frac{{\partial }^{2} {ε}_{13}}{\partial {x}_{1} \partial {x}_{2}} + \frac{{\partial }^{2} {ε}_{12}}{\partial {x}_{1} \partial {x}_{3}} & 1.7\end{matrix}$$

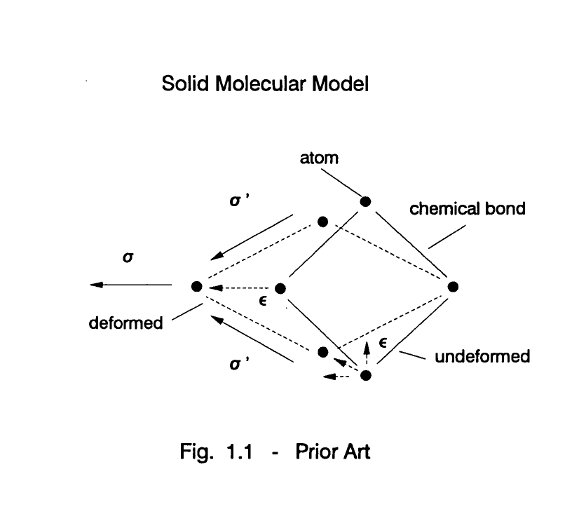

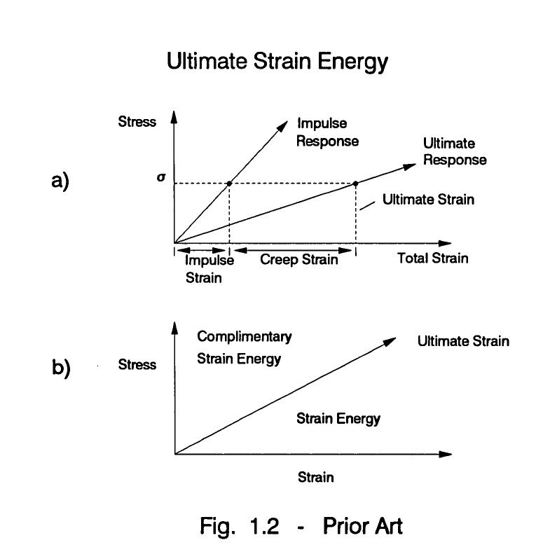

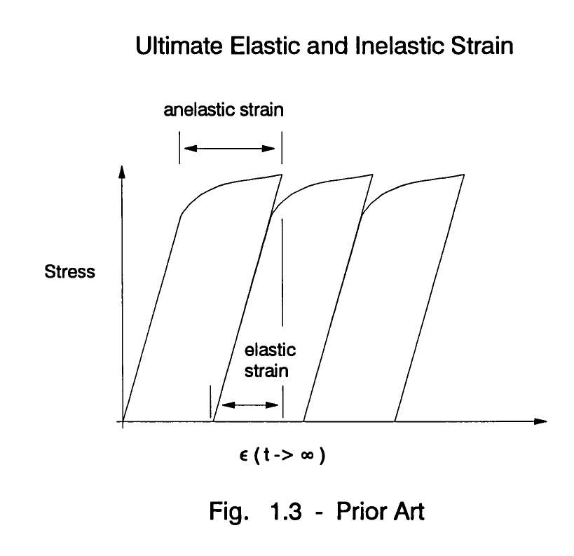

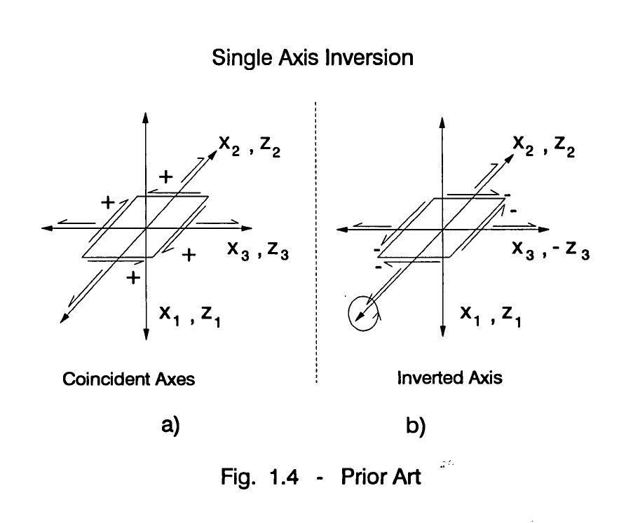

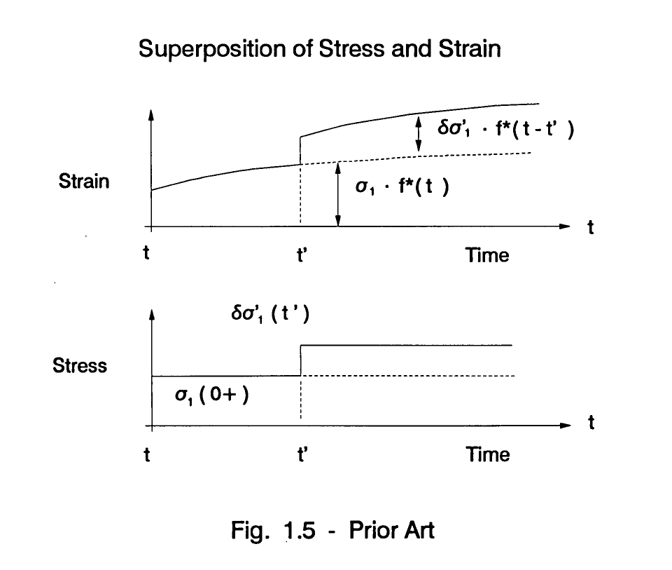

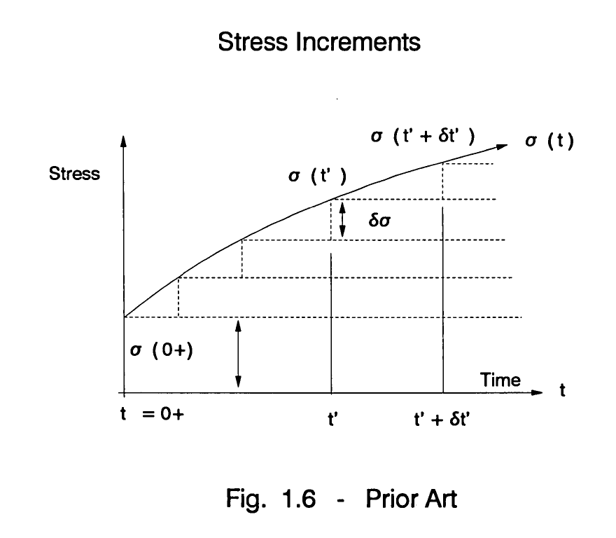

FIG. 1.1 illustrates bonding between atoms in some body, crystal or molecule of an arbitrary solid. Bonding and other interatomic forces distribute the induced internal stress produce by an applied load. These stresses in turn induce the distortions between atoms in the molecule or the crystal lattice. However, deformation in one given direction, although time dependent, must be coupled to deformation in any other direction. So, there is an incompatibility between physical reality and the assumption of independence in the f*ᵢⱼ(tⱼ) or fᵢⱼ(tⱼ).

It is also important to note that there is also an incompatibility between physical reality and the assumption of the existence of ‘perfectly linear’ constitutive behavior. Aside from the non-linearity in stress and strain functions associated with changes in internal lattice geometries, material constitutive behavior is fundamentally non-linear due to the non-linear nature of the electromagnetic forces acting between atoms, regardless of the material type or bonding condition. Contrary to what empirical data may imply, any linearity in material constitutive behavior, elastic or viscoelastic, can only be an approximation where linearity implicitly imposes a number of conditions that restrict ‘linear’ behavior to the small strain condition.

1.2 Reduction of the Function Matrix

Each scalar valued constitutive function, representative of a ‘real’ viscoelastic solid material, is always comprised of two physically measurable, independent and linearly additive component responses,
f*(t)=f*^{E}+f*^{D}(t) 1.8
The elastic impulse response of this arbitrary creep compliance function, f*^{E}, is time independent and a constant for linear materials. The second term, f*^{D}(t), is the time dependent delayed elasticity response that is, in general, non-linear in time.

Expanding one of the nine strain terms of equation 1.5, say ε₁(t), yields a sum of component strains,
ε₁(t)=f*₁₁(t₁)σ₁+f*₁₂(t₂)σ₂+ . . . +f*₁₉(t₉)σ₉=ε₁₁(t₁)+ε₁₂(t₂)+ . . . +ε₁₉(t₉) 1.9
and likewise for the other eight εᵢ(t). Obviously,
ε₁₁(t₁)=f*₁₁(t₁)σ₁ 1.10
and so on. If each static σⱼ is set to unity the f*ᵢⱼ(t) are equivalent to each component strain function, e.g., 1·f*₁₁(t₁)=ε₁₁(t₁). Variation in the magnitude of stress just scales the magnitude of the strain components, the εᵢⱼ(t). So, equation 1.10 may also be written as,
ε₁₁(t₁)=ε^{E}₁₁+ε^{D}₁₁(t₁) 1.11
etc.
The Unreal Materials

Consider the ‘unreal’ materials, those abstract and non-existent materials that lack an elastic impulse response. The f*ᵢⱼ(t) are now defined solely in terms of a time dependent delayed elastic response, f*ᵢⱼ(t)=f*^{D}ᵢⱼ(t). Set the static σⱼ=1, and apply all nine at the same initial time. If the functions of equation 1.5 are evaluated at some time t₁, the f*^{D}ᵢⱼ(t) become constant valued, i.e.,

$$\vert \begin{matrix}{Z}_{11} & {Z}_{12} & {Z}_{13} & … & {Z}_{19} \\ {Z}_{21} & {Z}_{22} & {Z}_{23} & … & {Z}_{29} \\ … & … & … & … & … \\ {Z}_{91} & {Z}_{92} & {Z}_{93} & … & {Z}_{99}\end{matrix} \vert \qquad 1.12$$

and likewise at some other time t₂,

$$\vert \begin{matrix}{Z}_{11}^{′} & {Z}_{12}^{′} & {Z}_{13}^{′} & … & {Z}_{19}^{′} \\ {Z}_{21}^{′} & {Z}_{22}^{′} & {Z}_{23}^{′} & … & {Z}_{29}^{′} \\ … & … & … & … & … \\ {Z}_{91}^{′} & {Z}_{92}^{′} & {Z}_{93}^{′} & … & {Z}_{99}^{′}\end{matrix} \vert \qquad 1.12$$

where the Zᵢⱼ and Z′ᵢⱼ are the values of f*^{D}ᵢⱼ(t) at t₁ and t₂ respectively. One constant can be expressed in terms of another constant multiplied by a scaling constant, so the relationship between f*^{D}₁₁(t) and f*^{D}₁₂(t) at time t₁, for example, becomes,
Z₁₂=f*^{D}₁₂(t₁)=k₁₂Z₁₁=k₁₂f*^{D}₁₁(t₁) 1.14
Likewise for f*^{D}₁₁(t) and f*^{D}₁₂(t) at time t₂,
Z′₁₂=f*^{D}₁₂(t₂)=k′₁₂Z′₁₁=k′₁₂f*^{D}₁₁(t₂) 1.15
As time t₁->t₂ the values of the f*^{D}ᵢⱼ(t) change, but the forms of the functions do not change. The function f*^{D}₁₂(t) at both times t₁ and t₂ is always defined in terms of f*^{D}₁₁(t). So, as time t₁->t₂ then f*^{D}₁₁(t₁)->f*^{D}₁₁(t₂), which demands that Z₁₁->Z′₁₁. Likewise f*^{D}₁₂(t₁)->f*^{D}₁₂(t₂), which demands that Z₁₂->Z′₁₂. The coefficients k₁₂ and k′₁₂ are time independent, so as t₁->t₂ equations 1.14 and 1.15 produce,
k₁₂f*^{D}₁₁(t₂)=k′₁₂f*^{D}₁₁(t₂) 1.16
where k₁₂=k′₁₂ for all time. Continuing for the remaining 80 f*^{D}ᵢⱼ(t) produces f*^{D}ᵢⱼ(t)=kᵢⱼ·f*^{D}₁₁(t). This solution not only satisfies the requirement of coupling in time between each component of strain, it also satisfies the defining requirement for linearity at very large time, call it t=∞, where each component of strain becomes a simple time independent and invariant function, a constant, that is scaled by both the values of the delayed elasticity function evaluated at t=∞ and the applied stresses.
The Real Materials

Equation 1.8 is the definition of the creep compliance function for all real materials. Expressing one of the strain components, say ε₁(t), of equation 1.5 in terms of each of the independent f*ᵢⱼ(t) yields,
ε₁(t)=f*₁₁(t₁)σ₁+f*₁₂(t₂)σ₂+ . . . +f*₁₉(t₉)σ₉=ε₁₁(t₁)+ε₁₂(t₂)+ . . . +ε₁₉(t₉) 1.17
and from equation 1.8,
ε₁(t)=[f*^{E}₁₁+f*^{D}₁₁(t₁)]σ₁+ . . . +[f*^{E}₁₉+f*^{D}₁₉(t₉)]σ₉ 1.18
which may be rewritten as,
ε₁(t)=f*^{E}₁₁σ₁+ . . . +f*^{E}₁₉σ₉+f*^{D}₁₁(t₁)σ₁+ . . . +f*^{D}₁₉(t₉)σ₉ 1.19
or
ε₁(t)=f*^{E}₁ⱼσⱼ+f*^{D}₁ⱼ(tⱼ)σⱼ 1.20
For all eᵢ(t) this leads to,
εᵢ(t)=[f*^{E}ᵢⱼ]σⱼ+[f*^{D}ᵢⱼ(tⱼ)]σⱼ=[f*^{E}ᵢⱼ+f*^{D}ᵢⱼ(tⱼ)]σⱼ 1.21

If the f*ᵢⱼ(tⱼ) are evaluated at time tⱼ=t=0+, these functions must degenerate into the impulse solution. The resulting coefficient matrix may always be written as f*^{E}ᵢⱼ=mᵢⱼ·f*^{E}, due to coupling through bonding, where the mᵢⱼ are constants and m₁₁=1, by choice of definition. f*^{E} is a scalar valued elastic impulse function, a constant. The impulse component represents an independent response, so equation 1.21 may be rewritten as,
εᵢ(t)−[mᵢⱼ]f*^{E}σⱼ+[f*^{D}ᵢⱼ(tⱼ)]σⱼ 1.22

Each of the delayed elasticity functions may be written as ε^{D}ᵢⱼ(tⱼ)=εᵢⱼ(t)−ε^{E}ᵢⱼ=f*^{D}ᵢⱼ(tⱼ) when the σⱼ₌1. From previous discussions pertaining to the ‘unreal’ materials we know that when the f*^{D}ᵢⱼ(tⱼ) are evaluated at equivalent but different time intervals (equations 1.14-1.16) the matrix of delayed elasticity functions will degenerate into a matrix of constants and a scalar value function of the form f*^{D}ᵢⱼ(t)=nᵢⱼ·f*^{D}(t), where n₁₁₌1, by choice of definition. Equation 1.22 then becomes,
εᵢ(t)=[mᵢⱼf*^{E}+nᵢⱼf*^{D}(tⱼ)]σⱼ 1.23
The times of application, the tⱼ, of each σⱼ have no effect of the form of f*^{D}(t), and the nᵢⱼ need not be equal to the mᵢⱼ. Any equivalence between the mᵢⱼ and the nᵢⱼ is a special case solution. The same procedures may be employed to derive the solution for stress producing,
σᵢ(t)=[aᵢⱼf^{E}+bᵢⱼf^{D}(tⱼ)]σⱼ 1.24

Equation 1.23 may also be written in terms of a single set of matrix coefficients and a single scalar valued constitutive function. Letting the tⱼ=t, for convenience, the expression for ε₁(t) from equation 1.23 becomes,
ε₁(t)=[f*^{E}+f*^{D}(t)]σ₁+[m₁₂f*^{E}+n₁₂f*^{D}(t)]σ₂+ . . . +[m₁₉f*^{E}+n₁₉f*^{D}(t)]σ₉ 1.25
where m₁₁=n₁₁=1. Likewise for the other eight εⱼ(t). Factoring out f*^{E}+f*^{D}(t) yields,

$${k}_{ij} ( t ) = \frac{{m}_{ij} f {*}^{E} + {n}_{ij} f {*}^{D} ( t )}{f {*}^{E} + f {*}^{D} ( t )} \qquad 1.26$$

where k₁₁=1. The right side of equation 1.22 now becomes,

$$[ {k}_{ij} ( t ) ] f * ( t ) {σ}_{j} = [ \frac{{m}_{ij} f {*}^{E} + {n}_{ij} f {*}^{D} ( t )}{f {*}^{E} + f {*}^{D} ( t )} ] [ f {*}^{E} + f {*}^{D} ( t ) ] {σ}_{j} \qquad 1.27$$

Note that the kᵢⱼ(t) are time dependent unless the mᵢⱼ=nᵢⱼ.

Note also that kᵢⱼ(t) is really kᵢⱼ(tⱼ) where there are six different times of application of each static stress. There are therefore six different values for f*^{D}(tⱼ) and the kᵢⱼ(tⱼ) matrix is not symmetric unless the six tⱼ=t, i.e., the six stresses are applied at the same initial time tₒ. For example n₁₂·f*^{D}(t₁)≠n₂₁·f*^{D}(t₂) unless t₁=t₂ even though n₁₂=n₂₁ because the two stresses σ₁ and σ₂ do not have the same times of initial application (the symmetry proof for the matrix coefficients is given in the next section). Clearly, f*^{D}(t₁)≠f*^{D}(t₂) and so k₁₂(t₁)≠k₂₁(t₂).

Let's now evaluate equations 1.26 and 1.27 at time tⱼ=0+, and tⱼ->∞. At time tⱼ=0+, f*^{D}(0+)->0, these equations yield the impulse solution where the kᵢⱼ(t)->mᵢⱼ. When time is large, say tⱼ->∞, then f*^{D}(t->∞) approaches an asymptotic elastic modulus. The kᵢⱼ(t->∞) are again constants, yielding,
εᵢ(t→∞)=[kᵢⱼ[f*^{E}+f*^{D}(t→∞)]σⱼ=[kᵢⱼ]f*(t→∞)σⱼ 1.28
which is identical in form to the linear elastic constitutive equations, but only at this time limit. At these two limiting times (or at any time) the values of the kᵢⱼ(t) are not equal unless the mᵢⱼ=nᵢⱼ.
The Number of Independent Constitutive Equations

From stress and strain theories we know that shear strains are symmetric and the shear stresses are symmetric if the stresses are not coupled. So, there are only six independent strains and six independent stresses. In the theory of elasticity the number of independent constitutive equations reduces from nine to six because of this symmetry. Evaluating at time t=0+, and taking into account symmetry in the ij and k1 indices of the mᵢⱼₖₗ and aᵢⱼₖₗ coefficients, the number of independent coefficients reduces from 81 to 36. Likewise for the bᵢⱼₖₗ and nᵢⱼₗ. The delayed elasticity component of equation 1.23 then reduces to,

$$\vert \begin{matrix}{ε}_{1}^{D} ( t ) \\ {ε}_{2}^{D} ( t ) \\ … \\ {ε}_{6}^{D} ( t )\end{matrix} \vert = \vert \begin{matrix}{n}_{11} & {n}_{12} & {n}_{13} & … & {n}_{16} \\ {n}_{21} & {n}_{22} & {n}_{23} & … & {n}_{26} \\ … & … & … & … & … \\ {n}_{61} & {n}_{62} & {n}_{63} & … & {n}_{66}\end{matrix} \vert \vert \begin{matrix}f {*}^{D} ( {t}_{1} ) \cdot {σ}_{1} \\ f {*}^{D} ( {t}_{2} ) \cdot {σ}_{2} \\ … \\ f {*}^{D} ( {t}_{6} ) \cdot {σ}_{6}\end{matrix} \vert \qquad 1.29$$

and so on.
1.3 System Energy and Symmetry in the Matrix Coefficients

In the theory of elasticity symmetry in the coefficient matrix may be demonstrated if a strain energy function exists. The basic assumptions involved are that strain is totally recoverable and deformation is adiabatic and/or isothermal with complete reversibility in heat transfer. Let's temporarily require deformation to be completely recoverable and slow enough such that it is isothermal, where heat transfer is completely reversible. Under these constraints a strain energy function will exist for the viscoelastic solids.

The second law of thermodynamics may be written as,

$$δ {E}_{ti} = U + {\int }_{{t}_{1}}^{{t}_{2}} [ J Q + Q ] ⅆ t \qquad 1.30$$

U represents the mechanical energy converted to recoverable elastic strain energy, while JQ represents mechanical energy converted to heat during deformation. Q represents heat loss and Eₜᵢ is total internal system energy. The integral term represents the net change in the total internal thermal energy, which has been constrained to be zero. For a complete deformation cycle this equation now reduces to, [symbol]
dEₜᵢ= [symbol] Pdt 1.31
where P is the stress power term, the time derivative of the elastic mechanical energy function, i.e, the strain energy function U.
Symmetry in the Matrix Coefficients

Both components of the function f(t) determine the magnitude of strain at any time t. Let's evaluate f^{D}(t) at a large finite time interval, call it t->∞, where the ‘ultimate’ strain has been reached. At this time the ultimate strain is the sum of the linear impulse strain, and the delayed elastic strain f^{D}(t->∞) (FIG. 1.2a). Equation 1.24 now becomes,
σᵢ(t→∞)=[aᵢⱼf^{E}+bᵢⱼf^{D}(t→∞)]εⱼ=[a′ᵢⱼ+b′ᵢⱼ]εⱼ=σ^{E}ᵢ+σ^{D}ᵢ(t→∞) 1.32
where a′ᵢⱼ=aᵢⱼ·f^{E} and b′ᵢⱼ=bᵢⱼ·f^{D}(t->∞). Likewise for equation 1.23,
εᵢ(t→∞)=[mᵢⱼf*^{E}+nᵢⱼf*^{D}(t→∞)]σⱼ=[m′ᵢⱼ+n′_{ij]σ}ⱼ=ε^{E}ᵢ+ε^{D}ᵢ(t→∞) 1.33
where m′ᵢⱼ=mᵢⱼ·f*^{E} and n′ᵢⱼ=nᵢⱼ·f*^{D}(t->∞).

Equations 1.32 and 1.33 are linear, so strain energy or complimentary strain energy functions derived from these solutions will also be linear. The strain energy function U is the sum of impulse component of strain energy, U^{E}, and the delayed elastic component of strain energy, U^{D}, i.e.,
U_{(t→∞)}=∫^{ε}^{ⱼ}σᵢ(t→∞)=dεⱼ=∫^{ε}^{ⱼ}[σ^{E}ᵢ+σ^{D}ᵢ(t→∞)]dεⱼ=U^{E}+U^{D}_{(t→∞)} 1.34
(Note that deformation also produces a kinetic energy term, call it KE, that is equal to zero for static equilibrium conditions). If only the ultimate strain is considered (FIG. 1.2b), the maximum possible value for strain energy is the area under the stress-ultimate strain curve. Given that stress and strain are monotonically related functions and that equation 1.34 is linear and continuous we may demand the equivalence,

$$\frac{{\partial }^{2} {U}_{( t -> ∞ )}}{\partial {ε}_{i} \partial {ε}_{j}} = \frac{{\partial }^{2} {U}_{( t -> ∞ )}}{\partial {ε}_{j} \partial {ε}_{i}} \qquad 1.35$$

and likewise for U^{E} and U^{D}.

Let's evaluate equations 1.35 for the derivatives of the strains ε₁ and ε₂. From equations 1.32 and 1.34 the first derivative with respect to ε₁ is,

$$\frac{{\partial }^{2} {U}_{( t - ∞ )}}{\partial {ε}_{1}} = {a}_{1 j} {f}^{E} {ε}_{j} + {b}_{1 j} {f}^{D} ( t -> ∞ ) {ε}_{j} \qquad 1.36$$

The derivative with respect to ε₂ is then,

$$\frac{{\partial }^{2} {U}_{( t -> ∞ )}}{\partial {ε}_{1} \partial {ε}_{2}} = {a}_{12} {f}^{E} + {b}_{12} {f}^{D} ( t -> ∞ ) \qquad 1.37$$

Inverting the order of differentiation yields,

$$\frac{{\partial }^{2} {U}_{( t -> ∞ )}}{\partial {ε}_{2} \partial {ε}_{1}} = {a}_{21} {f}^{E} + {b}_{21} {f}^{D} ( t -> ∞ ) \qquad 1.38$$

Equating the results of equations 1.37 and 1.38 then yields,
a₂₁f^{E}+b₂₁f^{D}(t→∞)=a₁₂f^{E}+b₁₂f^{D}(t→∞) 1.39
or
(a₂₁−a₁₂)f^{E}+(b₂₁−b₁₂)f^{D}(t→∞)=0 1.40
f(t) is non-zero in value for time t>0, so the coefficient differences must equal zero, and a₁₂=a₂₁ and b₁₂=b₂₁. These equivalences are independent of f^{E} and f^{D}(t) and therefore hold true for any time t>t=0+. Continuing for all possible variations will show that the aᵢⱼ=aⱼᵢ and bᵢⱼ=bⱼᵢ when i≠j. A similar result may be obtained from the complimentary strain energy function yielding mᵢⱼ=mⱼᵢ and nᵢⱼ=nⱼᵢ when i≠j. Each matrix is symmetric, with only 20 unknown coefficients (recall that m₁₁=n₁₁=1 by choice of definition). Because symmetry is independent of strain and the constitutive function, it must also be independent of stress, and hence independent of the magnitude of the recoverable strain energy as well as any change in strain energy.

As a material deforms the change in total internal energy is a function of both the change in the elastic strain energy, and the change in internal thermal energy. However, if the elastic energy term in equation 1.31 is evaluated for symmetry, but at some different temperature, we shall again obtain the symmetry solution for the coefficient matrices. The values of constitutive functions and the matrix coefficients may be functions of temperature (see section 1.5), but matrix symmetry is not a function of temperature nor of a change in temperature. Matrix symmetry is independent of the state of internal energy, so coefficient symmetry is independent of both the state of total internal energy, and changes in total internal energy.

Matrix symmetry is also independent of the state of strain, including non-recoverable strain. Non-recoverable strain is the consequence of a different physical process other than simple elastic deformation, e.g., the breaking and reforming of bonds, as in ductile plastic deformation of metals. However, so long as the material remains intact, the viscoelastic constitutive equations at any strain state condition will not change form. No matter the magnitude of unrecoverable strain (FIG. 1.3), the linear viscoelastic constitutive equations will always be given in terms of scalar valued constitutive equations and symmetric matrices of coefficients. The values of the matrix coefficients and the form of the constitutive functions may change, but the basic form of the equations does not.

1.4 Material Symmetry Considerations

The number of non-zero matrix coefficients associated with any degree of material anisotropy may be determined using the methods employed in the theory of linear elasticity, and require the vector transformation equations,

$$ε {*}_{ij} = \frac{\partial {z}_{j}}{\partial {x}_{k}} \frac{\partial {z}_{i}}{\partial {x}_{l}} {ε}_{kl} , σ {*}_{ij} = \frac{\partial {z}_{j}}{\partial {x}_{k}} \frac{\partial {z}_{i}}{\partial {x}_{l}} {σ}_{kl} \qquad 1.41$$

where the partial derivatives are the direction cosines. The constitutive functions f*^{E}, f^{E}, f*^{D}(t) and f^{D}(t) are all scalar valued functions and are therefore unaffected by reference frame transformations.
One Plane of Symmetry (Aelotroic Materials)

A plane within a body of material is considered symmetric if, for every pair of coordinate systems located at a point on that plane, which are mirror images of each other, the matrix coefficients have the same values at that same point. If two Cartesian reference frames are defined to be coincident with each other, this symmetry condition is equivalent to flipping one-axis of one spatial reference frame 180 degrees with respect to another axis of the other spatial reference frame (FIG. 1.4).

Define two reference frames, xᵢ and zᵢ, where the x₁-x₂ and z₁-z₂ axes are coincident, but where z₃=−X₃. Let stress and strain of the xᵢ system be σ and ε, while stress and strain associated with the zᵢ system are σ* and ε*. The defining axial transformations are x₁=z₁, x₂=z₂ and x₃=−z₃. So, equation 1.41 yields the following direction cosines,

$$\begin{matrix}\frac{\partial {z}_{1}}{\partial {x}_{1}} = 1 , \frac{\partial {z}_{2}}{\partial {x}_{2}} = 1 , \frac{\partial {z}_{3}}{\partial {x}_{3}} = - 1 \\ and & 1.42 \\ \frac{\partial {z}_{1}}{\partial {x}_{3}} = \frac{\partial {z}_{1}}{\partial {x}_{2}} = \frac{\partial {z}_{2}}{\partial {x}_{1}} = \frac{\partial {z}_{2}}{\partial {x}_{3}} = \frac{\partial {z}_{3}}{\partial {x}_{1}} = \frac{\partial {z}_{3}}{\partial {x}_{2}} = 0 & 1.43\end{matrix}$$

Substituting equations 1.42 and 1.43 into equation 1.41 yields σ*ᵢⱼ=σᵢⱼ, and ε*ᵢⱼ=εᵢⱼ, except as follows,
σ*₂₃=−σ₃₂, σ*₃₁=−σ₁₃
ε*₂₃=−ε₃₂, ε*₃₁=−σ₁₃ 1.44

Letting tⱼ=t in equation 1.24 produces the following two equations for σ₁(t),
σ₁(t)=[a₁ⱼf^{E}+b₁ⱼf^{D}(t)]εⱼ 1.45
and
σ*₁(t)=[a₁ⱼf^{E}+b₁ⱼf^{D}(t)]ε*ⱼ 1.46
Substitution of the appropriate σ*ᵢ and ε*ᵢ transformations into equation 1.46 produces,
σ₁(t)=[a₁₁ε₁+a₁₂ε₂+a₁₃ε₃−a₁₄ε₄−a₁₅ε₅+a₁₆ε₆]f^{E}+[b₁₁ε₁+b₁₂ε₂+b₁₃ε₃−b₁₄ε₄−b₁₅ε₅+b₁₆ε₆]f^{D}(t) 1.47
as well as the untransformed expression of equation 1.45,
σ₁(t)=[a₁₁ε₁+a₁₂ε₂+a₁₃ε₃+a₁₄ε₄+a₁₅ε₅+a₁₆ε₆]f^{E}+[b₁₁ε₁+b₁₂ε₂b₁₃ε₃b₁₄ε₄+b₁₅ ε₅+b₁₆ε₆]f^{D}(t) 1.48
Subtracting one equation from the other yields,
0=[−2a₁₄ε₄−2a₁₅ε₄]f^{E}+[−2b₁₄ε₅−2b₁₅ε₅]f^{D}(t) 1.49
for all arbitrary values of ε₄ and ε₅. Evaluating at time t>0, when the strains are not zero, equation 1.49 is satisfied only if the a₁₄=a₁₅=0, and b₁₄=b₁₅=0. Similar results will be obtained for transformations of σ₂(t), σ₃(t), and σ₆(t).

Continuing for the shear stresses yields the following equivalences for σ₄(t),
−σ₄(t)=[a₄₁ε₁+a₄₂ε₂+a₄₃ε₃−a₄₄ε₄−a₄₅ε₅+a₄₆ε₆]f^{E}+[b₄₁ε₁+b₄₂ε₂+b₄₃ε₃−b₄₄ε₄−b₄₅ε₅+b₄₆ε₆]f^{D}(t) 1.5
and the untransformed expression,
σ₄(t)−[a₄₁ε₁+a₄₂ε₂+a₄₃ε₃+a₄₄ε₄+a₄₅ε₅+a₄₆ε₆]f^{E}+[b₄₁ε₁+b₄₂ε₂+b₄₃ε₃+b₄₄ε₄+b₄₅ε₅+b₄₆ε₆]f^{D}(t) 1.51
Adding these equations produces,
0=[2a₄₁ε₁+2a₄₂ε₂+2a₄₃ε₃2a₄₆ε₆]f^{E}+[2b₄₁ε₁+2b₄₂ε₂+2b₄₃ε₃+2b₄₆ε₆]f^{D}(t) 1.52
Evaluating as before yields a₄₁=a₄₂=a₄₃=a₄₆=0, and b₄₁=b₄₂b₄₃=b₄₆=0. Similar results will be obtained for the transformation of σ₅(t).

The above results now produce the following solution for the aᵢⱼ matrix,

$$\vert \begin{matrix}{a}_{11} & {a}_{12} & {a}_{13} & 0 & 0 & {a}_{16} \\ {a}_{21} & {a}_{22} & {a}_{23} & 0 & 0 & {a}_{26} \\ {a}_{31} & {a}_{32} & {a}_{33} & 0 & 0 & {a}_{36} \\ 0 & 0 & 0 & {a}_{44} & {a}_{45} & 0 \\ 0 & 0 & 0 & {a}_{54} & {a}_{55} & 0 \\ {a}_{61} & {a}_{62} & {a}_{63} & 0 & 0 & {a}_{66}\end{matrix} \vert \qquad 1.53$$

and similarly for the bᵢⱼ, mᵢⱼ and nᵢⱼ matrices. The number of independent coefficients in each matrix has been reduced to 13, because the aᵢⱼ=aᵢⱼ, etc. Note from equation 1.27 that the number of non-zero kᵢⱼ(t) coefficients is also 13. This result and solutions for the number of non-zero matrix coefficients matrix for the other degrees of material symmetry or isotropy are identical to those obtained for the linear elastic materials.
Isotropic Linear Viscoelastic Materials

For isotropic materials the constitutive equations degenerate to a form very similar to the equations of isotropic linear elastic materials. Skipping the derivation, which is straight-forward, the constitutive equations for the time dependent strain field reduces to,

$${ε}_{ij} ( t ) = \frac{K * ( t )}{9} {σ}_{kk} {δ}_{ij} + \frac{G * ( t )}{2} {σ}_{ij}^{′} \qquad 1.54$$

where the σₖₖ·δᵢⱼ are the hydrostatic stresses, and the σ′ᵢⱼ are the deviatoric stresses. The bulk modulus K*(t) and shear modulus functions G*(t) are defined as,

$$\begin{matrix}K * ( t ) = 3 ( 1 + 2 {m}_{12} ) [ f {*}^{E} + \frac{( 1 + 2 {n}_{12} )}{( 1 + 2 {m}_{12} )} f {*}^{D} ( t ) ] \\ and & 1.55 \\ G * ( t ) = 2 ( 1 - {m}_{12} ) [ f {*}^{E} + \frac{( 1 - {n}_{12} )}{( 1 - {m}_{12} )} f {*}^{D} ( t ) ] & 1.56\end{matrix}$$

Only when the mᵢⱼ≈nᵢⱼ are the bulk modulus function and the shear modulus function described by what appears to be the same scalar valued constitutive function, f*(t). Similar expressions may be derived for the time dependent stress field of equation 1.24 as well.
1.5 Temperature Effects

Both the constitutive functions and the matrix coefficients may be functions of temperature. Letting the variable θ represent temperature equation 1.23 may be written as,
εᵢ(t, θ)=[mᵢⱼ(θ)]f*^{E}(θ)σⱼ+[nᵢⱼ(θ)]f*^{D}(t, θ)σⱼ 1.57
The variation in the mᵢⱼ and nᵢⱼ coefficients as functions of temperature is easy to understand if we recognize that the bond forces acting between atoms need not be geometrically symmetric or orthogonal, and the bonds need not be identical or between atoms of the same element. The same holds true for the other interatomic forces. As a consequence, temperature variations may produce geometric changes in lattice structure as different bond types, or similar types of bonds (covalent, ionic, etc.) between atoms of different elements expand or contract with different differential increments. Additionally, the relative strengths of each bond type, or of bonds between atoms of different elements, need not have the same differential variations for some incremental temperature change. Again, the nature of the forces acting between atoms demands that the expansion or contraction of the bonds be fundamentally non-linear. The same holds true for the other interatomic forces. So, the mᵢⱼ(θ) and nᵢⱼ(θ) are, in general, non-linear functions of temperature. Furthermore, as shall become apparent shortly, they can also be functions of time as the temperature varies.

Now, for a body of material a non-uniform temperature distribution would demand non-homogeneity in material properties. Restricting the temperature in a volume of material to be uniform, the mᵢⱼ(θ) and nᵢⱼ(θ) coefficients are then functions of the same independent scalar valued variable θ. If variations in temperature are sufficiently small such that there are inconsequential geometric changes to bonding angles and negligible differences in the relative changes of the bonding and non-bonding forces operating between atoms, then it is clear that the two coefficient matrices reduce to,
mᵢⱼ(θ)=mᵢⱼ nᵢⱼ(θ)=nᵢⱼ 1.58
and equation 1.57 now reduces to,
εᵢ(t,θ)=[mᵢⱼ]f*^{E}(θ)σⱼ+[nᵢⱼ]f*^{D}(t, θ)σⱼ 1.59
Temperature Induced Strains

In an undeformed condition let the state of internal stress be zero. Deformation will produce a change in internal thermal energy. Similarly, any change in material temperature will produce a change in material volume, i.e., it contracts or expands. Return to equation 1.26 and set the applied stresses, σⱼ, to zero, change the temperature of the material, and allow a corresponding change in material volume. This leads to a constitutive function of the form,
εᵢ(t,δθ)=Aᵢ(t,δθ) 1.60
δθ=θ−θₒ.θ is some new temperature, and θₒ is the reference temperature where the functions Aᵢ(t,0)=0, by choice of definition. The time t defines the time interval from the time of change from the reference temperature, θₒ.

Thermal expansion or contraction produces a stretch or compression in the bonds between atoms, as when subjected to a mechanical stress. The functions Aᵢ(t,δθ) must therefore, in general, be characterized like the mechanical constitutive functions, i.e.,
Aᵢ(t,δθ)=A^{E}ᵢ(δθ)+A^{D}ᵢ(t,δθ) 1.61
Once again restrict the change in temperature such that geometric changes in lattice structure and differences in relative changes of the bonding and non-bonding forces are negligible. Each elastic thermal strain function, the A^{E}ᵢ(δθ), and each delayed thermal strain function, the A^{D}ᵢ(t,δθ), are functions of the same variables, and must likewise be coupled. So equation 1.61 reduces to,
εᵢ(t,δθ)=Aᵢ(t,δθ)=αᵢA^{E}(δθ)+βᵢA^{D}(t,δθ) 1.62
where the αᵢ and βᵢ are constants, and α₁=β₁=1, by choice of definition. Note that this function also includes a subset of solutions where the time dependent component is a product of two non-linear functions, i.e.,
A^{D}(t,δθ)=A^{D}(t)·H(δθ) 1.63

The number of non-zero αᵢ and βᵢ and any equivalences between the αᵢ, and between the βᵢ, are determined from material symmetry considerations. For the special case of isotropy the coefficients α₁=α₂=α₃, β₁=β₂=β₃, and α₄=α₅=α₆=β₄=β₅=β₆=0.

The functions that define equations 1.62 and 1.63 are, in general, non-linear functions of temperature. If they are approximately linear for some range in temperature change, even for very large time, then equation 1.63 reduces to the approximation,
εᵢ(t,δθ)=αᵢA^{E}δθ+βᵢA^{D}(t)δθ=[αᵢA^{E}+βᵢA^{D}(t)]δθ 1.64
A^{E} and A^{D}(t) are now scalar valued coefficients of thermal expansion/contraction. For a large time interval, t->∞, the function A^{D}(t->∞) is constant, and from equation 1.59 the function 1.64 reduces to,
εᵢ(t→∞,δθ)=[αᵢA^{E}+βᵢA^{D}(t→∞)]δθ=Aᵢ(t→∞)δθ 1.65
Linear Thermo-Viscoelastic Constitutive Equations

Equations 1.59 and 1.64 produce the generalized thermo-viscoelastic function,
εᵢ(t, θ)=[mᵢⱼ]f*^{E}(θ)σⱼ+[nᵢⱼ]f*^{D}(tθ)σⱼ+[αᵢA^{E}+βᵢA^{D}(τ)]δθ 1.66
where the time variable τ has been used for the temperature function. Apply a set of stresses, σᵢ, to a body of material. If the resulting deformation does not cause any appreciable temperature change in the material, the effects of loading induced deformation and temperature may be uncoupled (an approximation). The effects of temperature change and loading are now separate and linearly additive, so the resulting thermo-viscoelastic constitutive equation becomes,
εᵢ(t, δθ)−[mᵢⱼ]f*^{E}σⱼ+[nᵢⱼ]f*^{D}(t) σⱼ+[αᵢA^{E}+βᵢA^{D}(τ) ]δθ 1.67
provided the temperature change has a negligible effect on f*^{E} and f*^{D}(t). Evaluating equation 1.67 at sufficiently large time, t=>∞ and τ=>∞, then f*^{D}(t=>∞) and A(τ=>∞) become constants. Equations 1.28 and 1.67 then yield,
εᵢ(t→∞, δθ)−[kᵢⱼ(t→∞)]f*(t→∞) σⱼ+Aᵢ(τ→∞)δθ 1.68
which is identical in form to the Duhamel-Neumann equations of linear thermo-elasticity where the coefficients of thermal expansion are taken to be a simple constants. In fact, dropping the time dependent functions in equation 1.67 when they are negligible will produce the Duhamel-Neumann equations for ‘perfect ’ elasticity, a non-existent material condition. Similar functions may be written for the stress equations.
1.6 Linear Hereditary Integrals

Strain in any ‘perfect ’ linear elastic material is solely dependent upon the magnitude of the stress acting on the material at any point in time. Stress may have been applied in different increments and at different times, but because the constitutive equation is time independent the magnitude of the strain will always be known at any specific time, regardless of when the stress increments were applied. Viscoelastic materials don't behave in this fashion. The resulting strain is a function of time, even if the applied stress is static, so the strain history is very much dependent upon the stress history.

Consider the three dimensional linear constitutive equation for static loading given by,
εᵢ(t)=[mᵢⱼ]f*^{E}σⱼ+[nᵢⱼ]f*^{D}(tⱼ)σⱼ 1.69
The strain component ε₁₁(t) is defined by,
ε₁₁(t)=m₁₁f*^{E}σ₁+n₁₁f*^{D}(t₁)σ₁ 1.70
Let an impulse stress σ₁=σ₁(0+) be applied at time t=0+. At another time t=t′ some incremental impulse stress δσ₁(t′) is applied. FIG. 1.5 illustrates the resulting stress and strain solutions as functions of time. The delayed elasticity function is only a function of time, so the strains associated with each applied stress are additive and the solution for total strain is,
ε₁₁(t)=m₁₁f*^{E}[σ₁(0+)+δσ₁(t′)]+n₁₁[σ₍0+)f*^{D}(t)+δσ₁(t′)f*^{D}(t−t′)] 1.71

There are two parts to this function, the initial impulse stress σ₁·δ(t), and a series of incremental impulse stress functions, the δσ′₁·δ(t−t′). The strain at some time t′ is the sum of all the strains caused by all the loading steps (FIG. 1.6) that have occurred at the various time intervals t′, i.e.,

$$\begin{matrix}{ε}_{11} ( t ) = {m}_{11} f {*}^{E} {σ}_{1} ( 0 + ) + {m}_{11} f {*}^{E} {\int }_{0 +}^{t} ⅆ {σ}_{1} ( {t}^{′} ) + \\ {n}_{11} {σ}_{1} ( 0 + ) f {*}^{D} ( t ) + {n}_{11} {\int }_{0 +}^{t} f {*}^{D} ( t - {t}^{′} ) \frac{ⅆ {σ}_{1} ( {t}^{′} )}{ⅆ {t}^{′}} ⅆ {t}^{′}\end{matrix} \qquad 1.72$$

where the differential stress, dσ₁(t′), may also be defined as,

$$d {σ}_{1} ( {t}^{′} ) = d {t}^{′} [ {lim}_{{t}^{′} -> o} \frac{δ {σ}_{1} ( {t}^{′} )}{δ {t}^{′}} ] = ( \frac{ⅆ {σ}_{1} ( {t}^{′} )}{ⅆ {t}^{′}} ) d {t}^{′} \qquad 1.73$$

Integrating the impulse integral term equation 1.72 becomes,

$$\begin{matrix}{ε}_{11} ( t ) = {m}_{11} f {*}^{E} {σ}_{1} ( t ) + {n}_{11} {σ}_{1} ( 0 + ) f {*}^{D} ( t ) + \\ {n}_{11} {\int }_{0 +}^{t} f {*}^{D} ( t - {t}^{′} ) \frac{ⅆ {σ}_{1} ( {t}^{′} )}{ⅆ {t}^{′}} ⅆ {t}^{′}\end{matrix} \qquad 1.74$$

Separate equation 1.74 into the impulse response ε^{E}₁₁(t)
ε^{E}₁₁(t)=m₁₁ f*^{E}σ₁(t) 1.75
and the delayed elastic response ε^{D}₁₁(t),

$${ε}_{11}^{D} ( t ) = {n}_{11} {σ}_{1} ( 0 + ) f {*}^{D} ( t ) + {n}_{11} {\int }_{0 +}^{t} f {*}^{D} ( t - {t}^{′} ) \frac{ⅆ {σ}_{1} ( {t}^{′} )}{ⅆ {t}^{′}} ⅆ {t}^{′} \qquad 1.76$$

The delayed elasticity term may be recast through integration by parts as,

$$\begin{matrix}{ε}_{11}^{D} ( t ) = {n}_{11} {σ}_{1} ( 0 + ) f {*}^{D} ( t ) + {{n}_{11} [ f {*}^{D} ( t - {t}^{′} ) {σ}_{1} ( {t}^{′} ) ]}_{0 +}^{t} - \\ {n}_{11} {\int }_{0 +}^{t} {σ}_{1} ( {t}^{′} ) \frac{ⅆ f {*}^{D} ( t - {t}^{′} )}{ⅆ {t}^{′}} ⅆ {t}^{′}\end{matrix} \qquad 1.77$$

When the bracketed term is evaluated, the sum of the second term and the strain term n₁₁·σ₁(0+)·f*^{D}(t) is zero. So, equation 1.77 reduces to,

$${ε}_{11}^{D} ( t ) = {n}_{11} {σ}_{1} ( t ) f {*}^{D} ( 0 + ) - {n}_{11} {\int }_{0 +}^{t} {σ}_{1} ( {t}^{′} ) \frac{ⅆ f {*}^{D} ( t - {t}^{′} )}{ⅆ {t}^{′}} ⅆ {t}^{′} \qquad 1.78$$

However, f*^{D}(t) has no impulse response, so f*^{D}(0+)->0 and equation 1.78 becomes,

$${ε}_{11}^{D} ( t ) = - {n}_{11} {\int }_{0 +}^{t} {σ}_{1} ( {t}^{′} ) \frac{ⅆ f {*}^{D} ( t - {t}^{′} )}{ⅆ {t}^{′}} ⅆ {t}^{′} \qquad 1.79$$

Now define the variable s as s=t−t′, the elapsed time between the initial load and the first incremental load. With a sequence of incremental differential loads the elapsed differential time between each incremental differential load is simply dt′, so ds=−dt′. From this definition the differential expression in the integral may be rewritten as,

$$\frac{ⅆ f {*}^{D} ( t - {t}^{′} )}{ⅆ {t}^{′}} = - \frac{ⅆ f {*}^{D} ( t - {t}^{′} )}{ⅆ ( t - {t}^{′} )} \qquad 1.80$$

Equation 1.79 then becomes,

$${ε}_{11}^{D} ( t ) = {n}_{11} {\int }_{0 +}^{t} {σ}_{1} ( {t}^{′} ) \frac{ⅆ f {*}^{D} ( t - {t}^{′} )}{ⅆ ( t - {t}^{′} )} ⅆ {t}^{′} \qquad 1.81$$

Combining equations 1.81 and 1.75 produces the final solution,

$${ε}_{11} ( t ) = {m}_{11} f {*}^{E} {σ}_{1} ( t ) + {n}_{11} {\int }_{0 +}^{t} {σ}_{1} ( {t}^{′} ) \frac{ⅆ f {*}^{D} ( t - {t}^{′} )}{ⅆ ( t - {t}^{′} )} ⅆ {t}^{′} \qquad 1.82$$

There are five more terms in the solution for the strain component ε₁(t). Letting tⱼ=t for convenience, and repeating this exercise for the remaining components produces,

$${ε}_{1} ( t ) = {m}_{1 j} f {*}^{E} {σ}_{j} ( t ) + {n}_{1 j} {\int }_{0 +}^{t} {σ}_{j} ( {t}^{′} ) \frac{ⅆ f {*}^{D} ( t - {t}^{′} )}{ⅆ ( t - {t}^{′} )} ⅆ {t}^{′} \qquad 1.83$$

Similar expressions will be obtained for the other five εᵢ(t), yielding the final hereditary integral solution,

$${ε}_{i} ( t ) = {m}_{ij} f {*}^{E} {σ}_{j} ( t ) + {n}_{ij} {\int }_{0 +}^{t} {σ}_{j} ( {t}^{′} ) \frac{ⅆ f {*}^{D} ( t - {t}^{′} )}{ⅆ ( t - {t}^{′} )} ⅆ {t}^{′} \qquad 1.84$$

In similar fashion an integral expression may be derived for the relaxation phase, i.e.,

$${σ}_{i} ( t ) = {a}_{ij} {f}^{E} {ε}_{j} ( t ) + {b}_{ij} {\int }_{0 +}^{t} {ε}_{j} ( {t}^{′} ) \frac{ⅆ {f}^{D} ( t - {t}^{′} )}{ⅆ ( t - {t}^{′} )} ⅆ {t}^{′} \qquad 1.85$$

where f^{D}(t) is the relaxation modulus function and tⱼ=t.
Temperature Effects

As with the delayed elasticity response function in equation 1.84, a time dependent temperature function δθ(τ) and the corresponding linear delayed thermal strain function A^{D}(τ) will produce a thermal strain response that is out of phase with the linear time independent function, A^{E}. Following the same procedures as outlined above we may derive a hereditary integral function for the time dependent temperature function δθ(τ), the elastic thermal stain function A^{E}, the delayed thermal strain function A^{D}(τ), the coefficients α₁ and βᵢ, and time τ. Beginning with equation 1.67, but skipping the details of the derivation, the complete form of the resulting linear thermo-viscoelastic hereditary integral equation will be given by,

$${ε}_{i} ( t ) = {m}_{ij} f {*}^{E} {σ}_{j} ( t ) + {n}_{ij} {\int }_{{t}_{o}^{+}}^{t} {σ}_{j} ( {t}^{′} ) \frac{ⅆ f {*}^{D} ( t - {t}^{′} )}{ⅆ ( t - {t}^{′} )} ⅆ {t}^{′} + {α}_{i} {A}^{E} δ θ ( τ ) + {β}_{i} {\int }_{{τ}_{o}^{+}}^{τ} δ θ ( {τ}^{′} ) \frac{ⅆ {A}^{D} ( τ - {τ}^{′} )}{ⅆ ( τ - {τ}^{′} )} ⅆ {τ}^{′} \qquad 1.86$$

If the time dependent functions f*^{D}(t) and A^{D}(τ) are inconsequential in defining material response, equation 1.86 again reduces to the Duhamel-Neumann equation of thermo-elasticity,
εᵢ(t,δθ)=mᵢⱼf*^{E}σⱼ(t)+αᵢA^{E}δθ(τ) 1.87
Sequential Loading

When each dynamic load is applied at some different initial time, the time variables in the hereditary integral functions need to be adjusted appropriately. In such a case it may readily be shown that the hereditary integral function of equation 1.81 may be written in the form,

$${ε}_{i} ( t ) = {m}_{ij} f {*}^{E} {σ}_{j} ( {τ}_{k} ) + {n}_{ij} {\int }_{{t}_{k}}^{t} {σ}_{j} ( {t}^{′} ) \frac{ⅆ f {*}^{D} ( {τ}^{′} )}{ⅆ ( {τ}^{′} )} ⅆ {t}^{′} \qquad 1.88$$

where the dummy variable k sets the order of application in time, tₖ, of each successively applied loading function, the σⱼ(τₖ). The variables τₖ and τ′ are defined as,
τₖ=t−tₖ, τ′=t−t′ 1.89
A similar expression may likewise be derived for the stresses,

$${σ}_{i} ( t ) = {a}_{ij} {f}^{E} {ε}_{j} ( {τ}_{k} ) + {b}_{ij} {\int }_{{t}_{k}}^{t} {ε}_{j} ( {t}^{′} ) \frac{ⅆ {f}^{D} ( {τ}^{′} )}{ⅆ ( {τ}^{′} )} ⅆ {t}^{′} \qquad 1.90$$

### Section 2

3-D Non-Linear Elastic Constitutive Functions

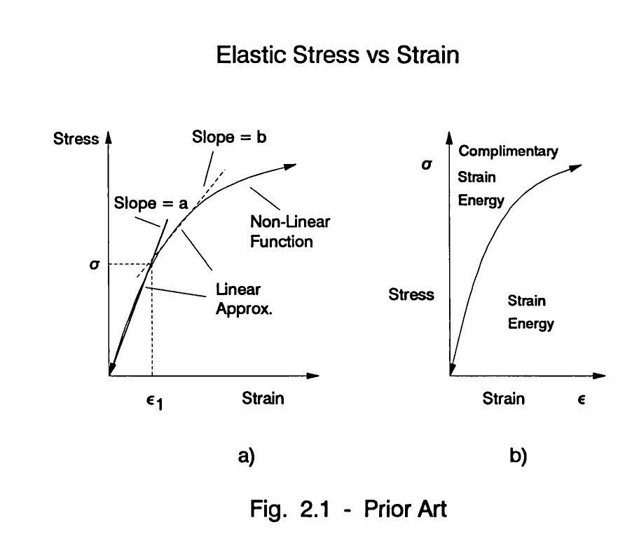

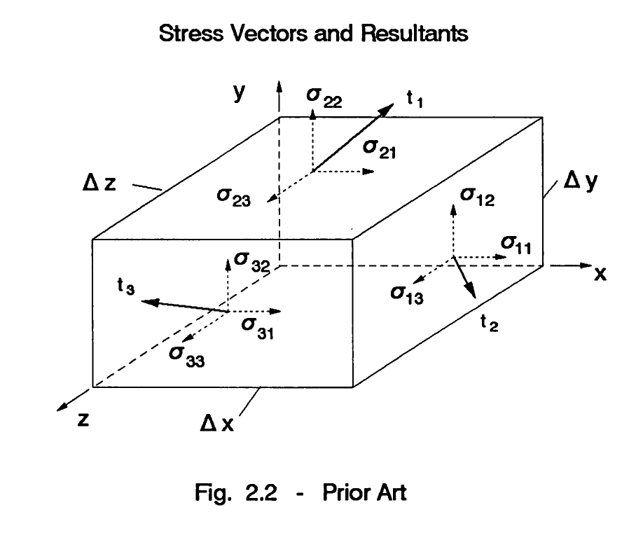

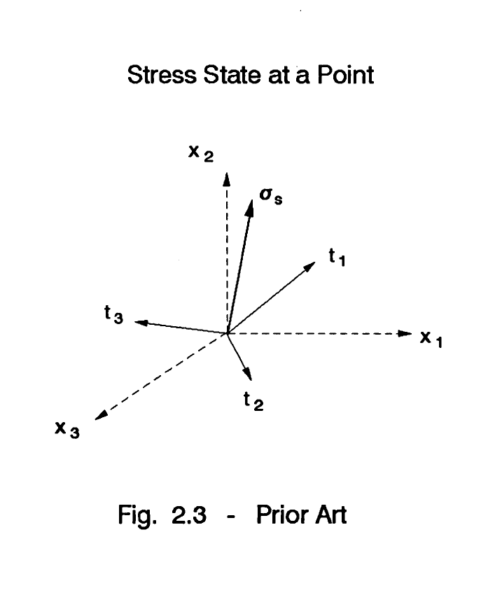

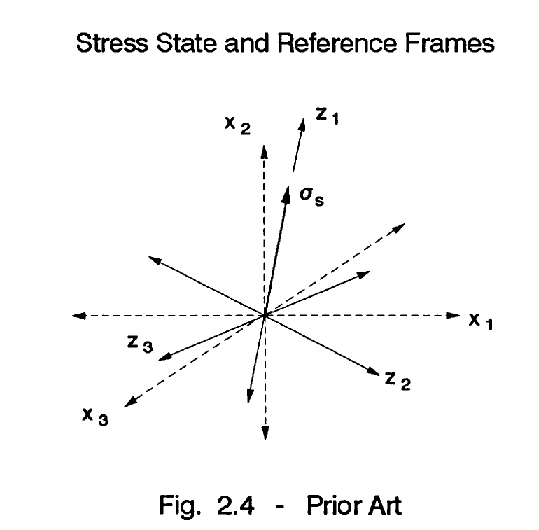

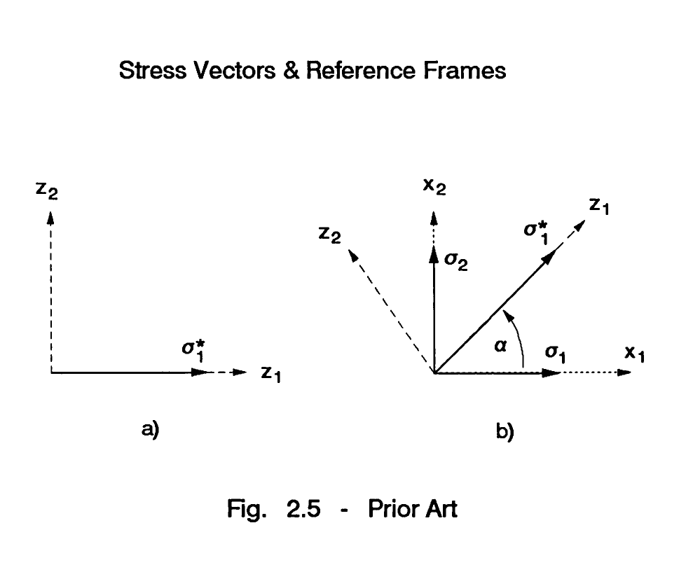

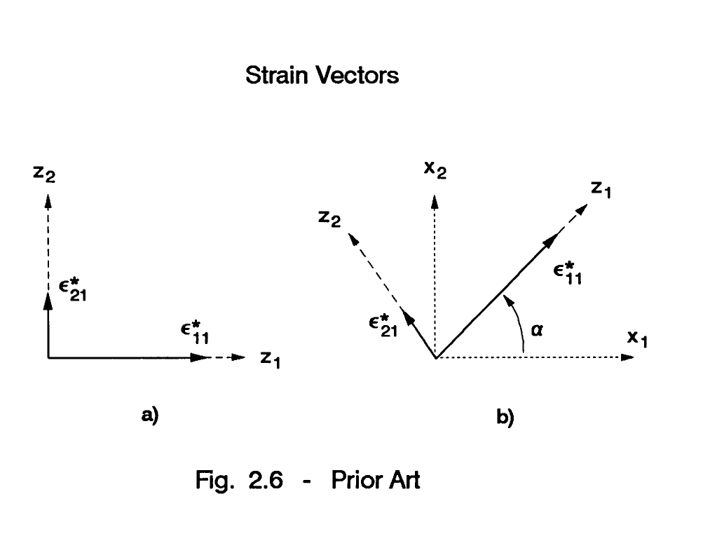

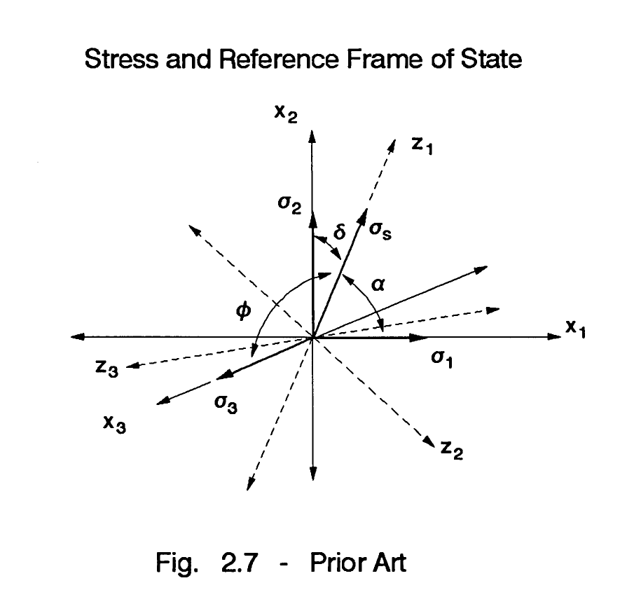

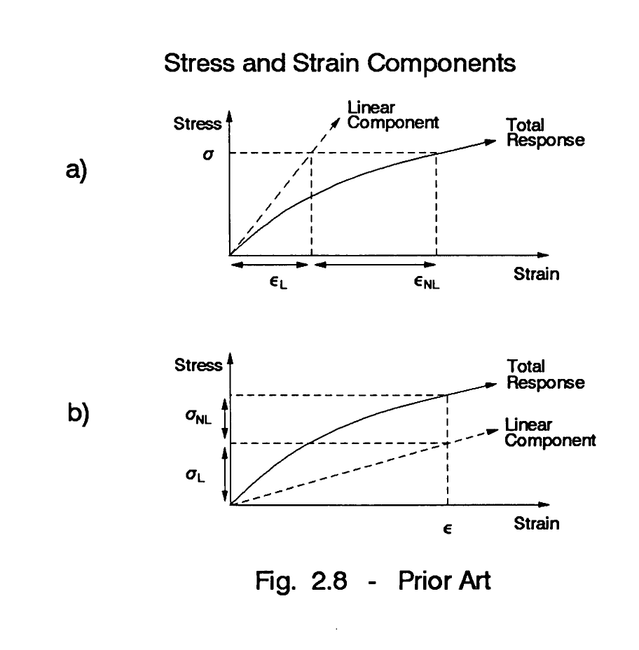

For a linear elastic impulse response the one dimensional constitutive relationships are,
σ=f^{E}ε, ε=f*^{E}σ 2.1
where f*^{E} and f^{E} are the elastic constitutive functions, simple proportionality constants. Linear constitutive behavior is just a limiting case to the larger, non-linear set of material behaviors. As mentioned previously, linear constitutive behavior cannot be an ‘exact’ solution for any material, and ‘linearity’ is strictly a small strain approximation. For a non-linear elastic response the one dimensional constitutive equations are,
σ=f^{E}(ε) ε=f*^{E}(σ) 2.2
where f^{E} (ε) and f*^{E}(σ) are generalized non-linear impulse functions, representing all possible solutions, linear and non-linear (FIG. 2.1a), large and small strains.
2.1 The Power Series Representation

Non-linear constitutive functions may be described in terms of ‘nth’ ordered power series functions,

$$\begin{matrix}\begin{matrix}σ = {f}^{E} ( ε ) = {c}_{1} ε + {c}_{2} {ε}^{2} + … + {c}_{n} {ε}^{n} = {c}_{1} ε + {\sum }_{n = 2}^{z} {c}_{n} {ε}^{n} \\ = {f}_{L}^{E} ( ε ) + {f}_{NL}^{E} ( ε )\end{matrix} \\ and & 2.3 \\ \begin{matrix}ε = f {*}^{E} ( σ ) = {b}_{1} σ + {b}_{2} {σ}^{2} + … + {b}_{n} {σ}^{n} = {b}_{1} σ + {\sum }_{n = 2}^{z} {b}_{n} {σ}^{n} \\ = f {*}_{L}^{E} ( σ ) + f {*}_{NL}^{E} ( σ )\end{matrix} & 2.4\end{matrix}$$

where f^{E} _{L}(ε) and f*^{E}_{L}(σ) are the linear components, and the higher order terms are the non-linear components, f^{E}_{NL}(ε) and f*^{E}_{NL}(σ). The cₖ are arbitrary constants. These two power series functions lack a free constant term, a cₒ or a bₒ. However, if there is no it applied strain there can be no associated stress, or if there is no applied stress there can be no associated strain, and so on. Therefore cₒ=bₒ=0, always. When the higher order non-linear terms are negligible these equations reduce to equations 2.1.
Linear Approximation

Because equations 2.2-2.4 are non-linear, incremental changes in stress and strain are not proportional to incremental changes in strain or stress. However, these functions may be approximated by piece-wise continuous linear functions within an appropriately restricted domain. If stress, σ, is constrained so that a σ<σ₁, then from FIG. 2.1 the strain solution becomes,
ε=f*^{E}(σ)=aσ 2.5
where ‘a’ defines the approximated slope of the stress-strain curve between zero strain and ε₁, and so on.
Power Series Sign Convention

The power series functions are scalar valued magnitude functions, not vector functions. Recalling the definition of a vector, equation 2.4 becomes,
ε=1·f*^{E}(σ) 2.6
where 1 is the unit vector and the power series function f*^{E}(σ) is a scalar valued magnitude term. Stress, σ, is likewise a scalar term. This definition insures that the vector is a non-trivial second order tensor.

Different sign conventions define compression and tension. Tension is usually designated positive, with compression negative. This convention is fairly standard, but arbitrary. Now, the power series expansions contain both even and odd powers of stress and strain. Applying a unit tensile stress, σ=1, equation 2.4 yields,
ε=f*^{E}(σ)=b₁+b₂+b₃+ . . . +bₙ 2.7
Applying a unit compressive stress, σ=−1, negative in sign, equation 2.4 now yields,
ε=f*^{E}(σ)=−b₁+b₂−b₃+ . . . +bₙ 2.8
Obviously, the two strain solutions differ in magnitude. By inverting the sign convention the strain solutions given by equations 2.7 and 2.8 should also invert in sign but maintain the same magnitude. However, changing sign conventions has caused material constitutive properties to change, a nonsensical result. To achieve a proper solution, the scalar valued constitutive functions f*^{E}(σ) and f^{E}(ε) must be evaluated using the magnitude of the appropriate stress or strain, where the sign convention is handled by the definitions,
f*^{E}(−σ)=>−f*^{E}(σ), f^{E}(−ε)=>−f^{E}(ε) 2.9

Let's again limit deformation to the small strain condition of the linear constitutive theory, but now allow for the c fundamental non-linearity in constitutive behavior for even very small strains. We may even allow the behavior to be wildly non-linear for very small strains. However, how ‘wildly’ non-linear the constitutive behavior may be for small strains is a function of the forces operating between atoms, and for small very strains is more an abstract notion than a possibility.

Now, the small strain condition also implies negligible changes in the internal lattice geometry of a body of material as it deforms. Obviously, very large strains would rack the internal lattice structure, causing directional changes in the internal stress distributions. The relationships between the resulting strains would therefore also change. By limiting interest to appropriately small strains we allow for the fundamental non-linearity in the bonding and non-bonding forces operating between atoms, but preclude any significant changes in the internal structural lattice geometries. Because changes in internal lattice geometries are constrained to be negligible, any internal stress redistributions are also negligible and the internal stress distributions retain their original geometric proportionalities. It then follows that because lattice geometries and internal stress distributions remain relatively unchanged the relationships between the various resulting directional components of strain will remain relatively unchanged and likewise remain simply proportional.

2.2 3-D Non-Linear Elastic Constitutive Functions

From stress theory we know that if there is no coupling in the stress field then the shear stresses will be symmetric. From strain theory we know the shear strains are always symmetric. Admitting the physically inadmissable possibility that each of the strain or stress components of a constitutive equation may be completely independent and described by a separate constitutive function leads to the following three dimensional form of equations 2.2,
εᵢⱼ=f*^{E}ᵢⱼ(σₖₗ) σᵢⱼ=f^{E}ᵢⱼ(εₖₗ) 2.10
There are now nine constitutive functions for each of the nine solutions for stress and strain, representing some form of a stress state or strain state function. Equations 2.10 may be written in an even more general format, where each of the 81 possible-components of stress or strain are assumed to be represented by a single independent constitutive function, i.e.,
σᵢⱼ=f^{E}ᵢⱼₖₗ(εₖₗ), εᵢⱼ=f*^{E}ᵢⱼₖₗ(σₖₗ) 2.11
where once again we may define stress and strain in terms of spatial coordinates because of the small strain constraints. Using reduced indicial notation and expanding the second of equations 2.11 yields,

$$\vert \begin{matrix}{ε}_{1} \\ {ε}_{2} \\ … \\ {ε}_{9}\end{matrix} \vert = \vert \begin{matrix}f {*}_{11}^{E} ( {σ}_{1} ) & f {*}_{12}^{E} ( {σ}_{2} ) & f {*}_{13}^{E} ( {σ}_{3} ) & … & f {*}_{19}^{E} ( {σ}_{9} ) \\ f {*}_{21}^{E} ( {σ}_{1} ) & f {*}_{22}^{E} ( {σ}_{2} ) & f {*}_{23}^{E} ( {σ}_{3} ) & … & f {*}_{29}^{E} ( {σ}_{9} ) \\ … & … & … & … & … \\ f {*}_{91}^{E} ( {σ}_{1} ) & f {*}_{92}^{E} ( {σ}_{2} ) & f {*}_{93}^{e} ( {σ}_{3} ) & … & f {*}_{99}^{E} ( {σ}_{9} )\end{matrix} \vert \qquad 2.12$$

The assumption of complete independence in the functions of equations 2.10 and 2.12 precludes any consideration of coupling between the strain response or of symmetry in the solutions for the shear strains, a condition completely incompatible with strain theory. The indices i and j of equation 2.12 therefore range from 1 to 9, not from 1 to 6.

Each of the f*^{E}ᵢⱼ(σⱼ) or f^{E}ᵢⱼ(σⱼ) functions now represent a potentially independent strain or stress component. From equation 2.12 the strain component ea, may be defined as,
ε₁₁=f*^{E}₁₁(σ₁) 2.13
Expanding one of the nine strain vectors, say ε₁, then yields,
ε₁=f*^{E}₁₁(σ₁)+f*^{E}₁₂(σ₂)+ . . . +f*^{E}₁₉(σ₉)=ε₁₁+ε₁₂+ . . . +ε₁₉ 2.14
and likewise for the other eight εᵢ, as well as the σᵢ of equation 2.11.
2.3 Reduction of the Function Matrix

The nine functions in each of the nine columns of equation 2.12 are defined in terms of the same independent variable. For example, the nine εᵢ₁,
εᵢ₁=f*^{E}ᵢ₁(σ₁) 2.15
are defined in terms of σ₁. The solutions for the strain functions, the f*^{E}ᵢ₁(σ₁), are as yet unknown. However, these functions must be coupled due to bonding, and they are functions of the same independent variable, σ₁.

When the strain functions of equation 2.15 are evaluated at, say σ₁, they degenerate into constants,
εᵢ₁=f*^{E}ᵢ₁(σ₁)=zᵢ₁ 2.16
where the zᵢ₁ are the strains associated with σ₁. When these functions are evaluated at some other value of stress, σ′₁, they degenerate into another set of constants,
εᵢ₁=f*^{E}ᵢ₁(σ′₁)=z′ᵢ₁ 2.17
One constant may be expressed in terms of another constant multiplied by another constant, so z₂₁ for example, may be expressed in terms of the strain term z₁₁ as follows,
f*^{E}₂₁(σ₁)=z₂₁=k₂₁z₁₁=k₂₁f*^{E}₁₁(σ₁) 2.18
Likewise for all seven other zᵢ₁, which may be expressed as zᵢ₁=kᵢ₁·f*^{E}ᵢ₁(σ₁). The kᵢ₁ are simple scaling constants.

At σ′₁ the strain term z′₂₁ may be written as,
f*^{E}₂₁(σ′₁)=z′₂₁=k′₂₁z′₁₁=k′₂₁f*^{E}₁₁(σ′₁) 2.19
and so on for the other seven z′ᵢ₁. Driving σ₁->σ′₁, the values of f*^{E}₂₁(σ₁) and f*^{E}₁₁(σ₁) change, but the functions do not change. The scaling coefficients k′₂₁ and k₂₁ are independent so when σ₁->σ ₁ then f*^{E}₂₁(σ₁)->f*^{E}₂₁(σ′₁) and f*^{E}₁₁(σ₁)->f*^{E}₁₁(σ′₁). Equations 2.18 and 2.19 then produce,
k₂₁f*^{E}₁₁(σ′₁)=k′₂₁f*^{E}₁₁(σ′₁)→k₂₁=k′₂₁ 2.20
for all σᵢ. Following the same procedure for the remaining seven f*^{E}ᵢ₁(σᵢ) produces similar results and equation 2.12 becomes,

$$\vert \begin{matrix}1 \\ {k}_{21} \\ … \\ {k}_{91}\end{matrix} \begin{matrix}f {*}_{12}^{E} ( {σ}_{2} ) & f {*}_{13}^{E} ( {σ}_{3} ) & … & f {*}_{19}^{E} ( {σ}_{9} ) \\ f {*}_{22}^{E} ( {σ}_{2} ) & f {*}_{23}^{E} ( {σ}_{3} ) & … & f {*}_{29}^{E} ( {σ}_{9} ) \\ … & … & … & … \\ f {*}_{92}^{E} ( {σ}_{2} ) & f {*}_{93}^{E} ( {σ}_{3} ) & … & f {*}_{99}^{E} ( {σ}_{9} )\end{matrix} \vert \vert \begin{matrix}f {*}_{11}^{E} ( {σ}_{1} ) \\ 1 \\ … \\ 1\end{matrix} \vert \qquad 2.21$$

where f*^{E}₁₁(σ₁) is now a scalar valued function. Again, the simple en proportionality between responses is obviously an approximation. As mentioned earlier, this approximation is allowed by the lack of any appreciable change in internal structural geometries, a consequence of the small strain condition. Continuing for each of the functions in the other eight columns in the matrix yields,

$$\vert \begin{matrix}1 & 1 & 1 & … & 1 \\ {k}_{21} & {k}_{22} & {k}_{23} & … & {k}_{29} \\ … & … & … & … & … \\ {k}_{91} & {k}_{92} & {k}_{93} & … & {k}_{99}\end{matrix} \vert \vert \begin{matrix}f {*}_{11}^{E} ( {σ}_{1} ) \\ 1 \\ … \\ 1\end{matrix} \vert \qquad 2.21$$

The f*^{E}₁ⱼ(σ₁) functions are scalar valued, and control all strains in all directions for any particular stress function.

The above solution implies that each constitutive function is independent, but associated with a particular type of stress, i.e., normal or shear, as well as a particular loading direction, where more that one function operates in any direction. Given the requirement for coupling through bonding, and given that loading from any direction results in the deformation of the same set of bonds, equation 2.22 makes no physical sense. The f*^{E}₁ⱼ(σⱼ) functions are scalar valued, so orthogonal reference frame transformations, which are completely spatial in nature, have no effect on the form of the functions. Furthermore, the non-linear functions of equation 2.22 must contain, as a limiting case, all possible linear solutions, where the linear constitutive functions are characterized by a single scalar valued constitutive coefficient. So, equation 2.22 can not possibly be the final solution. Each function must represent solutions to the same function, where that solution varies depending upon the magnitude of the stress and the sequence of application of each stress.

2.4 The Final Reduction

Application of Normal Stresses

Let's now evaluate the nine scalar valued constitutive functions of equation 2.22 where each stress is applied separately and alone. A single stress then defines the total state of stress, a deviatoric stress. First, set eight of the nine stresses equal to zero, except σ₁. Equation 2.22 then reduces to,

$${ε}_{i} = \vert \begin{matrix}1 \\ {k}_{21} \\ … \\ {k}_{91}\end{matrix} \vert f {*}_{11}^{E} ( {σ}_{1} ) \qquad 2.23$$

The shear strains must be symmetric so there can only be six independent values for the kⱼ₁, and equation 2.23 must reduce to,

$${ε}_{i} = \vert \begin{matrix}1 \\ {k}_{21} \\ … \\ {k}_{61}\end{matrix} \vert f {*}_{11}^{E} ( {σ}_{1} ) \qquad 2.24$$

Applying σ₂ and then σ₃ separately and alone produces similar strain solutions and equation 2.22 becomes,

$${ε}_{i} = \vert \begin{matrix}1 & 1 \\ {k}_{21} & {k}_{22} \\ … & … \\ {k}_{61} & {k}_{62}\end{matrix} \begin{matrix}1 \\ {k}_{23} \\ … \\ {k}_{63}\end{matrix} \vert \vert \begin{matrix}f {*}_{11}^{E} ( {σ}_{1} ) \\ f {*}_{12}^{E} ( {σ}_{2} ) \\ f {*}_{13}^{E} ( {σ}_{3} )\end{matrix} \vert \qquad 2.25$$

where the sequence of application of the stresses may be arbitrary. The different kᵢⱼ come about from material symmetry, or lack of symmetry, considerations.
Vector Transformation Equations

Material properties must be examined as a function of the variation in the orientation of a spatial reference frame. The vector transformation expressions for stress and strain are,

$$ε {*}_{ij} = \frac{\partial {z}_{j}}{\partial {x}_{k}} \frac{\partial {z}_{i}}{\partial {x}_{l}} {ε}_{kl} , σ {*}_{ij} = \frac{\partial {z}_{j}}{\partial {x}_{k}} \frac{\partial {z}_{i}}{\partial {x}_{l}} {σ}_{kl} \qquad 2.26$$

where the two reference frames are xᵢ and zᵢ. For Cartesian reference frames the spatial derivatives are the direction cosines.
Single Plane/Axis of Material Symmetry

Following discussions in section 1, define two orthonormal coordinate systems, xᵢ and zᵢ, where the x₁-x₂ and z₁-z₂ axes are coincident and define a plane, but where z₃=−x₃. Stress and strain in the xᵢ system shall be σ and ε, while stress and strain in the zᵢ system shall be σ* and ε*.

Consider the stresses and strains in the ‘2-3’ and ‘3-1’ directions. Solving for the direction cosines yields,

$$\frac{\partial {z}_{1}}{\partial {x}_{1}} = 1 , \frac{\partial {z}_{2}}{\partial {x}_{2}} = 1 , \frac{\partial {z}_{3}}{\partial {x}_{3}} = - 1 \\ \frac{\partial {z}_{1}}{\partial {x}_{3}} = \frac{\partial {z}_{1}}{\partial {x}_{2}} = \frac{\partial {z}_{2}}{\partial {x}_{1}} = \frac{\partial {z}_{2}}{\partial {x}_{3}} = \frac{\partial {z}_{3}}{\partial {x}_{1}} = \frac{\partial {z}_{3}}{\partial {x}_{2}} = 0 \qquad 2.27$$

Substituting these results into equation 2.26 yields σ*ᵢⱼ=σᵢⱼ, and ε*ᵢⱼ=εᵢⱼ, except as follows,
σ*₂₃=−σ₂₃, σ*₃₁=−σ₃₁, ε*₂₃=−ε₂₃, ε*₃₁=−ε₃₁ 2.28

None of the kᵢⱼ coefficients in equation 2.25 associated with the normal strains may be eliminated, unlike the kᵢⱼ associated with the shear strains. Applying only σ₁ the expression for the shear strain ε₄ in the xᵢ frame is,
ε₄=k₄₁f*^{E}₁₁(σ₁) 2.29
In the zᵢ frame the equivalent expression is,
ε*₄=k₄₁f*^{E}₁₁(σ*₁) 2.30
Flipping the z₃ axis and substituting the appropriate stress-strain transformations into equation 2.30 yields,
−ε₄=k₄₁f*^{E}₁₁(σ₁) 2.31
Adding equations 2.32 and 2.33 produces,
0=2k₄₁f*^{E}₁₁(σ₁) 2.32
The constitutive function is non-zero for any non-zero value of σ₁, so k₁₄=0. The same transformation result is obtained for ε₅, yielding k₁₅=k₁₄=0. Equation 2.24 then becomes,

$${ε}_{i} = \vert \begin{matrix}1 \\ {k}_{21} \\ {k}_{31} \\ 0 \\ 0 \\ {k}_{61}\end{matrix} \vert f {*}_{11}^{E} ( {σ}_{1} ) \qquad 2.33$$

Applying σ₂ and σ₃ separately, the same symmetry condition produces similar results yielding,

$${ε}_{i} = \vert \begin{matrix}1 & 1 \\ {k}_{21} & {k}_{22} \\ {k}_{31} & {k}_{32} \\ 0 & 0 \\ 0 & 0 \\ {k}_{61} & {k}_{62}\end{matrix} \begin{matrix}1 \\ {k}_{23} \\ {k}_{33} \\ 0 \\ 0 \\ {k}_{63}\end{matrix} \vert \vert \begin{matrix}\begin{matrix}f {*}_{11}^{E} ( {σ}_{1} ) \\ f {*}_{12}^{E} ( {σ}_{2} )\end{matrix} \\ f {*}_{13}^{E} ( {σ}_{3} )\end{matrix} \vert \qquad 2.34$$

Two/Three Planes of Symmetry

In addition to the axial rotation of z₃=−x₃ for a single axis of symmetry, the rotations for 2 axes of material symmetry now include z₁=−x₁, z₃=−x₃, with z₂₌ₓ₂. The direction cosines for these equivalences are,

$$\frac{\partial {z}_{1}}{\partial {x}_{1}} = - 1 , \frac{\partial {z}_{2}}{\partial {x}_{2}} = 1 , \frac{\partial {z}_{3}}{\partial {x}_{3}} = - 1 , \\ \frac{\partial {z}_{1}}{\partial {x}_{3}} = \frac{\partial {z}_{1}}{\partial {x}_{2}} = \frac{\partial {z}_{2}}{\partial {x}_{1}} = \frac{\partial {z}_{2}}{\partial {x}_{3}} = \frac{\partial {z}_{3}}{\partial {x}_{1}} = \frac{\partial {z}_{3}}{\partial {x}_{2}} = 0 \qquad 2.35$$

Equations 2.26 then yield the following transformations of ε₆ for the separately applied stresses σ₁, σ₂ and σ₃,
ε₁₂*=−ε₁₂, σ*₁=σ₁, σ*₂=σ₂, σ*₃=σ₃ 2.36
Following the same procedures yields k₆₁=k₆₂=k₆₃=0, and equation 2.34 reduces to,

$${ε}_{i} = \vert \begin{matrix}1 & 1 & 1 \\ {k}_{21} & {k}_{22} & {k}_{23} \\ {k}_{31} & {k}_{32} & {k}_{33} \\ 0 & 0 & 0 \\ 0 & 0 & 0 \\ 0 & 0 & 0\end{matrix} \vert \vert \begin{matrix}\begin{matrix}f {*}_{11}^{E} ( {σ}_{1} ) \\ f {*}_{12}^{E} ( {σ}_{2} )\end{matrix} \\ f {*}_{13}^{E} ( {σ}_{3} )\end{matrix} \vert \qquad 2.37$$

Normal Stresses and Complete Material Isotropy

Now consider complete material isotropy, beginning with the results just obtained. Again, the two reference systems are defined to be coincident initially. Rotate xᵢ the reference axes 90 degrees about the z₃ axis, such that the x₁ axis coincides with the z₂ axis, the z₂ axis with the −x₁ axis, and the x₃ axis with the z₃ axis. Rotating the x₁-x₂ axes through some angle α about the x₃ axis produces the transformations from the x₁-x₂ plane into the z₁-z₂ plane given by,
z₃=x₃, z₁=x₁ cos α+x₂ sin α, z₂=x₁ sin α+x₂ cos α 2.38
From equation 2.36 the 90 degree rotation of axes yields,
σ*₁=σ₂, σ*₂=σ₁, σ*₃=σ₃
ε*₁=ε₂, ε*₂=ε₁, ε*₃=ε₃ 2.39
Applying σ₁ in the x₁ axis direction the expression for strain in the x₁ direction is,
ε₁=k₁₁f*^{E}₁₁(σ₁)=f*^{E}₁₁(σ₁) 2.40
In the z₂ direction the solution for strain as a function of σ*₂ is,
ε₂*=k₂₂f*^{E}₁₂(σ₂) 2.41
Rotate the z₂ axis so that it is coincident with the x₁ axis, and demand equivalence in the resulting strains (the condition of isotropy). Substituting the transformations given by equation 2.39 into equation 2.41 yields,
ε₁=k₂₂f*^{E}₁₂(σ₁) 2.42
Equating equations 2.40 and 2.42 produces,
k₂₂f*^{E}₁₂(σ₁)=f*^{E}₁₁(σ₁) 2.43
and the solution for f*^{E}₁₂(σ₁),

$$f {*}_{12}^{E} ( {σ}_{1} ) = \frac{1}{{k}_{22}} f {*}_{11}^{E} ( {σ}_{1} ) \qquad 2.44$$

σ₁ is a magnitude term, so the scalar function f*^{E}₁₂(σ) scales in terms of the scalar function f*^{E}₁₁(σ). Multiplying the second column of the matrix of equation 2.37 by the constant term 1/k₂₂ yields,

$${ε}_{i} = \vert \begin{matrix}1 & 1 / {k}_{22} & 1 \\ {k}_{21} & 1 & {k}_{23} \\ {k}_{31} & {k}_{32} / {k}_{22} & {k}_{33} \\ 0 & 0 & 0 \\ 0 & 0 & 0 \\ 0 & 0 & 0\end{matrix} \vert \vert \begin{matrix}\begin{matrix}f {*}_{11}^{E} ( {σ}_{1} ) \\ f {*}_{11}^{E} ( {σ}_{2} )\end{matrix} \\ f {*}_{13}^{E} ( {σ}_{3} )\end{matrix} \vert \qquad 2.45$$

Demanding the same degree of symmetry with regard to the x₁-x₃ plane equation 2.45 reduces to,

$${ε}_{i} = \vert \begin{matrix}1 & 1 / {k}_{22} & 1 / {k}_{33} \\ {k}_{21} & 1 & {k}_{23} / {k}_{33} \\ {k}_{31} & {k}_{32} / {k}_{22} & 1 \\ 0 & 0 & 0 \\ 0 & 0 & 0 \\ 0 & 0 & 0\end{matrix} \vert \vert \begin{matrix}\begin{matrix}f {*}_{11}^{E} ( {σ}_{1} ) \\ f {*}_{11}^{E} ( {σ}_{2} )\end{matrix} \\ f {*}_{11}^{E} ( {σ}_{3} )\end{matrix} \vert \qquad 2.46$$

Redesignating coefficients equation 2.46 becomes,

$${ε}_{i} = \vert \begin{matrix}{m}_{11} & {m}_{12} & {m}_{13} \\ {m}_{21} & {m}_{11} & {m}_{23} \\ {m}_{31} & {m}_{32} & {m}_{11} \\ 0 & 0 & 0 \\ 0 & 0 & 0 \\ 0 & 0 & 0\end{matrix} \vert \vert \begin{matrix}\begin{matrix}f {*}^{E} ( {σ}_{1} ) \\ f {*}^{E} ( {σ}_{2} )\end{matrix} \\ f {*}^{E} ( {σ}_{3} )\end{matrix} \vert \qquad 2.47$$

where m₁₁=m₂₂=m₃₃=1, and f*^{E}₁₁(σ)=f*^{E}(σ).
Isotropy and Matrix Symmetry

When σ₁ is applied, the distortional strains are ε₂ and ε₃. Consider distortion within the 1-2 plane. The z₂ axis is rotated so it coincides with the x₁ axis, and equivalence demanded in the resulting distortional strains. In the x₁ direction the expression for the distortional strain ε₂ is,
ε₂=m₂₁f*^{E}(σ₁) 2.48
In the z₂ direction the distortion strain as a function of σ*₂ is,
ε₁*=m₁₂f*^{E}(σ₂) 2.49
Substituting the transformations of equation 2.26 into equation 2.49 produces,
ε₂=m₁₂f*^{E}(σ₁) 2.50
Equations 2.50 and 2.48 must be equivalent and yield the solution m₂₁=m₁₂. Likewise m₁₃=m₂₃. Similar transformations may be obtain for the distortional strains in the 1-3 and 2-3 planes, and m₂₁=m₃₁, and so on. So, the mᵢⱼ=mⱼᵢ when j≠i. For complete isotropy equation 2.47 now becomes,

$${ε}_{i} = \vert \begin{matrix}1 & {m}_{12} & {m}_{12} \\ {m}_{12} & 1 & {m}_{12} \\ {m}_{12} & {m}_{12} & 1 \\ 0 & 0 & 0 \\ 0 & 0 & 0 \\ 0 & 0 & 0\end{matrix} \vert \vert \begin{matrix}f {*}^{E} ( {σ}_{1} ) \\ f {*}^{E} ( {σ}_{2} ) \\ f {*}^{E} ( {σ}_{3} )\end{matrix} \vert \qquad 2.51$$

All these normal (but deviatoric) strains are functions of a single non-linear, stress dependent, scalar valued constitutive function.
Transformation Inversion

Inverting these transformations, and demanding a lack of equivalence in the resulting axial and lateral strains, the form and value of the constitutive function does not change, because it is scalar valued. Any lack of equivalence between strain solutions demands a lack of equivalence in the diagonal coefficients, i.e., m₁₁≠m₂₂≠m₃₃, and off-diagonal coefficients. In fact, inverting all the previous axial symmetry transformations has no effect on the constitutive function (the physics of this result, as well as exceptions to it, are discussed in section 4). Regardless of the degree of symmetry, the material is described by a single scalar valued constitutive function, at least with regard to the three normal strains, which are deviatoric because the σᵢ are deviatoric, having been applied separately and alone. For complete material anisotropy equation 2.25 becomes,

$${ε}_{i} = \vert \begin{matrix}{m}_{11} & {m}_{12} & {m}_{13} \\ {m}_{21} & {m}_{22} & {m}_{23} \\ {m}_{31} & {m}_{32} & {m}_{33} \\ … & … & … \\ {m}_{61} & {m}_{62} & {m}_{63}\end{matrix} \vert \vert \begin{matrix}f {*}^{E} ( {σ}_{1} ) \\ f {*}^{E} ( {σ}_{2} ) \\ f {*}^{E} ( {σ}_{3} )\end{matrix} \vert \qquad 2.52$$

Matrix symmetry for any degree of material symmetry is yet to be proven.
Shear Stress and a Single Plane/Axis of Material Symmetry

From stress theory we know that any shear (deviatoric) stress or shear strain vector may be converted into a normal stress or normal deviatoric strain vector through the proper change in the orientation of the spatial reference frame. However, before making use of this property, let's determine the number of non-zero matrix coefficients associated with a shear stress. Set eight of the nine stresses to zero, except σ₄. Equation 2.22 then becomes,

$${ε}_{i} = \vert \begin{matrix}1 \\ {k}_{24} \\ … \\ {k}_{64}\end{matrix} \vert f {*}_{14}^{E} ( {σ}_{4} ) \qquad 2.53$$

where there are only six independent kᵢ₄ due to symmetry in the shear strains.

Define two orthogonal reference frames, the xᵢ and zᵢ, to be initially coincident. For the single axis of symmetry the axial transformations are x₁=z₁, x₂=z₂, and −x₃=z₃. Let σᵢ and εᵢ be associated with the xᵢ frame, while σ*ᵢ and ε*ᵢ are associated with the zᵢ frame. The solutions for the direction cosines are given by equation 2.27. The stress and strain transformations are σᵢⱼ=σ*ᵢⱼ, and εᵢⱼ=ε*ᵢⱼ, except for those of equation 2.28. From equation 2.53 the normal strain ε₁ in the xᵢ frame is,
ε₁=k₁₄f*^{E}₁₄(σ₄) 2.54
In the zᵢ frame the equivalent expression is,
ε*₁=k₁₄f*^{E}₁₄(σ*₄) 2.55
Substituting into equation 2.54 the appropriate transformations produces,
ε₁=−k₁₄f*^{E}₁₄(σ₄) 2.56
Subtracting equation 2.54 from equation 2.56 yields,
0=−2k₁₄f*^{E}₁₄(σ₄) 2.57
f*(σ₄) is not equal to zero for any non-zero value of σ₄, so k₁₄=0. Similar results will be obtained for the transformations of the other two normal strains and k₂₄=k₃₄=0. No information is obtained for the coefficients k₄₄ and k₅₄, other than they are not equal to zero. However, this transformation does yield k₆₄=0, and equation 2.53 reduces to,

$${ε}_{i} = \vert \begin{matrix}0 \\ 0 \\ 0 \\ {k}_{44} \\ {k}_{54} \\ 0\end{matrix} \vert f {*}_{14}^{E} ( {σ}_{4} ) \qquad 2.58$$

Following the same procedures for the other shear stresses and resulting strains will produce similar results.
Shear Stress and Two/Three Planes of Material Symmetry

The axial transformations for two/three axes of material symmetry are z₂=x₂, z₃=−x₃, and z₁=−x₁. Solving for the direction cosines yields equation 2.35. This symmetry condition yields no new information pertaining to k₄₄. However, for ε₅ in the xᵢ frame we have,
ε₅=k₅₄f*^{E}₁₄(σ₄) 2.59
and in the zᵢ frame,
ε*₅=k₅₄f*^{E}₁₄(σ*₄) 2.60
Substituting the appropriate transformations for stress and strain into equation 2.60 yields,
ε₅=−k₅₄f*^{E}₁₄(σ₄) 2.61
where, by definition, f*^{E}(−σ)=−f*^{E}(σ). Subtracting equation 2.59 from equation 2.61 produces,
0=−2k₅₄f*^{E}₁₄(σ₄) 2.62
f*(σ₄) is not equal to zero for any non-zero value of σ₄, so k₅₄=0 and equation 2.58 reduces to,

$${ε}_{i} = \vert \begin{matrix}0 \\ 0 \\ 0 \\ {k}_{44} \\ 0 \\ 0\end{matrix} \vert f {*}_{14}^{E} ( {σ}_{4} ) \qquad 2.63$$

The other shear stresses, σ₅->σ₉, yield similar results for the other sets of coefficients.

Now, rotating a reference frame 45 degrees will convert any shear stress into a normal deviatoric stress, although the magnitude will change. Given that f*^{E}₄( . . . ) is scalar valued the function is unaltered by the transformation (obviously, a spatial reference frame transformation does nothing to alter physical material properties). A normal stress produces a normal strain, so f*^{E}₁₄( . . . ) must be equivalent to f*^{E}( . . . ). The same equivalence must also hold true for the remaining f*^{E}₁₅( . . . )->f*^{E}₁₉( . . . ). When the εᵢ are evaluated for σ₄, or any other shear stress, no other non-zero values for the kᵢⱼ are found for the condition of complete material isotropy. However, we do find that k₄₄=k₅₅=k₆₆, etc.

Complete Material Isotropy

symmetry in the shear stresses yields equivalence in the solution of the constitutive function for each of these stresses, i.e., f*^{E}(σᵢⱼ)=f*^{E}(σⱼᵢ). When the εᵢ are evaluated six shear stresses yield no more information about the strain field than three shear stresses, so equation 2.12 reduces to,

$$\vert \begin{matrix}{ε}_{1} \\ {ε}_{2} \\ {ε}_{3} \\ {ε}_{4} \\ {ε}_{5} \\ {ε}_{6}\end{matrix} \vert = \vert \begin{matrix}1 & {m}_{12} & {m}_{12} & 0 & 0 & 0 \\ {m}_{12} & 1 & {m}_{12} & 0 & 0 & 0 \\ {m}_{12} & {m}_{12} & 1 & 0 & 0 & 0 \\ 0 & 0 & 0 & {m}_{44} & 0 & 0 \\ 0 & 0 & 0 & 0 & {m}_{44} & 0 \\ 0 & 0 & 0 & 0 & 0 & {m}_{44}\end{matrix} \vert \vert \begin{matrix}f {*}^{E} ( {σ}_{1} ) \\ f {*}^{E} ( {σ}_{2} ) \\ f {*}^{E} ( {σ}_{3} ) \\ f {*}^{E} ( {σ}_{4} ) \\ f {*}^{E} ( {σ}_{5} ) \\ f {*}^{E} ( {σ}_{6} )\end{matrix} \vert \qquad 2.64$$

where the stresses are applied separately and alone (recall that for every operating σᵢⱼ there is also a σⱼᵢ operating and that σᵢⱼ=σⱼᵢ). The coefficient matrix is identical to that of linear elastic materials.

As discussed, we may invert all the previous reference frame transformations and material symmetry constraints, and arrive at a 9×9 matrix of constant coefficients. However, there are only six equations, six unknowns, and 36 unknown coefficients, so the most general form of the equation is,

$$\vert \begin{matrix}{ε}_{1} \\ {ε}_{2} \\ {ε}_{3} \\ {ε}_{4} \\ {ε}_{5} \\ {ε}_{6}\end{matrix} \vert = \vert \begin{matrix}{m}_{11} & {m}_{12} & {m}_{13} & {m}_{14} & {m}_{15} & {m}_{16} \\ {m}_{21} & {m}_{22} & {m}_{23} & {m}_{24} & {m}_{25} & {m}_{26} \\ {m}_{31} & {m}_{32} & {m}_{33} & {m}_{34} & {m}_{35} & {m}_{36} \\ {m}_{41} & {m}_{42} & {m}_{43} & {m}_{44} & {m}_{45} & {m}_{46} \\ {m}_{51} & {m}_{52} & {m}_{53} & {m}_{54} & {m}_{55} & {m}_{56} \\ {m}_{61} & {m}_{62} & {m}_{63} & {m}_{64} & {m}_{65} & {m}_{66}\end{matrix} \vert \vert \begin{matrix}f {*}^{E} ( {σ}_{1} ) \\ f {*}^{E} ( {σ}_{2} ) \\ f {*}^{E} ( {σ}_{3} ) \\ f {*}^{E} ( {σ}_{4} ) \\ f {*}^{E} ( {σ}_{5} ) \\ f {*}^{E} ( {σ}_{6} )\end{matrix} \vert \qquad 2.65$$

As a general condition matrix symmetry has not yet been demonstrated. However, the matrix coefficients must be symmetric in order to satisfy the limiting condition of linear elasticity.
Linear Approximations

Non-linear constitutive functions may be approximated by linear functions, where the logical choice to begin the approximation is the unstressed-unstrained condition. The non-linear constitutive function will be determined from the application of one applied stress function, say a normal stress, which completely defines the state of stress. Using such an approximation the solutions for the strains induced by different loads may then be superimposed, as with the linear elastic materials. However, once the total state of stress, the resultant of all stresses, exceeds the point on the stress-strain curve where a linear approximation is no longer valid, the resulting strain solutions become increasingly inaccurate.

2.5 Multiple Loads and the Non-Linear Solution

The Stress Field and the State of Stress

Recall that there are nine possible stresses, the σᵢⱼ, that may act about some element of solid material (FIG. 2.2). Those nine vectors may be expressed in terms of just three resultant stress vectors, t₁, t₂, and t₃, each of which is the resultant of the three stresses acting on one face of the element. Shrinking the volume of the element to where Δx·Δy·Δz->0, then the area of each surface face also approaches zero and yields the solution for stress at a point, σₛ (FIG. 2.3). This resultant stress has a magnitude and a direction of action with respect to the primary reference frame which may be calculated.

Again orient an orthogonal reference frame with respect to the vector σₛ, such that one axis, say the z₁ axis, is coincident with σₛ, and the z₂-z₃ plane is normal to σₛ (FIG. 2.4). The zᵢ system is now a reference frame for which the maximum state of stress is known, i.e., the type of stress, the magnitude, and the direction of action.

Also again recall that there is also a set of orthogonal axes, oriented in some fashion to a primary reference frame, where the nine stresses may be expressed in terms of just three orthogonal normal stresses. These three normal stresses, the ‘principle normal stresses’, are coincident with the axes of this new reference frame, the ‘principle axes’, and are just another representation for the state of stress.

Matrix Coefficients and Reference Frame Transformations

The values of the mᵢⱼₖₗ are, in general, dependent upon the orientation of the spatial reference frame with respect to a body of material. The mᵢⱼₖₗ matrix represents a fourth order tensor and the values of each mᵢⱼₖₗ coefficient vary according the orientation of respective reference frames, transforming according to the function,

$$m {*}_{ijkl} = \frac{\partial {x}_{a}}{\partial {z}_{i}} \frac{\partial {x}_{b}}{\partial {z}_{j}} \frac{\partial {x}_{k}}{\partial {z}_{c}} \frac{\partial {x}_{l}}{\partial {z}_{d}} {m}_{abcd} \qquad 2.66$$

where the partial derivatives are the direction cosines in Cartesian coordinates. If the mᵢⱼₖₗ are known for one choice of reference frame, then the values of the mᵢⱼₖₗ in another reference frame may be determined from equation 2.66. For complete isotropy the m*ᵢⱼₖₗ=mᵢⱼₖₗ for all reference frame orientations.
Isotropy and Non-Linear Elasticity

Load a differential element within a solid body such that the only stress σ*₁ is oriented along the z₁ axis of the orthogonal zᵢ reference frame (FIG. 2.5a). σ*₁ represents the solution for total stress, both in magnitude and direction, and therefore represents σₛ. Orient an xᵢ reference frame initially coincident with the zᵢ reference frame, then rotate the xᵢ system about the x₃ axis (which remains coincident with z₃) so that z₁-Z₂ axes are oriented with respect to the x₁-x₂ axes by some angle of rotation a (FIG. 2.5b). In the x₁-x₂ plane the stress vector σ*₁ may be equivalently expressed as the resultant of two simultaneously applied component normal stresses, σ₁ and σ₂, operating coincident with the x₁ and x₂ axes. σ*₁ now represents the solution for the total state stress, σₛ, in the zᵢ system.

Isotropy insures that the mᵢⱼₖₗ are invariant for any reference frame orientation. Now, the generalized governing constitutive equation of non-linear elasticity is εᵢ=[m_{ij]·f*}^{E}(σⱼ). For the condition of complete isotropy the solution for the constitutive equation is,

$${ε}_{i} = \vert \begin{matrix}1 & {m}_{12} & {m}_{12} & 0 & 0 & 0 \\ {m}_{12} & 1 & {m}_{12} & 0 & 0 & 0 \\ {m}_{12} & {m}_{12} & 1 & 0 & 0 & 0 \\ 0 & 0 & 0 & {m}_{44} & 0 & 0 \\ 0 & 0 & 0 & 0 & {m}_{44} & 0 \\ 0 & 0 & 0 & 0 & 0 & {m}_{44}\end{matrix} \vert \vert \begin{matrix}f {*}^{E} ( {σ}_{1} ) \\ f {*}^{E} ( {σ}_{2} ) \\ f {*}^{E} ( {σ}_{3} ) \\ f {*}^{E} ( {σ}_{4} ) \\ f {*}^{E} ( {σ}_{5} ) \\ f {*}^{E} ( {σ}_{6} )\end{matrix} \vert \qquad 2.67$$

where the individual component stresses are constrained to be applied separately and alone.

From equation 2.67 the loading function σ*₁ produces only three strains in the zᵢ system (FIG. 2.6a), ε*₁=ε*₁₁, ε*₂=ε*₂₁ and ε*₃=ε*₃₁. The solutions for ε₁ and ε₂, associated with the x₁ and x₂ axes, are obtained by adding the appropriate vector components of ε*₁₁ and ε*₂₁ (FIG. 2.6b),
ε₁=ε*₁₁ cos α+ε*₂₁ sin α
ε₂=ε*₁₁ sin α+ε*₂₁ cos α 2.68
From equation 2.67 the solutions for the strains, ε*₁ and ε*₂ in the zᵢ system are,
ε*₁=ε*₁₁=m₁₁f*^{E}(σ*₁)
ε*₂=ε*₂₁=m₁₂f*^{E}(σ*₁) 2.69
Substituting equations 2.69 into equations 2.68 produces the solutions for ε₁ and ε₂ in terms of the state of stress, σₛ=σ*₁,
ε₁=m₁₁ cos αf*^{E}(σ*₁)+m₁₂ sin αf*^{E}(σ*₁)
ε₂=m₁₁ sin αf*^{E}(σ*₁)+m₁₂ cos αf*^{E}(σ*₁) 2.70

So, only when f*^{E}(σₛ) may be approximated by a linear function may the base reference frame solutions for strain be added in a linear fashion to obtain a complete solution. A linear approximation of f*^{E}(σₛ) will yield reasonable solutions for strain from the component stresses only if the solution for the state of stress does not exceed the range of accuracy of the linear approximation (FIG. 2.1a).

Generalized Non-Linear Solutions

To obtain explicit strain solutions for simultaneously applied loads first define the stress components, the σⱼ, with respect to a base Cartesian reference frame, call it xᵢ. Next, solve for the magnitude and direction of action of σₛ with respect to the xᵢ system. Orient another Cartesian reference frame, the frame of state zᵢ, such that one axis is coincident with σₛ, and σₛ is normal to the plane defined by the other two orthogonal axes (FIG. 2.7). Next, define the direction cosines for the zᵢ system relative to the xᵢ system, and compute the transformation solution for the matrix coefficients mᵢⱼ, as given by equation 2.66. Finally, solve for the strains in the zᵢ system with a constitutive function of the form,
ε*ᵢ=[m*ᵢⱼ]f*^{E}(σₛ) 2.71
where the index j may be either 1, 2, or 3, and σₛ is a normal stress vector aligned coincident with one of the zᵢ axes. The index i will vary from 1 to 6. When solutions for the ε*ᵢ have been obtained in the zᵢ frame they may then be transformed into D solutions for strain in xᵢ frame with the vector transformation equations 2.27.
An Alternate Form of the Non-Linear Solution

In the zᵢ frame f*^{E}(σₛ) may always be written as a power series expansion in σₛ,

$$\begin{matrix}f {*}^{E} ( {σ}_{s} ) = {a}_{1} {σ}_{s} + {a}_{2} {σ}_{s}^{2} + … + {a}_{n} {σ}_{s}^{n} = {\sum }_{n = 1}^{x} {a}_{n} {σ}_{s}^{n} \\ = {a}_{1} {σ}_{s} + {\sum }_{n = 2}^{x} {a}_{n} {σ}_{s}^{n} = f {*}_{L}^{E} {σ}_{s} + f {*}_{NL}^{E} ( {σ}_{s} )\end{matrix} \qquad 2.72$$

and may always be expressed as the sum of linear component, f*^{E}_{L}·σₛ, and a non-linear component, f*^{E}_{NL}(σₛ). The solutions for the ε*ᵢ may then be written as,
ε*ᵢ=[m*ᵢ₁]f*^{E}(σₛ)=[m*ᵢ₁][f*^{E}_{L}σₛ+f*^{E}_{NL}(σₛ)]=ε*_{L(i)}+ε*_{NL(i)} 2,73
where the resulting strain field has two components, one linear and one non-linear. f*^{E}(σₛ) reduces to the first order term if the material is linearly elastic (an approximation). f*^{E}_{L} then becomes f*^{E}.
2.6 Symmetry in the Coefficient Matrix

It was possible to show that for linear materials the mᵢⱼ are symmetric in the indices, where the mᵢⱼ=mⱼᵢ, when i≠j. This symmetry produces a maximum of 21 matrix coefficients for anisotropic materials, where m₁₁=1, by choice of definition. Coefficient symmetry for complete anisotropy also established symmetry for all other possible degrees of symmetry and isotropy, valid for all possible choices of reference frames.

The Strain Energy Functions

FIG. 2.1b illustrates the one-dimensional form of the stress-strain relationship of equation 2.73. For any value of stress σ, there are two components to the solution for strain ε, ε_{L} and ε_{NL} (FIG. 2.8a). Similarly, for any value of stress ε, there are two components to the solution for stress σ, σ_{L} and σ_{NL} (FIG. 2.8b).

For either linear or non-linear elastic materials the work required to get from the undeformed state to a deformed state of a unit volume may be expressed by the one dimensional integral expression,

$$W = U = {\int }_{0}^{ε} σ ⅆ ε \qquad 2.74$$

W is work and U is strain energy. (Note that the work function defined here assumes static equilibrium, where the kinetic energy component, KE, is equal to zero. During the dynamic process of deformation the work function is given by W=U+KE.) The complementary strain energy function, U*, is defined by,

$$U * = {\int }_{0}^{σ} ε ⅆ σ \qquad 2.75$$

In three dimensions equation 2.77 becomes,

$$U * = {\int }_{0}^{{σ}_{ij}} {ε}_{ij} ⅆ {σ}_{ij} = {\int }_{0}^{{σ}_{j}} {ε}_{i} ⅆ {σ}_{j} \qquad 2.76$$

Now rewrite equation 2.73 in a one dimensional format and substitute the result into equation 2.76. This produces the solution for complimentary strain energy,

$$\begin{matrix}U * = {\int }_{0}^{σ} ε ⅆ σ = {\int }_{0}^{σ} ( {ε}_{L} + {ε}_{NL} ) ⅆ σ \\ = {\int }_{0}^{σ} {ε}_{L} ⅆ σ + {\int }_{0}^{σ} {ε}_{NL} ⅆ σ = U {*}_{L} + U {*}_{NL}\end{matrix} \qquad 2.77$$

which is now the sum of linear and non-linear components.

Let's now expand equation 2.77 into a three dimensional format by substituting the generalized form of equation 2.73 into equation 2.76,

$$U * = {\int }_{0}^{{σ}_{j}} ( {ε}_{L ( i )} + {ε}_{NL ( i )} ) ⅆ {σ}_{j} = {\int }_{0}^{{σ}_{j}} {ε}_{L ( i )} ⅆ {σ}_{j} + {\int }_{0}^{{σ}_{j}} {ε}_{NL ( i )} ⅆ {σ}_{j} \qquad 2.78$$

This function expands into,

$$U * = U {*}_{L} + U {*}_{NL} = {\int }_{0}^{{σ}_{1}} {ε}_{L ( i )} ⅆ {σ}_{1} + … + {\int }_{0}^{{σ}_{6}} {ε}_{L ( i )} ⅆ {σ}_{6} + {\int }_{0}^{{σ}_{1}} {ε}_{NL ( i )} ⅆ {σ}_{1} + … + {\int }_{0}^{{σ}_{6}} {ε}_{NL ( i )} ⅆ {σ}_{6} \qquad 2.79$$

In the zᵢ frame there is only one stress function, σₛ, which is equivalent to σ₁, so equation 2.79 reduces to,

$$U * = U {*}_{L} + U {*}_{NL} = {\int }_{0}^{{σ}_{s}} {ε}_{L ( i )} ⅆ {σ}_{s} + {\int }_{0}^{{σ}_{s}} {ε}_{NL ( i )} ⅆ {σ}_{s} \qquad 2.80$$

The Linear Energy Component

Recall that in the zᵢ frame the matrix coefficients m*ᵢⱼₖₗ are transformations of the mᵢⱼₖₗ from the base reference frame (equation 2.66). If that transformation is inverted we must again obtain the same mᵢⱼₖₗ. Furthermore, the product m*ᵢⱼₖₗ·f*^{E}_{L} will transform into mᵢⱼₖₗ·f*^{E}_{L} because f*^{E}_{L} is scalar valued and unaffected by coordinate transformations. An equivalent solution for the linear component of the strain field in the base reference frame may therefore be written as,
ε_{L(i)}=[mᵢⱼ]f*^{E}_{L}σⱼ 2.81
where the σⱼ represent the stress components in the base reference frame. This equivalence is obvious when we recall that when the non-linear term in the constitutive function f*^{E}(σₛ) is negligible or non-existent (which is never the case), there is only a linear solution for the state of strain.

The linear component of the complementary strain energy function may now be defined in terms of the mᵢⱼₖₗ, f*^{E}_{L}, and the component stresses, σⱼ. Because the strain field must be continuous and non-zero for any given applied stress field, the linear component of the complimentary strain energy function must exist for all possible non-linear materials (i.e., every material). The following equivalence must therefore hold true for the linear component of the complimentary strain energy equation,

$$\frac{{\partial }^{2} U {*}_{L}}{\partial {ε}_{i} \partial {ε}_{j}} = \frac{{\partial }^{2} U {*}_{L}}{\partial {ε}_{j} \partial {ε}_{i}} \qquad 2.82$$

Skipping the algebra we find that the mᵢⱼ=mⱼᵢ, when j≠i, for all degrees of material symmetry and isotropy. The solution for symmetry is also independent of strain, stress, the constitutive function, and system energy.
2.7 The Non-Linear Constitutive Equations for Stress

The constitutive functions for stress may likewise be expressed in terms of a matrix of coefficients and a single scalar valued constitutive function,

$${σ}_{i} = \vert \begin{matrix}1 & {a}_{12} & {a}_{13} & {a}_{14} & {a}_{15} & {a}_{16} \\ … & {a}_{22} & {a}_{23} & {a}_{24} & {a}_{25} & {a}_{26} \\ … & … & {a}_{33} & {a}_{34} & {a}_{35} & {a}_{36} \\ … & … & … & {a}_{44} & {a}_{45} & {a}_{46} \\ … & … & … & … & {a}_{55} & {a}_{56} \\ … & … & … & … & … & {a}_{66}\end{matrix} \vert \vert \begin{matrix}{f}^{E} ( {ε}_{1} ) \\ {f}^{E} ( {ε}_{2} ) \\ {f}^{E} ( {ε}_{3} ) \\ {f}^{E} ( {ε}_{4} ) \\ {f}^{E} ( {ε}_{5} ) \\ {f}^{E} ( {ε}_{6} )\end{matrix} \vert \qquad 2.83$$

where the aᵢⱼ are symmetric in the indices ij, and a₁₁=1, by definition. The number of non-zero aᵢⱼ for any degree of material symmetry and isotropy are the same as for the mᵢⱼ. When written in the above format, the individual strains in equation 2.83 are constrained to be induced separately and alone.

The method of solving for the resulting stress field is as outlined for the strain field, except that the constitutive function f^{E}(ε) is a function of the strain state vector, εₛ, oriented in some direction to the primary reference frame. The solution for equation 2.83 in the frame of state then becomes,
σ*ᵢ=[a*ᵢⱼ]f^{E}(εₛ) 2.84
where the a*ᵢⱼ have been transformed from the base reference frame to the frame of state. Once the σ*ᵢ have been determined in the frame of state, the σᵢ in the base reference frame may be obtained from the vector transformation equation 2.27.

### Section 3

Non-Linear 3-D Viscoelastic Constitutive Functions

From the previous section it follows that a one dimensional constitutive function for a non-linear viscoelastic material may be written as,
ε(σ,t)=1·f*(σ,t) σ(ε,t)=1·f(ε,t) 3.1
where 1 is the unit vector. f*(σ,t) and f(ε,t) are scalar valued non-linear creep compliance and relaxation modulus functions respectively, and are functions of time and a static stress, σ, or a static strain, ε. Like linear viscoelastic materials the non-linear viscoelastic materials must be described as the linear sum of two functions that describe separate, measurable, and physically distinct responses—a time independent elastic impulse response, and a time dependent delayed elastic response. This should be obvious because the forces operating between bonded atoms in a body of material are fundamentally non-linear and the linear viscoelastic functions can therefore only be approximations. These two component functions add linearly to give the complete solution at some time t>0, i.e.,
f*(σ,t)=f*^{E}(σ)+f*^{D}(σ,t) 3.2
and
f(ε,t)=f^{E}(ε)+f^{D}(ε,t) 3.3
Applying the assumptions, restrictions and methods of the previous section let's now discuss non-linear viscoelasticity.
3.1 The Non-linear Constitutive Equations

Allowing complete independence between each possible constitutive response, equations 3.1 and 3.2 may be expanded into the three dimensional constitutive equations,
εᵢⱼ(σₖₗ, t)=f*ᵢⱼₖₗ(σₖₗ, tₖₗ)=f*^{E}ᵢⱼₖₗ(σₖₗ)+f*^{D}ᵢⱼₖₗ(σₖₗ, tₖₗ)=ε^{E}ᵢⱼₖₗ(σₖₗ)+ε^{D}ᵢⱼₖₗ(σₖₗ, tₖₗ) 3.4
and
σᵢⱼ(εₖₗ, t)=f*ᵢⱼₖₗ(εₖₗ, tₖₗ)=f^{E}ᵢⱼₖₗ(εₖₗ)+f^{D}ᵢⱼₖₗ(εₖₗ, tₖₗ)=σ^{E}ᵢⱼₖₗ(εₖₗ)+σ^{D}ᵢⱼₖₗ(εₖₗ, tₖₗ) 3.5
ε^{E}ᵢⱼₖₗ(σₖₗ) and ε^{D}ᵢⱼₖₗ(σₖₗ,tₖₗ) are the impulse and delayed elastic strain components respectively. Likewise for the stresses. The shear strains are symmetric, as are the shear stresses unless there is stress coupling. As mentioned previously however, the assumption of complete independence in the component functions is incompatible with the requirement for symmetry in both the shear strains and the shear stresses, and incompatible with the compatibility conditions of strain theory, which demand coupling.

Using reduced indicial notation the expressions for each component of equations 3.4 and 3.5 ε₁(σⱼ,t) for example, may be written as,
ε₁(σⱼ,t)=ε₁₁( . . . )+ε₁₂( . . . )+ . . . +ε₁₉( . . . ) 3.6
where ε₁₁( . . . ) is,
ε₁₁(σ₁,t₁)=f*₁₁(σ₁,t₁)=f*^{E}₁₁(σ₁)+f*^{D}₁₁(σ₁,t₁) 3.7
and so on.
3.2 Sign Conventions

As discussed previously, the non-linear impulse response may be defined in terms of a power series expansion. Power series expansions contain both even and odd powers of stress or strain. A standard but arbitrary sign convention is to define tension as positive, while compression is negative. To achieve a proper solution to these functions the f*^{E}(σ) and f^{E}(ε) must be evaluated using the magnitude of the appropriate stress or strain, where the sign convention is handled by the definitions,
f*^{E}(−σ)=>−f*^{E}(σ) f^{E}(−ε)=>−f^{E}(ε) 3.8

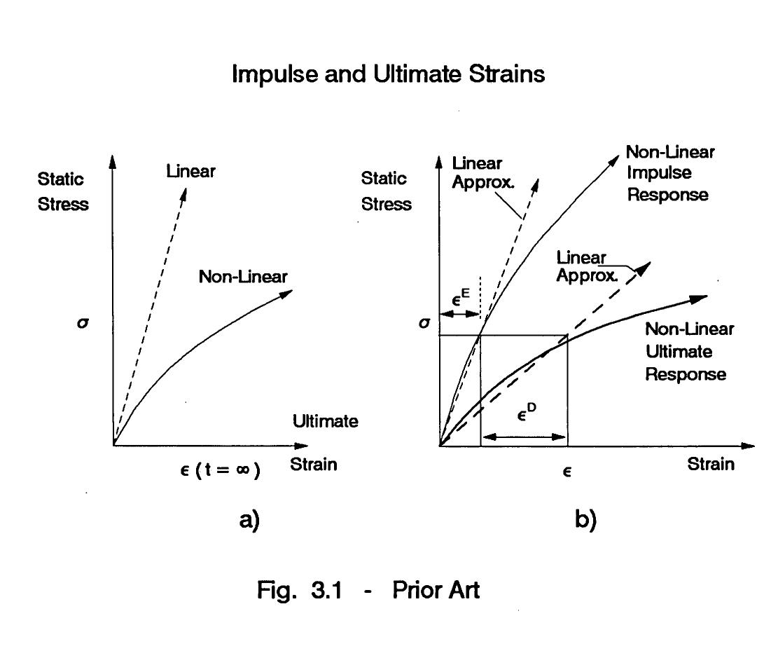

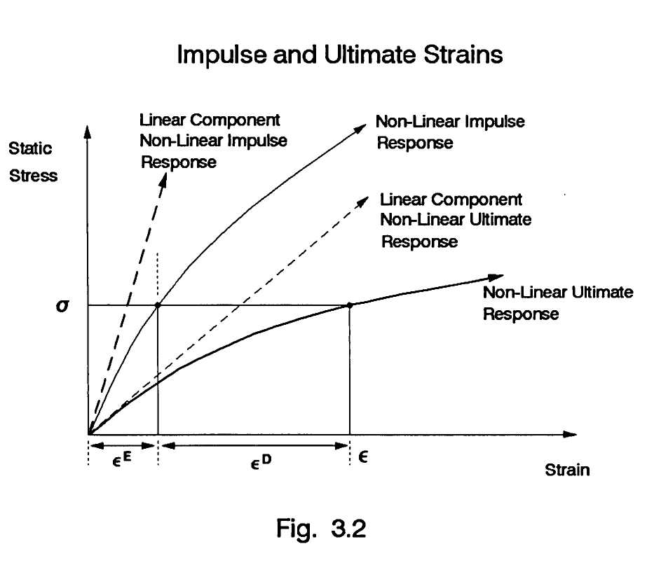

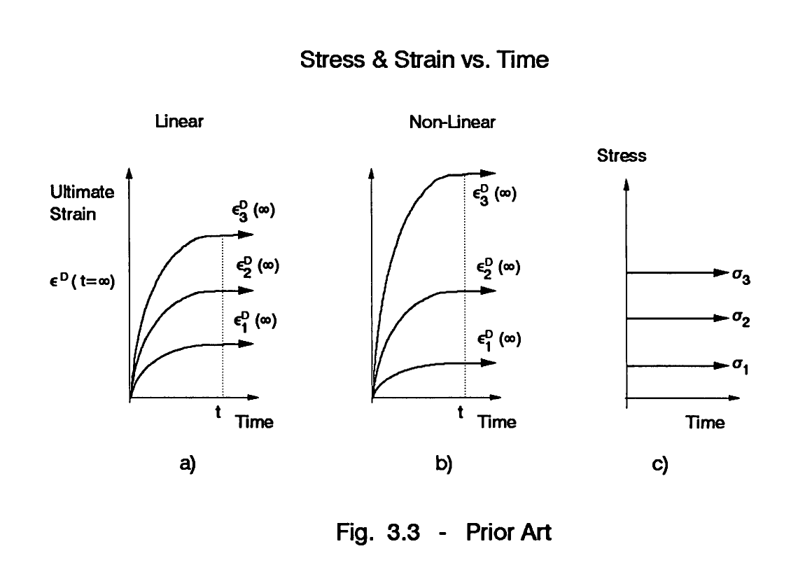

If the delayed elasticity component of the non-linear viscoelastic constitutive function is evaluated at very large time, designated t->∞, the ultimate strain will have been reached (FIG. 3.1a). The one dimensional stress-ultimate strain function then takes the form of,
ε(σ,t→∞)=f*^{E}(σ)+f*^{D}(σ,t→∞) 3.9
Now, ε(σ,t->∞) may be expressed in terms of a power series expansion in stress, like the impulse strain component f*^{E}(σ). So, f*^{D}(σ,t->∞) may also be expressed in terms of a power series expansion in stress. Given that there may be terms of both odd and even powers of stress in f*^{D}(σ,t) that produce the solution f*^{D}(σ,t->∞), we likewise impose the sign convention,
f*^{D}(−σ,t)->−f*^{D}(σ,t) f^{D}(−ε,t)->−f^{D}(ε,t) 3.10
3.3 Partial Reduction of the Delayed Elasticity Function Matrix
The Strain Solution

From section 2 we known that for the small strain condition the non-linear impulse response may be expressed in terms of a scalar valued constitutive function and a matrix of coefficients. This component of strain is time independent, so equation 3.4 may be rewritten as,
εᵢ(σⱼ,t)=[mᵢⱼ]f*^{E}(σⱼ)+f*^{D}ᵢⱼ(σⱼ,t)=ε^{E}ᵢⱼ(σⱼ)+ε^{D}ᵢⱼ(σⱼ,t) 3.11
where each stress is now constrained to be constant, and to be applied separately and alone.

Expanding the delayed elasticity term in equation 3.11 in matrix format yields,

$${ε}_{ij}^{D} ( {σ}_{j} , {t}_{j} ) = \vert \begin{matrix}f {*}_{11}^{D} ( {σ}_{1} , {t}_{1} ) \\ f {*}_{21}^{D} ( {σ}_{1} , {t}_{1} ) \\ … \\ f {*}_{91}^{D} ( {σ}_{1} , {t}_{1} )\end{matrix} \begin{matrix}f {*}_{12}^{D} ( {σ}_{2} , {t}_{2} ) & … & f {*}_{19}^{D} ( {σ}_{9} , {t}_{9} ) \\ f {*}_{22}^{D} ( {σ}_{2} , {t}_{2} ) & … & f {*}_{29}^{D} ( {σ}_{9} , {t}_{9} ) \\ … & … & … \\ f {*}_{92}^{D} ( {σ}_{2} , {t}_{2} ) & … & f {*}_{99}^{D} ( {σ}_{9} , {t}_{9} )\end{matrix} \vert \qquad 3.12$$

Each of the nine functions in each of the nine columns of equation 3.12 is defined in terms of the same independent variables, one of the nine stresses, and time. For example, the nine εᵢ₁,
ε^{D}ᵢ₁(σ₁, t)=f*^{D}ᵢ₁(σ₁, t) 3.13
are defined in terms of the same independent variables, σ₁ and t. These functions must also be coupled due to chemical bonding.

When equations 3.13 are evaluated at some value of stress, say σ₁ and at some time t, they degenerate to a set of constant values for strain,
ε^{D}ᵢ₁(σ₁, t)=f*^{D}ᵢ₁(σ₁, t)=zᵢ₁ 3.14
The zᵢ₁ are the strains associated with the stress σ₁ and time t. When evaluated at some other time, say t′, these functions degenerate into another set of strain constants,
ε^{D}ᵢ₁(σ₁, t′)=f*^{D}ᵢ₁(σ₁, t′)=z′ᵢ₁ 3.15
where the z′ᵢ₁ are the strains associated with the same static stress σ₁ and time t′.

One constant may be expressed in terms of another constant multiplied by another constant so the strain term z₂₁ may be expressed in terms of the strain term z₁₁ as,
f*^{D}₂₁(σ₁, t)=z₂₁=k₂₁z₁₁=k₂₁f*^{D}₁₁(σ₁, t) 3.16
and similarly for all other zᵢ₁, i.e. , zᵢ₁=kᵢ₁·f*^{D}ᵢ₁(σ₁,t). The kᵢ₁ are the scaling constants, and k₁₁=1. At time t′ the strain term z′₂₁ may be written as,
f*^{D}₂₁(σ₁, t′)=z′₂₁=k′₂₁z′₁₁=k′₂₁f*^{D}₁₁(σ₁, t′) 3.17
and so on.

Now, when t->t′ the values of f*^{D}₂₁(σ₁,t) and f*^{D}₁₁(σ₁,t) change, but the functions do not change. The scaling coefficients k′₂₁ and k₂₁ are independent of stress and time, so when t->t′ then f*^{D}₂₁(σ₁,t)->f*^{D}₂₁(σ₁,t′) and f*^{D}₁₁(σ,t)->f*^{D}₁₁(σ₁,t′). Equations 3.16 and 3.17 then yield,
k₂₁f*^{D}₁₁(σ₁, t′)=k′₂₁f*^{D}₁₁(σ₁, t′)→k₂₁=k′₂₁ 3.18
for all time, and for all values of σ₁. Following the same procedure for the remaining seven f*^{D}ᵢ₁(σ₁,t) will produce similar results and equation 3.12 reduces to,

$$\vert \begin{matrix}1 & f {*}_{12}^{D} ( {σ}_{2} , t ) & … & f {*}_{19}^{D} ( {σ}_{9} , t ) \\ {k}_{21} & f {*}_{22}^{D} ( {σ}_{2} , t ) & … & f {*}_{29}^{D} ( {σ}_{9} , t ) \\ … & … & … & … \\ {k}_{91} & f {*}_{92}^{D} ( {σ}_{2} , t ) & … & f {*}_{99}^{D} ( {σ}_{9} , t )\end{matrix} \vert \vert \begin{matrix}f {*}_{11}^{D} ( {σ}_{1} , t ) \\ 1 \\ … \\ 1\end{matrix} \vert \qquad 3.19$$

where f*^{D}₁₁(σ₁,t) is a scalar valued function. Continuing this same exercise for each of the functions in the other eight columns in the matrix will then yield,

$$\vert \begin{matrix}1 & 1 & … & 1 \\ {k}_{21} & {k}_{22} & … & {k}_{29} \\ … & … & … & … \\ {k}_{91} & {k}_{92} & … & {k}_{99}\end{matrix} \vert \vert \begin{matrix}f {*}_{11}^{D} ( {σ}_{1} , t ) \\ f {*}_{12}^{D} ( {σ}_{2} , t ) \\ … \\ f {*}_{19}^{D} ( {σ}_{9} , t )\end{matrix} \vert \qquad 3.20$$

Because the nine constitutive functions f*^{D}₁ⱼ(σⱼ,t) are supposedly independent, each now represents a solution for a particular state of stress. Again, the simple proportionality between responses is an approximation and the result of imposing the small strain condition (see section 2).

All nine of the f*^{D}₁ⱼ(σⱼ,t) functions in equation 3.20 are scalar valued, and control all possible strains in all possible directions for any loading function operating in any given direction. However, equation 3.20 implies that each function is independent, but somehow associated with a particular type of stress, i.e., normal or shear, as well as a particular loading direction, where more that one function operates in a given direction. Given the requirement for coupling in the strain components through bonding, and that loading from any direction produces deformation of the same set of bonds, this result makes no sense. Furthermore, the generalized non-linear functions of equation 3.20 must contain, as a special case, all possible linear viscoelastic solutions. So, equation 3.20 can not possibly be the final solution.

3.4 The Final Reduction

By using the reference frame transformation techniques already discussed the number of non-zero matrix coefficients associated with any degree of material symmetry or isotropy may be determined.

Application of Normal Stresses

Begin with the normal stresses, and set eight of the nine possible stresses equal to zero, with the exception of σ₁. Equation 3.20 then becomes,

$${ε}_{i}^{D} ( {σ}_{1} , t ) = \vert \begin{matrix}1 \\ {k}_{21} \\ … \\ {k}_{91}\end{matrix} \vert f {*}_{11}^{D} ( {σ}_{1} , t ) \qquad 3.21$$

The shear strains are symmetric, so there are only six independent values for the kⱼ₁ and equation 3.21 reduces to,

$${ε}_{i}^{D} ( {σ}_{1} , t ) = \vert \begin{matrix}1 \\ {k}_{21} \\ … \\ {k}_{61}\end{matrix} \vert f {*}_{11}^{D} ( {σ}_{1} , t ) \qquad 3.22$$

From equation 3.11 the solution for total strain is,

$${ε}_{i} ( {σ}_{1} , t ) = \vert \begin{matrix}1 \\ {m}_{22} \\ … \\ {m}_{61}\end{matrix} \vert f {*}^{E} ( {σ}_{1} ) + \vert \begin{matrix}1 \\ {k}_{21} \\ … \\ {k}_{61}\end{matrix} \vert f {*}_{11}^{D} ( {σ}_{1} , t ) \qquad 3.23$$

Applying σ₂ separately, and then applying σ₃ separately produces similar solutions. Equation 3.20 then reduces to,

$${ε}_{i}^{D} ( {σ}_{j} , t ) = \vert \begin{matrix}1 & 1 & 1 \\ {k}_{21} & {k}_{22} & {k}_{23} \\ … & … & … \\ {k}_{61} & {k}_{62} & {k}_{63}\end{matrix} \vert \vert \begin{matrix}f {*}_{11}^{D} ( {σ}_{1} , t ) \\ f {*}_{12}^{D} ( {σ}_{2} , t ) \\ f {*}_{13}^{D} ( {σ}_{3} , t )\end{matrix} \vert \qquad 3.24$$

where each stress is applied separately and alone, although the sequence of application is totally arbitrary.
Multiple Planes of Material Symmetry

Once again define two orthonormal coordinate systems, xᵢ and zᵢ, where the x₁-x₂ and z₁-z₂ axes are coincident and define a plane, but where z₃=−x₃, the mirror image of the x₃ axis. Stress and strain in the xᵢ reference system are σ and ε, while stress and strain associated with the zᵢ reference system are σ* and ε*. Now consider the stresses and strains in the ‘2-3’ and ‘3-1’ directions. The direction cosines for this transformation are given by equation 2.27. Substituting those results into equation 1.39 yields the vector transformation σ*ᵢⱼ=σᵢⱼ, and ε*ᵢⱼ=εᵢⱼ, except as follows,
σ*₂₃=−σ₂₃, σ*₃₁=−σ₃₁, ε*₂₃=−ε₂₃, ε*₃₁=−ε₃₁ 3.25
None of the kᵢⱼ coefficients associated with the normal strains in equation 3.24 can be eliminated, unlike the coefficients associated with the shear strains. From equation 3.20 the expression for the shear strain ε₄( . . . ), when only σ₁ is applied with respect to the xi reference frame, is,
ε₄(σ₁,t)=m₁₄f*^{E}(σ₁)+k₁₄f*^{D}₁₁(σ₁,t) 3.26
In the zᵢ frame the equivalent expression is,
ε*₄(σ*₁,t)=m₁₄f*^{E}(σ*₁)+k₁₄f*^{D}₁₁(σ₁,t) 3.27
Flipping the z₃ axis and substituting the appropriate transformations for stress and strain into equation 3.27 yields,
−ε₄(σ₁,t)=m₁₄f*^{E}(σ₁)+k₁₄f*^{D}₁₁(σ₁,t) 3.28
Adding equations 3.26 and 3.28 produces,
0=2m₁₄f*^{E}(σ₁)+2k₁₄f*^{D}₁₁(σ₁,t) 3.29
The constitutive functions are non-zero in value for any non-zero value of σ₁, and at any time t, so m₁₄=k₁₄=0. The same result will be obtained for the transformation of ε₅, which then yields k₁₅=k₁₄=0, and equation 3.23 reduces to,

$${ε}_{i} ( {σ}_{1} , t ) = \vert \begin{matrix}1 \\ {m}_{21} \\ {m}_{31} \\ 0 \\ 0 \\ {m}_{61}\end{matrix} \vert f {*}^{E} ( {σ}_{1} ) + \vert \begin{matrix}1 \\ {k}_{21} \\ {k}_{31} \\ 0 \\ 0 \\ {k}_{61}\end{matrix} \vert f {*}_{11}^{D} ( {σ}_{1} , t ) \qquad 3.30$$

Applying σ₂ and σ₃ separately, the same symmetry condition produces similar results and equation 3.24 becomes,

$${ε}_{i}^{D} ( {σ}_{j} , t ) = \vert \begin{matrix}1 & 1 \\ {k}_{21} & {k}_{22} \\ {k}_{31} & {k}_{32} \\ 0 & 0 \\ 0 & 0 \\ {k}_{61} & {k}_{62}\end{matrix} \begin{matrix}1 \\ {k}_{23} \\ {k}_{33} \\ 0 \\ 0 \\ {k}_{63}\end{matrix} \vert \vert \begin{matrix}f {*}_{11}^{D} ( {σ}_{1} , t ) \\ f {*}_{12}^{D} ( {σ}_{2} , t ) \\ f {*}_{13}^{D} ( {σ}_{3} , t )\end{matrix} \vert \qquad 3.31$$

and likewise for the impulse response.
Two/Three Planes of Symmetry

Let's now discuss the case of two, and hence three planes of axial symmetry. In addition to the defined axial rotation of z₃=−x₃ for a single axis of symmetry, the rotations for the condition of 2 axes of material symmetry now include z₁=−x₁, z₃=−x₃, with z₂=x₂. The only non-zero direction cosines for these equivalences are given by equation 2.35. Equations 2.26 yield the following transformations for ε₆, and for the stresses σ₁, σ₂ and σ₃,
ε₁₂*=−ε₁₂, σ*₁=σ₁, σ*₂=σ₂, σ*₃=σ₃ 3.32
Following the same above procedures will produce the equivalences k₆₁=k₆₂=k₆₃=0, and equation 3.31 reduces to,

$${ε}_{i}^{D} ( {σ}_{j} , t ) = \vert \begin{matrix}1 & 1 & 1 \\ {k}_{21} & {k}_{22} & {k}_{23} \\ {k}_{31} & {k}_{32} & {k}_{33} \\ 0 & 0 & 0 \\ 0 & 0 & 0 \\ 0 & 0 & 0\end{matrix} \vert \vert \begin{matrix}f {*}_{11}^{D} ( {σ}_{1} , t ) \\ f {*}_{12}^{D} ( {σ}_{2} , t ) \\ f {*}_{13}^{D} ( {σ}_{3} , t )\end{matrix} \vert \qquad 3.33$$

Normal stresses and Complete Material Isotropy

Begin with the results just obtained, where the two reference frames shall be initially coincident. Rotate the xᵢ reference axes 90 degrees about the z₃ axis, such that the x₁ axis coincides with the z₂ axes, the z₂ axis with the −x₁ axis, and the x₃ axis coincides with the z₃ axis. Rotating the x₁-x₂ axes through some angle α about the x₃ axis produces the transformations from the x₁-x₄ plane into the z₁-z2 plane given by,
z₃=x₃, z₁=x₁ cos α+x₂ sin α, z₂=−x₁ sin α+x₂ cos α 3.34
where α is equal to 90 degrees. From equation 1.39 the 90 degree rotation of axes yields the transformations,
σ*₁=σ₂, σ*₂=σ₁, σ*₃=σ₃
ε*₁=ε₂, ε*₂=ε₁, ε*₃=ε₃ 3.35
Applying the stress σ₁ in the x₁ axis direction the expression for strain in the x₁ direction yields,
ε^{D}₁(σ₁,t)=k₁₁f*^{D}₁₁(σ₁,t)=f*^{D}₁₁(σ₁,t) 3.36
In the z₂ direction the expression for strain as a function of σ*₂ is,
ε^{D}₂*(σ₂*,t)=k₂₂f*^{D}₁₂(σ₂*,t) 3.37
rotate the z₂ axis so that it is coincident with the x₁ axis, and demand equivalence in the resulting strains (the condition of isotropy). From the vector transformations equation 3.37 becomes,
ε^{D}₁(σ₂,t)=k₂₂f*^{D}₁₂(σ₁,t) 3.38
Equating equation 3.36 with equation 3.38 yields,
k₂₂f*^{D}₁₂(σ₁,t)=f*^{D}₁₁(σ₁,t) 3.39
and the solution for the function f*^{D}₁₂(σ₁,t),

$$f {*}_{12}^{D} ( {σ}_{1} , t ) = \frac{1}{{k}_{22}} f {*}_{11}^{D} ( {σ}_{1} , t ) \qquad 3.40$$

σ₁ is a magnitude term, so the scalar function f*^{D}₁₂(σ,t) scales in terms of the scalar function f*^{D}₁₁(σ,t). Multiplying through by the comstant term 1/k₂₂ equation 3.33 becomes,

$${ε}_{i}^{D} ( {σ}_{j} , t ) = \vert \begin{matrix}1 & 1 / {k}_{22} & 1 \\ {k}_{21} & 1 & {k}_{23} \\ {k}_{31} & {k}_{32} / {k}_{22} & {k}_{33} \\ 0 & 0 & 0 \\ 0 & 0 & 0 \\ 0 & 0 & 0\end{matrix} \vert \vert \begin{matrix}f {*}_{11}^{D} ( {σ}_{1} , t ) \\ f {*}_{11}^{D} ( {σ}_{2} , t ) \\ f {*}_{13}^{D} ( {σ}_{3} , t )\end{matrix} \vert \qquad 3.41$$

Demanding the same degree of symmetry with regard to the x₁-x₃ plane, equation 3.41 reduces further to,

$${ε}_{i}^{D} ( {σ}_{j} , t ) = \vert \begin{matrix}1 & 1 / {k}_{22} & 1 / {k}_{33} \\ {k}_{21} & 1 & {k}_{23} / {k}_{33} \\ {k}_{31} & {k}_{32} / {k}_{22} & 1 \\ 0 & 0 & 0 \\ 0 & 0 & 0 \\ 0 & 0 & 0\end{matrix} \vert \vert \begin{matrix}f {*}_{11}^{D} ( {σ}_{1} , t ) \\ f {*}_{11}^{D} ( {σ}_{2} , t ) \\ f {*}_{11}^{D} ( {σ}_{3} , t )\end{matrix} \vert \qquad 3.42$$

Redesignating the coefficients yields,

$${ε}_{i}^{D} ( {σ}_{j} , t ) = \vert \begin{matrix}{n}_{11} & {n}_{12} & {n}_{13} \\ {n}_{21} & {n}_{11} & {n}_{23} \\ {n}_{31} & {n}_{32} & {n}_{11} \\ 0 & 0 & 0 \\ 0 & 0 & 0 \\ 0 & 0 & 0\end{matrix} \vert \vert \begin{matrix}f {*}^{D} ( {σ}_{1} , t ) \\ f {*}^{D} ( {σ}_{2} , t ) \\ f {*}^{D} ( {σ}_{3} , t )\end{matrix} \vert \qquad 3.43$$

where n₁₁=1, by choice of definition.

Following the same procedures outlined in section 2 will yield equivalence and symmetry in the non-diagonal coefficients. Skipping the algebra, equation 3.43 then reduces to,

$${ε}_{i}^{D} ( {σ}_{j} , t ) = \vert \begin{matrix}{n}_{11} & {n}_{12} & {n}_{12} \\ {n}_{12} & {n}_{11} & {n}_{12} \\ {n}_{12} & {n}_{12} & {n}_{11} \\ 0 & 0 & 0 \\ 0 & 0 & 0 \\ 0 & 0 & 0\end{matrix} \vert \vert \begin{matrix}f {*}^{D} ( {σ}_{1} , t ) \\ f {*}^{D} ( {σ}_{2} , t ) \\ f {*}^{D} ( {σ}_{3} , t )\end{matrix} \vert \qquad 3.44$$

where n₁₁=1.
Shear Stress and a Single Plane/Axis of Material Symmetry

Again set eight of the nine stresses to zero, except σ₄. Equation 3.11 then reduces to,

$${ε}_{i} ( {σ}_{4} , t ) = \vert \begin{matrix}{m}_{14} \\ {m}_{24} \\ … \\ {m}_{64}\end{matrix} \vert f {*}^{E} ( {σ}_{4} ) + \vert \begin{matrix}1 \\ {k}_{24} \\ … \\ {k}_{64}\end{matrix} \vert f {*}_{14}^{D} ( {σ}_{4} , t ) \qquad 3.45$$

where there are only six independent mᵢ₄ and kᵢ₄ due to symmetry in the shear strains.

Let two orthogonal reference frames, the xᵢ and zᵢ systems, to be initially coincident. For a single axis of symmetry the axial transformations are again x₁=z₁, x₂=z₂, and −x₃=z₃. The solutions for the stress and strain transformations are σᵢⱼ=σ*ᵢⱼ, and εᵢⱼ( . . . )=ε*ᵢⱼ( . . . ), except for those given by equation 3.25. From equation 3.45 the expression for the normal strain ε₁( . . . ) in the xᵢ reference frame is,
ε₁(σ₄,t)=m₁₄f*^{E}(σ₄)+k₁₄f*^{D}₁₄(σ₄,t) 3.46
In the zᵢ reference frame the equivalent expression is,
ε*₁(σ*₄,t)=m₁₄f*^{E}(σ*₄)+k₁₄f*^{D}₁₄(σ*₄,t) 3.47
Substituting into equation 3.47 the appropriate transformations produces,
ε₁(σ₄,t)=−m₁₄f*^{E}(σ₄)−k₁₄f*^{D}₁₄(σ₄,t) 3.48
Subtracting equation 3.46 from equation 3.48 yields,
0=−2 m₁₄f*^{E}(σ₄)−2k₁₄f*^{D}₁₄(σ₄,t) 3.49
Given that the constitutive functions are not equal to zero for any non-zero value of σ₄ when time t>0 then m₁₄=k₁₄=0.

Similar results will be obtained for the transformations of the other two normal strains and m₂₄=m₃₄=k₂₄=k₃₄=0. No information is obtained for the coefficients m₄₄, m₅₄, k₄₄ and k₅₄, other than they are not equal to zero. These transformations however do yield m₆₄=k₆₄=0, and equation 3.45 reduces to,

$${ε}_{i} ( {σ}_{4} , t ) = \vert \begin{matrix}0 \\ 0 \\ 0 \\ {m}_{44} \\ {m}_{54} \\ 0\end{matrix} \vert f {*}^{E} ( {σ}_{4} ) + \vert \begin{matrix}0 \\ 0 \\ 0 \\ {k}_{44} \\ {k}_{54} \\ 0\end{matrix} \vert f {*}_{14}^{D} ( {σ}_{4} , t ) \qquad 3.50$$

Following the same procedures for the other shear stresses and resulting straind will produce similar results.
Shear Stress and Two/Three Planes of Material Symmetry

The axial transformations are again z₂=x₂, z₃=−x₃, and z₁=−x₁. The associated direction cosines are given by equations 1,40-1.41. This symmetry condition yields no new information pertaining to the coefficients m₄₄ or k₄₄. However, for ε₅( . . . ) in the xᵢ frame we have,
ε₅(σ₄,t)=m₅₄f*^{E}(σ₄)+k₅₄f*^{D}₁₄(σ₄,t) 3.51
and in the zᵢ frame,
ε*₅(σ*₄,t)=m₅₄f*^{E}(σ*₄)+k₅₄f*^{D}₁₄(σ*₄,t) 3.52
Substituting the appropriate transformations for stress and strain into equation 3.52 yields,
ε₅(σ₄,t)=−m₅₄f*^{E}(σ₄)−k₅₄f*^{D}₁₄(σ₄,t) 3.53
where f*^{E}(−σ)=−f*^{E}(σ) and f*^{D}(−σ,t)=−f*^{D}(σ,t), by definition.
Substracting equation 3.51 from equation 3.53 produces,
0=−2m₅₄f*^{E}(σ₄)−2k₅₄f*^{D}₁₄(σ₄,t) 3.54
Given that the constitutive functions are not equal to zero for any non-zero value of σ₄, then m₅₄=k₅₄=0. Equation 3.50 then reduces to,

$${ε}_{i} ( {σ}_{4} , t ) = \vert \begin{matrix}0 \\ 0 \\ 0 \\ {m}_{44} \\ 0 \\ 0\end{matrix} \vert f {*}^{E} ( {σ}_{4} ) + \vert \begin{matrix}0 \\ 0 \\ 0 \\ {k}_{44} \\ 0 \\ 0\end{matrix} \vert f {*}_{14}^{D} ( {σ}_{4} , t ) \qquad 3.55$$

Continuing on with the other shear stresses, σ₅->σ₉, will yield similar results for the other sets of coefficients.

By rotating a reference frame 45 degrees any shear stress may be comverted into a normal stress, although the magnitude differs. Given that f*^{D}₁₄(σ,t) is scalar valued, the form of the function is unaltered by the reference frame transformation. A normal stress produces a normal strain, so f*^{D}₁₄(σ,t) must be equivalent to f*^{D}(σ,t). Again, this should be obvious because simple rotations of spatial reference frame with respect to a body of material cannot cause changes in material properties. The same equivalence may be demonstrated for the remaining functions f*^{D}₁₅(σ,t)->f*^{D}₁₉(σ,t).

Complete Material Isotropy

When the strain functions εᵢ( . . . ) are evaluated for σ₄, or for any other shear stress, no other non-zero values for the coefficients are found for the condition of complete material isotropy. However, we do find that m₄₄=m₅₅=m₆, and that in the shear stress there is equivalence in k₄₄=k₅₅=k₆₆, etc.

Given symmetry in the shear stress there is equivalence in the value of the constitutive functions when evaluated for each of the these stresses .g., f*^{D}(σᵢⱼ,t)=f*^{D}(σⱼᵢ,t). When the εᵢ( . . . ) are evaluated, six shear stresses yield no more information about the strain field than three shear stresses. So, equation 3.24 becomes,

$${ε}_{i}^{D} ( {σ}_{j} , t ) = \vert \begin{matrix}1 & {n}_{12} & {n}_{12} & 0 & 0 & 0 \\ {n}_{12} & 1 & {n}_{12} & 0 & 0 & 0 \\ {n}_{12} & {n}_{12} & 1 & 0 & 0 & 0 \\ 0 & 0 & 0 & {n}_{44} & 0 & 0 \\ 0 & 0 & 0 & 0 & {n}_{44} & 0 \\ 0 & 0 & 0 & 0 & 0 & {n}_{44}\end{matrix} \vert \vert \begin{matrix}f {*}^{D} ( {σ}_{1} , t ) \\ f {*}^{D} ( {σ}_{2} , t ) \\ f {*}^{D} ( {σ}_{3} , t ) \\ f {*}^{D} ( {σ}_{4} , t ) \\ f {*}^{D} ( {σ}_{5} , t ) \\ f {*}^{D} ( {σ}_{6} , t )\end{matrix} \vert \qquad 3.56$$

Inverting all the reference frame transformations and material symmetry or isotropy constraints will produce the original 9×9 matrix of constant coefficients. However, there are only six equations and six unknowns, so equation 3.56 reduces to,

$${ε}_{i}^{D} ( {σ}_{j} , t ) = \vert \begin{matrix}{n}_{11} \\ {n}_{21} \\ {n}_{31} \\ {n}_{41} \\ {n}_{51} \\ {n}_{61}\end{matrix} \begin{matrix}{n}_{12} \\ {n}_{22} \\ {n}_{32} \\ {n}_{42} \\ {n}_{52} \\ {n}_{62}\end{matrix} \begin{matrix}{n}_{13} \\ {n}_{23} \\ {n}_{33} \\ {n}_{43} \\ {n}_{53} \\ {n}_{63}\end{matrix} \begin{matrix}{n}_{14} \\ {n}_{24} \\ {n}_{34} \\ {n}_{44} \\ {n}_{54} \\ {n}_{64}\end{matrix} \begin{matrix}{n}_{15} \\ {n}_{25} \\ {n}_{35} \\ {n}_{45} \\ {n}_{55} \\ {n}_{65}\end{matrix} \begin{matrix}{n}_{16} \\ {n}_{26} \\ {n}_{36} \\ {n}_{46} \\ {n}_{56} \\ {n}_{66}\end{matrix} \vert f {*}^{D} ( {σ}_{j} , t ) \qquad 3.57$$

where n₁₁=1 by definition. The compete solution for strain becomes,
εᵢ(σⱼ,t)=[mᵢⱼ]f*^{E}(σⱼ)+[nᵢⱼ]f*^{D}(σj,t) 3.58
As a general condition, symmetry in the matrix coefficients for any degree of material symmetry or anisotropy has not yet been demonstrated.
3.5 Multiple Loads and the Non-Linear Solution
The Stress Field and the State of Stress

Following the discussion in section 2 define a Cartesian reference frame, the xᵢ system, where the nine a σᵢⱼ about some differential element of a solid material (FIG. 2.2). Shrink that differential element to where δx·δy·δz->0. The resultant of the nine σᵢⱼ stresses will then be the solution for the total state of stress at a point, σₛ (FIG. 2.3). This resultant vector has a magnitude and a direction of action with respect to the xᵢ axes which may be calculated.

Now orient another orthogonal reference frame, the zᵢ reference frame, with respect to σₛ such that one axis, say the z₁ axis, is coincident and collinear with σₛ, and the z₂-z₃ plane is normal to σ₅ (FIG. 2.4). The zᵢ system is now the frame of state for which the maximum state of stress is known, i.e., the type of stress, the magnitude, and the direction of action.

Matrix Coefficients and Reference Frame Transformations

Recall from section 2 that the number of non-zero matrix coefficients is determined from various symmetry and isotropy conditions, and with reference to a primary Cartesian reference frame. The nᵢⱼₖₗ and mᵢⱼₖₗ matrices represent fourth order tensors, and like stress and strain tensors, the value of each coefficient varies according the orientation of respective reference frames. These coefficients transform from one reference frame, say the xᵢ primary reference frame, to the frame of state, the zᵢ system, according to the function 2.66. Again, the exception is complete isotropy, where the m*ᵢⱼₖₗ=mᵢⱼₖₗ, and the n*ᵢⱼₖₗ=nᵢⱼₖₗ for all reference frame orientations.

The Example of Isotropy and Non-Linear Viscoelasticity

Load an element of an isotropic, non-linear viscoelastic body such that the only stress σ*₁ is oriented along the z₁ axis of the orthogonal zᵢ reference frame (FIG. 2.5a). Orient an xᵢ reference frame initially coincident with the zᵢ reference frame, then rotate the xᵢ system about the x₃ axis (which remains coincident with z₃) so that z₁-z₂ axes are oriented with respect to the x₁-x₂ axes by some angle of rotation a (FIG. 2.5b). In the x₁-x₂ plane the vector σ*₁ may be defined to be the resultant of two simultaneously applied normal stresses, σ₁ and σ₂, operating coincident with the x₁ and x₂ axes. σ*₁ now also represents the solution for the total state stress, σₛ, in both the zᵢ and xᵢ systems.

For static loading the generalized governing constitutive equation of non-linear viscoelasticity is,
εᵢ(σⱼ,t)=[mᵢⱼ]f*^{E}(σⱼ)+[nᵢⱼ]f*^{D}(σⱼ,t) 3.59
which is valid for all orientations of orthogonal reference frames, regardless of the degree of material symmetry or isotropy. For complete isotropy the form of the matrix solutions are given by,

$$\vert \begin{matrix}1 & {m}_{12} & {m}_{12} & 0 & 0 & 0 \\ {m}_{12} & 1 & {m}_{12} & 0 & 0 & 0 \\ {m}_{12} & {m}_{12} & 1 & 0 & 0 & 0 \\ 0 & 0 & 0 & {m}_{44} & 0 & 0 \\ 0 & 0 & 0 & 0 & {m}_{44} & 0 \\ 0 & 0 & 0 & 0 & 0 & {m}_{44}\end{matrix} \vert \qquad 3.60$$

and likewise for the nᵢⱼ, etc., for all possible reference frame orientations.

From equation 3.59 the loading function σ*₁ will produce three strains in the zᵢ system (FIG. 2.6a), ε*₁(σ*₁,t)=ε*₁₁(σ*₁,t), ε*₂(σ*₁,t)=ε*₂₁(σ*₁,t) and ε*₃(σ*₁,t)=ε*₃₁(σ*₁,t). The solutions for the strains ε₁(σ*₁,t) and ε₂(σ*₁,t) associated with the x₁ and x₂ axes are obtained by adding the appropriate vector components of ε*₁₁(σ*₁,t) and ε*₂₁(σ*₁,t) (FIG. 2.6b),
ε₁(σ*₁,t)=ε*₁₁(σ*₁,t)cos α+ε*₂₁(σ*₁,t)sin α
ε₂(σ*₁,t)=ε*₁₁(σ*₁,t)sin α+ε*₂₁(σ*₁,t)cos α 3.61
From equation 3.59 the solutions for the strains, ε1(σ*₁,t) and ε*₂(σ*₁,t) in the zᵢ system are,
ε*₁(σ*₁,t)=ε*₁₁(σ*₁,t)=m₁₁f*^{E}(σ*₁)+n₁₁f*^{D}(σ*₁,t)
ε*₂(σ*₁,t)=ε*₂₁(σ*₁,t)=m₁₂f*^{E}(σ*₁)+n₁₂f*^{D}(σ*₁,t) 3.62
Substituting equations 3.62 into equations 3.61 produces the solutions for ε₁(σ*₁,t) and ε₂(σ*₁,t) in terms of σₛ=σ*_{1,}
ε₁(σ*₁,t)=[m₁₁f*^{E}(σ*₁)+n₁₁f*^{D}(σ*₁,t)] cos α+[m₁₂f*^{E}(σ*₁)+n₁₂f*^{D}(σ*₁,t)] sin α
ε₂(σ*₁,t)=[m₁₁f*^{E}(σ*₁)+n₁₁f*^{D}(σ*₁,t)] sin α+[m₁₂f*^{E}(σ*₁)+n₁₂f*^{D}(σ*₁ ,t)] cos α 3.63

So, as we saw in section 2, even with a simple isotropic material it is clear that only when f*(σ,t) is linear, or may be approximated by a linear function, may the base reference frame solutions for strain be added in a linear fashion to obtain a correct solution. As with the non-linear elastic materials, a linear approximation of f*(σ,t) will yield reasonable solutions for strain from the component stresses only if the solution for the state of stress does not exceed the range of accuracy of the linear approximation.

Generalized Non-Linear Solutions for Static Loading

To obtain explicit non-linear solutions for multiple loading conditions first define the stress components, the σⱼ, with respect to a base Cartesian reference frame, call it xᵢ. Next, solve for the magnitude and direction of action of state of stress vector with respect to the xᵢ system. Now, orient another Cartesian reference frame, call it the frame of state zᵢ, such that one axis is coincident with state of stress vector, σₛ, and σₛ is normal to the plane defined by the other two orthogonal axes (FIG. 2.7). Next, define the appropriate direction cosines for the zᵢ system relative to the xᵢ system, and compute the transformation solution for the two sets of matrix coefficients, the mᵢⱼ and nᵢⱼ, as given by equation 2.66. Finally, solve for strains in the zᵢ system with the constitutive function,
ε*ᵢ(σₛ,t)=[m*ᵢⱼ]f*^{E}(σₛ)+[n*ᵢⱼ]f*^{D}(σ_{s,}t) 3.64
The index j may be 1, 2, or 3, and the state of stress vector is a normal stress vector aligned coincident with one of the zᵢ axes. The index i will vary from 1 to 6 depending upon the degree of material symmetry or isotropy.

Once the solutions for the ε*ᵢ(σₛ,t) have been obtained in the zᵢ frame of state they may then be transformed into solutions for strain in xᵢ base reference frame with the vector transformation equations.

3.6 Time Limited Forms of the Non-Linear Solution

In the zᵢ frame the impulse response function f*^{E}(σₛ) may always be written as a power series expansion in σₛ, i.e.,

$$\begin{matrix}f {*}^{E} ( {σ}_{s} ) = {a}_{1} {σ}_{s} + {a}_{2} {σ}_{s}^{2} + … + {a}_{n} {σ}_{s}^{n} = {\sum }_{n = 1}^{x} {a}_{n} {σ}_{s}^{n} \\ = {a}_{1} {σ}_{s} + {\sum }_{n = 2}^{x} {a}_{n} {σ}_{s}^{n} = f {*}_{L}^{E} {σ}_{s} + f {*}_{NL}^{E} ( {σ}_{s} )\end{matrix} \qquad 3.65$$

where f*^{E}(σₛ) may always be expressed as the sum of a linear component, f*^{E}_{L}·σₛ, and a non-linear component, f*^{E}_{NL}(σₛ). The solution for the impulse strains in the frame of state, the ε*ᵢ(σₛ), may then be written as,
ε*^{E}(σₛ)ᵢ=[m*ᵢ₁]f*^{E}(σₛ)=[m*ᵢ₁][f*^{E}_{L}σₛ+f*^{E}_{NL}(σₛ)]=ε*_{L(i)}+ε*_{NL(i)} 3.66

For linearity f*^{E}(σₛ) reduces to the first order term, with f*^{E}_{L}=f*^{E}.

At very large time, t->∞, the non-linear viscoelastic strain function ε*(σₛ,t->∞) approaches an asymptotic limit for any constant σₛ. At this time limit f*(σₛ,t->∞) may likewise always be written as a power series expansion in σₛ (FIG. 3.2),

$$\begin{matrix}f * ( {σ}_{s} , t -> ∞ ) = {b}_{1} {σ}_{s} + {b}_{2} {σ}_{s}^{2} + … + {b}_{n} {σ}_{s}^{n} = {\sum }_{n = 1}^{x} {b}_{n} {σ}_{s}^{n} \\ = {b}_{1} {σ}_{s} + {\sum }_{n = 2}^{x} {b}_{n} {σ}_{s}^{n} = f {*}_{L} {σ}_{s} + f {*}_{NL} ( {σ}_{s} )\end{matrix} \qquad 3.67$$

and expressed as the sum of linear component, f*_{L}·σₛ, and a non-linear component, f*_{NL}(σₛ).

Now if the ultimate strain and the impulse strain may be expressed as power series expansions at t->∞, then obviously so may be the delayed elasticity strain component, which is the difference between the ultimate strain and the impulse strain. The expression for total strain at t->∞ may then be written as,
ε*(σₛ,t→∞)ᵢ=[m*ᵢ₁]f*^{E}(σₛ)+[n*ᵢ₁]f*^{D}(σₛ,t→∞) 3.68
or upon expansion,
ε*(σₛ,t→∞)ᵢ =[m*ᵢ₁][a₁σₛ+f*^{E}_{(NL(σ}ₛ)]+[n*ᵢ₁ ][c₁σₛ+f*^{D}_{NL}(σs,t→∞)]=ε*_{L(i)}+ε*_{NL(i)} 3.69
The non-linear terms are the higher order expansions in σₛ. The solution for the linear strain term is,
ε*_{L(i)}=[m*ᵢ₁]a₁σₛ+[n*ᵢ₁]c₁σₛ 3.70
When the higher order non-linear terms are negligible then equation 3.69 degenerates to equation 3.70 and a₁->f*^{E} and c₁->f*^{D}(t->∞).
3.7 Symmetry in the Coefficient Matrices
The Work and Strain Energy Functions

FIG. 3.2 illustrates the one-dimensional form of the stress-strain relationship of equation 3.69. For either linear or non-linear viscoelastic materials the work, W, required to get from the undeformed state to the ultimate static deformed state at time t->∞ is given by the integral expression,

$$W = {\int }_{0}^{e} σ ⅆ ε ( t -> ∞ ) \qquad 3.71$$

This expression is the sum of an elastic potential energy function and a dissipation function, a heat term (the kinetic energy of deformation term, KE, is equal to zero). When deformation is very slow and essentially isothermal then equation 3.71 reverts to a strain energy function.

A complementary work function, W*, may be defined by,

$$W *= {\int }_{0}^{σ} ε ( t -> ∞ ) ⅆ σ \qquad 3.72$$

and in a three dimensional format becomes,

$$W *= {\int }_{0}^{{σ}_{j}} {ε}_{i} ( t -> ∞ ) ⅆ {σ}_{j} \qquad 3.73$$

Rewriting equation 3.70 in a one dimensional format, ignoring heat loss, and substituting the result into equation 3.72 produces a one dimensional recoverable strain energy function of the form,

$$\begin{matrix}W *= {\int }_{0}^{σ} ε ( t -> ∞ ) ⅆ σ = {\int }_{0}^{σ} ( {ε}_{L} + {ε}_{NL} ) ⅆ σ \\ = {\int }_{0}^{σ} {ε}_{L} ⅆ σ + {\int }_{0}^{σ} {ε}_{NL} ⅆ σ = U {*}_{L} + U {*}_{NL}\end{matrix} \qquad 3.74$$

where the total complimentary strain energy is the sum of linear and non-linear components. Expanding equation 3.74 into a three dimensional format by substituting the generalized form of equation 3.70 into equation 3.73 produces,

$$W *= {\int }_{0}^{{σ}_{j}} ( {ε}_{L ( i )} + {ε}_{NL ( i )} ) ⅆ {σ}_{j} = {\int }_{0}^{{σ}_{j}} {ε}_{L ( i )} ⅆ {σ}_{j} + {\int }_{0}^{{σ}_{j}} {ε}_{NL ( i )} ⅆ {σ}_{j} \qquad 3.75$$

In the zᵢ frame of state there is only one stress function, σₛ, which is equivalent to σ₁, so equation 3.75 reduces to,

$$W *= W {*}_{L} + W {*}_{NL} = {\int }_{0}^{{σ}_{s}} {ε}_{L ( i )} ⅆ {σ}_{s} + {\int }_{0}^{{σ}_{s}} {ε}_{NL ( i )} ⅆ {σ}_{s} \qquad 3.76$$

The Linear Component of Work

Recall that in the zᵢ frame of state the matrix coefficients are transformations from the base reference frame, the transformation being accomplished from equation 2.66. Obviously, if the transformations are inverted we must obtain once again the same mᵢⱼₖₗ and nᵢⱼₖₗ. Furthermore, the products m*ᵢⱼₖₗ·a₁ and n*_{ijkl·c}₁ of equation 3.70 will transform into mᵢⱼₖₗ·a₁ and nᵢⱼₖₗ·c₁ because a₁ and c₁ are scalar valued constants. An equivalent solution for the linear component of the strain field in the base reference frame may therefore be written in the form,
ε_{L(i)}=[mᵢⱼ]a₁σⱼ+[nᵢⱼ]c₁σⱼ 3.77
where the σⱼ represent the stress components in the base reference frame.

The linear component of the strain energy function may now be defined in terms of the mᵢⱼₖₗ, nᵢⱼₖₗ, a₁, c₁ and the component stresses, σⱼ. Because the strain field must be continuous and non-zero for any given applied stress field, the linear component of the complimentary strain energy function must exist. The following equivalence must therefore hold true,

$$\frac{{\partial }^{2} W {*}_{L}}{\partial {ε}_{i} \partial {ε}_{j}} = \frac{{\partial }^{2} W {*}_{L}}{\partial {ε}_{j} \partial {ε}_{i}} \qquad 3.78$$

and as before we find that the mᵢⱼ=mⱼᵢ, and nᵢⱼ=nⱼᵢ when j≠i. So, the coefficient matrices are symmetric for all non-linear viscoelastic materials, for all degrees of material symmetry and isotropy. As with the linear materials the solution for symmetry is independent of strain, stress, the constitutive function, and system energy.
3.8 The Non-Linear Constitutive Equations for Stress

The constitutive functions for stress may also be expressed in terms of two matrices of tensor valued coefficients and a single scalar valued constitutive function,
σ(εⱼ,t)ᵢ=[aᵢⱼ]f^{E}(εⱼ)+[bᵢⱼ]f^{D}(εⱼ,t) 3.79
where the matrices of coefficients are symmetric in the indices ij, and a₁₁=b₁₁=1, by choice of definition. The number of non-zero matrix coefficients for any degree of material symmetry and isotropy are the same as for the mᵢⱼ and nᵢⱼ coefficients. Again, when written in the above format, the individual strains in equation 3.79 are constrained to be induced separately and alone.

Now, we may define each component of strain in terms of a single vector, the strain state vector, εₛ, that defines the maximum magnitude of strain of a differential element of material. Following the above discussions we arrive at the function,
σ*(εₛ,t)ᵢ=[a*ᵢ₁]f^{E}(εₛ)+[b*ᵢ₁]f^{D}(εₛ, t) 3.80
where the matrix coefficient are transformation determined through equation 2.66. The method of solving this equation for the resulting stress field is the same as that used to solve for the strain field of equation 3.64. Once the σ*ᵢ have been determined in the reference frame of state, the σᵢ may be determined in the base reference frame from the transformation equations.
3.9 Hereditary Integral Functions

The creep compliance function f*^{D}(σ,t) and the relaxation modulus function f^{D}(ε,t) are always non-linear functions. They are non-linear functions in time, and may or may not be non-linear in stress or strain. Even when, for example, the function f*^{D}(σ,t)=f*(t)·σ, the definition of a linear response, f*^{D}(σ,t) is still a non-linear function of time, although delayed elastic strain, strain rate, and ultimate strain are proportional to a static σ (FIG. 3.3a).

A non-linear delayed elasticity stress-strain curve defined by the function f*^{D}(σ,t=∞) may always be approximated by a series of piecewise continuous linear functions, as in FIG. 2.1a. This implies that over the range in strain where each piecewise approximation is defined the functions f*^{D}(σ,t) may always be approximated in the linear form, i.e., f*^{D}(t)·σ. However, the various f*^{D}(t) over the various linear approximation ranges need not necessarily be identical. Now, generalized function f*^{D}(σ,t) defines the time dependent response for all possible materials, and includes as a subset of solutions the response of the linear materials. However, the linear approximations suggest that there is a possible subset of solutions where, for example, the delayed elastic strain, strain rate and the ultimate strain are proportional to some function of stress (FIG. 3.3b), i.e.,
f*^{D}(σ,t)=f*^{D}(t)·g(σ) 3.81
and similarly,
f^{D}(ε,t)=f^{D}(t)·h(ε) 3.82

These particular solution sets are suggested by the physics of deformation and the nature of the electromagnetic forces operating between atoms.

When the scalar functions g(σ) and h(ε) are approximated as linear functions over limited ranges in the stress-strain domain (FIG. 2.1a) the linear hereditary integral functions may then be invoked as solutions to time dependent loading, σⱼ(t), or time dependent deformation, εⱼ(t). This is convenient, for it avoids the complexity of calculating the stress and strain state functions, the orientation of the frame of state, the variation in the values of the matrix coefficients as the orientation of the frame of state varies with respect to the base reference frame, and the transformations of the resulting stress or strain vectors. However, the functions g(σ) and h(ε) are-scalar valued, and scale the time dependent functions f*^{D}(t) and f^{D}(t). So, we may defer from piecewise linear approximations and insert these functions directly into the linear hereditary integral functions to obtain explicit solutions. Because there is now only a single loading function in the frame of state the resulting hereditary integrals for strain will take the form of,

$$ε {*}_{i} ( {σ}_{s} ( t ) , t ) = m {*}_{ij} f {*}^{E} ( {σ}_{s} ( t ) ) + n {*}_{ij} {\int }_{0}^{t} g ( {σ}_{s} ( {t}^{′} ) ) \frac{ⅆ f {*}^{D} ( t - {t}^{′} )}{ⅆ ( t - {t}^{′} )} ⅆ {t}^{′} \qquad 3.83$$

Again, the index j may be set to 1, 2, or 3. In general, the matrix coefficients m*ᵢⱼ and n*ᵢⱼ also vary in time because the orientation of the frame of state, relative to the base reference frame, also varies. The one exception is, of course, the condition of complete isotropy where mᵢⱼ and nᵢⱼ are invariant for all orientations of reference frames. The solution for g(σ) is readily determined from FIG. 3.1b. Obviously, an equation may be developed for stress which take a similar form. Developing that equation from the above discussions is straight-forward and warrants no further discussion.

As mentioned, the deformation physics of some types of materials, such as the fibrous polymers, actually suggests equations 3.81 and 3.82 as a solutions for the time dependent components of the constitutive equation. Solid polymers, such as rubbers and plastics, are structurally defined by a chaotic lattice network of interlocking polymer fibers. As such these materials usually have relatively low densities because of the void space between fibers. Because of their structure polymers are often capable of very large strains (e.g., rubber bands). However, most natural crystalline materials, glasses, metals, etc., have a structural lattice framework defined by chemical bonds, and will only sustain strains on the order perhaps 1% before the bonds begin breaking. So, as a consequence of their structure we may anticipate that when the strains in the polymers exceed a few percent that changes in fiber geometries will produce non-linear changes in the internal distribution of stress, the components of which vary as trigonometric functions, and hence the constitutive functions. Obviously, in the case of large strains, the matrix coefficients need not be constant. Because large strains are probably more a function of fiber lattice deformation than bond stretching, the non-linear stress-strain relationships of the delayed elasticity functions are most likely best defined by functions of the form given by equations 3.81 and 3.82. The caveat being that strain magnitude be moderate enough that the stress-strain relationships between bonding and non-bonding forces still remain relatively linear, unless we can argue-that equations 3.81 and 3.82 hold true for bond stretching as well.

3.10 Temperature Effects

The non-linear constitutive equations describing temperature induced stresses and strains were discussed in section 1 and warrant no further discussion. Obviously, the constitutive properties of a material, will vary with changes in temperature. Following those discussions for the non-linear materials leads to a temperature dependant solution of equation 3.58 of the form,
ε(θ,σⱼ,t)=[mᵢⱼ]f*^{E}(θ,σⱼ)+[nᵢⱼ]f*^{D}(θ,σⱼ,t) 3.84

### Section 4

Orthogonality and Uncoupling

Implicit to the derivations in the previous three sections are the assumptions that: 1) a volume of material under consideration was sufficiently large such that we considered a basic structural unit of a bonding framework between atoms or molecules; 2) that bonding geometries between atoms caused deformation in one direction to automatically produce deformation in the other directions, i.e., there is no orthogonality to material structure or in the bonding arrangements, e.g., cubic, orthorhombic, etc., or in the types of bonds—ionic, covalent, etc; and 3) that deformation produced small strains, on the order of a few percent at most, and negligible changes in internal lattice structure geometries and bonding angles.

4.1 Uncoupling and Orthogonality

Orthogonality, Orthotropy and Normal Stresses and Strains

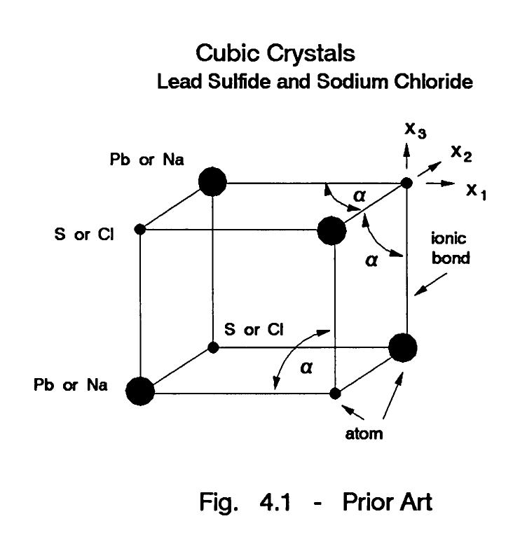

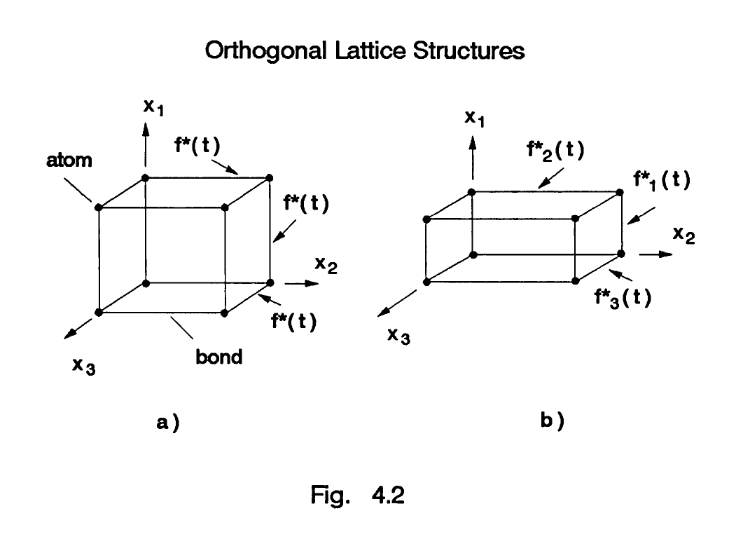

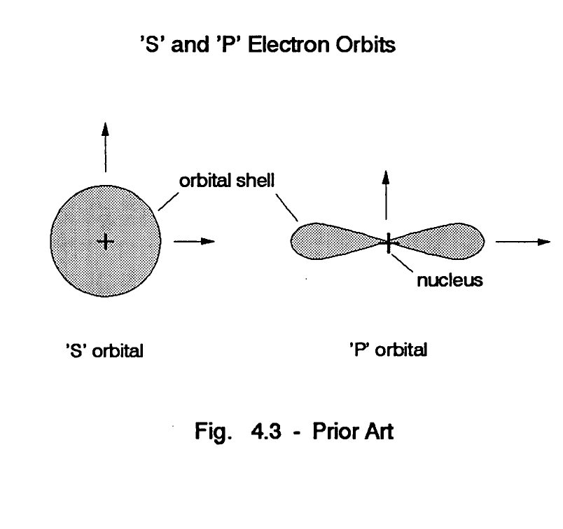

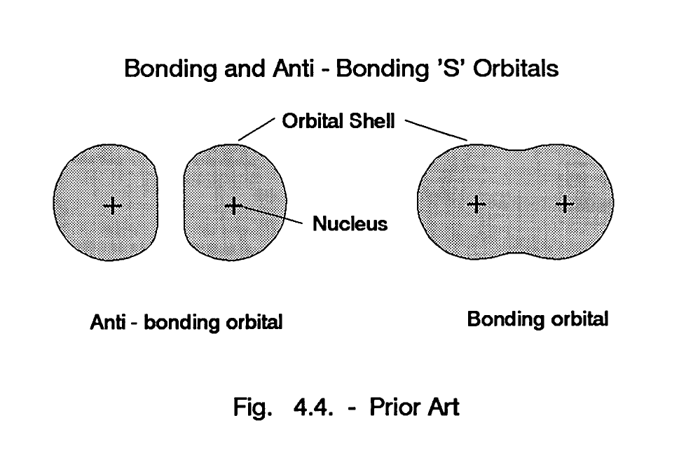

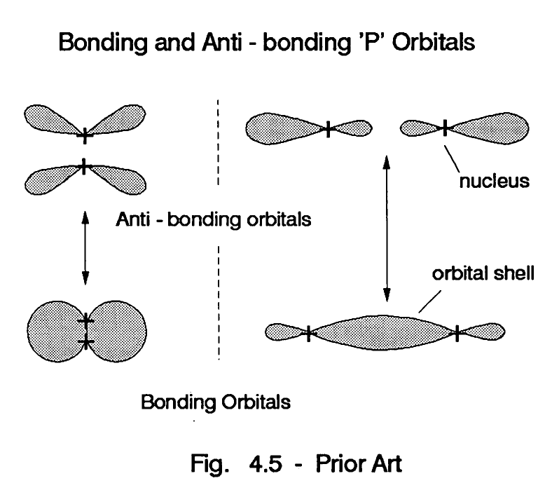

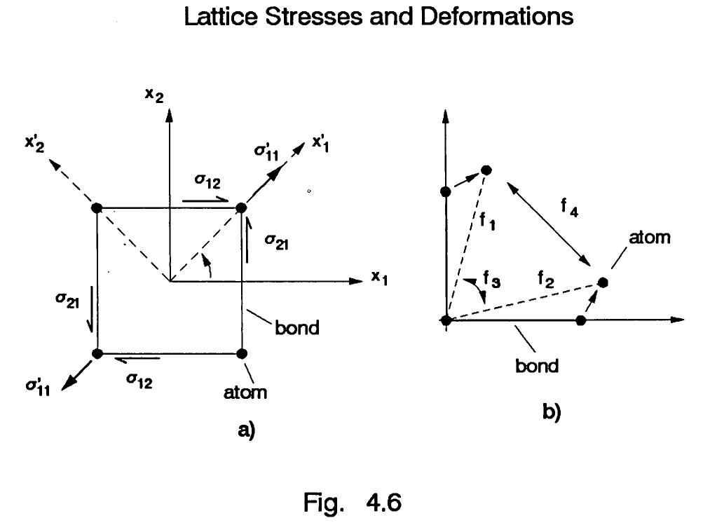

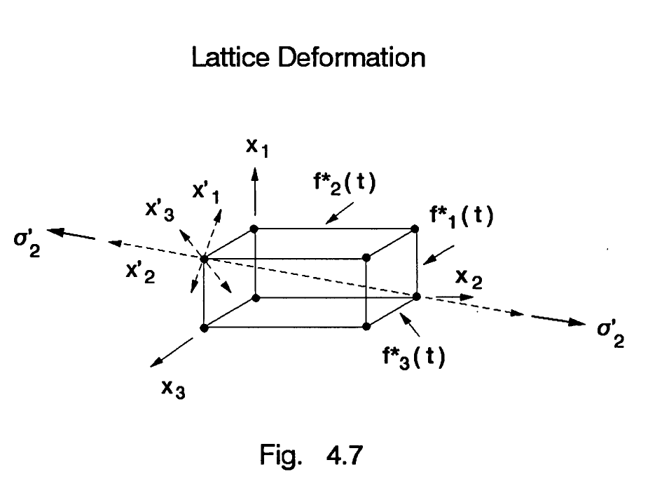

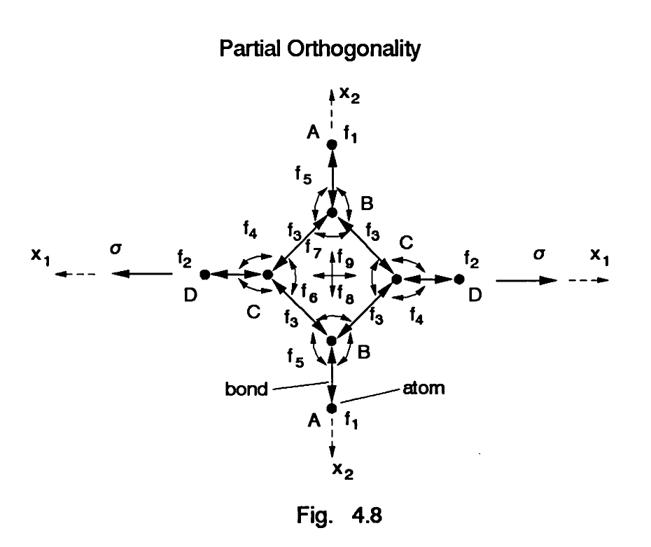

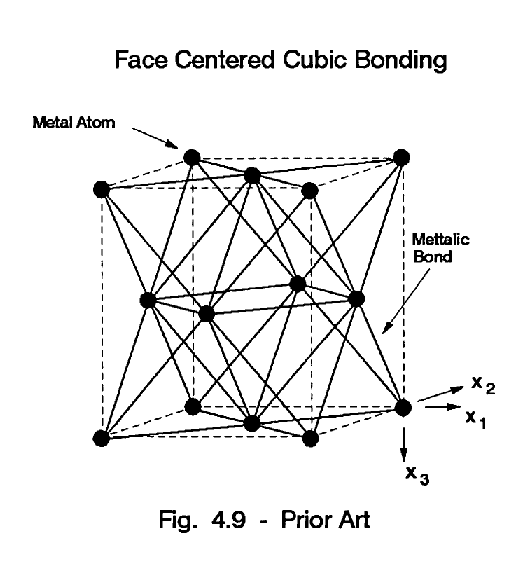

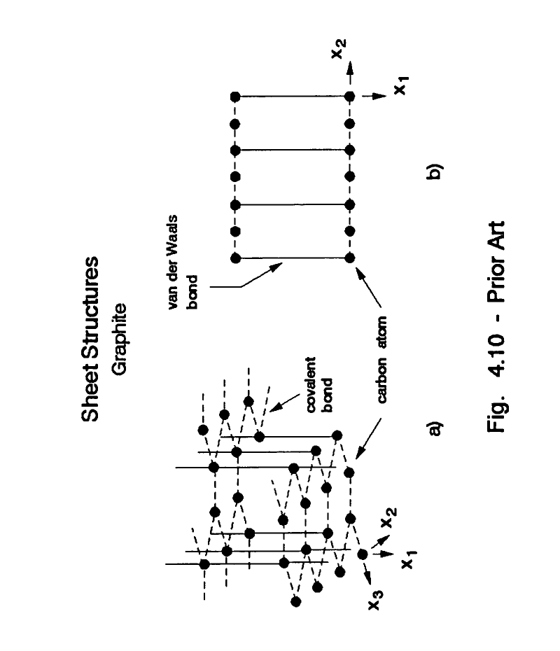

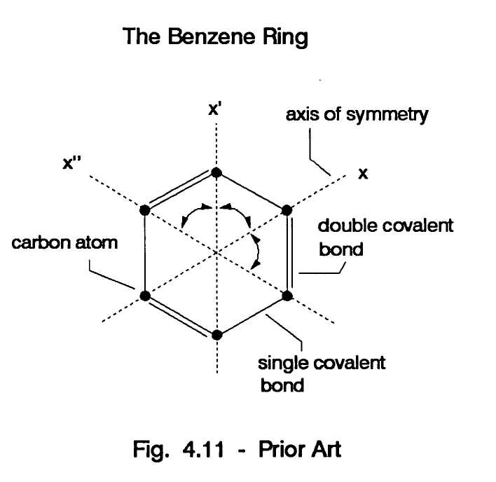

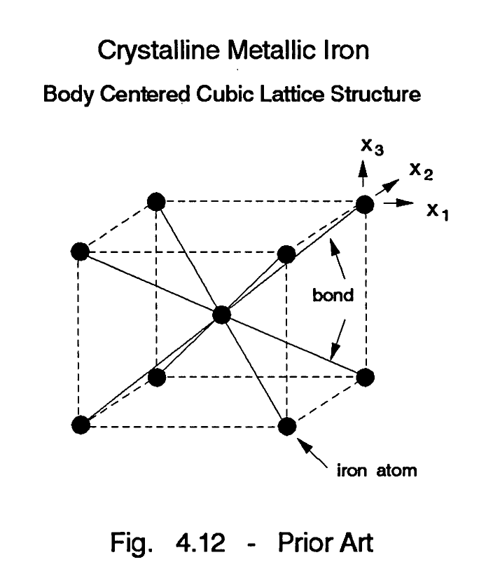

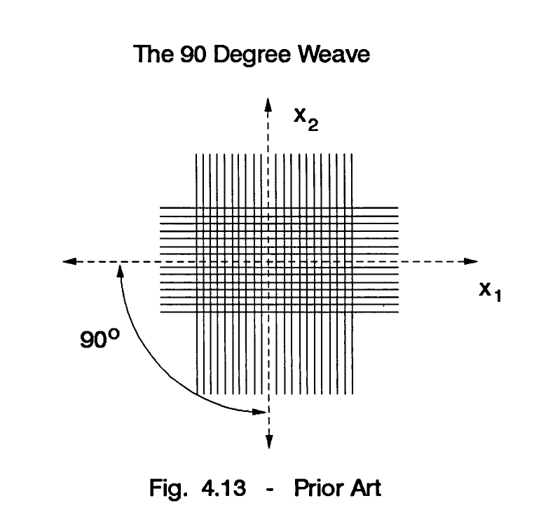

The most obvious condition through which directional uncoupling in constitutive properties may occur is through bonding orthogonality, where the bonds between atoms are arranged at 90 degrees, and the loading is in the direction of the bonds. A few materials, such as table salt, sodium chloride (NaCl), and lead sulfide (PbS) have orthogonal bonding (FIG. 4.1). This bonding arrangement produces orthotropy, the condition of three axes of material symmetry.

Consider two simple three dimensional crystal lattice structures, cubic and orthorhombic, where all bonding is orthogonal (FIG. 4.2). Initially restrict the loading to be normal and coincident with the bonding directions, where each load is applied separately. Let the axes of an orthogonal reference frame be aligned and coincident with the bonds. First consider the cubic lattice, with identical bonds (FIGS. 4.1 and 4.2a), and for the sake of argument let the constitutive responses ‘perfectly’ uncouple, eliminating the Poisson ratio terms, i.e., the lateral strains. Linear constitutive functions for the normal impulse strains would then be of the form,

$$\vert \begin{matrix}{ε}_{1}^{E} \\ {ε}_{2}^{E} \\ {ε}_{3}^{E} \\ {ε}_{4}^{E} \\ {ε}_{5}^{E} \\ {ε}_{6}^{E}\end{matrix} \vert = \vert \begin{matrix}1 & 0 & 0 \\ 0 & 1 & 0 \\ 0 & 0 & 1 \\ 0 & 0 & 0 \\ 0 & 0 & 0 \\ 0 & 0 & 0\end{matrix} \vert \vert \begin{matrix}f {*}^{E} \cdot {σ}_{1} \\ f {*}^{E} \cdot {σ}_{2} \\ f {*}^{E} \cdot {σ}_{3}\end{matrix} \vert \qquad 4.1$$

where the three f*^{E} impulse functions are all equivalent and the Poisson ratio terms equal zero. There are no associated shear strains, ε₄->ε₆, because of bonding orthogonality. Bonds need not be identical and the lattice structure may be orthorhombic (FIG. 4.2b), so constitutive functions in each direction need not be equivalent. The general form of equation 4.1 is then,

$$\vert \begin{matrix}{ε}_{1}^{E} \\ {ε}_{2}^{E} \\ {ε}_{3}^{E}\end{matrix} \vert = \vert \begin{matrix}1 & 0 & 0 \\ … & 1 & 0 \\ … & … & 1\end{matrix} \vert \vert \begin{matrix}f {*}_{1}^{E} \cdot {σ}_{1} \\ f {*}_{2}^{E} \cdot {σ}_{2} \\ f {*}_{3}^{E} \cdot {σ}_{3}\end{matrix} \vert \qquad 4.2$$

Similar solutions may be obtained for the delayed elasticity response and generalized linear viscoelastic functions for the normal strain responses become,

$${ε}_{i} ( t ) = \vert \begin{matrix}1 & 0 & 0 \\ … & 1 & 0 \\ … & … & 1\end{matrix} \vert \vert \begin{matrix}f {*}_{1}^{E} \cdot {σ}_{1} \\ f {*}_{2}^{E} \cdot {σ}_{2} \\ f {*}_{3}^{E} \cdot {σ}_{3}\end{matrix} \vert + \vert \begin{matrix}1 & 0 & 0 \\ … & 1 & 0 \\ … & … & 1\end{matrix} \vert \vert \begin{matrix}f {*}_{1}^{D} ( t ) \cdot {σ}_{1} \\ f {*}_{2}^{D} ( t ) \cdot {σ}_{2} \\ f {*}_{3}^{D} ( t ) \cdot {σ}_{3}\end{matrix} \vert \qquad 4.3$$

A solution for the stress functions would be of the form,

$${σ}_{i} ( t ) = \vert \begin{matrix}1 & 0 & 0 \\ … & 1 & 0 \\ … & … & 1\end{matrix} \vert \vert \begin{matrix}{f}_{1}^{E} \cdot {ε}_{1} \\ {f}_{2}^{E} \cdot {ε}_{2} \\ {f}_{3}^{E} \cdot {ε}_{3}\end{matrix} \vert + \vert \begin{matrix}1 & 0 & 0 \\ … & 1 & 0 \\ … & … & 1\end{matrix} \vert \vert \begin{matrix}{f}_{1}^{D} ( t ) \cdot {ε}_{1} \\ {f}_{2}^{D} ( t ) \cdot {ε}_{2} \\ {f}_{3}^{D} ( t ) \cdot {ε}_{3}\end{matrix} \vert \qquad 4.4$$

Equivalence may also occur between any or all of the impulse or delayed elasticity functions in equations 4.3 and 4.4.

‘Perfect’ uncoupling probably never occurs, and for several reasons, the most obvious being that atoms in a crystal are not stationary, they always vibrate. However, a more compelling reason that ‘perfect’ uncoupling probably never occurs is that deformation of a bond entails the deformation of shared electron orbitals (FIG. 4.3) and the associated electric and magnetic fields. The electromagnetic fields associated with the non-bonding/anti-bonding orbitals also provide reactive forces between the bonded atoms, and will also be effected by spacing changes between atoms (FIGS. 4.4 and 4.5). It is therefore unreasonable to expect or demand that distortion of the electron orbitals and their related electromagnetic fields be simply unidirectional. Likewise for those fields associated with the nuclei. Field distortion in the direction of the bonding will almost certainly result in lateral field distortions and produce lateral strains. So, in general, a Poisson effect of some form must be admitted and equation 4.3 becomes,

$${ε}_{i} ( t ) = \vert \begin{matrix}1 & {m}_{12} & {m}_{13} \\ {m}_{21} & 1 & {m}_{23} \\ {m}_{31} & {m}_{32} & 1\end{matrix} \vert \vert \begin{matrix}f {*}_{1}^{E} \cdot {σ}_{1} \\ f {*}_{2}^{E} \cdot {σ}_{2} \\ f {*}_{3}^{E} \cdot {σ}_{3}\end{matrix} \vert + \vert \begin{matrix}1 & {n}_{12} & {n}_{13} \\ {n}_{21} & 1 & {n}_{23} \\ {n}_{31} & {n}_{32} & 1\end{matrix} \vert \vert \begin{matrix}f {*}_{1}^{D} ( t ) \cdot {σ}_{1} \\ f {*}_{2}^{D} ( t ) \cdot {σ}_{2} \\ f {*}_{3}^{D} ( t ) \cdot {σ}_{3}\end{matrix} \vert \qquad 4.5$$

Orthogonality, Orthotropy and Shear Stresses and Strains

From previous discussion we know that the solution for the completely coupled linear impulse strain response for the condition of orthotropy is,

$${ε}_{i}^{E} = \vert \begin{matrix}1 & {m}_{12} & {m}_{13} & 0 & 0 & 0 \\ {m}_{12} & {m}_{22} & {m}_{23} & 0 & 0 & 0 \\ {m}_{13} & {m}_{23} & {m}_{33} & 0 & 0 & 0 \\ 0 & 0 & 0 & {m}_{44} & 0 & 0 \\ 0 & 0 & 0 & 0 & {m}_{55} & 0 \\ 0 & 0 & 0 & 0 & 0 & {m}_{66}\end{matrix} \vert f {*}^{E} \cdot {σ}_{j} \qquad 4.6$$

where a shear stress only produces a shear strain, and a normal stress only produces normal strains. This directional uncoupling in strains does not mean that the constitutive responses controlling shear deformation are uncoupled from those controlling the normal strains, it just means that they may be of different magnitude.

Consider the cubic crystal lattice. Applying a shear stress to two opposite sides of one side of the cube (FIG. 4.6a), the lattice racks, producing only shear distortions and no normal strains (obviously, only for very small shear strains). Recall that for every σᵢⱼ there is a corresponding equivalent σⱼᵢ. The constitutive function that describes shear distortion is, in general, not the same as that which defines normal deformation in the direction of the bonds (FIG. 4.6b). When the lattice is deformed by an applied shear force, or equivalently by a normal force oriented 45 degrees to the bonding direction, more than a single reactive force acts to constrain deformation of the lattice. Both bonds, defined by the constitutive functions f₁ and f₂, stretch simultaneously and define a coupled reaction. As bond angles change there is an additional reactive force, call it f₃, established by the interaction of the electromagnetic fields of not only the bonding orbitals, but also of the non-bonding/anti-bonding orbitals. Finally, there is a reactive force, f₄, between the positively charged nuclei of the diagonal atoms that also acts to constrain lattice deformation. All these reactive forces act simultaneously. Simple stretching of the bonds in a normal direction does not bring into play all of these same force functions.

Because there may be 3 different bonds there are 3 possible combinations of force functions, one for each of the 3 orthogonal planes defined by the crystal lattice faces (parallel faces are equivalent). So, there are 3 possible shearing functions, each acting within one of the three orthogonal planes defined by the crystal lattice (FIG. 4.2). The generalized impulse response then becomes,

$${ε}_{i}^{E} = \vert \begin{matrix}1 & {m}_{12} & {m}_{13} & 0 & 0 & 0 \\ {m}_{21} & 1 & {m}_{23} & 0 & 0 & 0 \\ {m}_{31} & {m}_{32} & 1 & 0 & 0 & 0 \\ 0 & 0 & 0 & 1 & 0 & 0 \\ 0 & 0 & 0 & 0 & 1 & 0 \\ 0 & 0 & 0 & 0 & 0 & 1\end{matrix} \vert \vert \begin{matrix}f {*}_{1}^{E} \cdot {σ}_{1} \\ f {*}_{2}^{E} \cdot {σ}_{1} \\ f {*}_{3}^{E} \cdot {σ}_{1} \\ f {*}_{4}^{E} \cdot {σ}_{1} \\ f {*}_{5}^{E} \cdot {σ}_{1} \\ f {*}_{6}^{E} \cdot {σ}_{1}\end{matrix} \vert \qquad 4.7$$

while the delayed elasticity strain response is defined by,

$${{ε}_{i} ( t )}^{D} = \vert \begin{matrix}1 & {n}_{12} & {n}_{13} & 0 & 0 & 0 \\ {n}_{21} & 1 & {n}_{23} & 0 & 0 & 0 \\ {n}_{31} & {n}_{32} & 1 & 0 & 0 & 0 \\ 0 & 0 & 0 & 1 & 0 & 0 \\ 0 & 0 & 0 & 0 & 1 & 0 \\ 0 & 0 & 0 & 0 & 0 & 1\end{matrix} \vert \vert \begin{matrix}f {*}_{1}^{D} ( t ) \cdot {σ}_{1} \\ f {*}_{2}^{D} ( t ) \cdot {σ}_{2} \\ f {*}_{3}^{D} ( t ) \cdot {σ}_{3} \\ f {*}_{4}^{D} ( t ) \cdot {σ}_{4} \\ f {*}_{5}^{D} ( t ) \cdot {σ}_{5} \\ f {*}_{6}^{D} ( t ) \cdot {σ}_{6}\end{matrix} \vert \qquad 4.8$$

The three normal functions may be equivalent, and the three shear functions may be equivalent. However, the shear and normal functions are most probably never equivalent, and for the reasons just discussed.

FIG. 4.7 illustrates an orthorhombic crystal lattice oriented so that one axis, the x′₂ axis of the x′ᵢ reference frame, runs diagonally through two corners of the structure. Applying a load coincident with that axis causes the entire lattice to deform, stretching all bonds and changing all angles between the bonds. All forces acting between the atoms come into play simultaneously and produce a coupled response. The constitutive response in this particular reference frame is therefore defined by a single scalar valued impulse function and delayed elasticity function.

The static load, σ′₂, may also be defined as the resultant of as many as six separate loads, the σᵢ, operating in the reference system defined by the direction of bonding, the xᵢ reference frame, where these loads now operate simultaneously in the direction of the orthogonal bonding and/or in the orthogonal planes defined by the lattice. It is evident that unless loading is normal to, and coincident with, the direction of bonding, or shear loading is directionally constrained to be within one of the planes defined by any two orthogonal set of bonds, the constitutive response will be defined by a single scalar valued function. Partial uncoupling only occurs when loading is Ad constrained to be coincident with the direction of bonding, or a within a plane defined by two orthogonal sets of bonds. Hence, orthogonal bonds and lattice planes define directional singularities in the constitutive response.

4.2 Orthotropy and Symmetry in the Matrix Coefficients

The Linear Impulse Response

Recall that the test for symmetry in the matrix coefficients involves the use of a strain energy function, U, and the equivalences,

$$\frac{\partial U}{\partial {σ}_{i} \partial {σ}_{j}} = \frac{\partial U}{\partial {σ}_{j} \partial {σ}_{i}} \\ \frac{\partial U}{\partial {σ}_{j} \partial {ε}_{j}} = \frac{\partial U}{\partial {ε}_{j} \partial {ε}_{i}} \qquad 4.9$$

Applying this test to the impulse response of equation 4.7, for the stresses σ₁ and σ₂, produces the equivalence,
m₁₂f*₂^{E}=m₂₁f*₁^{E} 4.10
Given that f*₁^{E}≠f*₂^{E}, then m₁₂≠m₂₁, and so on. So, the matrix coefficients of equation 4.7 are not symmetric, at least in the format in which the equation is written.

However , one constant may always be written in terms of another constant equation 4.7 may be rewritten as,

$${ε}_{i}^{E} = \vert \begin{matrix}1 & {m}_{12} & {m}_{13} & 0 & 0 & 0 \\ {m}_{21} & 1 & {m}_{23} & 0 & 0 & 0 \\ {m}_{31} & {m}_{32} & 1 & 0 & 0 & 0 \\ 0 & 0 & 0 & 1 & 0 & 0 \\ 0 & 0 & 0 & 0 & 1 & 0 \\ 0 & 0 & 0 & 0 & 0 & 1\end{matrix} \vert \vert \begin{matrix}1 \cdot f {*}_{1}^{E} \cdot {σ}_{1} \\ {d}_{2} \cdot f {*}_{1}^{E} \cdot {σ}_{2} \\ {d}_{3} \cdot f {*}_{1}^{E} \cdot {σ}_{3} \\ {d}_{4} \cdot f {*}_{1}^{E} \cdot {σ}_{4} \\ {d}_{5} \cdot f {*}_{1}^{E} \cdot {σ}_{5} \\ {d}_{6} \cdot f {*}_{1}^{E} \cdot {σ}_{6}\end{matrix} \vert \qquad 4.11$$

where the f*ⱼ^{E}=dⱼ·f*₁^{E}. Multiplying through by the dⱼ's yields,

$${ε}_{i}^{E} = \vert \begin{matrix}1 & {m}_{12}^{′} & {m}_{13}^{′} & 0 & 0 & 0 \\ {m}_{21}^{′} & {d}_{2} & {m}_{23}^{′} & 0 & 0 & 0 \\ {m}_{31}^{′} & {m}_{32}^{′} & {d}_{3} & 0 & 0 & 0 \\ 0 & 0 & 0 & {d}_{4} & 0 & 0 \\ 0 & 0 & 0 & 0 & {d}_{5} & 0 \\ 0 & 0 & 0 & 0 & 0 & {d}_{6}\end{matrix} \vert \vert \begin{matrix}f {*}_{1}^{E} \cdot {σ}_{1} \\ f {*}_{1}^{E} \cdot {σ}_{2} \\ f {*}_{1}^{E} \cdot {σ}_{3} \\ f {*}_{1}^{E} \cdot {σ}_{4} \\ f {*}_{1}^{E} \cdot {σ}_{5} \\ f {*}_{1}^{E} \cdot {σ}_{6}\end{matrix} \vert \qquad 4.12$$

where m′ᵢⱼ=dⱼ·mᵢⱼ, and d₁=1, by choice of definition. Equation 4.12 now has the appearance of a completely coupled set of linear elastic functions.

Substituting the equivalences of equation 4.12 into equation 4.10 (where the appropriate number of σᵢ are applied) produces,
m′₁₂f*₁^{E}=m′₂₁f*₁^{E} 4.13
where m′₁₂=m′₂₁. Likewise for the other m′ᵢⱼ. So, regardless of whether the constitutive functions are completely coupled, or partially uncoupled, the linear impulse response may always be written in terms of a symmetric coefficient matrix and a single scalar valued constitutive function.
The Delayed Linear Elastic Response

The six creep compliance functions of equation 4.8 are non-linear linear functions of time. However, when evaluated at t->∞ the six f*ⱼ^{D}(t->∞) are simple constants. Letting the f*ⱼ^{D}(t->∞)=zⱼ the zⱼ's may be expressed as zⱼ=cⱼ·z₁, where c₁=1. Equation 4.8 now becomes,

$${ε}_{i}^{D} ( t -> ∞ ) = \vert \begin{matrix}1 & {n}_{12} & {n}_{13} & 0 & 0 & 0 \\ {n}_{21} & 1 & {n}_{23} & 0 & 0 & 0 \\ {n}_{31} & {n}_{32} & 1 & 0 & 0 & 0 \\ 0 & 0 & 0 & 1 & 0 & 0 \\ 0 & 0 & 0 & 0 & 1 & 0 \\ 0 & 0 & 0 & 0 & 0 & 1\end{matrix} \vert \vert \begin{matrix}1 \cdot {z}_{1} \cdot {σ}_{1} \\ {c}_{2} \cdot {z}_{1} \cdot {σ}_{2} \\ {c}_{3} \cdot {z}_{1} \cdot {σ}_{3} \\ {c}_{4} \cdot {z}_{1} \cdot {σ}_{4} \\ {c}_{5} \cdot {z}_{1} \cdot {σ}_{5} \\ {c}_{6} \cdot {z}_{1} \cdot {σ}_{6}\end{matrix} \vert \qquad 4.14$$

which is of the same form as equation 4.11. Multiplying through by the cⱼ's produces a set of matrix coefficients, the n′ᵢⱼ's, and a solution of the same form-as equation 4.12. Invoking the same test as applied to equation 4.12 will show that the n′ᵢⱼ coefficient matrix is likewise symmetric.

It is now a simple matter to rewrite equation 4.8 for all time t. Factor out the value of unity from each f*ⱼ^{D}(t) function of equation 4.8, where unity for each function is defined as cⱼ/cⱼ and each time independent cⱼ is as determined from equation 4.14. Multiplying each column of the matrix by the appropriate cⱼ produces matrix symmetry and equation 4.8 becomes,

$${{ε}_{i} ( t )}^{D} = \vert \begin{matrix}1 & {n}_{12}^{′} & {n}_{13}^{′} & 0 & 0 & 0 \\ {n}_{21}^{′} & {c}_{2} & {n}_{23}^{′} & 0 & 0 & 0 \\ {n}_{31}^{′} & {n}_{32}^{′} & {c}_{3} & 0 & 0 & 0 \\ 0 & 0 & 0 & {c}_{4} & 0 & 0 \\ 0 & 0 & 0 & 0 & {c}_{5} & 0 \\ 0 & 0 & 0 & 0 & 0 & {c}_{6}\end{matrix} \vert \vert \begin{matrix}{f}^{′} {*}_{1}^{D} ( t ) \cdot {σ}_{1} \\ {f}^{′} {*}_{2}^{D} ( t ) \cdot {σ}_{2} \\ {f}^{′} {*}_{3}^{D} ( t ) \cdot {σ}_{3} \\ {f}^{′} {*}_{4}^{D} ( t ) \cdot {σ}_{4} \\ {f}^{′} {*}_{5}^{D} ( t ) \cdot {σ}_{5} \\ {f}^{′} {*}_{6}^{D} ( t ) \cdot {σ}_{6}\end{matrix} \vert \qquad 4.15$$

where f′*ⱼ(t)=f*ⱼ(t)/cⱼ. At t->∞ the f′*ⱼt->∞)->z₁.
Partial Orthogonality and Uncoupling

There are three different sets of bonds in the lattice system of FIG. 4.8. Each may be a different type and/or between he atoms of different elements. Only the bond sets between the atoms labeled A and B, and C and D are directionally orthogonal. Because of potential differences in bonding, it is necessary to allow the three sets of bonds to be defined by different viscoelastic functions, call them f₁, f₂ and f₃. In addition to these forces there are those reactive forces that arise between the electromagnetic fields of the bonding and anti-bonding/non-bonding orbitals, f₄ and f₅. Finally, there are the reactive forces between the nuclei of the atoms B and C, the force f₆. Considered separately each of these functions has a potentially different time dependent response (see section 5).

Now apply a constant static stress σ₁ in the x₁ direction. This load propagates through bond sets 1 and 2 into bond set 3, producing the time independent impulse response. Is it reasonable however, to presume that time dependent deformation of some combination of bonds, say the B-C and C-D bonds, may possibly halt prior to the point in time when deformation of the A-B bond halts?

When the bonds between the D and C atoms are stretched there is a corresponding change in the orientation and intensity of the electric and magnetic fields operating between the atoms, defined by both the bonding and anti-bonding orbitals and the nuclei. This reaction produces the coupled constitutive responses f₂ and f₄. These changes in field orientation and distribution produce a displacement in atom C, which produce a simultaneous change in the fields between atoms C and B, establishing the reaction f₃. This leads to a displacement in atom B, which establishes the reactions f₅, f₆. Any change in the spacing between atoms B and C causes a corresponding reaction between atoms C and D and the constitutive reactions f₂ and f₄. Simultaneously, the change in the spacing between atoms B and C leads to a displacement in atom B, which establishes the reaction f₁, and displacement of atom A, and so on. So, it makes no difference whether the applied force σ₁ produces time independent or time dependent displacements, the reactions are coupled in both space and in time, and the Poisson ratio terms are time independent coefficients.

Other Examples of Orthotropy

Three dimensional bonding orthogonality implies material orthotropy, but orthotropy does not imply orthogonality. One example of material orthotropy without bonding orthogonality is the face-centered cubic bonding system, common to many metals (FIG. 4.9). This type of bonding arrangement produces a lattice with three axes of identical symmetry. In the pure metals, composed of a single element, the bonds are all equal and oriented at 60 degrees. From this example we may conclude that the constitutive properties of materials characterized by non-orthogonal bonding arrangements will be defined in terms of a single scalar valued constitutive function, whether loading is coincident with the axis of material symmetry or not.

4.3 Uncoupling and other Material Symmetry Conditions

Orthotropy is just one of three material symmetry conditions where the shear stresses produce only shear strains, and normal stresses produce only normal strains. The other two symmetry conditions that display such uncoupling are: one plane of isotropy and one axis of symmetry; and complete isotropy. The constitutive properties of isotropic materials have already been discussed in detail and partial directional uncoupling is not possible for this symmetry condition.

It is not necessary that two or three sets of bonds be orthogonal for partial uncoupling in the constitutive response to occur. One set of bonds orthogonal to a sheet of atoms that have no orthogonality may also produce uncoupling and material orthotropy. Furthermore, it is possible that a given material may be compositionally and/or structurally laminated in one or more directions, where each layer has a distinct and separate chemical composition and/or structure. Each such layer may be thick enough and structurally complex enough to have its own distinct constitutive behavior.

One Plane of Isotropy and One Axis of Symmetry

Like orthotropy, this symmetry condition does not necessarily imply orthogonality. However, orthogonality is possible. There are few naturally occurring minerals that have laminated structures, one of which is graphite (FIG. 4.10). There are even fewer lattice structures that can produce crystalline isotropy. One such structural arrangement is the hexagonal benzene ring, a sequence of carbon atoms that share resonating hybrid double-single covalent carbon-carbon bonds (FIG. 4.11). Within the plane of the benzene ring there are three axes of associated symmetry, oriented 60 degrees to each other. This type of symmetry produces material isotropy in the plane of bonding. The carbon atoms in graphite are arranged in sheets of interconnected benzene rings bonded together by weak van der Waals bonds oriented 90 degrees to the sheets of carbon atoms. Given the orthogonality of the Van der Waals bonds to the carbon sheets it is clear that there will be directional differences in material constitutive properties between the axial direction coincident with the van der Waals bonds and those in the plane of the carbons sheets.

Let's now define a reference frame for graphite such that the x₁ and x₂ axes are oriented within a plane defined by the carbon sheets, and the x₃ axis is coincident with the van der Waals bonds. The constitutive equation that defines the singularities in the delayed elasticity response for this frame of reference are then,

$${{ε}_{i} ( t )}^{D} = \vert \begin{matrix}1 & {n}_{12}^{′} & {n}_{13}^{′} & 0 & 0 & 0 \\ {n}_{21}^{′} & 1 & {n}_{23}^{′} & 0 & 0 & 0 \\ {n}_{31}^{′} & {n}_{32}^{′} & {c}_{3} & 0 & 0 & 0 \\ 0 & 0 & 0 & {c}_{4} & 0 & 0 \\ 0 & 0 & 0 & 0 & {c}_{5} & 0 \\ 0 & 0 & 0 & 0 & 0 & {c}_{6}\end{matrix} \vert \vert \begin{matrix}{f}^{′} {*}_{1}^{D} ( t ) \cdot {σ}_{1} \\ {f}^{′} {*}_{1}^{D} ( t ) \cdot {σ}_{2} \\ {f}^{′} {*}_{2}^{D} ( t ) \cdot {σ}_{3} \\ {f}^{′} {*}_{3}^{D} ( t ) \cdot {σ}_{4} \\ {f}^{′} {*}_{3}^{D} ( t ) \cdot {σ}_{5} \\ {f}^{′} {*}_{1}^{D} ( t ) \cdot {σ}_{6}\end{matrix} \vert \qquad 4.16$$

Because of isotropy within the x₁-x₂ plane, there are only three different delayed elasticity and impulse functions. The function f′*₁^{D}(t) defines the isotropic properties within the plane of a carbon sheets, f′*₂^{D}(t) defines the constitutive response normal to the carbon sheets, and f′*₃^{D}(t) defines the shear response function in the two planes normal to the plane of the carbon sheets. Using the same scheme as applied to the orthotropic material we may show that the matrix coefficients are symmetric.
Complete Anisotropy

Aside from the condition of complete isotropy, those symmetry conditions that do not produce uncoupling of the normal and shear responses are complete anisotropy, and the condition of one axis of symmetry. No matter how a reference frame is oriented with respect to a body of an anisotropic material there are no axes or planes of symmetry. This complete lack of symmetry produces the impulse response function,

$${ε}_{i}^{E} = \vert \begin{matrix}1 & {m}_{12} & {m}_{13} & {m}_{14} & {m}_{15} & {m}_{16} \\ … & {m}_{22} & {m}_{23} & {m}_{24} & {m}_{25} & {m}_{26} \\ … & … & {m}_{33} & {m}_{34} & {m}_{35} & {m}_{36} \\ … & … & … & {m}_{44} & {m}_{45} & {m}_{46} \\ … & … & … & … & {m}_{55} & {m}_{56} \\ … & … & … & … & … & {m}_{66}\end{matrix} \vert f {*}^{E} \cdot {σ}_{j} \qquad 4.17$$

The matrix coefficients are all non-zero in value, so any applied normal stress produces not only three normal strains, but also three shear strain in the three axial planes. Likewise any applied shear stress produces three normal strains and shear strains in all three axial planes. Any applied stress causes not only normal deformations, but also racking of the lattice structure in all three directions. Hence, partial directional uncoupling in constitutive properties is not possible.
One Axis of Material Symmetry

When a material has one axis of material symmetry the impulse stain response will be given by the function,

$${ε}_{i}^{E} = \vert \begin{matrix}1 & {m}_{12} & {m}_{13} & 0 & 0 & {m}_{16} \\ {m}_{21} & {m}_{22} & {m}_{23} & 0 & 0 & {m}_{26} \\ {m}_{31} & {m}_{32} & {m}_{33} & 0 & 0 & {m}_{36} \\ 0 & 0 & 0 & {m}_{44} & {m}_{45} & 0 \\ 0 & 0 & 0 & {m}_{54} & {m}_{55} & 0 \\ {m}_{61} & {m}_{62} & {m}_{63} & 0 & 0 & {m}_{66}\end{matrix} \vert f {*}^{E} \cdot {σ}_{j} \qquad 4.18$$

Any normal stress produces not only normal strains, but also a shear strain in the 1-2 plane, i.e., the strain ε₆. When a shear stress is applied the shear strains do not completely uncouple. However, the deviatoric racking of the lattice structure is directionally dependent upon the applied load, and not all shear stresses produce normal strains, e.g., σ₄ and σ₅. So, partial directional uncoupling in the constitutive functions is possible for this symmetry condition.
Hydrostatic Loading and Singularities Due to Structural Symmetries

Consider once again the cubic crystalline structure of common table salt (FIG. 4.1). For a crystal of this material there will be no racking of the lattice structure under hydrostatic loading. All net resultant forces act in the direction of the bonds. Hence, hydrostatic loading also produces a singularity in the constitutive response. However, because the structure of the crystal is cubic and all bonds are identical and normal to one another there is no difference in the constitutive response as compared to equations 4.5, 4.7 and 4.8.

Now consider the body centered cubic crystalline structure of a material like pure metallic iron (FIG. 4.12). Clearly, there is no orthogonality to bonding for this type of crystalline structure. However, all bonds are identical and the bonding about the central atom is geometrically symmetric. So, hydrostatic loading cannot cause racking of the crystalline lattice structure and the resulting deformation is the same as if loading had been applied only in the direction of the bonds. Hence, for hydrostatic loading this type of crystalline structure also produce a singularity in the constitutive response of the material.

4.4 Materials and Matrix Symmetry

Matrix Symmetry and the Non-Linear Impulse Response

Again assume orthogonality in bonding, resulting in material orthotropy. Let the constitutive response to loading be non-linear for even very small strains. The most general solution for the resulting impulse response functions is then,

$${ε}_{i}^{E} ( {σ}_{j} ) = \vert \begin{matrix}1 & {m}_{12} & {m}_{13} & 0 & 0 & 0 \\ {m}_{21} & 1 & {m}_{23} & 0 & 0 & 0 \\ {m}_{31} & {m}_{32} & 1 & 0 & 0 & 0 \\ 0 & 0 & 0 & 1 & 0 & 0 \\ 0 & 0 & 0 & 0 & 1 & 0 \\ 0 & 0 & 0 & 0 & 0 & 1\end{matrix} \vert \vert \begin{matrix}f {*}_{1}^{E} ( {σ}_{1} ) \\ f {*}_{2}^{E} ( {σ}_{2} ) \\ f {*}_{3}^{E} ( {σ}_{3} ) \\ f {*}_{4}^{E} ( {σ}_{4} ) \\ f {*}_{5}^{E} ( {σ}_{5} ) \\ f {*}_{6}^{E} ( {σ}_{6} )\end{matrix} \vert \qquad 4.19$$

where the individual stresses are applied separately and alone. Each non-linear constitutive function may be expressed in terms of a power series expansion, and each expansion may be expressed as the sum of a linear and nonlinear function, e.g.,
f*₁^{E}(σ₁)=a₁σ₁+b₁σ₁²+ . . . =a₁σ₁+f*₁^{E}(σ₁)_{NL} 4.20
and so on. Rewriting equation 4.19 in terms of the non-linear and linear response produces,
εᵢ^{E}(σⱼ)=[mᵢⱼ]aⱼσⱼ+[mᵢⱼ]f*ⱼ^{E}(σⱼ)_{NL}=εᵢ^{E}(σⱼ)_{L}+εᵢ ^{E}(σⱼ)_{NL} 4.21

The linear term of equation 4.21 is identical in form to equation 4.7. So, rewriting the aⱼ in terms of a₁ and a series of scaling constants, cⱼ, produces,

$${{ε}_{i}^{E} ( {σ}_{j} )}_{L} = \vert \begin{matrix}1 & {m}_{12} & {m}_{13} & 0 & 0 & 0 \\ {m}_{21} & 1 & {m}_{23} & 0 & 0 & 0 \\ {m}_{31} & {m}_{32} & 1 & 0 & 0 & 0 \\ 0 & 0 & 0 & 1 & 0 & 0 \\ 0 & 0 & 0 & 0 & 1 & 0 \\ 0 & 0 & 0 & 0 & 0 & 1\end{matrix} \vert \vert \begin{matrix}1 \cdot {a}_{1} {σ}_{1} \\ {c}_{2} \cdot {a}_{1} {σ}_{2} \\ {c}_{3} \cdot {a}_{1} {σ}_{3} \\ {c}_{4} \cdot {a}_{1} {σ}_{4} \\ {c}_{5} \cdot {a}_{1} {σ}_{5} \\ {c}_{6} \cdot {a}_{1} {σ}_{6}\end{matrix} \vert \qquad 4.22$$

where aⱼ=cⱼ·a₁. Multiplying through by the cⱼ's yields,

$${{ε}_{i}^{E} ( {σ}_{j} )}_{L} = \vert \begin{matrix}1 & {m}_{12}^{′} & {m}_{13}^{′} & 0 & 0 & 0 \\ {m}_{21}^{′} & {c}_{2} & {m}_{23}^{′} & 0 & 0 & 0 \\ {m}_{31}^{′} & {m}_{32}^{′} & {c}_{3} & 0 & 0 & 0 \\ 0 & 0 & 0 & {c}_{4} & 0 & 0 \\ 0 & 0 & 0 & 0 & {c}_{5} & 0 \\ 0 & 0 & 0 & 0 & 0 & {c}_{6}\end{matrix} \vert {a}_{1} {σ}_{j} \qquad 4.23$$

where in this format the m′ᵢⱼ coefficients are symmetric. Now, factor out unity from each of the six non-linear f*ⱼ^{E}(σⱼ) functions, where unity for each function is defined as cⱼ/cⱼ, as determined from equation 4.22. Equation 4.19 then becomes,

$${ε}_{i}^{E} ( {σ}_{j} ) = \vert \begin{matrix}1 & {m}_{12} & {m}_{13} & 0 & 0 & 0 \\ {m}_{21} & 1 & {m}_{23} & 0 & 0 & 0 \\ {m}_{31} & {m}_{32} & 1 & 0 & 0 & 0 \\ 0 & 0 & 0 & 1 & 0 & 0 \\ 0 & 0 & 0 & 0 & 1 & 0 \\ 0 & 0 & 0 & 0 & 0 & 1\end{matrix} \vert \vert \begin{matrix}{c}_{1} / {c}_{1} \cdot f {*}_{1}^{E} ( {σ}_{1} ) \\ {c}_{2} / {c}_{2} \cdot f {*}_{2}^{E} ( {σ}_{2} ) \\ {c}_{3} / {c}_{3} \cdot f {*}_{3}^{E} ( {σ}_{3} ) \\ {c}_{4} / {c}_{4} \cdot f {*}_{4}^{E} ( {σ}_{4} ) \\ {c}_{5} / {c}_{5} \cdot f {*}_{5}^{E} ( {σ}_{5} ) \\ {c}_{6} / {c}_{6} \cdot f {*}_{6}^{E} ( {σ}_{6} )\end{matrix} \vert \qquad 4.24$$

Multiplying the mᵢⱼ by the appropriate cⱼ, and defining f′*ⱼ^{E}(σⱼ)=f*ⱼ^{E}(σⱼ)/cⱼ produces the symmetric matrix solution,

$${ε}_{i}^{E} ( {σ}_{j} ) = \vert \begin{matrix}1 & {m}_{12}^{′} & {m}_{13}^{′} & 0 & 0 & 0 \\ {m}_{21}^{′} & {c}_{2} & {m}_{23}^{′} & 0 & 0 & 0 \\ {m}_{31}^{′} & {m}_{32}^{′} & {c}_{3} & 0 & 0 & 0 \\ 0 & 0 & 0 & {c}_{4} & 0 & 0 \\ 0 & 0 & 0 & 0 & {c}_{5} & 0 \\ 0 & 0 & 0 & 0 & 0 & {c}_{6}\end{matrix} \vert \vert \begin{matrix}{f}^{′} {*}_{1}^{E} ( {σ}_{1} ) \\ {f}^{′} {*}_{2}^{E} ( {σ}_{2} ) \\ {f}^{′} {*}_{3}^{E} ( {σ}_{3} ) \\ {f}^{′} {*}_{4}^{E} ( {σ}_{4} ) \\ {f}^{′} {*}_{5}^{E} ( {σ}_{5} ) \\ {f}^{′} {*}_{6}^{E} ( {σ}_{6} )\end{matrix} \vert \qquad 4.25$$

Matrix Symmetry and the Non-Linear Creep Compliance Response

Given the condition of orthogonality and resulting material orthotropy, the most general non-linear form of a delayed elasticity function is similarly,

$${ε}_{i}^{D} ( t , {σ}_{j} ) = \vert \begin{matrix}1 & {n}_{12} & {n}_{13} & 0 & 0 & 0 \\ {n}_{21} & 1 & {n}_{23} & 0 & 0 & 0 \\ {n}_{31} & {n}_{32} & 1 & 0 & 0 & 0 \\ 0 & 0 & 0 & 1 & 0 & 0 \\ 0 & 0 & 0 & 0 & 1 & 0 \\ 0 & 0 & 0 & 0 & 0 & 1\end{matrix} \vert \vert \begin{matrix}f {*}_{1}^{D} ( t , {σ}_{1} ) \\ f {*}_{2}^{D} ( t , {σ}_{2} ) \\ f {*}_{3}^{D} ( t , {σ}_{3} ) \\ f {*}_{4}^{D} ( t , {σ}_{4} ) \\ f {*}_{5}^{D} ( t , {σ}_{5} ) \\ f {*}_{6}^{D} ( t , {σ}_{6} )\end{matrix} \vert \qquad 4.26$$

At large time, t->∞, transient time dependent deformation ceases and all f*ⱼ^{D}(t->∞,σⱼ) become constant valued, independent of time, and may be expressed solely as functions of stress. The six f*ⱼ^{D}(t->∞,σⱼ) may then be rewritten as power series expansions of stress, and equation 4.26 takes the same form as equation 4.19. The same procedures applied to equation 4.19 may be used to show that the nᵢⱼ matrix may always be expressed as a symmetric matrix, producing a solution for equation 4.26 of the form,

$${{ε}_{i} ( t , {σ}_{j} )}^{D} = \vert \begin{matrix}1 & {n}_{12}^{′} & {n}_{13}^{′} & 0 & 0 & 0 \\ {n}_{21}^{′} & {d}_{2} & {n}_{23}^{′} & 0 & 0 & 0 \\ {n}_{31}^{′} & {n}_{32}^{′} & {d}_{3} & 0 & 0 & 0 \\ 0 & 0 & 0 & {d}_{4} & 0 & 0 \\ 0 & 0 & 0 & 0 & {d}_{5} & 0 \\ 0 & 0 & 0 & 0 & 0 & {d}_{6}\end{matrix} \vert \vert \begin{matrix}{f}^{′} {*}_{1}^{D} ( t , {σ}_{1} ) \\ {f}^{′} {*}_{2}^{D} ( t , {σ}_{2} ) \\ {f}^{′} {*}_{3}^{D} ( t , {σ}_{3} ) \\ {f}^{′} {*}_{4}^{D} ( t , {σ}_{4} ) \\ {f}^{′} {*}_{5}^{D} ( t , {σ}_{5} ) \\ {f}^{′} {*}_{6}^{D} ( t , {σ}_{6} )\end{matrix} \vert \qquad 4.27$$

where f′*ⱼ^{D}(t,σⱼ)=f*ⱼ^{D}(t,σⱼ)/dⱼ, and the n′ᵢⱼ=nᵢⱼ·dⱼ. d₁=1, by definition.

These same procedures may be applied to the other conditions of material symmetry, as with the linear materials, so no further discussion is warranted.

4.5 Induced Singularities

It is also possible to induce directionality in manufactured materials. Reinforced fiber composite materials, for example, are constructed by imbedding fibers or a woven cloth of one type of material in a matrix of another type of material. Typical examples of such types of materials are fiberglass and carbon fiber reinforced plastics, steel belted rubber tires, steel reinforced stressed and unstressed concrete, etc. The purpose of imbedding fibers in a matrix of another material is usually to limit tensile deformation and provide a degree of tensile strength that the matrix alone does not possess. The coupling mechanism between the imbedded fibers and the matrix is most often mechanical, but may be chemical as well.

Now non-reinforced matrix materials are, like rubbers and plastics and concrete, typically isotropic. If the imbedded fibers are directionally oriented, as in a 90 degree blanket weave, they will impart a directionality, or even a directional singularity, to the constitutive response of the composite material. A 90 degree blanket weave will produce material orthotropy (FIG. 4.13), with identical properties within the plane of the weave, provided the type and number of fibers in each direction is identical. A directional singularity normal to the blanket weave is also possible, depending upon how the woven fiber blankets are laminated, and so on for the planes of shear normal to the axes of singularity. Using a different number of fibers in one direction compared to another, or imbedding parallel fibers in just one direction produces not only orthotropy, but also a directional singularity in the axial direction parallel to the fibers, and so on. Using fibers of different material properties, like carbon and steel, oriented at 90 degrees, would likewise produce directional singularities in the axial directions parallel to each type of fiber.

Constitutive Property Approximations

It is not uncommon for the constitutive properties of the reinforcing fiber material to be markedly different than that of the surrounding matrix material. All the constituent materials are always fundamentally viscoelastic. However, the disparity in the delayed elasticity response of one material in comparison to the other may be such that the time dependent response for one may dominate to such an extent that the time dependent response of the other may be ignored in defining a constitutive function for the composite material. Steel belted rubber tires and reinforced concrete would be examples of such possible types of composite materials. The delayed elasticity responses for rubber and concrete are far more pronounced than they are for steel (the delayed elasticity response of steel is insignificant enough that most engineers are unaware of the existence of this component response, so it is ignored for virtually all applications).

Assuming linearity in the constitutive responses for both the fibers and matrix materials the governing constitutive response for the fibers may be written as,
ε(t)_{i(f)}=[m_{ij(f)}]f*^{E}_{(f)}+[n_{ij(f)}]f*^{D}(t)_{(f)} 4.28
and for the matrix,
ε(t)ᵢ₍ₘ₎=[mᵢⱼ₍ₘ₎]f*^{E}₍ₘ₎+[nᵢⱼ₍ₘ₎]f*^{D}(t)₍ₘ₎ 4.29

If the creep compliance response of the fibers is negligible, then regardless of the relative volume of the fibers with respect to the matrix material we may be able to ignore that response component, and the resulting constitutive function for the composite material would be of the form,
ε(t)_{i(c)}=[m_{ij(c)}]f*^{E}_{(c)}+[n_{ij(c)}]f*^{D}(t)₍ₘ₎ 4.30

If the matrix material is isotropic then a 60 degree weave would produce isotropy for the composite material in the plane of the weave, while a 90 degree weave produces orthotropy. Needless to say, a similar scheme may be applied to non-linear materials as well.

4.6 Temperature

The constitutive response of any material will undoubtedly vary with temperature. Letting θ represent temperature, equation 4.15 may be rewritten as,

$${{ε}_{i} ( t , θ )}^{D} = \vert \begin{matrix}1 & {n}_{12}^{′} & {n}_{13}^{′} & 0 & 0 & 0 \\ {n}_{21}^{′} & {c}_{2} & {n}_{23}^{′} & 0 & 0 & 0 \\ {n}_{31}^{′} & {n}_{32}^{′} & {c}_{3} & 0 & 0 & 0 \\ 0 & 0 & 0 & {c}_{4} & 0 & 0 \\ 0 & 0 & 0 & 0 & {c}_{5} & 0 \\ 0 & 0 & 0 & 0 & 0 & {c}_{6}\end{matrix} \vert \vert \begin{matrix}{f}^{′} {*}_{1}^{D} ( t , θ ) \cdot {σ}_{1} \\ {f}^{′} {*}_{2}^{D} ( t , θ ) \cdot {σ}_{2} \\ {f}^{′} {*}_{3}^{D} ( t , θ ) \cdot {σ}_{3} \\ {f}^{′} {*}_{4}^{D} ( t , θ ) \cdot {σ}_{4} \\ {f}^{′} {*}_{5}^{D} ( t , θ ) \cdot {σ}_{5} \\ {f}^{′} {*}_{6}^{D} ( t , θ ) \cdot {σ}_{6}\end{matrix} \vert \qquad 4.31$$

Likewise for the linear impulse response, and for the non-linear materials. The only demand applicable to these functions is that there be no temperature variation within the volume of material under consideration. So long as strains are small and changes in lattice structure geometry are small and negligible, the matrix coefficients should show no change in value.
Temperature Induced Strains

If a volume of some mechanically unstrained and unstressed material changes temperature it should either contract or expand. For an unstressed volume of material this produces a constitutive function of the form,
εᵢ(t,δθ)=Aᵢ(t,δθ) 4.32
where δθ=θ−θₒ. θ is different than the initial reference temperature θₒ. The strain functions Aᵢ(t,δθ=0)=0, by definition. The time variable defines the time required to reach strain equilibrium from the point in time of the change in material temperature from the reference temperature, θₒ.

Thermal expansion and contraction will stretch and compress bonds between atoms, like an applied mechanical stress. So, the Aᵢ(t,δθ) must, in general, be characterized similarly, i.e.,
Aᵢ(t,δθ)=A^{E}ᵢ(δθ)+A^{D}ᵢ(t,δθ) 4.33
The A^{E}ᵢ(δθ) and the A^{D}ᵢ(t,δθ) are coupled functions, so for completely anisotropic materials equation 4.32 reduces to,

$${ε}_{i} ( t , θ ) = \vert \begin{matrix}{α}_{1} \\ {α}_{2} \\ {α}_{3} \\ {α}_{4} \\ {α}_{5} \\ {α}_{6}\end{matrix} \vert {A}^{E} ( θ ) + \vert \begin{matrix}{β}_{1} \\ {β}_{2} \\ {β}_{3} \\ {β}_{4} \\ {β}_{5} \\ {β}_{6}\end{matrix} \vert {A}^{D} ( t , θ ) \qquad 4.34$$

and so on for the other degrees of material symmetry. However, as with mechanical strain functions, bonding orthogonality will produce separate thermal strain responses. Consider, for example, the condition of material orthotropy, where bonding is orthogonal in three axial directions. Equation 4.32 now reduces to,

$${ε}_{i} ( t , θ ) = \vert \begin{matrix}{A}_{1}^{E} ( θ ) \\ {A}_{2}^{E} ( θ ) \\ {A}_{3}^{E} ( θ ) \\ 0 \\ 0 \\ 0\end{matrix} \vert + \vert \begin{matrix}{A}_{1}^{D} ( t , θ ) \\ {A}_{2}^{D} ( t , θ ) \\ {A}_{3}^{D} ( t , θ ) \\ 0 \\ 0 \\ 0\end{matrix} \vert \qquad 4.35$$

All three elastic and transient functions may be different, or may be equivalent, or any combination of any two functions may be equivalent, depending upon the degree of orthogonality and symmetry.

### Section 5

Fluids, Unconstrained Deformation, and Inelastic Deformation

Unlike the solids the fluids are materials where there is no chemical bonding between molecules, or groups of molecules. Deformation is therefore potentially unconstrained for any magnitude of applied deviatoric stress.

5.1 Response of ‘Simple’ Fluids to Deviatoric Loading

A ‘simple fluid’ shall be defined as a material that can not support an applied shear stress of any magnitude, where the lack of bonding or any other forces of significance acting as coupling agents between molecules, or clumps of molecules, precludes any resistance to shear forces of any magnitude, other than a frictional resistance. The relationship between a shear stress, σᵢⱼ, and deviatoric (shear) strain rate, ∂ε′ᵢⱼ/∂t, or deviatoric rate of deformation, D′ᵢⱼ, may then be defined as,

$$\begin{matrix}{σ}_{ij} = F ( \frac{ⅆ {ε}_{ij}^{′}}{ⅆ t} ) \\ or & 5.1 \\ {σ}_{ij} = F ( {D}_{ij}^{′} ) & 5.2\end{matrix}$$

where rate of deformation, Dᵢⱼ, is defined as,

$${D}_{ij} = \frac{1}{2} ( \frac{\partial {v}_{i}}{\partial {x}_{j}} + \frac{\partial {v}_{j}}{\partial {x}_{i}} ) \qquad 5.3$$

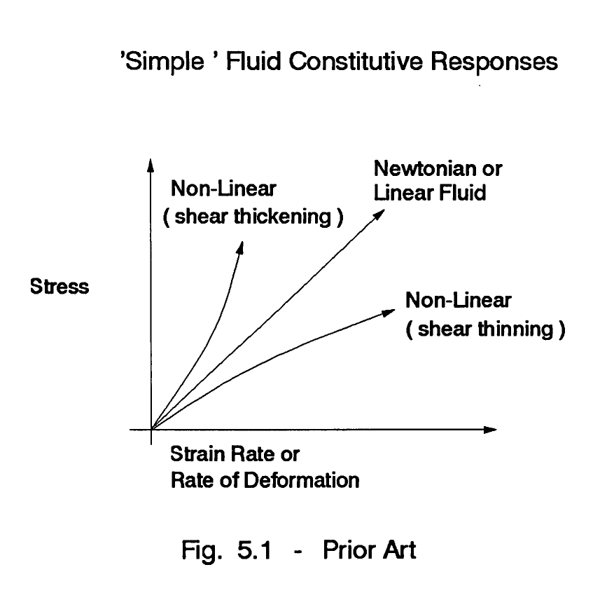

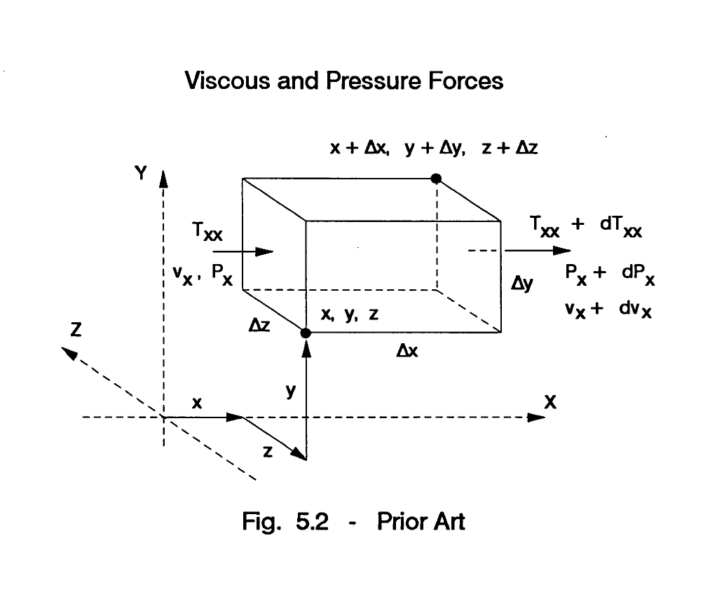

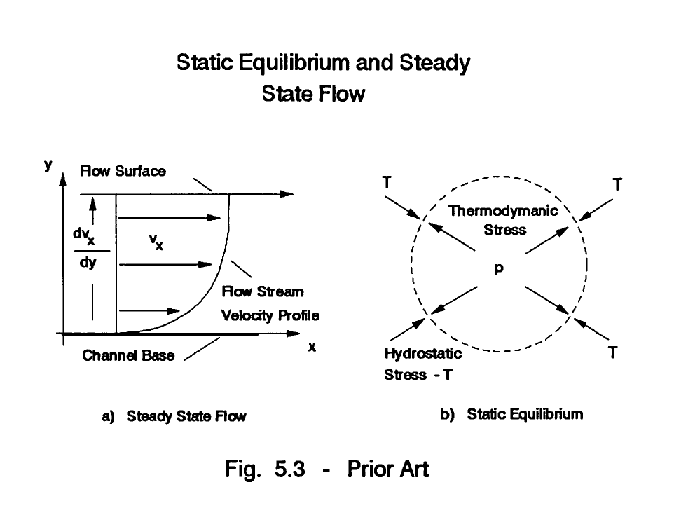

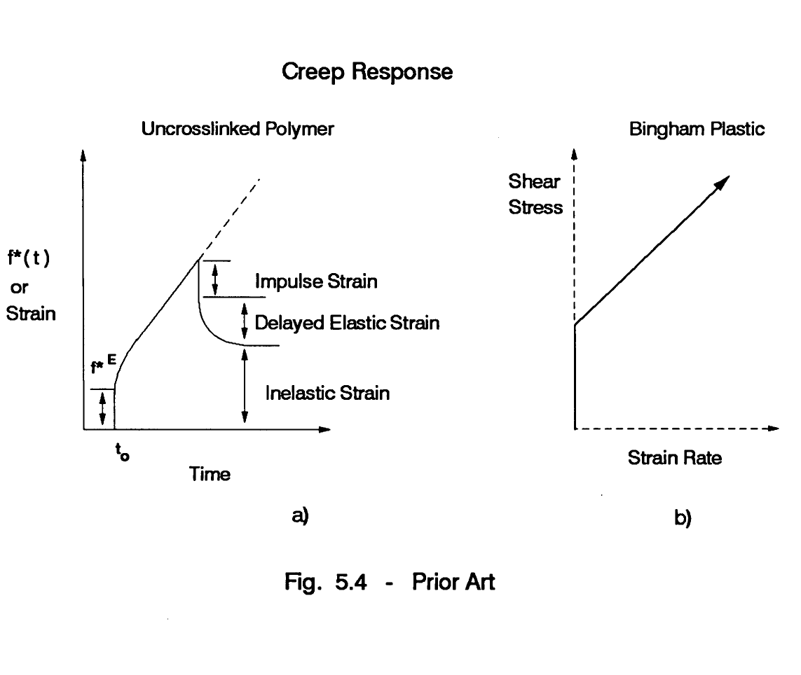

The vᵢ are velocity terms, and the xᵢ are spatial coordinates. The rate of deformation function, Dᵢⱼ, like shear strain, is always symmetric, and D′ᵢⱼ=D′ⱼᵢ, when i≠j. All sorts of linear and non-linear relationships are possible for these functions (FIG. 5.1). As we shall see from the following discussion, equations 5.1 and 5.2 are not even approximately equivalent unless total deformation and total strain are small, on the order of a percent or so. Unlike the strain rate function the rate of deformation function is always linear, even for very large deformations.
5.2 Small strain Rates and Rate of Deformation

From strain theory we know that we may write the expression for finite strains as,

$${ε}_{ij} = \frac{1}{2} ( \frac{\partial {u}_{i}}{\partial {x}_{j}} + \frac{\partial {u}_{j}}{\partial {x}_{i}} ) + \frac{1}{2} ( \frac{\partial {u}_{k}}{\partial {x}_{j}} \frac{\partial {u}_{k}}{\partial {x}_{i}} ) \qquad 5.4$$

where the uᵢ, uⱼ, and uₖ are displacements and the xₖ and xⱼ are the material coordinates. For the small strain condition the higher order partial derivative terms are much smaller than the first order terms, so equation 5.4 reduces to,

$${ε}_{ij} = \frac{1}{2} ( \frac{\partial {u}_{i}}{\partial {x}_{j}} + \frac{\partial {u}_{j}}{\partial {x}_{i}} ) \qquad 5.5$$

Now, the xᵢ, etc., of equation 5.5 may be also taken to be spatial coordinates for small strains. So, differentiating equation 5.4 with respect to time produces,

$$\begin{matrix}\frac{ⅆ {ε}_{ij}}{ⅆ t} = \frac{1}{2} \frac{ⅆ}{ⅆ t} ( \frac{\partial {u}_{i}}{\partial {x}_{j}} + \frac{\partial {u}_{j}}{\partial {x}_{i}} ) \\ = \frac{1}{2} [ \frac{\partial }{\partial {x}_{j}} ( \frac{ⅆ {u}_{i}}{ⅆ t} ) + \frac{\partial }{\partial {x}_{i}} ( \frac{ⅆ {u}_{j}}{ⅆ t} ) ]\end{matrix} \qquad 5.6$$

where duᵢ/dt=vᵢ and the vᵢ are velocity terms, etc. Hence equation 5.6 becomes,

$$\frac{ⅆ {ε}_{ij}}{ⅆ t} = \frac{1}{2} ( \frac{\partial {v}_{i}}{\partial {x}_{j}} + \frac{\partial {v}_{j}}{\partial {x}_{i}} ) = {D}_{ij} \qquad 5.7$$

which is equivalent to equation 5.3. So, the small strain restriction on all possible forms of equation 5.1 for approximate equivalence with equation 5.2 should now be clear.
5.3 The Definition of Newtonian Fluids

The simplest of all possible ‘simple’ fluids are Newtonian fluids. By definition, Newtonian fluids have a linear relationship between stress and the rate of deformation. The proportionality constant between stress and rate of deformation is the ‘viscosity’ of the fluid, a pressure and temperature dependent measure of resistance to deformation under a shear stress. All gases behave as Newtonian fluids, do many liquids. From equations 5.1 and 5.2 the constitutive equations of Newtonian fluids may be defined as,

$$\begin{matrix}{σ}_{ij} = 2 μ \frac{ⅆ {ε}_{ij}^{′}}{ⅆ t} \\ or & 5.8 \\ {σ}_{ij} = 2 μ {D}_{ij}^{′} & 5.9\end{matrix}$$

By definition, μ is dynamic ‘viscosity’. The factor ‘2’ is a constant of convenience. These algorithms are valid only for dynamic flow conditions. They do not define the static or dynamic behavior under hydrostatic loading.
5.4 The Continuity Condition of Mass Flow
The Mass Balance Equation

Consider a reference volume (FIG. 5.2) located with respect to some spatial reference frame x-y-z, and through which mass may flow in all directions. The rate of mass, ρ, accumulated per unit of time, ∂ρ/∂t, in the reference volume Δx·Δy·Δz, is the difference between the mass flowing into the volume and the mass flowing out. In the x direction, the mass flowing into the reference volume per unit of time, at velocity vₓ, through the area Δy·Δz at reference point x, y, z is given by Δy·Δz·ρ·vₓ. The mass flowing out of the reference volume per unit of time, and through the area Δy·Δz located at reference point x+Δx, y, z is given by Δy·Δz·[ρ·vₓ+Δ(ρ·vₓ)]. The difference between these two expressions defines the mass rate of change,

$$Δ x Δ y Δ z \frac{\partial ρ}{\partial t} = Δ y Δ z ρ {v}_{x} - Δ y Δ z [ ρ {v}_{x} + Δ ( ρ {v}_{x} ) ] \qquad 5.10$$

Similar expressions may also be derived for flow into the reference volume from the y and z directions. Summing these expressions and taking the limit as Δx, Δy, and Δz->0 produces the following differential expression for the time rate of change in mass density,

$$\frac{\partial ρ}{\partial t} = - [ \frac{\partial ( ρ {v}_{x} )}{\partial x} + \frac{\partial ( ρ {v}_{y} )}{\partial y} + \frac{\partial ( ρ {v}_{z} )}{\partial z} ] \qquad 5.11$$

Reference Frame Transformation

Performing the indicated differentiation on the right side of equation 5.11 produces,

$$\frac{\partial ρ}{\partial t} + {v}_{x} \frac{\partial ρ}{\partial x} + {v}_{y} \frac{\partial ρ}{\partial y} + {v}_{z} \frac{\partial ρ}{\partial z} = - ρ ( \frac{\partial {v}_{x}}{\partial x} + \frac{\partial {v}_{y}}{\partial y} + \frac{\partial {v}_{z}}{\partial z} ) \qquad 5.12$$

The left side of this equation is now the time derivative of density along the path of fluid motion, the ‘substantiative’ or material derivative. The right side is the solution for the local change in density about some moving reference molecule as a function of the divergence in the fluid velocity field, ∇·v, where by definition,

$$∇ \cdot v = \frac{\partial {v}_{x}}{\partial x} + \frac{\partial {v}_{y}}{\partial y} + \frac{\partial {v}_{z}}{\partial z} \qquad 5.13$$

Equation 5.12 may be rewritten as,

$$\begin{matrix}\frac{D ρ}{D t} = - ρ ( ∇ \cdot v ) \\ where , & 5.14 \\ \frac{D ρ}{D t} = \frac{\partial ρ}{\partial t} + {v}_{x} \frac{\partial ρ}{\partial x} + {v}_{y} \frac{\partial ρ}{\partial y} + {v}_{z} \frac{\partial ρ}{\partial z} & 5.15\end{matrix}$$

Equation 5.14 is the continuity equation of compressible fluid flow. If a fluid is nearly incompressible, or when-density changes during flow are negligible, then Dρ/Dt=0 or Dρ/Dt≈0 and,
∇·v=0 5.16
For static conditions the vᵢ=0, and equation 5.15 reduces to the obvious equivalence.
5.5 Density, Volumetric Strain and Rates of Deformation

Let's now develop some relationships between material density, strain, strain rates and rates of deformation that we shall use in upcoming discussions.

Let an initial reference volume, as in FIG. 5.2, have initial dimensions and volume of unity. Let the finite strains, εᵢᵢ, represent the changes in the length of each side of this unit volume. Let Vₒ represent the initial unit volume, V_{f} the strained volume, and eᵥ the volumetric strain. The solution for the volumetric strain may now be written as,

$${e}_{v} = \frac{( 1 + {ε}_{11} ) ( 1 + {ε}_{22} ) ( 1 + {ε}_{33} ) - {V}_{o}}{{V}_{o}} \qquad 5.17$$

Given that Vₒ=1, then the time derivative of eᵥ is,

$$\frac{ⅆ {e}_{v}}{ⅆ t} = \frac{ⅆ}{ⅆ t} [ ( 1 + {ε}_{11} ) ( 1 + {ε}_{22} ) ( 1 + {ε}_{33} ) - 1 ] \qquad 5.18$$

For very small strains the higher order terms of equations 5.17 and 5.18 may be ignored yielding the solution,

$$\frac{ⅆ {e}_{v}}{ⅆ t} = \frac{ⅆ}{ⅆ t} ( {ε}_{11} + {e}_{22} + {e}_{33} ) = \frac{ⅆ {ε}_{kk}}{ⅆ t} \approx {D}_{kk} \qquad 5.19$$

where, by definition,
Dₖₖ=D₁₁+D₂₂+D₃₃=∇·v 5.20
Equations 5.14 and 5.19 then yield the following equivalences and approximations,

$$\frac{D ρ}{D t} = - ρ ( ∇ \cdot v ) = - ρ {D}_{kk} = - ρ \frac{ⅆ {e}_{v}}{ⅆ t} = - ρ \frac{ⅆ {ε}_{kk}}{ⅆ t} \qquad 5.21$$

Now, the density, ρ, of any material at some initial volume, Vₒ, and another volume, V₂, and density condition, ρ₂, may be written as,

$$ρ = \frac{m}{{V}_{o}} , {ρ}_{2} = \frac{m}{{V}_{2}} \qquad 5.22$$

where m is mass, a constant, and where V₂=Vₒ+dV. eᵥ represents the differential volumetric change of the initial unit volume of material Vₒ. So, from the definition of V₂ it is obvious that we may write,

$$\frac{{V}_{2} - {V}_{o}}{{V}_{o}} = \frac{dV}{1} = dV = {e}_{v} \qquad 5.23$$

Defining ρ₂ in terms of the differential change in density, dρ, gives us,
ρ₂=ρ+dρ 5.24
From the definitions of ρ₂ and V₂ second of equations 5.22 may be rewritten as,

$$ρ + d ρ = \frac{m}{( {V}_{o} + dV )} \qquad 5.25$$

Substituting the solution for m from the first of equations 5.22 then yields,

$$ρ + d ρ = \frac{ρ {V}_{o}}{( {V}_{o} + d V )} \qquad 5.26$$

or upon rearrangement where Vₒ=1,

$$d ρ = - ρ \frac{ⅆ V}{( 1 + ⅆ V )} \qquad 5.27$$

which holds true for any material. Confining interest to small volumetric changes, where dV<<1, equation 5.27 reduces to,

$$d ρ = - ρ \frac{ⅆ V}{( 1 + ⅆ V )} = - ρ d V = - ρ {e}_{v} \approx - ρ {ε}_{kk} \qquad 5.28$$

5.6 Hydrostatic Loading and the Kinetic Equations of State

No known fluid demonstrates unconstrained volumetric deformation under a constant hydrostatic load. Unlike the deviatoric response, the degree of deformation associated with any given hydrostatic stress is constrained, regardless of the magnitude of the applied stress. As with the solids, it must be that the electromagnetic and thermodynamic forces acting at the atomic level prevent the collapse of molecules in fluids onto each other. These two markedly different responses in the simple fluids demand that each response be described by separate and uncoupled constitutive functions, where uncoupling is a consequence of the lack of bonding or other coupling forces acting between molecules.

Definition of the Stress Functions

Experimental observation tells us that for the simple static no-flow condition, or the uniform flow condition, a simple fluid will not support any applied shear stress. The total state of internal stress is then purely hydrostatic. Total hydrostatic pressure P is defined as,

$${T}_{ii} = - P {δ}_{ij} = - \frac{{T}_{kk}}{3} = - \frac{{T}_{11} + {T}_{22} + {T}_{33}}{3} \qquad 5.29$$

where Tᵢᵢ is total stress, and P is the mean hydrostatic pressure. The (−) indicates compression.

Consider steady state flow, where a velocity gradient is permitted within a flow stream. Let some simple fluid, a liquid, be flowing through some channel (FIG. 5.3a). Viscosity and frictional drag at the fluid-solid interface produce the velocity profile internal to the flow stream. Let flow rate be constant and the internal velocity profile be constant, with gravity as the driving force. Similarly, let gravity alone produce the hydrostatic stress. Under these conditions the hydrostatic stress remains unchanged in the flow column because there is no change in fluid density or volumetric flow rate. This condition demands no divergence in velocity field, so from equation 5.21 Dₖₖ=∇·v=deᵥ/dt=0. The hydrostatic stress, which is in equilibrium, must vary with column height, where Tᵢᵢ=−P=−ρ·g·h. h is fluid column height, and g is gravitational acceleration. Again, the (−) simply indicates compression.

Total stress, P, may be expressed in terms of two separate components, an applied hydrostatic stress, σᵢᵢ, and a thermodynamic stress (pressure) p, a function of the thermodynamic equation of state. At equilibrium the total hydrostatic stress P equals the thermodynamic stress p.

The thermodynamic stress p may be defined by some material dependent equation of state of the form,
p(Tᵢᵢ, ρ, θ)=0 5.30
such that the relationship between density, ρ, and temperature, θ, yields the solution for the total hydrostatic stress Tᵢᵢ at equilibrium (FIG. 5.3b). This equation is called a ‘kinetic’ equation of state, and is by definition, a constitutive equation. At equilibrium conditions,

$$\frac{{T}_{kk}}{3} = {T}_{ii} = P = p \qquad 5.31$$

Stress is a linearly additive quantity, so the net applied stress, σᵢᵢ, may be written as the difference between the total hydrostatic stress, Tᵢᵢ, and the thermodynamic stress, p,

$$- {T}_{ii} + p = - P + p = - {σ}_{ii} = - \frac{{σ}_{kk}}{3} = - \frac{{σ}_{11} + {σ}_{22} + {σ}_{33}}{3} \qquad 5.32$$

Kinetic Equations of State for The Gases

Kinetic equations of state for gases are relatively well defined, at least at equilibrium conditions. For a perfect gas the thermodynamic pressure p (or Tᵢᵢ) can be written as,

$$P = p = ρ R θ = \frac{1}{V} R θ \qquad 5.33$$

where R is the gas law constant and V=1/ρ. For an ideal gas equation 5.33 becomes,
PV=pV=nRθ 5.34
where n is molecular weight and V is volume. If the gas is real then the equation of state may be defined as,
PV=pV=Z(P,θ)nRθ 5.35
Z(P,θ) is a correction factor from the ideal gas condition, a function of both pressure and temperature. The mass in a reference volume of gas does not change with variations in that volume, so equations 5.33 and 5.35 may be defined in terms of density. Letting V=1/ρ we have,
P=p=ρZ(P,θ)nRθ 5.36

and so on. For isothermal conditions, or the reversible adiabatic condition, the equations of state become independent of temperature. This is the ‘barotropic’ flow condition, where equations of state are defined solely in terms of mechanical variables.

Now, the above equations of state are defined in a time independent fashion. This does not mean that there are no time dependent effects, only that these functions reflect known relationships between individual variables at equilibrium.

Hydrostatic Constitutive Functions

A hydrostatic stress applied to a volume of a simple fluid, regardless of the flow condition, will result in a stress limited change in material density. Let some fluid, a gas, be contained at some constant temperature θ, pressure of magnitude Pₒ, density ρₒ, and be governed by the kinetic equation of state 5.33,
Pₒ=ρₒRθ 5.37
At some other time, some other pressure P₂, and some other density ρ₂, let the constitutive equation be,
P₂=ρ₂Rθ=ρ₂q 5.38
where q=Rθ is constant at constant temperature. Define P₂ in terms of differential changes in pressure, i.e.,
P₂=Pₒ+dP 5.39
Equation 5.24 yields the density expression and equation 5.38 may then be rewritten as,
Pₒ+dP=(ρₒ+dρ)q 5.40
Subtracting equation 5.37 yields,
dP=dρq 5.41
From equation 5.27 we then obtain,

$$d P = d ρ q = - {ρ}_{o} q \frac{ⅆ V}{( 1 + ⅆ V )} \approx - {ρ}_{o} d V q \qquad 5.42$$

dP is the net applied hydrostatic stress, σᵢᵢ, as defined in equation 5.32 and from which we may write the equivalence,
σₖₖ32 3dP=σ₁₁+σ₂₂+σ₃₃=3σᵢᵢ 5.43
Now, for a perfect gas, a function K(ρ,θ) may be defined as,
K( . . . )=ρₒq=ρₒRθ 5.44
The expression for small volumetric changes is given by equation 5.23. The hydrostatic strain, εᵢᵢ, is equal to the mean normal strain, eᵥ/3, and dV=eᵥ≈εₖₖ=3εᵢᵢ. From equations 5.43 and 5.23 equation 5.42 produces,
σᵢᵢ=−K( . . . )eᵥ=−3K( . . . )εᵢᵢ 5.45
which is identical in form to the hydrostatic constitutive function for isotropic linear elastic solids, or isotropic linear viscoelastic solids evaluated at t->∞. The (−) indicates compression. For solids the coefficient function K( . . . ) is the bulk modulus function, and for liquids K( . . . ) is the bulk compressibility function. Equation 5.45 may also be written as,
P=K( . . . )eᵥ 5.46

Now K( . . . ) is not constant over large ranges in volumetric deformation. For real gases, this non-linearity is evident from equation 5.35. However, any non-linear function can be approximated by a linear function so long as the domain of interest is confined to an appropriately narrow range. Equations 5.45 and 5.46 will be acceptable approximations so long as interest is confined to small, isothermal changes of some reference volume. For simple fluids subjected to isothermal hydrostatic volumetric changes equation 5.46 also represents the barotropic equation of state. For small volumetric strains it is also a linear ‘elastic’ equation, where the magnitude of any volumetric change is a linear function of some increase or decrease in net applied stress.

5.7 The Kinetic Equation of State as a Viscoelastic Function

The Frictionless Elastic Fluid

The simplest possible fluid is the perfectly ‘elastic’ fluid. By definition this fluid is frictionless and has no viscosity. The barotropic equation of state is defined in terms of pressure and density (volume) only,
P=P(ρ) 5.47
The stress function for both the deviatoric and hydrostatic stress fields is simply,

$${T}_{ij} = - \frac{{σ}_{ij} {δ}_{ij}}{3} = - P = p \qquad 5.48$$

which states that at equilibrium the state of stress is always defined in terms of the thermodynamic pressure, equal to the hydrostatic pressure, regardless of the state of motion. No viscous effects are allowed, so there are no energy losses during deformation, either in dilation (volumetric) or in distortion (shear). While shear deformation still occurs, the only resistance to any deformation is in dilation. This fluid is then perfectly ‘elastic’ in the sense that volumetric deformation is constrained for any applied stress and completely recoverable under isothermal and/or adiabatic conditions. No such fluid exists.
The Real Viscous Fluids

The interaction between bonded atoms under an applied stress provides for the elastic impulse and the delayed elasticity responses in solids. This interaction must occur through interaction between electromagnetic fields. However, such interference and interaction need not require bonding. An example of unbonded molecular/atomic interaction is to place a heavy solid object on top another solid supporting object. The atoms in each object at the interface need not be bonded for the lower object to provide the counteracting support. Likewise, the atoms in each object at the interface are not physically touching. There is some spacing between the atoms that is determined and maintained by the electromagnetic repulsive forces acting between atoms. These load induced forces are then transmitted throughout the objects through the interaction of the electromagnetic fields of each bonded atom.

The interaction between unbonded polyatomic molecules in fluids occurs similarly, but the unbonded molecules are usually in a state of random motion and orientation. Consider the case of one fluid molecule colliding with another fluid molecule, resulting in the transfer of momentum from one moving molecule to the other. Momentum transfer comes about as a result of some of the kinetic energy being converted to elastic potential energy through the interaction of the electromagnetic fields between the atoms of the two molecules, including bond distortion. That stored elastic potential energy in the distorted molecule is then released through a repulsive (elastic) rebound reaction and, in combination with the electrostatic repulsive forces, etc., acting between the molecules causes each molecule to assume a trajectory that causes collisions with other molecules which in turn rebound and collide with other molecules, and so on.

Recall that the elastic impulse response is mandatory in solids because stress transmission cannot possibly be instantaneous. The same holds true for fluid molecules as well because the manner in which bonded atoms in the unbonded molecules of a fluid connect and interact is the same. In fact, cooling a fluid results in the bonding of the individual fluid molecules to form solid crystals. The chemical makeup of the molecules does not change with phase changes, and the atoms of each molecule remain bonded. Interaction between molecules of the solid phase or the fluid phase must therefore be described by the same form of constitutive function. The values of the parameters in this function may vary, but the basic form of the function will not change. So, the interaction between atoms and the stress induced straining of the bonds of a fluid molecule will be. defined in terms of a viscoelastic constitutive function with two basic component responses: an impulse response, and a delayed elasticity response. Because fluid volumetric deformation is stress limited, constrained by the thermodynamic and electromagnetic forces, the generalized solution for a constitutive function may not, by definition, be that of a ‘fluid’. A function analogous to that of a viscoelastic solid must describe volumetric deformation.

The Generalized Hydrostatic Constitutive Function

Equations of state are determined from pressure and density/volume measurements, at some temperature, all of which are measured at an equilibrium condition. This is analogous to deriving constitutive equations for viscoelastic solids by measuring the ultimate volumetric strain associated with some load and ignoring time dependent effects (e.g., Hooke's Law of linear elasticity). The most generalized form of any linear viscoelastic hydrostatic function evaluated at t->∞ may be written as,
σ(t→∞)ᵢᵢ=[f(t→∞)ᵢⱼₖₗ]εₒ₍ₖₖ₎δₖₗ 5.49
The εₒ₍ₖₖ₎·δₖₗ are volumetric strains, and the σ(t->∞)ᵢᵢ are the hydrostatic stresses, the mean pressure, P.

For solids we demand coupling between the initially assumed independent f(t->∞)ᵢⱼₖₗ functions through bonding. That is not the case for the simple fluids. The deviatoric constitutive behavior of fluids is markedly different that the hydrostatic constitutive behavior, a consequence of the lack of bonding, or any other coupling forces of significance acting between molecules. Because there is no bonding we may not even demand coupling between the deviatoric constitutive functions. Unless it can be shown or argued that a fluid is isotropic/homogeneous, or behaves as such, we must admit the possibility that deformation under shear will be described by separate deviatoric functions, each one of which is associated with one of the shear stresses. An example of a non-isotropic fluid would be a polymeric fluid with the long chain molecules aligned preferentially in one direction.

The lack of bonding does not however, preclude coupling in the hydrostatic f(t->∞)ᵢⱼₖₗ functions. Coupling does occur and the coupling mechanism is pressure, the result of the thermodynamic and electromagnetic forces acting between the unbonded molecules. When coupling may be demanded equation 5.49 always reduces to,
σ(t→∞)ᵢᵢ=[dᵢⱼₖₗ]εₒ₍ₖₖ₎δₖₗf(t→∞) 5.50

The previously discussed equations of state normally demand material isotropy, because the molecules of a liquid or gas are naturally in a state of random motion and random orientation. Expanding equation 5.50 for isotropy yields,

$$\vert \begin{matrix}{σ}_{11} ( t -> ∞ ) \\ {σ}_{22} ( t -> ∞ ) \\ {σ}_{33} ( t -> ∞ )\end{matrix} \vert = \vert \begin{matrix}{d}_{11} & {d}_{12} & {d}_{12} \\ … & {d}_{11} & {d}_{12} \\ … & … & {d}_{11}\end{matrix} \vert \vert \begin{matrix}{ε}_{o ( 11 )} \\ {ε}_{o ( 22 )} \\ {ε}_{o ( 33 )}\end{matrix} \vert f ( t -> ∞ ) \qquad 5.51$$

Recall that dᵢⱼ=dⱼᵢ; when i≠j, and d₁₁=d₂₂=d₃₃, all a result of isotropy. Given that σ₁₁=σ₂₂=σ₃₃, and ε₁₁=ε₂₂=ε₃₃, the solution for equation 5.51 reduces to,
σᵢᵢ(t→∞)=f(t→∞)(d₁₁+2d₁₂)εᵢᵢ 5.52
or from equation 5.46,
P(t→∞)=K(t→∞)eᵥ 5.53
where the solution for K(t->∞) is,

$$K ( t -> ∞ ) = \frac{f ( t -> ∞ ) ( {d}_{11} + 2 {d}_{12} )}{3} \qquad 5.54$$

which is identical in form to the solution for the bulk modulus function of viscoelastic solids.

Now consider a perfect gas. From the definition of equation 5.44 equation 5.54 implies the following,
K(t→∞,θ)=ρₒRθ 5.55
If the gas were ‘real’ then from equation 5.35 the equivalence would be,
K(t→∞,P,θ)=ρₒZ(P,θ)nRθ 5.56
a non-linear function because Z(P,θ) is non-linear.

For isothermal conditions equations 5.55 and 5.56 represent barotropic equations of state and K(..,t->∞) is, in general, non-linear. However, if volumetric deformations about some reference volume are small, K(..,t->∞) may be approximated as a linear function. This implies that elastic components in the function K(..,t->∞), which provide the limit to volumetric deformation, may also be approximated by a set of linear constants.

Oscillatory Volumetric Deformation

Consider the frictionless and perfectly elastic fluid, where some reference volume is subjected to some small oscillatory deformation. Let the resulting change in density in time be defined by,
ρ=ρₒ cos(ωt) 5.57
ω is frequency, in cycles/sec. t is time. Define the equation of state, at isothermal conditions, to be that of a perfect gas, given by equation 5.33. The mean stress or pressure, P., is then,
P(t,θ)=Pₒ cos(ωt), Pₒ=ρₒRθ 5.58
Let volumetric strain be eᵥ=eₒ·cos(ωt). From equation 5.46 we obtain,
P(t,θ)=Pₒ cos(ωt)=eₒK( . . . )cos(ωt) 5.59
where K( . . . ) is the linear time-independent bulk compressibility function.

If the linear bulk compressibility function, K( . . . ), is not perfectly elastic and the fluid has energy losses associated with volumetric deformation, then K( . . . ) is a viscoelastic function. The solution for net hydrostatic stress, σᵢᵢ(t), as a function of the oscillatory variation in volumetric strain then becomes a function of the hereditary integral.

Frequency Dependent Hereditary Integrals

Recall the linear hereditary integrals of the solids,

$$\begin{matrix}{ε}_{i} ( t ) = {m}_{ij} f {*}^{E} {σ}_{j} ( t ) + {n}_{ij} {\int }_{0 +}^{t} {σ}_{j} ( {t}_{1} ) \frac{ⅆ f {*}^{D} ( t - {t}_{1} )}{ⅆ ( t - {t}_{1} )} ⅆ {t}_{1} \\ and & 5.60 \\ {σ}_{i} ( t ) = {a}_{ij} {f}^{E} {ε}_{j} ( t ) + {b}_{ij} {\int }_{0 +}^{t} {ε}_{j} ( {t}_{1} ) \frac{ⅆ {f}^{D} ( t - {t}_{1} )}{ⅆ ( t - {t}_{1} )} ⅆ {t}_{1} & 5.61\end{matrix}$$

When loading and deformation are defined in terms of frequency dependent sine and cosine functions the hereditary integrals reduce to,
εᵢ(t)=mᵢⱼf*^{E}σⱼ(t)+nᵢⱼC*(ωⱼ)σⱼ(t) 5.62
and
σ(t)=aᵢⱼf^{E}εⱼ(t)+bᵢⱼC(ωⱼ)εⱼ(t) 5.63
where C*(ω) is the complex compliance function, C(ω) is the complex modulus function. Both are non-linear complex functions of frequency defined in terms of two component functions,
C*(ω)=C*₁(ω)+iC*₂(ω), C(ω)=C₁(ω)+iC₂(ω) 5.64
The complex stress function of equation 5.62 is defined as,
σⱼ(t)=σₒ₍ⱼ₎[ cos(ωⱼt)+i sin(ωⱼt)]=σₒ₍ⱼ₎e^{iω}^{ⱼ}^{t} 5.65
and the complex strain function of equation 5.63 is defined as,
εⱼ(t)=εₒ₍ⱼ₎[ cos(ωⱼt)+i sin(ωⱼt)]=εₒ₍ⱼ₎e^{iω}^{ⱼ}^{t} 5.66
For loading defined in terms of cosine functions, the real stress functions are σⱼ(t)=σₒ₍ⱼ₎·cos(ωt), and the resulting strain solution to equation 5.62 is,
εᵢ(t)=[mᵢⱼ]f*^{E}σₒ₍ⱼ₎ cos(ωⱼt)+[nᵢⱼ]σₒ₍ⱼ₎{C*₁(ωⱼ)cos(ωⱼt)−C*₂(ωⱼ)sin(ωⱼt)} 5.67
The strain solution associated with the real loading functions σⱼ(t)=σₒ₍ⱼ₎·sin(ωⱼt) is,
εᵢ(t)=[mᵢⱼ]f*^{E}σₒ₍ⱼ₎ sin(ωⱼt)+[nᵢⱼ]σₒ₍ⱼ₎{C*₂(ωⱼ)sin(ωⱼt)+C*₁(ωⱼ)cos(ωⱼt)} 5.68
Consider an isotropic material subjected to a static hydrostatic load where the hereditary integral function 5.60 degenerates to,

$${ε}_{ii} ( t ) = - \frac{K * ( t )}{3} {σ}_{o ( ii )} \qquad 5.69$$

and the bulk modulus function, K*(t), is defined as,
K*(t)=3(1+2m₁₂)f*^{E}+3(1+2n₁₂)f*^{D}(t)=K*^{E}+K*^{D}(t) 5.70
From the hereditary integral functions the frequency dependent solution for periodic, time dependent hydrostatic loading and deformation take the form of,

$${ε}_{ii} ( t ) = - \frac{K * ( ω )}{3} {σ}_{o ( ii )} {ⅇ}^{ⅈ ω t} = - \frac{K * ( ω )}{3} {σ}_{ii} ( t ) \qquad 5.71$$

where the solution for K*(ω) is,
K*(ω)=3(1+2m₁₂)f*^{E}+3(1+2n₁₂)C*(ω)=K*^{E}+K*^{D}(ω) 5.72
The volumetric strain is eᵥ=εₖₖ, the net normal stress, σᵢᵢ(t), and hydrostatic pressure, P(t). Following equation 5.46 equation 5.71 becomes,
eᵥ(t)=−K*(ω)Pₒe^{iωt}=−K*(ω)P(t) 5.73
For the relaxation modulus we have,
P(t)=−K(ω)eₒe^{iωt}=−K(ω)eᵥ(t) 5.74
where K(ω) is,

$$\begin{matrix}K ( ω ) = \frac{f {*}^{E}}{3 ( 1 + 2 {a}_{12} )} + \frac{C ( ω )}{3 ( 1 + 2 {b}_{12} )} \\ = {K}^{E} + {K}^{D} ( ω )\end{matrix} \qquad 5.75$$

K^{E} is obviously the classic linear elastic bulk modulus function.
5.8 Work, Energy Loss and Propagation Characteristics

In ‘perfectly’ elastic solids the work of deformation would be stored as elastic potential energy and completely recoverable. In viscoelastic solids some of the energy expended in the 15 deformation process is lost, i.e., internalized and transformed into ‘heat’ through friction (electromagnetic field interaction effects), and is not recoverable as mechanical elastic energy. Briefly, the internalization occurs through the deformation of bonds and vibration between bonded atoms. Ignoring conduction, energy or heat loss then occurs through radiation—photon (electromagnetic energy) emission. Unlike the solids, gas and fluid molecules are free to translate laterally, and this kinetic energy of motion is transferred and internalized through molecular collisions. For polyatomic gas molecules rotation must also be considered, with rotation also producing photon emission (ignoring any transitions between electron energy states, as with monatomic gases). All electromagnetic emissions are, of course, quantized.

The Frequency Dependent Work Functions

Consider a differential element of a solid material being acted upon by some force σᵢ·A, where A is the cross sectional area of each face of this element. The dimensions of the element are defined to be dxᵢ. In a differential time interval, dt, these forces cause an increase in induced strain by an incremental strain factor (dεᵢ/dt)·dt. The work, dW, performed per differential unit of time, dt, is then,

$${σ}_{i} A d {x}_{i} \frac{ⅆ {ε}_{i}}{ⅆ t} d t = d W A d {x}_{i} \qquad 5.76$$

For any finite time interval the solution for mechanical work W is the integral of this equation,

$$W = \int ⅆ W = \int {σ}_{i} \frac{ⅆ {ε}_{i}}{ⅆ t} ⅆ t \qquad 5.77$$

(In general, this expression is not the solution for total work, for there is an additional kinetic energy term, call it KE, that comes about from the general consideration of both the effects of surface tractions and body forces. Letting Σ be the total work expression, the most general differential form of the total work function has the form of,

$$\frac{ⅆ Σ}{ⅆ t} = \frac{ⅆ KE}{ⅆ t} + \frac{ⅆ W}{ⅆ t} \qquad 5.78$$

where equation 5.77 is the integral, in time, of the differential mechanical work term dW/dt. The kinetic energy of a solid body subjected to dynamic deformation is,

$$KE = \frac{1}{2} {\int }_{A} ρ \frac{ⅆ {ε}_{i}}{ⅆ t} \frac{ⅆ {ε}_{i}}{ⅆ t} ⅆ A = \frac{1}{2} ρ \frac{ⅆ {ε}_{i}}{ⅆ t} \frac{ⅆ {ε}_{i}}{ⅆ t} \qquad 5.79$$

where ρ is mass density and A is area, defined here to be unity. The time derivatives of strain are velocity terms. The time rate of change in kinetic energy is then just,

$$\frac{ⅆ KE}{ⅆ t} = ρ \frac{{ⅆ}^{2} {ε}_{i}}{ⅆ {t}^{2}} \frac{ⅆ {ε}_{i}}{ⅆ t} \qquad 5.80$$

This expression plus the time derivative of the mechanical work function of equation 5.77 yield the complete solution for equation 5.78,

$$\frac{ⅆ Σ}{ⅆ t} = \frac{ⅆ KE}{ⅆ t} + \frac{ⅆ W}{ⅆ t} = ρ \frac{{ⅆ}^{2} {ε}_{i}}{{ⅆ}^{2} t} \frac{ⅆ {ε}_{i}}{ⅆ t} + {σ}_{i} \frac{ⅆ {ε}_{i}}{ⅆ t} \qquad 5.81$$

We have no interest in KE and therefore confine interest to the mechanical work function W. Note that for static conditions KE=0, and W appears to become equivalent to the elastic strain energy function U. As we shall see shortly, this is not exactly the case.)

From equations 5.60 and 5.62 the solution for strain is composed of two time dependent components, the impulse response and the delayed elasticity response, i.e.,
εᵢ(t)=ε^{E}ᵢ(t)+ε^{D}ᵢ(t) 5.82
Substituting this expression into equation 5.77 then yields,

$$W = \int {σ}_{i} \frac{ⅆ {ε}_{i} ( t )}{ⅆ t} ⅆ t = \int {σ}_{i} \frac{ⅆ {ε}_{i}^{E} ( t )}{ⅆ t} ⅆ t + \int {σ}_{i} \frac{ⅆ {ε}_{i}^{D} ( t )}{ⅆ t} ⅆ t \qquad 5.83$$

Solving this function requires definition of the time dependent expressions for stress and-strain. Define the loading function to be,
σᵢ(t)=σₒ₍ᵢ₎ cos(ωᵢt) 5.84
which produces a solution for the impulse response strain given by the first term of equation 5.67,
ε^{E}ᵢ(t)=[mᵢⱼ]f*^{E}σₒ₍ⱼ₎ cos(ωⱼt) 5.85
The solution for the delayed elasticity strain response is given by the second term of equation 5.67,
ε^{D}ᵢ(t)32 [nᵢⱼ]σₒ₍ⱼ₎{C*₁(ωⱼ)cos(ωⱼt)−C*₂(ωⱼ)sin(ωⱼt)} 5.86
The derivative of equation 5.85 with respect to time is,

$$\frac{ⅆ {ε}_{i}^{E} ( t )}{ⅆ t} = - [ {m}_{ij} ] f {*}^{E} {ω}_{j} {σ}_{o ( j )} sin ( {ω}_{j} t ) \qquad 5.87$$

and the derivative of equation 5.86 with respect to time is,

$$\frac{ⅆ {ε}_{i}^{D} ( t )}{ⅆ t} = - [ {n}_{ij} ] {ω}_{j} {σ}_{o ( j )} \{ C {*}_{1} ( {ω}_{j} ) sin ( {ω}_{j} t ) + C {*}_{2} ( {ω}_{j} ) cos ( {ω}_{j} t ) \} \qquad 5.88$$

Substituting equations 5.87 and 5.88 into equation 5.83 yields the generalized solution,
W=−[mᵢⱼ]f*^{E}ωⱼσₒ₍ᵢ₎σₒ₍ⱼ₎∫ₜcos(ωᵢt)sin(ωⱼt)dt−[nᵢⱼ]ωⱼσₒ₍ᵢ₎σₒ₍ⱼ₎C*₁(ωⱼ)∫ₜcos(ωᵢt)sin(ωⱼt)dt−[nᵢⱼ]ωⱼσₒ₍ᵢ₎σₒ₍ⱼ₎C*₂(ωⱼ)∫ₜcos(ωᵢt)cos(ωⱼt)dt 5.89
where only the first line represents the classic elastic strain energy function, being associated with the elastic impulse response.
Energy Dissipation

The amount of energy lost per vibration cycle, or per unit of time, is a measure of the relative energy dissipation efficiency. Let's simplify equation 5.89 for hydrostatic loading and material isotropy. Under these constraints, the stress functions are equivalent and the ωⱼ=ω, and equation 5.84 reduces to σᵢ(t)=σₒ·cos(ωt). A logical choice for the time period over which to evaluate equation 5.89 is one complete period of vibration, defined as t=2π/ω. Equation 5.89 now becomes,

$$\begin{matrix}W = - [ {m}_{ij} ] f {*}^{E} {σ}_{o}^{2} {\int }_{0}^{2 π / ω} ω cos ( ω t ) sin ( ω t ) ⅆ t \\ - [ {n}_{ij} ] {σ}_{o}^{2} C {*}_{1} ( ω ) {\int }_{0}^{2 π / ω} ω cos ( ω t ) sin ( ω t ) ⅆ t \\ - [ {n}_{ij} ] {σ}_{o}^{2} C {*}_{2} ( ω ) {\int }_{0}^{2 π / ω} ω {cos}^{2} ( ω t ) ⅆ t\end{matrix} \qquad 5.90$$

The first term of equation 5.90, call it W^{E}, is associated with the impulse response,

$${W}^{E} = - [ {m}_{ij} ] f {*}^{E} {σ}_{o}^{2} {\int }_{0}^{2 π / ω} ω cos ( ω t ) sin ( ω t ) ⅆ t \qquad 5.91$$

which upon integration yields,

$$\begin{matrix}{W}^{E} = \frac{1}{2} [ {m}_{ij} ] f {*}^{E} {σ}_{o}^{2} [ {cos}^{2} ( ω t ) ] {\int }_{0}^{2 π / ω} \\ = \frac{1}{2} [ {m}_{ij} ] f {*}^{E} {σ}_{o}^{2} [ {cos}^{2} ( 2 π ) - {cos}^{2} ( 0 ) ] = 0\end{matrix} \qquad 5.92$$

which is the classic potential energy function of linear elastic materials.

The second term of equation 5.90, call it W^{D}₁, is associated with the delayed elasticity response function,

$${W}_{1}^{D} = - [ {n}_{ij} ] {σ}_{o}^{2} C {*}_{1} ( ω ) {\int }_{0}^{2 π / ω} ω cos ( ω t ) sin ( ω t ) ⅆ t \qquad 5.93$$

and upon integration yields,

$$\begin{matrix}{W}_{1}^{D} = \frac{1}{2} [ {n}_{ij} ] {σ}_{o}^{2} C {*}_{1} ( ω ) [ {cos}^{2} ( ω t ) ] {\int }_{0}^{2 π / ω} \\ = \frac{1}{2} [ {n}_{ij} ] {σ}_{o}^{2} C {*}_{1} ( ω ) [ {cos}^{2} ( 2 π ) - {cos}^{2} ( 0 ) ] = 0\end{matrix} \qquad 5.94$$

So, this function must also represent recoverable elastic potential energy.

The last term of equation 5.90, call it W^{D}₂, is likewise associated with the delayed elasticity response function and is,

$${W}_{2}^{D} = - [ {n}_{ij} ] {σ}_{o}^{2} C {*}_{2} ( ω ) {\int }_{0}^{2 π / ω} ω {cos}^{2} ( ω t ) ⅆ t \qquad 5.95$$

which upon integration becomes,

$$\begin{matrix}{W}_{2}^{D} = - [ {n}_{ij} ] ω {σ}_{o}^{2} C {*}_{2} ( ω ) [ \frac{t}{2} + \frac{1}{4 ω} sin ( 2 ω t ) ] {\int }_{0}^{2 π / ω} \\ = - [ {n}_{ij} ] ω {σ}_{o}^{2} C {*}_{2} ( ω ) [ \frac{π}{ω} + \frac{1}{4 ω} sin ( 4 π ) ]\end{matrix} \qquad 5.96$$

The term sin(4π)=0, so this solution reduces to,
W^{D}₂=−[nᵢⱼ]πσₒ²C*₂(ω) b 5.97
which is not equal to zero, and represents the mechanical energy lost (converted to heat) in-every deformation cycle. Note that the solution for W^{D}₂ is never equal to zero, except when t=0, and that the magnitude of this term will increase with each deformation cycle. An equivalent energy loss function, defined in terms of the strain, would be,
W^{D}₂=−[bᵢⱼ]πεₒ²C₂(ω) 5.98

By convention, ‘dissipation’ is defined as the energy lost per unit of time, not per deformation cycle. To determine the loss per unit time divide equations 5.97 and 5.98 by the time factor 2·π/σ and obtain,

$$\begin{matrix}{E}_{D} \vert [ {n}_{ij} ] \frac{ω}{2} {σ}_{o}^{2} C {*}_{2} ( ω ) \vert \\ and & 5.99 \\ {E}_{D} = \vert [ {b}_{ij} ] \frac{ω}{2} {ε}_{o}^{2} {C}_{2} ( ω ) \vert & 5.100\end{matrix}$$

Both are positive definite functions where ‘E_{D}’ denotes the dissipated energy per unit time. Note from equations 5.97-5.100 that E_{D} is a quantized function.
Dissipation and Speed of Propagation of a Disturbance

The stored potential energy in a volume of deformed viscoelastic material does not equal the energy expended during a deformation because some of the input energy is converted to heat. Consider now an impulse disturbance that travels from atom to atom along the length of a bar of a solid viscoelastic material. An initial impulse at one end of the bar imparts momentum, and hence kinetic energy, to the atoms at this end of the bar. Some of the kinetic energy involved in displacing these atoms and deforming the bonds with the following group of atoms in the bar is converted to elastic potential energy, and some is converted to heat as each bond is compressed or stretched. When the following group of atoms rebound from the deformation, the recoverable elastic energy transmitted through the bonds to the next group of atoms is less that the amount of energy expended in deforming the bonds. So, as the disturbance travels from atom to atom the magnitude of the elastic potential energy that may be transmitted continually decreases. This means that the amplitude of the disturbance must decrease as the disturbance travels along the bar.

It has been shown that the propagation velocity (speed of sound) of an impulse disturbance in a viscoelastic solid is solely a function of the impulse response. In linear materials, this propagation speed is independent of the magnitude of a given impulse or time dependent disturbance. However, energy loss rate is very much frequency dependent. The faster the oscillation (the higher the frequency) the greater the rate of energy loss. However, it is only the delayed elasticity term that is responsible for this loss of elastic energy.

In fluids the propagation velocity may be derived from the barotropic equation of state. For small amplitude (small volume) disturbances the speed of sound is given by a constant that is a function of the change in pressure and density (volume) with respect to some reference condition, i.e.,

$${c}^{2} = \frac{ⅆ P}{ⅆ ρ} \qquad 5.101$$

where c is the compressional speed of sound.

For a frictionless, perfectly elastic fluid this relationship implies that the speed of sound may always be determined directly and precisely from the equation of state. The solution for ‘c’ then becomes,
c²=q=Rθ 5.102
From equations 5.41 and 5.42 equations 5.101 and 5.102 may be rewritten as,

$$\frac{ⅆ P}{ⅆ V} = {c}^{2} , {c}^{2} = K ( ρ , θ ) = {ρ}_{o} R θ \qquad 5.103$$

and so on for ideal and real gases. As a frequency dependent disturbance travels through the perfect frictionless fluid and away from a source location there will be no energy loss, and hence no decrease in disturbance amplitude or intensity (aside from spreading effects).

Let's now examine wave propagation in ‘real’ molecular fluids. Let-the disturbance be small enough such that the hydrostatic constitutive function can be approximated by a barotropic equation of state. No polyatomic fluid molecule will be ‘perfectly’ elastic so the equation of state must be given by some sort of viscoelastic function.

In order to-propagate a disturbance in a viscoelastic material there must be an impulse response. For small disturbances the speed of propagation should be relatively constant. However, because the constitutive response must be viscoelastic, there should be energy loss associated with a delayed elasticity response component, and the energy loss rate should be a non-linear function of frequency. Furthermore, as the disturbance propagates there should be a reduction in the amplitude/intensity of the disturbance.

Table 5.1 gives experimental data for the speed of sound in dry air at several frequencies. As can be seen, the speed of sound is virtually constant, and is definitely frequency independent. These data also show that for small disturbances the

TABLE 5.1
Wave Propagation Characteristics
of Still Dry Air at 68° F. (20° C.)

| Frequency | Velocity | Absorption |
|---|---|---|
| (Hz) | (k-ft/sec) | (Db/sec) |
| 20 | 1.126892 | 0.174 |
| 40 | 1.127013 | 0.368 |
| 50 | 1.127050 | 0.433 |
| 100 | 1.127131 | 0.573 |
| 200 | 1.127161 | 0.631 |
| 400 | 1.127169 | 0.672 |
| 800 | 1.127172 | 0.780 |
| 1250 | 1.127172 | 0.970 |
| 2000 | 1.127173 | 1.423 |
| 4000 | 1.127178 | 3.039 |
| 10000 | 1.127184 | 9.032 |
| 12500 | 1.127186 | 12.306 |
| 16000 | 1.127187 | 17.923 |
| 20000 | 1.127187 | 25.901 |
| 40000 | 1.127188 | 91.759 |
| 80000 | 1.127188 | 354.700 |

Note: Dry denotes the relative humidity = 0%. k-ft/sec denotes 1000's ft/sec. Hz is frequency in cycles/sec. Db is decibels.
1979 CRC Handbook of Physics and Chemistry

impulse response can readily, and quite accurately, be approximated by a linear elastic impulse term to the governing constitutive equation, the barotropic equation of state. These data also show that there is indeed energy loss with propagation, and that the energy loss is very much a function of frequency.

So, if the state equation is described in terms of a viscoelastic function it is possible to account for a host of observed behavioral characteristics in polyatomic fluids including: limited volumetric deformation for any net stress, volumetric rebound after stress release, wave propagation velocities that are dependent upon an elastic impulse response, the decay in wave amplitudes/intensities with increasing distance from source, and energy loss as a function of volumetric deformation and frequency.

From these data, and the requirement for uncoupling between the hydrostatic and deviatoric response, we conclude that the complete form of the constitutive equation for the simple fluids must be written in terms of two independent and linearly additive responses, i.e.,
Tᵢⱼ=Pδᵢⱼ+F(D′ᵢⱼ) 5.104
or for the Newtonian fluids,
Tᵢⱼ=Pδᵢⱼ+2μD′ᵢⱼ 5.105
where the pressure function ‘P’ is defined by a viscoelastic equation of state.
Extensions to the Atomic Level

Consider now, for example, a chemically bonded diatomic gas molecule oscillating over a constant range in amplitude ε=εₒ·cos(ωt) and frequency ω. The viscoelastic work functions 5.97 and 5.98 are energy loss terms that are functions of frequency, ω. This implies that if energy loss (which is quantized in terms of the classic vibration frequency ω) is in the form of photon emission, then the energy of the emitted photon, always defined in terms of frequency, should be a function of this oscillation frequency, ω. The energy of the emitted photon would then be,
Eₚₕₒₜₒₙ=hω 5.106
where h is Plank's constant. This result is in accord with observation. However, quantum theory follows the classical theory of elasticity and assumes that the harmonic oscillation of bonded atoms is ‘perfectly’ elastic. This assumption precludes any prediction and requirement of energy loss, or the functional relationship of that energy loss with the frequency of molecular vibration.

Interestingly, because of the assumption of ‘perfect’ elasticity for harmonic oscillation between bonded atoms, gases are often assumed to be ‘perfectly’ elastic, or very nearly so, although this clearly cannot be the case. (In texts physicists often assume ‘perfect’ elastic behavior while engineers generally assume ‘perfectly’ viscous behavior, i.e., the Navier-Poisson constitutive function for the Navier-Stokes equations.) When a collision occurs between two molecules of a polyatomic gas a ‘perfectly’ elastic reaction can only occur if there is no net decrease in the sum of the kinetic energies. Assuming no change in rotational energies, which are quantized, a collision between molecules may cause a change in the non-quantized amplitudes of interatomic vibration. Any change in amplitude produces a change in vibration energy even though the vibration frequency, which is quantized, may remain unchanged. So, some of the translational kinetic energy is internalized within the molecule and eventually dissipated as ‘heat’, i.e., photon emission. A perfectly elastic reaction may occur only for a relatively unique matching of the various energy states of molecules at the moment of collision, a result that is probably very rare for even the simple diatomic gases.

We may further observe that if polyatomic gases were indeed ‘perfectly’ elastic then the equations of state should be accurate predictors of the speed of sound, for a broad range of temperature and pressure conditions, and energy losses should be negligible as a disturbance propagates. There would also be no reason to presume that when liquified or solidified these polyatomic compounds should then not also be ‘perfectly’ elastic, and the bulk compressibility or bulk modulus function an accurate predictor of the speed of sound. However, this is not the case. For heavier and more complex polyatomic gases, such as the hydrocarbon gases methane, propane, etc., the equations of state are notoriously inaccurate predictors for the speed of sound.

‘Perfectly’ elastic interactions between polyatomic liquid/gas molecules can only be rare occurrences. However, the same can not be said or interactions between monatomic gas atoms and/or atoms and subatomic particles (e.g., electrons). Perfectly elastic interactions are known to readily occur if the collision energy between atoms, or atoms and subatomic particles, is not sufficient to excite the electrons of a monatomic atom to higher energy states, which are always quantized. Classic experimental examples are the interactions between electrons and hydrogen atoms, and between electrons and mercury atoms in a vapor.

5.9 Viscoelastic and Viscoplastic Fluids

Viscoelastic Fluids

Not all fluids are simple or Newtonian. Some of these materials, which have no bonding between molecules, and are therefore thought of as fluids, do have the ability to support some level of deviatoric stress. Coupling between molecules may be mechanical or electrostatic, or both, but these mechanisms provide for an interaction that supports a deviatoric stress. Examples of such complex fluids are the liquid uncrosslinked polymers used in the manufacture of rubbers, plastics, etc. FIG. 5.4a illustrates the observed constitutive response under a unit stress. The molecules of such polymers are long chain hydrocarbon molecules. These fluids are often conceptualized as being analogous to a squirming, entangled mass of worms, where the physical entanglement of the molecules provides mechanical coupling without bonding.

Now, a pure shear stress may always be converted into a normal deviatoric stress, and we see from FIG. 5.4a that the elastic impulse strain and the delayed elasticity strain for such a stress is recoverable. So, a constitutive function for such a material would essentially be defined like the constitutive response of a solid, except for the unconstrained creep response. The elastic impulse response and the delayed elasticity response are defined and coupled for both hydrostatic loading and shear loading, but the unconstrained creep response can only be defined in shear.

Viscoplastic Fluids

Another class of materials, the so-called viscoplastic fluids, again have no bonding between molecules, but mechanical and/or electrostatic forces again act to couple the unbonded molecules and prevent unconstrained deformation until some minimum level of shear stress has been obtained. Examples of such materials are drilling muds. These highly useful materials are often simple concoctions of water, starch (a long chain polymer), and bentonitic clays, and are used extensively in the drilling of oil, gas and water wells.

The simplest of these materials is the idealized Bingham plastic. FIG. 5.4b illustrates the relationship between applied stress and a linear rate of deformation for this material. Of course, in general, the relationship between stress and rate of deformation need not be strictly linear. These materials behave as solids until a critical value of shear stress is reached, then behave as a fluids. The idealization of FIG. 5.4b may illustrate the deformation properties under shear, but it does not account for material behavior before flow is initiated. Prior to flow the response must be that of a solid, specifically a viscoelastic solid. As such, the functions describing the ‘solid’ phase of behavior must have two component responses, an impulse response, and a delayed elasticity response.

Other types of non-solid materials that show this same type god of behavior are granulated solids, such as flour, sugar, and common beach sand. These materials may be piled into free standing mounds that clearly support some minimum level of shear stress. The coupling mechanism between particles is ‘frictional’ resistance—surface roughness coupled with granular angularity and lithostatic (overburden) pressure (marbles, ball bearings, etc., will not form free standing mounds). Until the ‘frictional’ resistance between particles is overcome the material behaves as a solid, capable of supporting and transmitting a shear stress. Once this ‘frictional’ resistance has been exceeded the particles of the material begin to flow in a fashion analogous to fluids. A mass of smooth spherical particles, like marbles, move and behave in a fashion analogous to the simple fluids.

5.10 Inelastic (Plastic) Deformation of Solids

Plastic or inelastic deformation covers a host of behaviors, some of which are physically destructive and occur when the bonds in a solid are broken, crystals are cleaved, and separation planes form internally between continuous masses of material. Not all inelastic deformation in solids is destructive and not all is non-recoverable. Some materials, which show a permanent set as a result of very large strain, may return to their to the pre-deformation shape when heated.

So long as the deformation process in solids is not physically destructive, and molecules remain bonded, we may demand coupling in the associated strain fields. Without specifying the controls over any recoverability in the inelastic component, a generalized linear constitutive function for such a material would take the form of,
εᵢ(t)=[mᵢⱼ]f*^{E}+[nᵢⱼ]f*^{D}(t)+[oᵢⱼ]f*^{P}(t, . . . ) 5.107
Likewise for the non-linear equations. Each function represents a physically distinct and measurable response.

Inelastic deformation may result in more than the simple crystal lattice and bond deformation. It may include the breaking and reforming of bonds, producing extremely large strains. An example would be high temperature molding of metals. However, large deformations are analogous to fluid flow, and can only be accommodated deviatorically (e.g., the Bingham model).

### Section 6

Application Examples—Elementary Beam Theory & Material Approximations

To illustrate how constitutive functions are employed, let's review the development of elementary beam theory. Originally developed using the equations of Hookean elasticity, it may now be extended to include the viscoelastic materials as well.

6.1 Shear Forces and Bending Moments

Consider any engineered structure, a house, bridge, ship, etc. Many of the load carrying members of these structures are ‘slender members’, i.e., a structural member where the length greatly exceeds the lateral dimensions. A ‘slender member’ may be a beam, a shaft, a rod, a strut, and so on. These structural members may be bent, pulled, and twisted. In engineering design we are interested in the internal forces, moments, stresses, and the deflections and strains of the members that result from loading and deformation.

When a slender member is subjected to transverse loading, we say that it acts as a ‘beam’. Examples of slender members that act as ‘beams’ are joists and girders, leaf springs, even the wings of airplanes act as beams (albeit complicated beams).

The following discussion pertains to viscoelastic ‘beams’. The purpose is to illustrate the method of application of the linear viscoelastic constitutive equations in engineering design. For the sake of brevity, interest is restricted to beams with cross-sectional areas that are symmetric with respect to a cross-sectional plane located along the length and through the middle of the beam. Material properties are constrained to be linear, homogenous and isotropic, and only static loading conditions will be considered.

Differential Equations

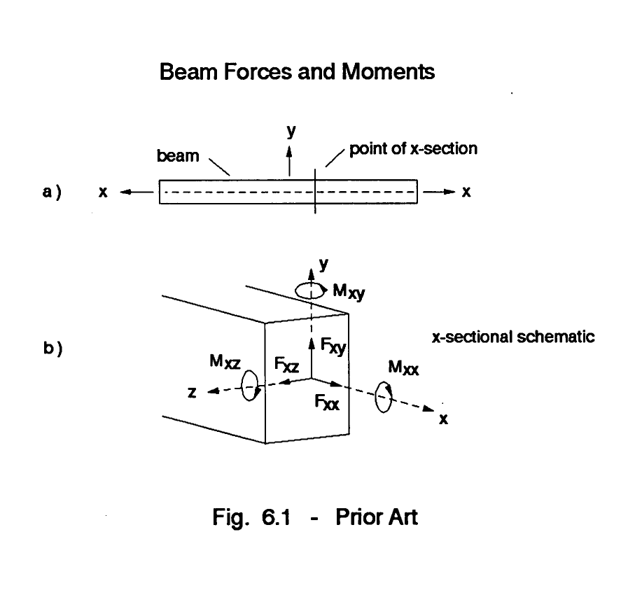

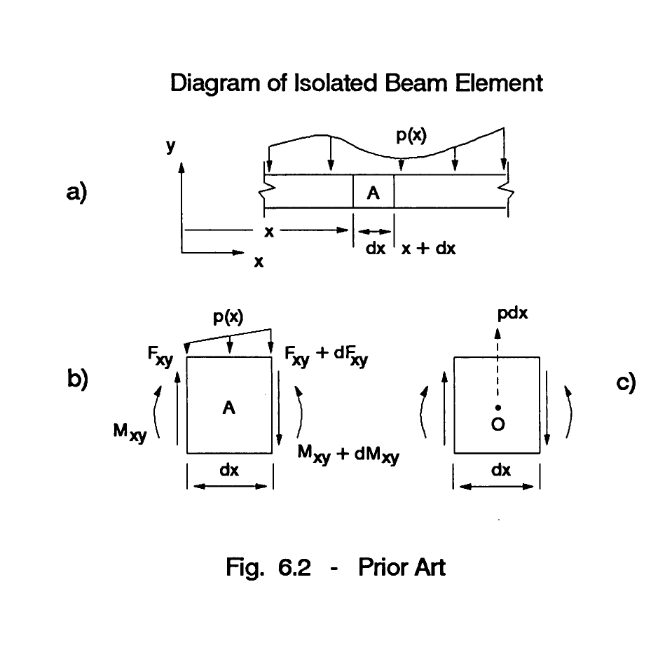

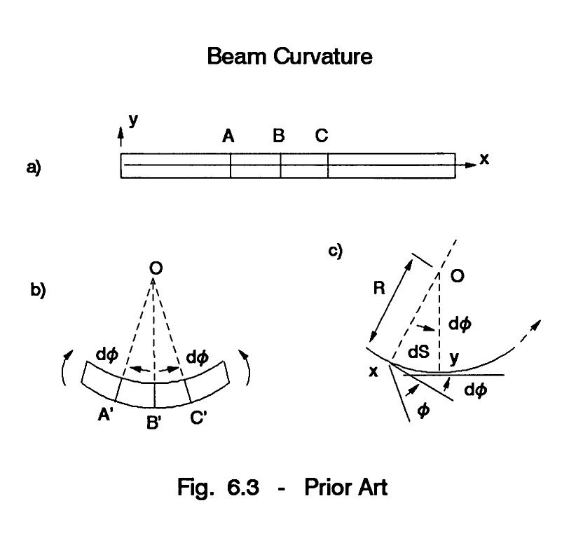

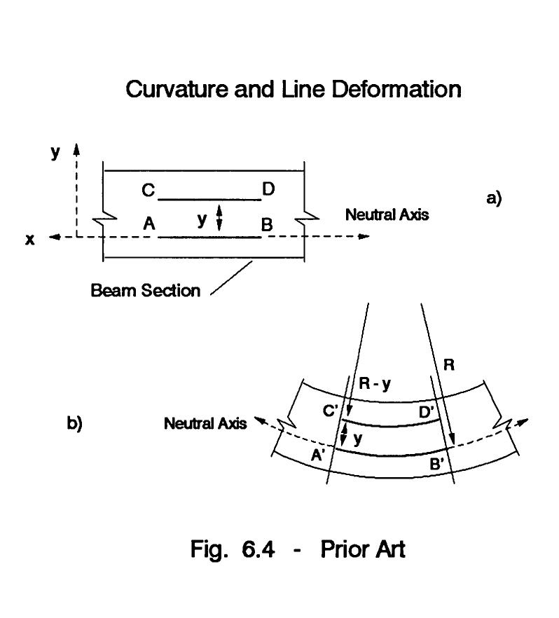

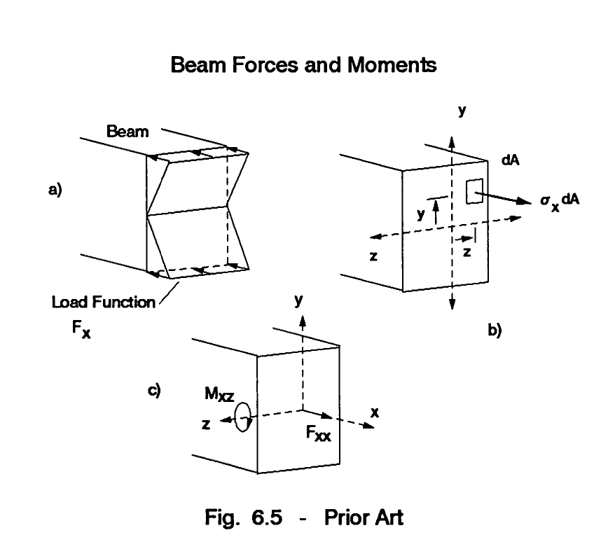

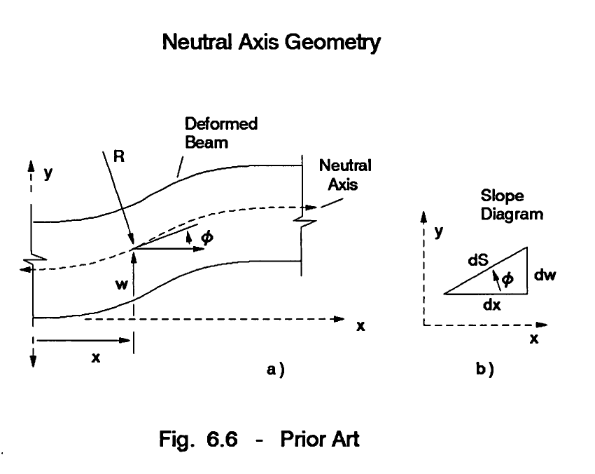

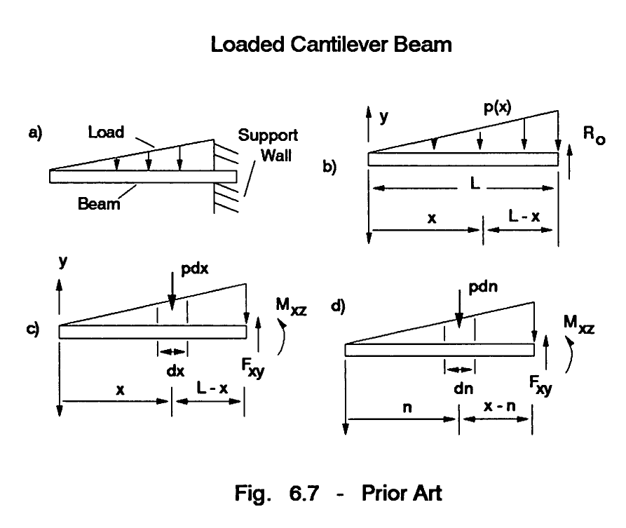

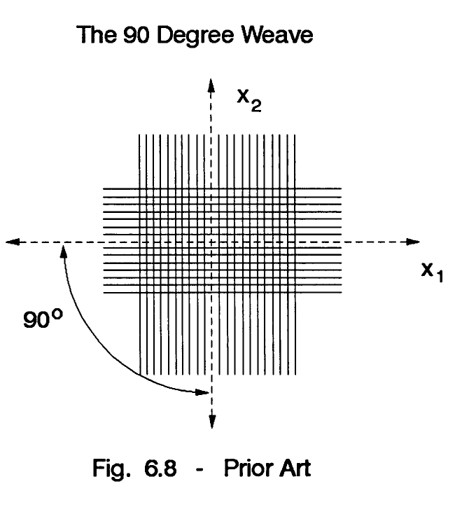

Three forces and three moments act about a cross-sectional surface within a transversely loaded rectangular beam (FIG. 6.1). Fₓₓ is the axial force which elongates the beam. F_{xy} and F_{xz} are the forces that shear one part of the beam relative to another. Mₓₓ is the twisting moment acting about the x axis. M_{xy} and M_{xz} are the moments that bend the beam-in the z and y directions.

FIG. 6.2 illustrates a differential element located somewhere along the beam (FIG. 6.2a), and those forces and moments acting about that element (FIGS. 6.2b and 6.2c). The distributed transverse loading function is p(x). The magnitude of the total force acting along this element is p·Δx which acts through some point O, where p is the average load intensity.

Static equilibrium demands that the sum of the forces and the moments equal zero, yielding the following solution for the sum of the forces, ΣF_{y}, acting in the y direction,
ΣF_{y}=0=(F_{xy}+ΔF_{xy})−F_{xy}+pΔx 6.1
and the solution for the sum of the moments, ΣMₒ, acting about the z axis and in the x direction, located through point O,

$$\sum {M}_{O} = 0 = ( {M}_{xz} + Δ {M}_{xz} ) + ( {F}_{xy} + Δ {F}_{xy} ) \frac{Δ x}{2} + Δ {F}_{xy} \frac{Δ x}{2} - {M}_{xz} \qquad 6.2$$

These equations reduce to,

$$\begin{matrix}\frac{Δ {F}_{xy}}{Δ x} + p = 0 \\ and & 6.3 \\ \frac{Δ {M}_{xz}}{Δ x} + {F}_{xy} - \frac{Δ {F}_{xy}}{2} = 0 & 6.4\end{matrix}$$

As Δx->0 these functions reduce to,

$$\begin{matrix}\frac{ⅆ {F}_{xy}}{ⅆ x} + p = 0 \\ and & 6.5 \\ \frac{ⅆ {M}_{xz}}{ⅆ x} + {F}_{xy} = 0 & 6.6\end{matrix}$$

where the shear force ΔF_{xy}->0 as Δx->0. These two equations are the governing differential equations relating load p(x) to the shear force F_{xy}(x) and the bending moment M_{xz}(x). Integrating from x₁ to x₂ produces the solutions for the shear force and the bending moment,

$$\begin{matrix}{F}_{xy} ( {x}_{2} ) - {F}_{xy} ( {x}_{1} ) + {\int }_{{x}_{1}}^{{x}_{2}} p ⅆ x = 0 \\ and & 6.7 \\ {M}_{xz} ( {x}_{2} ) - {M}_{xz} ( {x}_{1} ) + {\int }_{{x}_{1}}^{{x}_{2}} {F}_{xy} ⅆ x = 0 & 6.8\end{matrix}$$

6.2 Viscoelastic Constitutive Equations

We are interested in beams composed of all possible isotropic linear viscoelastic materials. Loading conditions are static,-so the generalized hereditary integral functions degenerate into the functions for static loading,
εᵢ(t)=[mᵢⱼf*^{E}+nᵢⱼf*^{D}(tⱼ)]σⱼ 6.9
and
σᵢ(t)=[aᵢⱼf^{E}+bᵢⱼf^{D}(tⱼ)]εⱼ 6.10
which may also be written as,

$$\begin{matrix}\begin{matrix}{ε}_{i} ( t ) = [ {k}_{ij} ( t ) ] [ f {*}^{E} + f {*}^{D} ( {t}_{1} ) ] {σ}_{j} \\ = [ {k}_{ij} ( t ) ] f * ( {t}_{1} ) {σ}_{j}\end{matrix} \\ and & 6.11 \\ \begin{matrix}{σ}_{i} ( t ) = [ {l}_{ij} ( t ) ] [ {f}^{E} + {f}^{D} ( {t}_{1} ) ] {ε}_{j} \\ = [ {l}_{ij} ( t ) ] f ( {t}_{1} ) {ε}_{j}\end{matrix} \\ where & 6.12 \\ {k}_{ij} ( t ) = \frac{f {*}^{E} {m}_{ij} + f {*}^{D} ( {t}_{j} ) {n}_{ij}}{f {*}^{E} + f {*}^{D} ( {t}_{1} )} & 6.13\end{matrix}$$

and likewise for lᵢⱼ(t). Because only isotropic materials are considered, the matrices mᵢⱼ, nᵢⱼ, etc., reduce to,

$${m}_{ij} = \vert \begin{matrix}1 & {m}_{12} & {m}_{12} & 0 & 0 & 0 \\ … & 1 & {m}_{12} & 0 & 0 & 0 \\ … & … & 1 & 0 & 0 & 0 \\ … & … & … & μ & 0 & 0 \\ … & … & … & … & μ & 0 \\ … & … & … & … & … & μ\end{matrix} \vert \qquad 6.14$$

and so on. Recall that μ=(1=m₁₂)/2.
6.3 Bending Induced Stresses and Strains

Shearing forces and bending moments act on any cross-section surface (FIG. 6.1). Let's now determine the distribution of internal stresses induced by pure bending, the bending moments M_{xz}(x) and M_{xy}(x). Deformation and strain are time dependent, reaching a maximum value at appropriately large time. So, interested is initially restricted to solutions for f*(t) and f(t) at very large time, call it t->∞, where transient deformation has ceased.

Curvature Concepts

When loaded a straight beam will deform into a curved shape. ‘Curvature’ is defined as the rate of change in the slope of the beam curvature. Curvature may be thought of as the shape of a line or fiber imbedded within the originally undeformed straight beam and oriented parallel to the longitudinal x axis. FIGS. 6.3a and 6.3c illustrate the curvature of the line segment XY of length ΔS. The change in the slope of the angle φ between point X and point Y is Δφ. When the change in slope angle is small, the small angle approximation yields the solution for arc length ΔS as R·Δφ. Curvature of a line segment, dφ/dS, is then,

$$\frac{ⅆ ϕ}{ⅆ S} = {lim}_{Δ S -> o} \frac{Δϕ}{Δ S} = {lim}_{Δ S -> o} \frac{1}{R} = \frac{1}{R} \qquad 6.15$$

where R is the ‘radius of curvature’ at point X.

Consider the geometry of deformation of a beam illustrated in FIGS. 6.3a and 6.3b. The lines A, B, and C represent three equally spaced cross-sections through the undeformed beam. A′, B′, and C′ represent the same cross-sections in the deformed beam. During bending the two sections of the beam, defined by the 3 cross-sections (A, B, and C), are deformed. Because of symmetry in the bending moments about the x-y plane of symmetry, deformation should be symmetric about that plane. Let the cross-sections be placed such that the two beam elements defined by the three cross-sections are identical. By demanding that the transmitted moment throughout the beam be constant, it is reasonable to expect that the deformed shapes will likewise be identical. However, changes in shape of the two elements will be accompanied by a corresponding changes in shape of the three cross-sections. Any such changes would require shape changes in the surfaces defining the sides of contact between the two adjacent elements. Furthermore, moment symmetry requires symmetry in deformation, and therefore mirror image shape changes in the contact surfaces, a physical impossibility. Hence, all cross-sections must remain plane and normal to the plane of symmetry, and each element deforms identically, due to the constant M_{xz} along the length of the beam. Extensions into space of the initially parallel cross-sections will then all have a common intersection point, and the beam bends into the arc of a circle centered about this point.

The above arguments have not ruled out deformation of a cross-sectional plane within it own plane, which does occur. The only restriction imposed on such deformation is that it must be symmetric with respect to the plane of symmetry of the beam.

Deformation Geometry and Strain

FIG. 6.4a illustrates a segment from a beam before deformation. While any cross-section through the beam remains plane during deformation, any straight line or fiber parallel to the x axis is bent into an arc. Some will elongate while others shorten. There is however, some location within the beam, as yet unknown, where these lines remain unchanged in length. This line is called the ‘neutral axis’, and our reference coordinate system is set up so the x axis is coincident with this ‘neutral’ axial line. By convention, the x-y plane is the ‘plane of symmetry’, and the x-z plane is the ‘neutral surface’.

We are developing a small displacement theory. So, while there may be deformation of each cross-section within the plane of the cross-section, deformation is constrained to be sufficiently small so the location of a point in the undeformed cross-section is an adequate approximation for the location of that point in the deformed cross-section. From FIG. 6.4 observe that the lines AB and CD, separated by some distance y before deformation, are deformed into the arcs AB′ and CD′ after deformation. Given the above constraint these lines will be separated by approximately the same distance, y, after deformation. The radius of curvature for the line AB′ is R, but R−y for the line CD′. y is measured from the neutral axis.

Since the neutral axis is a line of zero deformation, the lines AB=CD=CD′, and yield the strain solution,

$${ε}_{xx} = \frac{{AB}^{′} - AB}{AB} = \frac{{AB}^{′} - {CD}^{′}}{{CD}^{′}} \qquad 6.16$$

Using the small angle approximation, sin φ≈φ, and letting each line represent a differential quantity, the arcs formed by the lines may be expressed in terms of dφ,
CD′=Rdφ, AB′=(R−y)dφ 6.17
Let dS=CD′. From equation 6.16 the solution for longitudinal strain along the plane of symmetry becomes,

$${ε}_{xx} = - \frac{y}{R} = - \frac{ⅆ ϕ}{ⅆ S} y \qquad 6.18$$

The minus sign indicates shortening above and extension below the neutral axis. From symmetry arguments requiring plane sections to remain plane we conclude that the shear strains ε_{xy}=ε_{xz}=0. Because the transverse shear strains ε_{xy}=ε_{xz}=0, it follows from equations 6.9 and 6.14 that the corresponding shear stresses σ_{xy} and σ_{xz} must also equal zero. However, no definitive statements may yet be made about the strains ε_{yy}, ε_{zz}, and ε_{yz} beyond the requirement of symmetry about the plane of symmetry.
Additional Equilibrium Equations and Stress Solutions

Equations 6.9 and 6.14 produce the constitutive equation for isotropic materials that relates the maximum longitudinal strain, εₓ(t->∞), to the appropriate stresses, i.e,
εₓ(t→∞)=f*^{E}[m₁₁σₓ+m₁₂(σ_{y}+σ_{z})]+f*^{D}(t→∞)[n₁₁σₓ+n₁₂(σ_{y}+σ_{z})] 6.19
or after rearrangement and following equation 6.11,
εₓ(t→∞)=f*(t→∞)[σₓ+k₁₂(t→∞)(σ_{y}+σ_{z})] 6.20
where from equation 6.13,

$${k}_{12} ( t -> ∞ ) = \frac{f {*}^{E} {m}_{12} + f {*}^{D} ( t -> ∞ ) {n}_{12}}{f {*}^{E} + f {*}^{D} ( t -> ∞ )} \qquad 6.21$$

and m₁₁=n₁₁=k₁₁=1, by definition. When the delayed elasticity component of the constitutive function is negligible, f*(t) approaches the linear elastic solution, i.e., f*(t)->1/E and k₁₂->m₁₂->−υ. E is Young's modulus, and υ is Poisson's ratio. So, equations 6.11, 6.20 and 6.21 are not only identical in form to the linear elastic solutions, they yield the linear elastic solution as f*^{D}(t)->0.

Equation 6.18 provides a method of solving for the longitudinal strain, εₓ(t->∞), if y and R can be measured. Unfortunately, equations 6.19 and 6.20 do not provide unique solutions for the three normal stresses, σ_{y}, σ_{z}, and σₓ.

Because we are considering pure bending only the shear forces F_{xz} and F_{xy} equal zero. If dA is some differential area on the face of a cross-section through a beam, then the force acting on dA is simply dFₓ=σₓ·dA (FIGS. 6.5a and 6.5b), where ΣFₓ=0 at equilibrium. This constraint yields,
ΣFₓ=∫_{A}σₓdA=0 6.22
Symmetry in the loading force (Fₓ) about the plane of symmetry yields the equilibrium equation for the bending moments M_{y},
ΣM_{y}=∫_{A}zσₓdA=0 6.23
Conversely, loading symmetry about the neutral surface (the x-z plane) has not been required. So, the corresponding equilibrium equation for the bending moments M_{xz} becomes,
ΣM_{z}=∫_{A}yσₓdA=M_{xz} 6.24
None of the above expressions yield any information about the transverse normal stresses σ_{z}, σ_{y}, or the transverse shear stress σ_{zy}. However, the external surfaces of the beam are free of such forces, due to the imposed boundary conditions. Given that the beam is slender, it is reasonable to assume that any such stresses, if they exist, are much smaller than the induced loading stress, σₓ, and negligible in comparison. We therefore impose,
σ_{y}=σₓ=σ_{yz}=0 6.25
throughout the interior of the beam. These conditions leave only one normal stress, σₓ, and equations 6.19 and 6.20 reduce to,
εₓ(t→∞)=[f*^{E}+f*^{D}(t→∞)]σₓ=f*(t→∞)σₓ 6.26
Combining this expression with equation 6.18 yields the solution for the longitudinal normal stress σₓ,

$${σ}_{x} = - \frac{y}{R} \frac{1}{f * ( t -> ∞ )} = - \frac{y}{f * ( t -> ∞ )} \frac{ⅆ ϕ}{ⅆ S} \qquad 6.27$$

which is identical in form to the linear elastic solution, and will degenerate to that solution when f*^{D}(t) is negligible.
Moments of Inertia and the Flexural Rigidity Term

Substitution of equation 6.27 into equation 6.22 produces,

$$\sum {F}_{x} = {\int }_{A} {σ}_{x} ⅆ A = {\int }_{A} \frac{y}{R f * ( t -> ∞ )} ⅆ A = \frac{1}{R f * ( t -> ∞ )} {\int }_{A} y ⅆ A = 0 \qquad 6.28$$

The final integral term is the first moment of the cross-section area. R and f*(t) do not equal zero for any real material or any bent beam, so the integral term must equal zero, a result that demands the neutral axis pass through the centroid of the cross-section of the beam.

Substituting equation 6.27 into equation 6.24 yields,

$$\sum {M}_{z} = {\int }_{A} y {σ}_{z} ⅆ A = \frac{1}{f * ( t -> ∞ ) R} {\int }_{a} {y}^{2} ⅆ A = {M}_{bx} \qquad 6.29$$

where M_{bz} (M_{xz}) represents the solution for the applied bending moment about the z axis. The integral function on the right hand side is the second moment of the beam cross-sectional area, the ‘moment of inertia’ I_{yy}, defined by,
I_{yy}=∫_{A}y²dA 6.30
Redesignating f*(t->∞)/I_{yy} as the ‘bending modulus’ or ‘flexural rigidity’ of the beam, D(t->∞), yields,

$$D ( t -> ∞ ) = \frac{f * ( t -> ∞ )}{{I}_{yy}} \qquad 6.31$$

When f*^{D}(t)->0, then f*(t)->1/E, the linear elastic solution, and then D(t)->I/EI_{yy}, the standard definition of D for linear elasticity.
Final Stress and Strain Solutions

Substituting equation 6.31 into equation 6.29 yields the solution for 1/R,

$$\frac{1}{R} = {M}_{bz} D ( t -> ∞ ) \qquad 6.32$$

Equations 6.18 and equation 6.32 then produce the final solution for the longitudinal strain, εₓ(t->∞), in terms of M_{bz},
εₓ(t→∞)=−M_{bx}D(t→∞)y 6.33
The solution for longitudinal stress, σₓ, is obtained from equation 6.27,

$${σ}_{x} = - \frac{{M}_{bz} y}{{I}_{yy}} = \frac{{ε}_{x} ( t -> ∞ )}{f * ( t -> ∞ )} \qquad 6.34$$

Given that σ_{y}=σ_{z}=0, equation 6.21 and equations 6.9 and 6.11 produce the following solution for the transverse normal strains, ε_{y}(t->∞) and ε_{z}(t->∞),
ε_{z}(t→∞)=ε_{y}(t→∞)=f*(t→∞)k₁₂(t→∞)σₓ 6.35
Substituting equation 6.34 into this solution yields the final solution for the transverse strains defined in terms of the applied bending moment,
ε_{z}(t→∞)=ε_{y}(t→∞)=−k₁₂(t→∞)M_{bz}D(t→∞)y=k₁₂(t→∞)εₓ(t→∞) 6.36
The strain ε_{yz}=0 due to the stress conditions imposed by equation 6.25.
6.4 Solutions for Deflections
Bending Moments and the Moment-Curvature Function

When a symmetric, linear viscoelastic beam of isotropic material properties is subjected to pure bending the curvature of the neutral axis is defined by,

$$\frac{1}{R} = \frac{ⅆ ϕ}{ⅆ S} = {M}_{bz} D ( t -> ∞ ) = {M}_{bz} \frac{f * ( t -> ∞ )}{{I}_{yy}} \qquad 6.37$$

If a beam is conceptualized as a connected series of differential elements then equation 6.37 describes the curvature of the neutral axis in each of those elements. Extending this function to a generalized loading condition we make the approximation that the internal shear forces, which necessarily accompany any variation in bending moments, do not make any significant contribution to bending. Given this approximation any variations in beam curvature may be determined from equation 6.37.

To determine the curvature of the bent neutral axis it is necessary to deduce its displacement, defined as w(x), from a static x axis (FIG. 6.6). The slope of the neutral axis may be defined as,

$$\frac{ⅆ w ( x )}{ⅆ x} = tan ϕ \qquad 6.38$$

Differentiating with respect to the arc length S yields,

$$\frac{ⅆ}{ⅆ S} ( \frac{ⅆ w ( x )}{ⅆ x} ) = \frac{ⅆ}{ⅆ S} ( tan ϕ ) \qquad 6.39$$

Making use of the differential relationship,

$$\frac{ⅆ ( … )}{ⅆ S} = \frac{ⅆ ( … )}{ⅆ x} \frac{ⅆ x}{ⅆ S} \qquad 6.40$$

produces the differential function,

$$\frac{{ⅆ}^{2} w ( x )}{ⅆ {x}^{2}} \frac{ⅆ x}{ⅆ S} = {sec}^{2} ϕ \frac{ⅆ ϕ}{ⅆ S} \qquad 6.41$$

Solving for the curvature dφ/dS then yields,

$$\frac{ⅆ ϕ}{ⅆ S} = \frac{{ⅆ}^{2} w ( x )}{ⅆ {x}^{2}} \frac{ⅆ x}{ⅆ S} {cos}^{2} ϕ \qquad 6.42$$

From FIG. 6.6 the solution for the cos φ function is,

$$cos ϕ = \frac{ⅆ x}{ⅆ S} = \frac{1}{{[ 1 + {( ⅆ w ( x ) / ⅆ x )}^{2} ]}^{2 / 3}} \qquad 6.43$$

Substituting this expression into equation 6.42 produces,

$$\frac{ⅆ ϕ}{ⅆ S} = \frac{{ⅆ}^{2} w ( x ) / ⅆ {x}^{2}}{{[ 1 + {( ⅆ w ( x ) / ⅆ x )}^{2} ]}^{2 / 3}} \qquad 6.44$$

and from equation 6.37 we obtain,

$${M}_{bz} = \frac{1}{D ( t -> ∞ )} \frac{{ⅆ}^{2} w ( x ) / ⅆ {x}^{2}}{{[ 1 + {( ⅆ w ( x ) / ⅆ x )}^{2} ]}^{2 / 3}} \qquad 6.45$$

Restricting interest to small angle deflections, say on the order of 5 degrees or less, then tan φ=dw(x)/dx has a magnitude of 0.1 or less, and [dw(x)/dx]² has a magnitude of 0.01 or less.
So, neglecting this squared term in equation 6.44 yields,

$$\frac{{ⅆ}^{2} w ( x )}{ⅆ {x}^{2}} \approx \frac{ⅆ ϕ}{ⅆ S} \qquad 6.46$$

which has an error of one percent or less when compared to the exact solution. Equation 6.45 then reduces to,

$${M}_{bz} = \frac{1}{D ( t -> ∞ )} \frac{{ⅆ}^{2} w ( x )}{ⅆ {x}^{2}} \qquad 6.47$$

and is known as the moment-curvature relation.
The Load-Deflection Function

Refer back to equations 6.5 and 6.6. Differentiate equation 6.6 again with respect to x and substitute those results into equation 6.5. This yields,

$$\frac{{ⅆ}^{2} {M}_{bz}}{ⅆ {x}^{2}} = p \qquad 6.48$$

Combining this result with equation 6.47 produces the expression relating loading to displacement,

$$\frac{{ⅆ}^{2}}{ⅆ {x}^{2}} ( \frac{1}{D ( t -> ∞ )} \frac{{ⅆ}^{2} w ( x )}{ⅆ {x}^{2}} ) = p \qquad 6.49$$

If D(t) is constant along the entire length of the beam, i.e., I_{yy} is constant and the constitutive properties are always described by [kᵢⱼ(t)]·f*(t), then equation 6.49 reduces to,

$$\frac{1}{D ( t -> ∞ )} \frac{{ⅆ}^{4} w ( x )}{ⅆ {x}^{4}} = p \qquad 6.50$$

Equations 6.5 and 6.47 now yield the following expression for the shear force F_{xy} in terms of displacements,

$${F}_{xy} = \frac{1}{D ( t -> ∞ )} \frac{{ⅆ}^{3} w ( x )}{ⅆ {x}^{3}} \qquad 6.51$$

6.5 Time Dependent Solutions

The displacement function w(x) has only been expressed in terms of the independent variable x. However, because f*(t) is evaluated at t->∞, it is obvious that the displacement function is also a function of time and that w(x)=w(x,t->∞).

Loading conditions are constrained to be static. So, how does a change in the time variable from t->∞ to t=0+ effect the previous derivations and solutions? In this case f*(t) reduces to f*(0+)=f*^{E}, and k₁₂(0+)=m₁₂. The bending modulus function D(t) reduces to D(0+)=f*^{E}·I_{yy}. These functions represent the impulse response, or similarly, the linear elastic constitutive functions if the delayed elastic response is negligible. The only difference between the two solution sets are the values for f*(0+) and f*(t->∞), etc.

When f*(t) is evaluated at any time t it is constant valued. This function is the sole control over the magnitude of the bending modulus D(t), likewise constant valued at time t. Recall that the loading forces are time independent. Therefore any time dependence in the solutions for the longitudinal stress, the three normal strains, and the resulting displacements will be controlled entirely by the time dependence in f*(t) and D(t).

Keeping in mind these observations, and that all the applied forces are time independent, then from equation 6.33 the time dependent solution for the longitudinal strain, εₓ(t), becomes,
εₓ(t)=−M_{bz}D(t)y 6.52
From equation 6.36 the time dependent solutions for the lateral transverse strains, ε_{z}(t) and ε_{y}(t) become,
ε_{z}(t)=ε_{y}(t)=−k₁₂(t)M_{bz}D(t)y=k₁₂(t)εₓ(t) 6.53
Likewise equations 6.34 and 6.52 yield the solution for longitudinal stress, σₓ,

$${σ}_{x} = - \frac{{M}_{bz} y}{{I}_{yy}} \qquad 6.54$$

From equation 6.50 the load-deflection equation is now,

$$\frac{{ⅆ}^{4} w ( x , t )}{ⅆ {x}^{4}} = p ( x ) D ( t ) \qquad 6.55$$

Integrating with respect to x four times, and evaluating at the appropriate boundary conditions, will produce the time dependent solution for the displacements as a function of both time t and location x.

Likewise the time dependent solution for the moment-deflection equation given by equation 6.47 becomes,

$$\frac{{ⅆ}^{2} w ( x , t )}{ⅆ {x}^{2}} = D ( t ) {M}_{bz} \qquad 6.56$$

Integrating with respect to x twice, and evaluating at the appropriate boundary conditions, will yield the solution for the displacements as a function of time t and location x.

There is a caveat to these time dependent solutions which we lob shall now discuss and illustrate by example.

6.6 Application to an Example Problem

Consider the problem of a cantilever beam loaded and supported as illustrated in FIG. 6.7a. Define the beam to be rectangular, of thickness H, width B, length L, and homogenous and isotropic in constitutive properties defined by the linear function f*(t)=f*^{E}+f*^{D}(t).

The Loading Function

The loading function is p(x), where the maximum load, defined as pₒ, occurs at the supported end of the beam. The loading function, as a function of location x along the beam is,

$$p ( x ) = {p}_{o} \frac{x}{L} \qquad 6.57$$

where x is measured from the unsupported end of the beam.
The Moment of Inertia and the Bending Modulus

The solution for the moment of inertia I_{yy}, given by equation 6.30, is,

$${I}_{yy} = {\int }_{A} {y}^{2} ⅆ A = {\int }_{- H / 2}^{H / 2} {y}^{2} B ⅆ y = \frac{B {H}^{3}}{12} \qquad 6.58$$

The solution for the bending modulus function D(t) is,

$$D ( t ) = \frac{f * ( t )}{{I}_{yy}} = \frac{12 f * ( t )}{B {H}^{3}} \qquad 6.59$$

The Limiting Boundary Conditions

Because the beam is imbedded in the wall at x=L, the displacement of the beam at x=L is zero for all time. Furthermore, the imbedded end of the beam is restrained from deflecting, so the slope of the beam at x=L is likewise zero for all time. The two defining boundary conditions are therefore,

$$w ( L , t ) = 0 , \frac{ⅆ w ( L , t )}{ⅆ x} = 0 \qquad 6.60$$

Equilibrium Equations and Solutions for Shear Forces and Bending Moments

Refer to FIGS. 6.7b and 6.7c. Summing the forces F_{y} in the y direction and demanding equilibrium yields,

$$\sum {F}_{y} = {\int }_{0}^{L} p ⅆ x - {R}_{o} = 0 \qquad 6.61$$

where the integral represents the intensity of the load distributed along the length of the beam. Rₒ represents the opposing resultant force required to maintain equilibrium. Substituting equation 6.57 into 6.61 and integrating the result produces the solution for the resultant force Rₒ,

$${R}_{o} = {\int }_{0}^{L} \frac{{p}_{o}}{L} x ⅆ x = \frac{{p}_{o} L}{2} \qquad 6.62$$

FIG. 6.7d illustrates the shear force and moment distribution at some location within the beam. Again, summing the forces F_{y} in the y direction and demanding equilibrium yields,

$$\sum {F}_{y} = - {\int }_{0}^{x} p ⅆ n + {F}_{xy} = 0 \qquad 6.63$$

where F_{xy} is the internal shear force. Inserting the loading distribution function p=pₒ·n/L and integrating yields the shear force solution as a function of location x,

$${F}_{xy} ( x ) = {\int }_{0}^{x} \frac{{p}_{o}}{L} n ⅆ n = \frac{{p}_{o} {x}^{2}}{2 L} \qquad 6.64$$

At x=L the sum of the resultant maximum moments, M_{L}, must equal zero for equilibrium to exist. The force exerted by a load p·dx across the moment arm L−x (FIG. 6.7c) produces the moment p·dx·(L−x). The sum of all these differential moments, and the opposing moment M_{bz}, must equal zero. This leads to the integral expression,

$$\sum {M}_{L} = 0 = {\int }_{0}^{L} p ( L - x ) ⅆ x + {M}_{bz} \qquad 6.65$$

Substituting equation 6.57 into equation 6.65 and integrating produces the final solution for the maximum bending moment,

$${M}_{bx} = {\int }_{0}^{L} {p}_{o} \frac{x}{L} ( L - x ) ⅆ x = \frac{{p}_{o} {L}^{2}}{6} \qquad 6.66$$

Refer once again to FIG. 6.7d. Following the same procedures as before produces the solution for the bending moment along the length of the beam,

$${M}_{bx} ( x ) = - {\int }_{0}^{x} {p}_{o} \frac{n}{L} ( x - n ) ⅆ n = - \frac{{p}_{o} {x}^{3}}{6 L} \qquad 6.67$$

which is independent of w(x). The stress function of equation 6.54 is therefore also independent of w(x), and must be in order to obtain a time dependent solution for w(x).
The Solution for Displacements, Strains, and Stress

Substituting equation 6.67 into equation 6.56 produces the differential equation,

$$\frac{{ⅆ}^{2} w ( x , t )}{ⅆ {x}^{2}} = - D ( t ) {p}_{o} \frac{{x}^{3}}{6 L} \qquad 6.68$$

Integrating this expression once yields,

$$\frac{ⅆ w ( x , t )}{ⅆ x} = - D ( t ) {p}_{o} \frac{{x}^{4}}{24 L} + {C}_{1} \qquad 6.69$$

Recall the constraining boundary condition dw(x,t)/dx=0, at x=L. This boundary condition yields the solution for the constant of integration C₁,

$${C}_{1} = D ( t ) {p}_{o} \frac{{L}^{3}}{24} \qquad 6.70$$

Substituting equation 6.70 into equation 6.69 and integrating again yields,

$$w ( x , t ) = - D ( t ) {p}_{o} \frac{{x}^{5}}{120 L} + D ( t ) {p}_{o} \frac{{L}^{3} x}{24} + {C}_{2} \qquad 6.71$$

Evaluating at the boundary condition w(x,t)=0 at x=L yields the solution for C₂,

$${C}_{2} = - D ( t ) {p}_{o} \frac{{L}^{4}}{30} \qquad 6.72$$

Substituting this result into equation 6.71 produces the final solution for displacement,

$$w ( x , t ) = - D ( t ) {p}_{o} [ \frac{{x}^{5}}{120 L} - \frac{{L}^{3} x}{24} + \frac{{L}^{4}}{30} ] \qquad 6.73$$

Substitute equation 6.59 into equation 6.73 and evaluate at time t->∞. The result is the solution for the maximum deflection along the length of the beam, i.e.,

$$w ( x , t -> ∞ ) = - \frac{f * ( t -> ∞ ) {p}_{o}}{{BH}^{3}} [ \frac{{x}^{5}}{10 L} - \frac{{L}^{3} x}{2} + \frac{{L}^{4}}{2.5} ] \qquad 6.74$$

Equations 6.52 and 6.67 now yield the solution for ultimate longitudinal strain,

$${ε}_{x} ( x , t -> ∞ ) = \frac{2 {p}_{o} {x}^{3} f * ( t -> ∞ ) y}{L B {H}^{3}} \qquad 6.75$$

For a rectangular beam the neutral axis is coincident with the centroid of the cross-section area, which is located at the in the middle of the rectangular cross-section, at H/2 and B/2. y is measured from the neutral axis. Hence, the maximum strains occur at y=H/2 and y=−H/2, the top and bottom of the beam respectively.

The solutions for the ultimate lateral transverse strains are obtained from 6.53 and 6.75,

$$\begin{matrix}{ε}_{x} ( x , t -> ∞ ) = {ε}_{y} ( x , t -> ∞ ) = {k}_{12} ( t -> ∞ ) {ε}_{x}^{′} ( x , t -> ∞ ) \\ = \frac{2 {k}_{12} ( t -> ∞ ) {p}_{o} {x}^{3} f * ( t -> ∞ ) y}{L B {H}^{3}} \\ = \frac{2 {p}_{o} {x}^{3} y}{L B {H}^{3}} [ {m}_{12} f {*}^{E} + {n}_{12} f {*}^{D} ( t -> ∞ ) ]\end{matrix} \qquad 6.76$$

which also maximize along the top and bottom of the beam.

Last but not least, the solution for stress along the length of the beam is given by equations 6.54, 6.58 and 6.67, or from equation 6.75,

$${σ}_{x} ( x ) = - \frac{{M}_{bz} ( x ) y}{{I}_{yy}} = \frac{2 y {p}_{o} {x}^{3}}{B {H}^{3} L} \qquad 6.77$$

which likewise maximizes along the top and bottom of the beam. This stress solution is independent of the constitutive properties of the material, the displacement of the beam, and is dependent only upon the magnitude of the bending moment.

If stress were a function of w(x) then we could only solve for the impulse displacement, w(x,t=0+) and the ultimate displacement w(x,t=∞). A time dependent stress function would require the use of hereditary integrals for solution. Higher order theories, such as plate and shell theories, produce solutions where stress is very much a function of the displacement.

6.7 Fiber Composite Approximations

Reinforced fiber composite materials may be constructed by imbedding long fibers of one type of material in a matrix of another type of material. Typical examples of such types of materials are fiberglass and carbon fiber reinforced plastics, steel belted rubber tires, steel reinforced stressed and unstressed concrete, etc.

It is not uncommon for the constitutive properties of the reinforcing fiber material to be markedly different than that of the surrounding matrix material. Now, both types of materials are always fundamentally viscoelastic. However, the disparity in the delayed elasticity response of one material in comparison to the other may be such that the time dependent response for one may dominate to such an extent that the time dependent response of the other may be ignored in defining a constitutive function for the composite material. Steel belted rubber tires and reinforced concrete would be examples of such types of composite materials. The delayed elasticity responses for rubber and concrete are far more pronounced than they are for steel. In fact, the delayed elasticity response of steel is so insignificant that it is ignored for most engineering applications.

The purpose of imbedding fibers in a matrix of another material is usually to limit deformation and provide a degree of tensile strength that the matrix alone does not possess. The coupling mechanism between the imbedded fibers and the matrix is most often mechanical, but may be chemical as well. A non-reinforced mass of matrix material is, like rubbers and plastics, typically isotropic. If the imbedded fibers are directionally oriented, as in a 90 degree blanket weave, they will impart a directionality to the constitutive response of the composite material (FIG. 6.8). A 90 degree weave will produce orthotropy.

Assuming linearity in the constitutive responses for both the fibers and matrix materials the governing constitutive response for the fibers may be written as,
ε(t)_{i(f)}=[m_{ij(f)}]f*^{E}_{(f)}+[n_{ij(f)}]f*^{D}(t)_{(f)} 6.78
and for the matrix,
ε(t)ᵢ₍ₘ₎=[mᵢⱼ₍ₘ₎]f*^{E}₍ₘ₎+[nᵢⱼ₍ₘ₎]f*^{D}(t)₍ₘ₎ 6.79

If the creep compliance response of the fibers is negligible, then regardless of the relative volume of the fibers with respect to the matrix material we may be able to ignore that response component, and the resulting constitutive function for the composite material would be of the form,
ε(t)_{i(c)}=[m_{ij(c)}]f*^{E}_{(c)}+[n_{ij(c)}]f*^{D}(t)₍ₘ₎ 6.80

If the matrix material is isotropic then a 60 degree weave would produce isotropy for the composite material, while a 90 degree weave produces orthotropy. Needless to say, a similar scheme may be applied to non-linear materials as well.

6.8 Discussion

Elementary beam theory may be extended to include linear viscoelastic materials now that the fundamental form of the viscoelastic constitutive equations are known. In this section only static loading conditions were discussed, but clearly the above theory may be extended to include dynamic loading. However, an extension for the viscoelastic materials must incorporate the hereditary integral functions.

From the above discussions it is obvious that other well developed, and higher order structural theories, such as those developed for plates and shells, may be extended to include the viscoelastic materials as well. Interest need not be confined to structural design, but may be extended to included vibrations, wave propagation, etc. In fact, the field of interest includes virtually any engineering problem requiring incorporation of material constitutive properties into solution algorithms.

Furthermore, now that the fundamental form of the viscoelastic constitutive functions are known the numerical methods, such as finite element or finite difference mathematics, may be used to develop numerical algorithms that are incorporated into computer software. These algorithms in turn may then be used to solve scientific or engineering design problems which do not have closed form solutions and involve objects of very complex geometries, material properties, and loading.

Last, but not least, we assumed that the constitutive properties were known. However, proper characterization and quantification of the constitutive properties of a given material is not possible without a some knowledge of the basic form the constitutive function may take. This basic knowledge fundamental to the development of the appropriate laboratory testing methods necessary for accurate quantification of any given material's constitutive functions, the degree of material symmetry or isotropy, the number and values of the non-zero material matrix coefficients, the form of thermal expansion functions and the values of the associated matrix coefficients, and so on.

### Section 7

Application Example—Flow Equations for Compressible Newtonian Fluids

It is from the generalized equations of motion for fluids that the Navier-Stokes equations for compressible Newtonian fluid flow were developed (c. 1845). Originally developed from the Navier-Poisson constitutive equations for Newtonian fluids (c. 1831), the Navier-Stokes equations may now be corrected to incorporate the proper constitutive equations.

7.1 The Continuity Equation

Recall that the solution for the continuity condition of compressible and incompressible fluid flow was based on the mass balance function,

$$\frac{\partial ρ}{\partial t} = - [ \frac{\partial ( ρ {v}_{x} )}{\partial x} + \frac{\partial ( ρ {v}_{y} )}{\partial y} + \frac{\partial ( ρ {v}_{z} )}{\partial z} ] \qquad 7.1$$

which defines the time rate of change in mass density (FIG. 5.2). Differentiating the right side of equation 7.1 produces,

$$\begin{matrix}\frac{\partial ρ}{\partial t} + {v}_{x} \frac{\partial ρ}{\partial x} + {v}_{y} \frac{\partial ρ}{\partial y} + {v}_{z} \frac{\partial ρ}{\partial z} = - ρ ( \frac{\partial {v}_{x}}{\partial x} + \frac{\partial {v}_{y}}{\partial y} + \frac{\partial {v}_{z}}{\partial z} ) \\ or & 7.2 \\ \frac{D ρ}{D t} = - ρ ( ∇ \cdot v ) & 7.3\end{matrix}$$

where Dρ/Dt is the ‘substantiative’ or material derivative defined as,

$$\frac{D ρ}{D t} = \frac{\partial ρ}{\partial t} + {v}_{x} \frac{\partial ρ}{\partial x} + {v}_{y} \frac{\partial ρ}{\partial y} + {v}_{z} \frac{\partial ρ}{\partial z} \qquad 7.4$$

If a fluid is nearly incompressible, or when flow is steady state and density changes during flow are negligible and it follows that Dρ/Dt≈0. This condition produces the continuity equation for incompressible fluid flow,
∇·v=0 7.5
7.2 Force, Momentum Balance and the Equation of Motion

Equations 7.3 and 7.5 do not completely describe fluid behavior because they fail to consider the forces acting on, and within, a given volume of fluid. Because a fluid of interest may be in motion, it is convenient to express this force balance equation in terms of the rate of accumulation of momentum. For any given differential volume through which fluid material may be moving the force and momentum balance expressions may be written as,

$$\begin{matrix}Rate of \\ Momentum \\ Accumulation\end{matrix} = \begin{matrix}Rate of \\ Momentum \\ In\end{matrix} - \begin{matrix}Rate of \\ Momentum \\ Out\end{matrix} + \begin{matrix}Sum of \\ Forces\end{matrix}$$

Momentum enters a differential volume element by two mechanisms. The first is convection, which is simply bulk fluid flow. The rate of momentum accumulation is the mass flow rate, ρ·v, entering the differential element multiplied by the velocity, v, of the moving volume of material. ρ is mass per unit volume. The second mechanism of momentum transfer is the internal viscous shear (deviatoric) stress effects resulting from molecular interaction. These viscous stress effects produce the velocity gradients within a volume of fluid. There are two other stress fields that also act on this differential element of fluid. One is hydrostatic pressure, which acts equally in all axial directions. The other is a body force induced by gravity and which acts about the mass centroid of the differential volume (FIG. 5.2).

The Summation of Forces

Let's now sum the forces acting in the x direction of flow through the differential fluid element. The x-component of momentum that enters the x-face of the element at point x through convection is Δz·Δy·{ρ·vₓ·vₓ}ₓ, and the rate at which momentum leaves the element at point x+Δx is Δz·Δy·{ρ·vₓ·vₓ}_{x+Δx}. The rate at which momentum enters the element through the y-face is Δz·Δx·{ρ·v_{y}·vₓ}_{y}, and so on. Adding all six components of momentum in the x direction yields,
ΔyΔz[(ρvₓvₓ)|ₓ−(ρvₓvₓ)|_{x+Δx}]+ΔxΔz[(ρv_{y}vₓ)|_{y}−(ρv_{y}vₓ)|_{y+Δy}]+ΔxΔy[(ρv_{z}vₓ)|_{z}−(ρv_{z}vₓ)|_{z+Δz}] 7.6

The viscous stress induced x-component of the normal deviatoric stress at point x is Δy·Δz·{T′ₓₓ}ₓ and likewise for the other stress components. Summing all these stresses acting in the x direction produces,
ΔyΔz[T′ₓₓ|ₓ−T′ₓₓ|_{x+Δx}]+ΔxΔz[T′_{yx}|_{y}−T′_{yx}|_{y+Δy}]+ΔxΔy[T′_{zx}|_{z}−T′_{zx}|_{z+Δz}] 7.7

In addition to the deviatoric stresses there is also the net hydrostatic pressure, P*, acting on this volume of material, and the forces exerted by gravity, g. Summing the x-component of these forces yields,
ΔyΔz[P*|ₓ−P*|_{x+Δx}]+ΔxΔzΔy[ρgₓ] 7.8

Lastly, the total rate of x-momentum accumulation within the element is simply,

$$Δ x Δ y Δ z ( \frac{Δ ρ {v}_{x}}{Δ t} ) \qquad 7.9$$

(Note that: Δx/Δt=vₓ).

Inserting these equations into the momentum balance equation, dividing by Δx·Δy·Δz, and taking the limits as Δt, Δx, Δy, and Δz go to zero produces the x-component of the equation of motion,

$$\frac{\partial ρ {v}_{x}}{\partial t} = - ( \frac{\partial ρ {v}_{x} {v}_{x}}{\partial x} + \frac{\partial ρ {v}_{y} {v}_{x}}{\partial y} + \frac{\partial ρ {v}_{z} {v}_{x}}{\partial z} ) - ( \frac{\partial {T}_{xx}^{′}}{\partial x} + \frac{\partial {T}_{xy}^{′}}{\partial y} + \frac{\partial {T}_{zx}^{′}}{\partial z} ) - \frac{\partial p *}{\partial x} + ρ {g}_{x} \qquad 7.10$$

Similar results will be obtained for the z- and y-components of momentum and force yielding,

$$\begin{matrix}\frac{\partial ρ {v}_{y}}{\partial t} = - ( \frac{\partial ρ {v}_{x} {v}_{y}}{\partial x} + \frac{\partial ρ {v}_{y} {v}_{y}}{\partial y} + \frac{\partial ρ {v}_{z} {v}_{y}}{\partial z} ) - ( \frac{\partial {T}_{xy}^{′}}{\partial x} + \frac{\partial {T}_{yy}^{′}}{\partial y} + \frac{\partial {T}_{zy}^{′}}{\partial z} ) - \frac{\partial P *}{\partial y} + ρ {g}_{y} \\ and & 7.11 \\ \frac{\partial ρ {v}_{z}}{\partial t} = - ( \frac{\partial ρ {v}_{z} {v}_{x}}{\partial x} + \frac{\partial ρ {v}_{y} {v}_{z}}{\partial y} + \frac{\partial ρ {v}_{z} {v}_{z}}{\partial z} ) - ( \frac{\partial {T}_{xz}^{′}}{\partial x} + \frac{\partial {T}_{zy}^{′}}{\partial y} + \frac{\partial {T}_{zz}^{′}}{\partial z} ) - \frac{\partial P *}{\partial z} + ρ {g}_{z} & 7.12\end{matrix}$$

These three equations may be rewritten as,

$$\frac{\partial ρ V}{\partial t} = - ∇ \cdot ( ρ V V ) - ∇ P * - ∇ \cdot {T}^{′} + ρ G \qquad 7.13$$

where V is the velocity vector, G is the gravity vector, and T′ is the deviatoric stress tensor. The gravity vector G has 3 component terms. The stress tensor T′ has nine component terms, as does the momentum flux term, ρVV.

Equation 7.10 may also be rearranged into,

$$\frac{\partial ρ {v}_{x}}{\partial t} + ( \frac{\partial ρ {v}_{x} {v}_{x}}{\partial x} + \frac{\partial ρ {v}_{y} {v}_{x}}{\partial y} + \frac{\partial ρ {v}_{z} {v}_{x}}{\partial z} ) = ( \frac{\partial {T}_{xx}^{′}}{\partial x} + \frac{\partial {T}_{xy}^{′}}{\partial y} + \frac{\partial {T}_{zx}^{′}}{\partial z} ) - \frac{\partial P *}{\partial x} + ρ {g}_{x} \qquad 7.14$$

where the left hand side of this equation is,

$$\frac{\partial ρ {v}_{x}}{\partial t} + ( \frac{\partial ρ {v}_{x} {v}_{x}}{\partial x} + \frac{\partial ρ {v}_{y} {v}_{x}}{\partial y} + \frac{\partial ρ {v}_{z} {v}_{x}}{\partial z} ) \qquad 7.15$$

These four terms may in turn be expanded into the expression,

$$ρ \frac{\partial {v}_{x}}{\partial t} + ρ {v}_{x} \frac{\partial {v}_{x}}{\partial x} + ρ {v}_{y} \frac{\partial {v}_{x}}{\partial y} + ρ {v}_{z} \frac{\partial {v}_{x}}{\partial z} + ρ {v}_{x} \frac{\partial {v}_{x}}{\partial x} + ρ {v}_{x} \frac{\partial {v}_{y}}{\partial y} + ρ {v}_{x} \frac{\partial {v}_{z}}{\partial z} + {v}_{x} ( \frac{\partial ρ}{\partial t} + {v}_{x} \frac{\partial ρ}{\partial x} + {v}_{y} \frac{\partial ρ}{\partial y} + {v}_{z} \frac{\partial ρ}{\partial z} ) \qquad 7.16$$

Refer back to equation 7.2. Substituting this expression into the last term of equation 7.16 yields,

$$ρ \frac{\partial {v}_{x}}{\partial t} + ρ {v}_{x} \frac{\partial {v}_{x}}{\partial x} + ρ {v}_{y} \frac{\partial {v}_{x}}{\partial y} + ρ {v}_{z} \frac{\partial {v}_{x}}{\partial z} \qquad 7.17$$

Recall that the definition of the ‘substantiative’ or material derivative, Dc/Dt, is,

$$\frac{D C}{D t} = \frac{\partial C}{\partial t} + {v}_{x} \frac{\partial C}{\partial x} + {v}_{y} \frac{\partial C}{\partial y} + {v}_{z} \frac{\partial C}{\partial z} \qquad 7.18$$

where C is a dummy variable. From this definition equation 7.17 may be rewritten as,

$$ρ \frac{D {v}_{x}}{D t} = ρ \frac{\partial {v}_{x}}{\partial t} + ρ {v}_{x} \frac{\partial {v}_{x}}{\partial x} + ρ {v}_{y} \frac{\partial {v}_{x}}{\partial y} + ρ {v}_{z} \frac{\partial {v}_{x}}{\partial z} \qquad 7.19$$

Expressions similar to equation 7.19 may be derived for equations 7.11 and 7.12 and equation 7.13 may then be rewritten as,

$$ρ \frac{D V}{\partial t} = - ∇ P * - ∇ \cdot {T}^{′} + ρ G \qquad 7.20$$

Note that the two stress terms, the net hydrostatic pressure P*, and the deviatoric stresses associated with the viscous forces, T′, are expressed separately.
7.3 The Governing Constitutive Equations

To proceed any further in the solution of equation 7.20 it is necessary to define the appropriate constitutive response for both the viscous stress term and the hydrostatic stress term. Let's restrict interest to the simple Newtonian fluids. The Navier-Poisson constitutive equation for Newtonian fluids was derived on the assumption that the viscous forces acted not only deviatorically, but also hydrostatically. This assumption produces a set of stress equations of the form,
T^{T}ᵢⱼ=cᵢⱼₖₗDₖₗ 7.21
which are analogous in form to the equations of isotropic linear elastic solids. The total stress T^{T}ᵢⱼ is defined to be the sum of the applied stresses, Tᵢⱼ, and the thermodynamic stress p. Equation 7.21 may be expressed equivalently as,
Tᵢⱼ+pδᵢⱼ=cᵢⱼₖDₖₗ 7.22
or
Tᵢⱼ=−pδᵢⱼ+cᵢⱼₖₗDₖₗ 7.23

The normal stresses, the Tᵢᵢ, may always be written in terms of a deviatoric component, T′, and a hydrostatic component, T^{h}, i.e., Tᵢᵢ=T′ᵢᵢ+T^{h}ᵢᵢ. The hydrostatic stress component is also equivalent to the total mean normal stress or pressure, −P,

$${T}_{ii}^{h} = \frac{{T}_{kk}}{3} = \frac{{T}_{11} + {T}_{22} + {T}_{33}}{3} = - P \qquad 7.24$$

where the (−) sign indicates compression. From this definition and Tₖₖ/3+p=−P+p, the net applied hydrostatic pressure is then simply −σᵢᵢ=−P*=−P+p. Obviously, if σᵢᵢ=P*=0, then P=p. Equation 7.24 leads to the generalized stress expression,

$${T}_{ij} = {T}_{ij}^{′} + {T}_{ij}^{h} {δ}_{ij} = {T}_{ij}^{′} - P {δ}_{ij} = {T}_{ij}^{′} + \frac{{T}_{kk}}{3} {δ}_{ij} \qquad 7.25$$

Demanding isotropy (and following the development of a similar set of equations for the linear elastic solids) equation 7.23 then becomes,
Tᵢⱼ=−pδᵢⱼ+λDₖₖδᵢⱼ+2μDᵢⱼ 7.26
where λ and μ are the Lame′ coefficients, analogous to similar coefficients in the theory of elasticity. This is the Navier-Poisson equation for isotropic Newtonian fluid flow. The Cᵢⱼₖₗ coefficients of equation 7.23 are now defined as,

$${C}_{ijkl} = \vert \begin{matrix}λ + 2 μ & λ & λ & 0 & 0 & 0 \\ λ & λ + 2 μ & λ & 0 & 0 & 0 \\ λ & λ & λ + 2 μ & 0 & 0 & 0 \\ 0 & 0 & 0 & 2 μ & 0 & 0 \\ 0 & 0 & 0 & 0 & 2 μ & 0 \\ 0 & 0 & 0 & 0 & 0 & 2 μ\end{matrix} \vert \qquad 7.27$$

where μ is the dynamic viscosity. This matrix is identical in form to that for linear isotropic elastic solids.

The normal rate of deformation terms, the Dᵢᵢ, may also be written in terms of a deviatoric rate of deformation, D′ᵢᵢ, and a mean volumetric rate of deformation, Dₖₖ/3, i.e.,

$$\begin{matrix}{D}_{ii} = {D}_{ii}^{′} + \frac{1}{3} {D}_{kk} = {D}_{ii}^{′} + \frac{{D}_{11} + {D}_{22} + {D}_{33}}{3} \\ = {D}_{ii}^{′} + \frac{∇ \cdot V}{3}\end{matrix} \qquad 7.28$$

This function in turn leads to a generalized expression for the rate of deformation,

$${D}_{ij} = {D}_{ij}^{′} + \frac{1}{3} {D}_{kk} {δ}_{ij} \qquad 7.29$$

where Dᵢⱼ is defined by equation 5.3.

Substituting equations 7.25 and 7.29 into equation 7.26 to separate deviatoric and hydrostatic responses yields,

$$\begin{matrix}{T}_{ij}^{′} - P {δ}_{ij} = - p {δ}_{ij} + λ {D}_{kk} {δ}_{ij} + 2 μ ( {D}_{ij}^{′} + \frac{1}{3} {D}_{kk} {δ}_{ij} ) \\ = - p {δ}_{ij} + ( λ + \frac{2}{3} μ ) {D}_{kk} {δ}_{ij} + 2 μ {D}_{ij}^{′}\end{matrix} \qquad 7.30$$

This equation may now be separated into an equation that defines the hydrostatic response,

$$P = p - ( λ + \frac{2}{3} μ ) {D}_{kk} = p - K {D}_{kk} = p - K \frac{ⅆ {e}_{v}}{ⅆ t} = > K = λ + \frac{2}{3} μ \qquad 7.31$$

and another that defines the deviatoric response,
T′ᵢⱼ=2μD′ᵢⱼ 7.32

Equation 7.31 now has two additive constitutive functions that define the total constitutive response under hydrostatic loading, the thermodynamic equation of state p, and a viscous term, K·deᵥ/dt. eᵥ is the volumetric deformation and K is the ‘bulk viscosity’. Equation 7.31 results from the assumption of a viscous constitutive response for hydrostatic loading identical to that for deviatoric loading. This equation is incorrect, for it implies that some net sudden (shock) impulse hydrostatic stress, defined as σᵢᵢ=P*=P−p at time t=0+, will produce only a viscous response, i.e.,

$${σ}_{ii} = P *= P - p = - ( λ + \frac{2}{3} μ ) {D}_{kk} = - K {D}_{kk} = - K \frac{ⅆ {e}_{v}}{ⅆ t} \qquad 7.33$$

There is simply no real material that behaves in such a fashion. Consider a volume of gas that is subjected to a sudden shock impulse stress generated by a piston, an explosion, or whatever. Equation 7.33 implies that the gas molecules, which are disconnected and floating in free space, do not recoil elastically from the impact of other gas molecules, or the impact of a solid interface, the surface of our piston, etc. Hence, there is no shock wave or any physical mechanism to propagate a shock wave, or any elastic (acoustic) stress wave for that matter. Furthermore, at the atomic level equation 7.33 also implies that the electrostatic repulse forces operating between (at the very least) the nuclei of colliding gas molecules, or the gas molecules and the surface of the piston, have no influence on material behavior. This result is clearly physical nonsense and comes about from the assumed form of the governing constitutive function, equation 7.21. This result is also why the equations of state, and not the Navier-Poisson equation, are used for wave propagation studies.

Note also that equation 7.31 is analogous in form the Maxwellian viscoelastic fluid model, where this hypothetical constitutive function is the sum of an elastic response term (the thermodynamic equation of state, p) and a viscous response term (K·deᵥ/dt). No known material, fluid or otherwise, behaves in this fashion for the viscous term allows for unconstrained deformation for any level of applied stress.

So, the correct form of the complete constitutive equation of Newtonian fluids must take the form of two independent and linearly additive responses and may be written as,
Tᵢⱼ=T^{h}ᵢⱼδᵢⱼ+T′ᵢⱼ=−Pδᵢⱼ+2μD′ᵢⱼ 7.34
where the volumetric pressure term, call it P=P(P*,p,θ,ρ,eᵥ,t), and the deviatoric term are characterized by two different and uncoupled functions. P=P(P*,p,θ,ρ,eᵥ,t) is an equation of state that defines volumetric deformation, eᵥ, as a function of net stress hydrostatic stress P*=P−p, temperature θ, density ρ, and time t.

Note that equation 7.34 is analogous to the ‘Navier-Poisson equation of Newtonian fluids with no bulk viscosity’. The form of this function is not new (except for the recognition of viscoelastic behavior for the equation of state and the required uncoupling between the two responses). Historically this function has been derived by imposing the approximation that bulk viscosity may be ignored for most applications. This is equivalent to demanding λ≈−2/3μ in equation 7.30, the so-called Stokes condition. In our case, equation 7.34 represents the complete and proper solution, not an approximation.

7.4 Final Solution for the Equations of Compressible Flow

Now that the proper form of the constitutive equation has been determined, we need only substitute the appropriate expressions into equations 7.20 to obtain the final form of the equation of motion for compressible fluids. Equations 7.3, 7.25 and 7.32 yield the following solution for deviatoric stress, T′ᵢⱼ,

$${T}_{ij}^{′} = 2 μ ( {D}_{ij} - \frac{1}{3} {D}_{kk} {δ}_{ij} ) \qquad 7.35$$

From equations 7.26 and 7.28 the expanded forms of T′ᵢⱼ and T′ᵢᵢ are then,

$$\begin{matrix}{T}_{ii}^{′} = - 2 μ \frac{\partial {v}_{i}}{\partial {x}_{i}} + \frac{2}{3} μ ( ∇ \cdot v ) \\ {T}_{ij}^{′} = {T}_{ji}^{′} = - μ ( \frac{\partial {v}_{i}}{\partial {x}_{j}} + \frac{\partial {v}_{j}}{\partial {x}_{i}} )\end{matrix} \qquad 7.36$$

Symmetry in the shear stresses is guaranteed by symmetry in Dᵢⱼ (note the sign convention change to conform to the sign convention of equation 7.20, which comes about from equations 7.6-7.8).

Now, expanding the x-component of equation 7.20 yields,

$$ρ \frac{D {v}_{x}}{D t} = - ( \frac{\partial {T}_{xx}^{′}}{\partial x} + \frac{\partial {T}_{xy}^{′}}{\partial y} + \frac{\partial {T}_{zx}^{′}}{\partial z} ) - \frac{\partial P *}{\partial x} + ρ {g}_{x} \qquad 7.37$$

Substituting the appropriate expression for stress, as defined by equation 7.36, produces,

$$ρ \frac{D {v}_{x}}{Dt} = - \frac{\partial P *}{\partial x} + ρ {g}_{x} + \frac{\partial }{\partial x} [ 2 μ \frac{\partial {v}_{x}}{\partial x} - \frac{2}{3} μ ( ∇ \cdot V ) ] + \frac{\partial }{\partial y} [ μ ( \frac{\partial {v}_{x}}{\partial y} + \frac{\partial {v}_{y}}{\partial x} ) ] + \frac{\partial }{\partial z} [ μ ( \frac{\partial {v}_{x}}{\partial x} + \frac{\partial {v}_{x}}{\partial z} ) ] \qquad 7.38$$

Similar expressions will be obtained for the y-component,

$$ρ \frac{D {v}_{y}}{D t} = - \frac{\partial P *}{\partial y} + ρ {g}_{y} + \frac{\partial }{\partial y} [ 2 μ \frac{\partial {v}_{y}}{\partial y} - \frac{2}{3} μ ( ∇ \cdot V ) ] + \frac{\partial }{\partial x} [ μ ( \frac{\partial {v}_{y}}{\partial x} + \frac{\partial {v}_{x}}{\partial y} ) ] + \frac{\partial }{\partial z} [ μ ( \frac{\partial {v}_{z}}{\partial y} + \frac{\partial {v}_{y}}{\partial z} ) ] \qquad 7.39$$

and the z-component,

$$ρ \frac{D {v}_{z}}{D t} = - \frac{\partial P *}{\partial z} + ρ {g}_{z} + \frac{\partial }{\partial z} [ 2 μ \frac{\partial {v}_{z}}{\partial z} - \frac{2}{3} μ ( ∇ \cdot V ) ] + \frac{\partial }{\partial x} [ μ ( \frac{\partial {v}_{z}}{\partial x} + \frac{\partial {v}_{x}}{\partial z} ) ] + \frac{\partial }{\partial y} [ μ ( \frac{\partial {v}_{y}}{\partial z} + \frac{\partial {v}_{z}}{\partial y} ) ] \qquad 7.40$$

These three equations, coupled with the temperature, density, and a viscoelastic equation of state (bulk compressibility function), P=P(P*,p,θ,ρ,eᵥ,t), the temperature and density dependent viscosity function μ=μ(θ,ρ), and the initial boundary conditions, completely determine the pressure, density, and velocity components of a flowing compressible isotropic Newtonian fluid. Assuming a constant viscosity μ, i.e., invariant θ and ρ, these three equations may be rewritten in a more compact format as,

$$ρ \frac{D V}{D t} = - ∇ P * + ρ G + μ {∇}^{2} V + \frac{μ}{3} ∇ ( ∇ \cdot V ) \qquad 7.41$$

where the net hydrostatic pressure function P* is defined in terms of the equation of state, P=P(P*,p,eᵥ,t), which is a viscoelastic function.

Equations 7.38-7.41 may also be obtained by substituting equation 7.34 directly into Cauchy's equations of motion, i.e.,

$$∇ \cdot T + ρ G = ρ \frac{D V}{D t} = > \frac{\partial {T}_{ij}}{\partial {x}_{i}} + ρ {g}_{j} = ρ \frac{D {v}_{j}}{D t} \qquad 7.42$$

Note that equation 7.20 is equivalent to equation 7.42, only equation 7.20 has a reverse sign convention for stress.
7.5 Prior Derivations and the Stokes Condition
The Complete Navier-Stokes Equations

Assuming for the moment that there is such a property as ‘bulk viscosity’, equations 7.20 and 7.26 may be used to derived the complete traditional form of the Navier-Stokes equations for compressible fluids. While the viscous deviatoric stress terms are unchanged by this assumption, i.e.,

$${T}_{ij}^{′} = {T}_{ji}^{′} = - μ ( \frac{\partial {v}_{i}}{\partial {x}_{j}} + \frac{\partial {v}_{j}}{\partial {x}_{i}} ) \qquad 7.43$$

The hydrostatic viscous stress terms now become,

$${T}_{ii}^{′} = - 2 μ \frac{\partial {v}_{i}}{\partial {x}_{i}} - λ ( ∇ \cdot V ) \qquad 7.44$$

Substituting these equations into equation 7.37 yields the x-component solution,

$$ρ \frac{D {v}_{x}}{D t} = - \frac{\partial P *}{\partial x} + ρ {g}_{x} + \frac{\partial }{\partial x} [ 2 μ \frac{\partial {v}_{x}}{\partial x} + λ ( ∇ \cdot V ) ] + \frac{\partial }{\partial y} [ μ ( \frac{\partial {v}_{x}}{\partial y} + \frac{\partial {v}_{y}}{\partial x} ) ] + \frac{\partial }{\partial z} [ μ ( \frac{\partial {v}_{z}}{\partial x} + \frac{\partial {v}_{x}}{\partial z} ) ] \qquad 7.45$$

Similar expressions will be obtained for the y-component,

$$ρ \frac{D {v}_{y}}{D t} = - \frac{\partial P *}{\partial y} + ρ {g}_{y} + \frac{\partial }{\partial y} [ 2 μ \frac{\partial {v}_{y}}{\partial y} + λ ( ∇ \cdot V ) ] + \frac{\partial }{\partial x} [ μ ( \frac{\partial {v}_{y}}{\partial x} + \frac{\partial {v}_{x}}{\partial y} ) ] + \frac{\partial }{\partial z} [ μ ( \frac{\partial {v}_{x}}{\partial y} + \frac{\partial {v}_{y}}{\partial z} ) ] \qquad 7.46$$

and the z-component,

$$ρ \frac{D {v}_{z}}{D t} = - \frac{\partial P *}{\partial z} + ρ {g}_{z} + \frac{\partial }{\partial z} [ 2 μ \frac{\partial {v}_{z}}{\partial z} + λ ( ∇ \cdot V ) ] + \frac{\partial }{\partial x} [ μ ( \frac{\partial {v}_{z}}{\partial x} + \frac{\partial {v}_{x}}{\partial z} ) ] + \frac{\partial }{\partial y} [ μ ( \frac{\partial {v}_{y}}{\partial z} + \frac{\partial {v}_{z}}{\partial y} ) ] \qquad 7.47$$

Letting λ and μ be constant, these three equations may be rewritten as,

$$ρ \frac{DV}{Dt} = - ∇ P * + ρ G + μ {∇}^{2} V + ( λ + μ ) ∇ ( ∇ \cdot V ) \qquad 7.48$$

Equations 7.45-7.48 are the complete form of the Navier-stokes equations for compressible fluid flow. However, these equations are based upon an assumed form for a governing constitutive function, equation 7.21, that in part describes unreal material behavior, so they cannot be correct.
The Stokes Condition

Return to equation 7.30 and impose the Stokes condition, i.e., the assumption that viscous stress effects are negligible for volumetric deformation. This leads to the relationship λ=−2/3μ, equivalent to K≈0. The only viscous effects allowed are those associated with deviatoric loading and deformation. The Stokes condition now eliminates the assumption in equation 7.21-7.23 that hydrostatic loading and the associated volumetric rate of deformation are also governed by the same basic constitutive relationship of Newtonian fluid flow that governs the deviatoric rate of deformation.

Substituting the Stokes condition term λ=−2/3μ into equation 7.30 produces K=λ+2/3μ=0 and,
Tᵢⱼ=−pδᵢⱼ+2μD′ᵢⱼ 7.49
a result similar to equation 7.34. This equation likewise implies that there are two different, and uncoupled, constitutive functions now governing fluid deformation: the thermodynamic equation of state, p, and the constitutive equation relating the deviatoric stresses to the deviatoric rate of deformation, 2μ·D′ᵢⱼ. Substituting equation 7.49 into the governing equations of motion 7.20, letting p=P, the result will again be equations 7.38-7.41.

### Section 8

Application Example—Numerical Solutions of the Linear Hereditary Integrals

The hereditary integrals provide a means of obtaining closed-form solutions for the constitutive equations under dynamic loading or deformation conditions. For steady state, periodic loading these integrals degenerate into a unique format. However, not all loading is periodic, nor is it always steady state. Furthermore, not all applications (e.g., beam, plate, shell, etc. theories) lend themselves to closed-form mathematical solutions for all possible boundary and loading conditions. In addition, static loading of a body of material may produce hereditary effects because internal stresses can vary as a function of deformation and time.

As a consequence of constraints inherent to any closed-form solution, including the various application theories, the hereditary integral functions need to be adapted for numerical applications, such as finite difference or finite element methods. These numerical methods, which incorporate material constitutive properties, can provide accurate (albeit approximate) solutions to a wide variety of engineering and scientific problems. A scheme is therefore needed for solving the various forms of the hereditary integrals numerically, for both static and dynamic loading or deformation of all forms. We also need to be able to invert the hereditary integrals. Once developed this method may then be incorporated into the higher order finite element, finite difference, etc. numerical solution schemes, thus forming the technical foundation for all derivative forms of computer software.

8.1 The Linear Constitutive Equations

Let's restrict interest to the strain limited linear approximations of viscoelastic behavior where constitutive properties are given by the functions,
εᵢ(t)=[mᵢⱼ]f*^{E}σⱼ+[nᵢⱼ]f*^{D}(t)σⱼ 8.1
and
σᵢ(t)=[aᵢⱼ]f^{E}εⱼ+[bᵢⱼ]f^{D}(t)εⱼ 8.2
which define response to a static load or static strain. Recall that these equations may be rewritten as,

$$\begin{matrix}{ε}_{i} ( t ) = [ {k}_{ij} ( t ) ] f * ( t ) {σ}_{j} {σ}_{i} ( t ) [ {l}_{ij} ( t ) ] f ( t ) {ε}_{j} \\ or & 8.3 \\ {ε}_{i} ( t ) = [ {D}_{ij} ( t ) ] {σ}_{j} {σ}_{i} ( t ) = [ {C}_{ij} ( t ) ] {ε}_{j} \\ where & 8.4 \\ {k}_{ij} ( t ) = \frac{{m}_{ij} f {*}^{E} + {n}_{ij} f {*}^{D} ( t )}{f {*}^{E} + f {*}^{D} ( t )} f * ( t ) = f {*}^{E} + f {*}^{D} ( t ) \\ and & 8.5 \\ {D}_{ij} ( t ) = [ {m}_{ij} ] f {*}^{E} + [ {n}_{ij} ] f {*}^{D} ( t ) & 8.6\end{matrix}$$

and similarly for lᵢⱼ(t), f(t), and Cᵢⱼ(t). Note that the kᵢⱼ(t), Dᵢⱼ(t), etc. are not symmetric in time unless each static σⱼ and εⱼ is applied simultaneously. They are however, always symmetric at time t=0+ and t=∞. Equations 8.3 may readily be inverted to yield solutions for the static stresses, the σⱼ, or the static strains, the εⱼ, i.e.,
σⱼ=εᵢ(t)[kᵢⱼ(t)]⁻¹f*(t)⁻¹ εⱼ=σᵢ(t)[lᵢⱼ(t)]⁻¹f(t)⁻¹ 8.7

From previous discussion we know that the hereditary integrals of equations 8.1 and 8.2, which quantify stress and strain under dynamic loading or deformation, may be expressed as,
εᵢ(t)=mᵢⱼf*^{E}σⱼ(t)+nᵢⱼ∫₀f*^{D}(t−t′)dσⱼ(t′) 8.8
and
σᵢ(t)=aᵢⱼf^{E}εⱼ(t)+bᵢⱼ∫₀f^{D}(t−t′)dεⱼ(t′) 8.9
or similarly as,

$$\begin{matrix}{ε}_{i} ( t ) = {m}_{ij} f {*}^{E} {σ}_{j} ( t ) + {n}_{ij} {\int }_{0 +}^{t} f {*}^{D} ( t - {t}^{′} ) \frac{ⅆ {σ}_{j} ( {t}^{′} )}{ⅆ {t}^{′}} ⅆ {t}^{′} \\ and & 8.10 \\ {σ}_{i} ( t ) = {a}_{ij} {f}^{E} {ε}_{j} ( t ) + {b}_{ij} {\int }_{0 +}^{t} {f}^{D} ( t - {t}^{′} ) \frac{ⅆ {ε}_{j} ( {t}^{′} )}{ⅆ {t}^{′}} ⅆ {t}^{′} & 8.11\end{matrix}$$

or, after some manipulation,

$$\begin{matrix}{ε}_{i} ( t ) = {m}_{ij} f {*}^{E} {σ}_{j} ( t ) + {n}_{ij} {\int }_{0 +}^{t} {σ}_{j} ( {t}^{′} ) \frac{ⅆ f {*}^{D} ( t - {t}^{′} )}{ⅆ ( t - {t}^{′} )} ⅆ {t}^{′} \\ and & 8.12 \\ {σ}_{i} ( t ) = {a}_{ij} {f}^{E} {ε}_{j} ( t ) + {b}_{ij} {\int }_{0 +}^{t} {ε}_{j} ( {t}^{′} ) \frac{ⅆ {f}^{D} ( t - {t}^{′} )}{ⅆ ( t - {t}^{′} )} ⅆ {t}^{′} & 8.13\end{matrix}$$

Recall that equations 8.1->8.6 are limiting solutions to the hereditary integrals for static loading or deformation.
8.2 Incrementing the Constitutive Functions

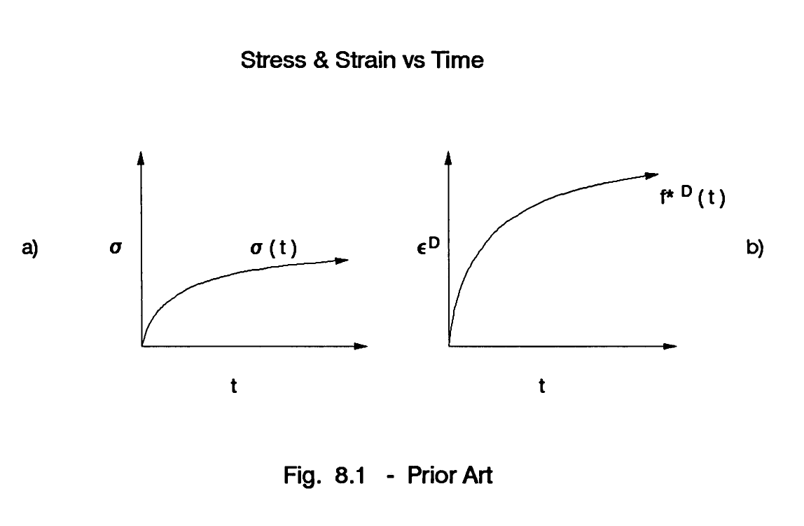

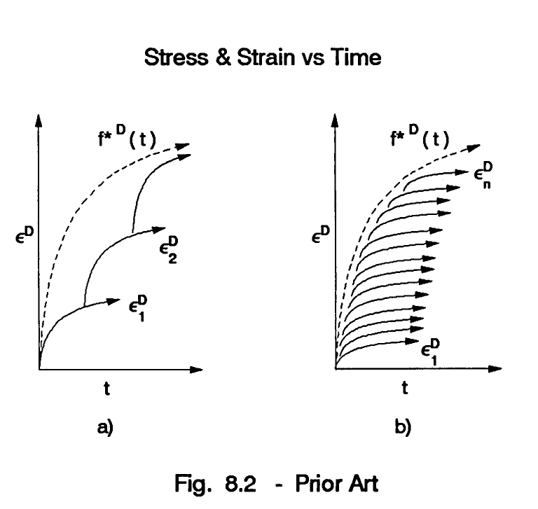

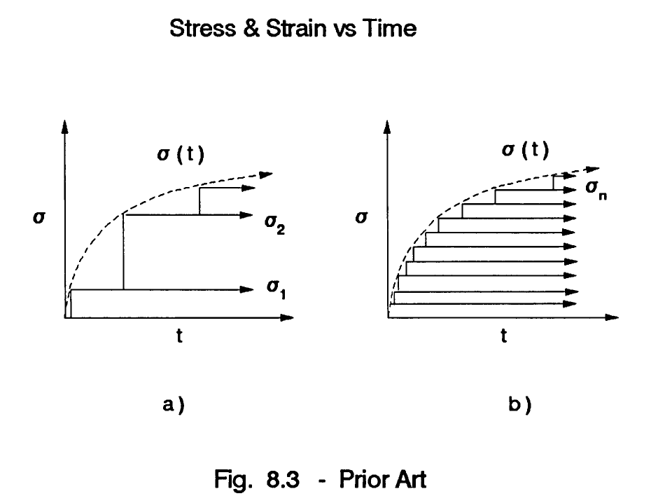

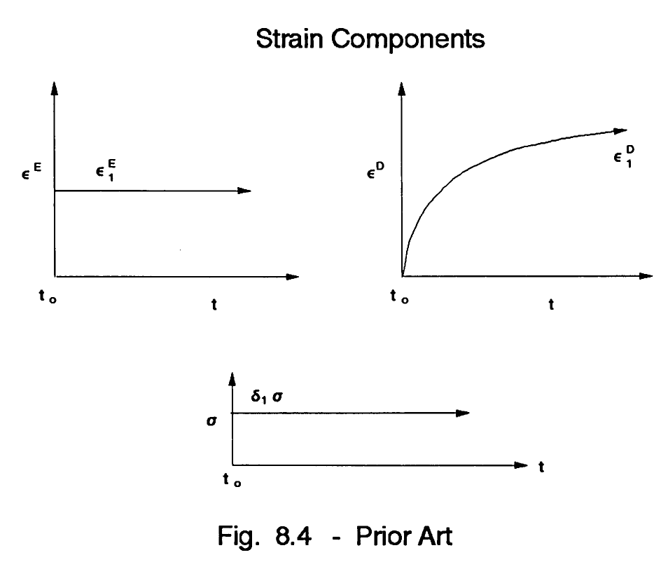

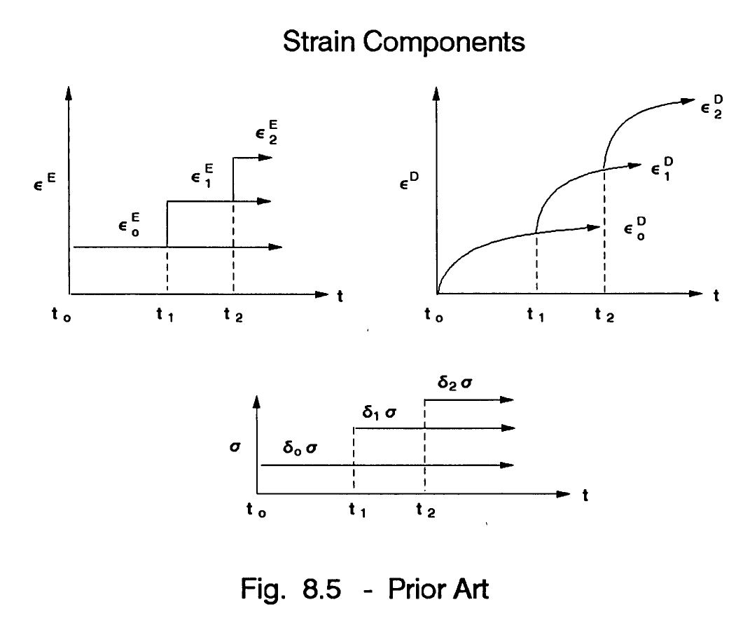

FIG. 8.1a illustrates some time dependent stress function σ(t) which produces the time dependent delayed elasticity response f*^{D}(t) (FIG. 8.1b). f*^{D}(t) may be approximated as the sum of a series of incremental responses (FIG. 8.2a) resulting from the application a series of incrementally applied stresses, the δₙσ(tₙ) (FIG. 8.3a). The better the stress function approximation (FIG. 8.3b) the more accurate the strain history approximation (FIG. 8.2b). Differentially small stress intervals produce the hereditary integral functions of equations 8.8 and 8.9, as well as other various equivalent forms of those functions, e.g., equations 8.10 through 8.13.

Let's review the method of establishing the hereditary integral function 8.8, but refrain from converting the resulting algebraic equation into an integral function. Consider equation 8.1 which may be rewritten as,
εᵢ(t)=ε^{E}ᵢⱼ+ε^{D}(t)ᵢⱼ=εᵢⱼ(t) 8.14
where, for example, ε₁₁(t) is simply,
ε₁₁(t)=ε^{E}₁₁+ε^{D}(t)₁₁=m₁₁f*^{E}σ₁+n₁₁f*^{D}(t)σ₁ 8.15
By choice of definition m₁₁=n₁₁=1. FIG. 8.4 is the graphical illustration of the two strain components.

Let's now incrementally increase the stress σ₁ with time. The time interval between incremental stress increases being irrelevant. Each incremental increase in stress, the δₙσ₁, produces linearly additive impulse and linearly additive delayed elasticity strain responses (FIG. 8.5). The solution for the elastic impulse response as a function of time is then,

$$\begin{matrix}{ε}_{11}^{E} = {m}_{11} {\sum }_{n = 0} f {*}^{E} {δ}_{n} {σ}_{1} ( {t}_{n} ) = {m}_{11} f {*}^{E} {\sum }_{n = 0} {δ}_{n} {σ}_{1} ( {t}_{n} ) \\ = {m}_{11} f {*}^{E} {δ}_{0} {σ}_{1} ( 0 + ) + {m}_{11} f {*}^{E} {δ}_{1} {σ}_{1} ( {t}_{1} ) + … + \\ {m}_{11} f {*}^{E} {δ}_{n} {σ}_{1} ( {t}_{n} )\end{matrix} \qquad 8.16$$

where each δₙσ₁(tₙ) represents a constant valued incremental increase in σ₁ applied at some time tₙ. tₒ=0+ by choice of definition. The corresponding delayed elasticity response will likewise be the sum of the incremental responses,

$$\begin{matrix}{ε}_{11}^{D} ( t ) = {n}_{11} {\sum }_{n = 0} f {*}^{D} ( t - {t}_{n} ) {δ}_{n} {σ}_{1} ( {t}_{n} ) \\ = {n}_{11} f {*}^{D} ( t ) {δ}_{o} {σ}_{1} ( 0 + ) + {n}_{11} f {*}^{D} ( t - {t}_{1} ) {δ}_{1} {σ}_{1} ( {t}_{1} ) + … + \\ {n}_{11} f {*}^{D} ( t - {t}_{n} ) {δ}_{n} {σ}_{1} ( {t}_{n} )\end{matrix} \qquad 8.17$$

where the solution for ε₁₁(t)=ε^{E}₁₁+ε^{D}₁₁(t) is,
ε₁₁(t)=m₁₁Σf*^{E}δₙσ₁(tₙ)+n₁₁Σf*^{D}(t−tₙ)δₙσ₁(tₙ) 8.18
Similarly, the solution for the six εᵢ(t) now becomes,
εᵢ(t)=mᵢ₁Σf*^{E}δₙσ₁(tₙ)+nᵢ₁Σf*^{D}(t−tₙ)δₙσ₁(tₙ) 8.19
where the only applied stress is σ₁.

For convenience the full three dimensional form of equation 8.19 may be simplified by requiring that incremental increases in the σⱼ occur at the same interval in time, tₙ, although the magnitude of the incremental increases, and the number of increases in stress may be different for each σⱼ. Equation 8.19 may then be expanded to,
εᵢ(t)=mᵢⱼΣf*^{E}δₙ(j)σⱼ(tₙ)+nᵢⱼΣf*^{D}(t−tₙ)δₙ₍ⱼ₎σⱼ(tₙ) 8.20
The time interval tₙ is incremented from the time of application of the first incremental stress component to the last increment, regardless of which σⱼ is applied first and which is applied last. There are nⱼ increases in stress for each σⱼ. Each stress may also have a different to as well as a different time of application of the last incremental increase in stress.

It is from equation 8.20 that equation 8.8 is obtained. The conversion is made by simply driving each finite incremental stress to a differentially small value and converting the summation to an integral, which is simply the sum of all the differential component strains through the time interval t. The integral is evaluated by integrating over each increment of stress using the proper tₙ in the argument of f*^{D}(t−tₙ). Equation 8.10 is also obtained directly from equation 8.20, where the substitution dσ(t′)=(dσ(t′)/dt′)·dt′ has been made for dσ(t′).

Alternative Solutions for the Creep Compliance Functions

Each strain component is linearly additive, despite any non-linearity in f*^{D}(t), so we may rewrite equation 8.18 as,
ε₁₁(t)=Σ68 ₁₁(tₙ)=[m₁₁f*^{E}δₒσ₁(0+)+n₁₁f*^{D}(t−tₒ)δₒσ₁(0+)]+[m₁₁f*^{E}δ₁σ₁(t₁)+n₁₁f*^{D}(t−t₁)δ₁σ₁(t₁)]+ . . . +[m₁₁f*^{E}δₙσ₁(tₙ)+n₁₁f*^{D}(t−tₙ)δₙσ₁(tₙ)] 8.21
or more compactly,
ε₁₁(t)=Σε₁₁(tₙ)=Σ[m₁₁f*^{E}δₙσ₁(tₙ)+n₁₁f*^{D}(t−tₙ)δₙσ₁(tₙ)] 8.22
where the total strain at time t is simply the sum of the incremental strains. Equation 8.19 then becomes,
εᵢ(t)=Σεᵢ(tₙ)=Σ[mᵢ₁f*^{E}δₙσ₁(tₙ)+nᵢ₁f*^{D}(t−tₙ)δₙσ₁(tₙ)] 8.23
which then leads to the following equivalent of equation 8.20,
εᵢ(t)=Σ[mᵢⱼf*^{E}δₙ₍ⱼ₎σⱼ(tₙ)+nᵢⱼf*^{D}(t−tₙ)δₙ₍ⱼ₎σⱼ(tₙ)] 8.24

Let's now rewrite equation 8.21 in a form similar to that of equations 8.3 and 8.5, i.e.,

$$\begin{matrix}{ε}_{11} ( t ) = [ \frac{{m}_{11} f {*}^{E} + {n}_{11} f {*}^{D} ( t )}{f {*}^{E} + f {*}^{D} ( t )} ] f * ( t ) {δ}_{o} {σ}_{1} ( 0 + ) + \\ [ \frac{{m}_{11} f {*}^{E} + {n}_{11} f {*}^{D} ( t - {t}_{1} )}{f {*}^{E} + f {*}^{D} ( t - {t}_{1} )} ] f * ( t - {t}_{1} ) {δ}_{1} {σ}_{1} ( {t}_{1} ) + … + \\ [ \frac{{m}_{11} f {*}^{E} + {n}_{11} f {*}^{D} ( t - {t}_{n} )}{f {*}^{E} + f {*}^{D} ( t - {t}_{n} )} ] f * ( t - {t}_{n} ) {δ}_{n} {σ}_{1} ( {t}_{n} )\end{matrix} \qquad 8.25$$

which is equivalent to,

$$\begin{matrix}{ε}_{11} ( t ) = \sum {k}_{11} ( t - {t}_{n} ) f * ( t - {t}_{n} ) {δ}_{n ( 1 )} {σ}_{1} ( {t}_{n} ) \\ where & 8.26 \\ {k}_{11} ( t - {t}_{n} ) = \frac{{m}_{11} f {*}^{E} + {n}_{11} f {*}^{D} ( t - {t}_{n} )}{f {*}^{E} + f {*}^{D} ( t - {t}_{n} )} & 8.27\end{matrix}$$

and f*(t−tₙ)=f*^{E}+f*^{D}(t−tₙ). So, the value of k₁₁(t−tₙ) varies in time for each incremental value in stress. For example, when time 0>t>t₁ then k₁₁(t−tₙ)=k₁₁(t) because tₒ=0+, and is equivalent to,

$${k}_{11} ( t ) = \frac{{m}_{11} f {*}^{E} + {n}_{11} f {*}^{D} ( t )}{f {*}^{E} + f {*}^{D} ( t )} \qquad 8.28$$

When time t₁>t>t₂ then k₁₁(t−tₙ)=k₁₁(t−t₁), i.e.,

$${k}_{11} ( t - {t}_{1} ) = \frac{{m}_{11} f {*}^{E} + {n}_{11} f {*}^{D} ( t - {t}_{1} )}{f {*}^{E} + f {*}^{D} ( t - {t}_{1} )} \qquad 8.29$$

and so on for all tₙ. Equation 8.23 may now be rewritten as,
εᵢ(t)=Σεᵢ(tₙ)=Σkᵢ₁(t−tₙ)f*(t−tₙ)δₙ₍₁₎σ₁(tₙ) 8.30
where the kᵢ₁(t−tₙ) are given by,

$${k}_{i1} ( t - {t}_{n} ) = \frac{{m}_{i1} f {*}^{E} + {n}_{i1} f {*}^{D} ( t - {t}_{n} )}{f {*}^{E} + f {*}^{D} ( t - {t}_{n} )} \qquad 8.31$$

Given that each incremental increase in the σⱼ occurs at the same point in time tₙ, the delayed elasticity constitutive function f*^{D}(t−tₙ) has the same value for each incremental δₙ₍₁₎σⱼ. So, the three dimensional form of equation 8.30 may be rewritten as,
εᵢ(t)=Σkᵢⱼ(t−tₙ)f*(t−tₙ)δₙ₍ⱼ₎σⱼ(tₙ₍ⱼ₎) 8.32
where the kᵢⱼ(t−tₙ) are,

$${k}_{ij} ( t - {t}_{n} ) = \frac{{m}_{ij} f {*}^{E} + {n}_{ij} f {*}^{D} ( t - {t}_{n} )}{f {*}^{E} + f {*}^{D} ( t - {t}_{n} )} \qquad 8.33$$

Note that when the approximation mᵢⱼ≈nᵢⱼ is applicable then kᵢⱼ(t−tₙ)≈mᵢⱼ. Also note that equation 8.32 is identical in form to Hooke's law at any time t. By letting each incremental increase in stress, δₙ₍ⱼ₎σⱼ, be applied at the same incremental time tₙ, we also insure that the incremental equation 8.33 produces a symmetric matrix of time dependent coefficients, the incremental kᵢⱼ(t−tₙ).
The Relaxation Functions

Following the above discussions equivalent solutions for the relaxation response functions are given by,
σᵢ(t)=Σlᵢⱼ(t−tₙ)f(t−tₙ)δₙ₍ⱼ₎εⱼ(tₙ) 8.34
where the lᵢⱼ(t−tₙ) are defined as,

$${l}_{ij} ( t - {t}_{n} ) = \frac{{a}_{ij} {f}^{E} + {b}_{ij} {f}^{D} ( t - {t}_{n} )}{{f}^{E} + {f}^{D} ( t - {t}_{n} )} \qquad 8.35$$

and f(t−tₙ)=f^{E}+f^{D}(t−tₙ). These functions are likewise identical in form to Hooke's law at any time t.
8.3 Inversion of the Hereditary Response

From the above solutions for creep compliance we may obtain solutions for the loading induced stress histories if the six εᵢ(t) are known as a function of time. As we have seen, all solutions for strain are linearly additive. Each component of stress is also linearly additive where the value for each of the σⱼ is simply,

$${σ}_{j} ( t ) = {\sum }_{n = 0} {δ}_{n ( j )} {σ}_{j} ( {t}_{n} ) \qquad 8.36$$

Let's now presume that some body of material has been subjected to loading functions, producing about a small finite element of that body the surface tractions σⱼ(t). Let's further presume that, aside from the material properties, i.e., the mᵢⱼ and nᵢⱼ, f*^{E}, f^{D}(t), etc., that we know the strain histories εᵢ(t), which may obtained from the displacement histories. The variation of the σⱼ(t) as a function of time (and therefore also strain) are unknown and it is these stress histories that we seek to determine. An example of such a case would be a structure subjected to one or more loading functions that produce bending, twisting, displacement, etc., where the εᵢ(t) are determined from the displacement histories, strain gauges, etc.

As discussed, the time dependent and presumably (albeit not necessarily) continuous stress functions may be approximated as step functions which increase in time in very small but finite increments. Let the initial applied incremental stresses be the δₒ₍ⱼ₎σⱼ(0+), which are all unknown. At anytime t>0+ the εᵢ(t) are known. Let t₁ be some small time interval greater than t=0+, the instant the first incremental stress was applied. From equations 8.32 and 8.33 the solutions for the associated strains at time t₁ are then simply,

$$\begin{matrix}{ε}_{i} ( t ) = {ε}_{i ( 1 )} ( {t}_{1} ) = {k}_{ij} ( {t}_{1} ) f * ( {t}_{1} ) {δ}_{o ( j )} {σ}_{j} ( 0 + ) \\ where & 8.37 \\ {k}_{ij} ( {t}_{1} ) = \frac{{m}_{ij} f {*}^{E} + {n}_{ij} f {*}^{D} ( {t}_{1} )}{f {*}^{E} + f {*}^{D} ( {t}_{1} )} & 8.38\end{matrix}$$

Given that the εᵢ₍₁₎(t₁) are known from physical measurements the solutions for the incremental stresses, the δₒ₍ⱼ₎σⱼ(0+), at time t₁ are then,
δₒ₍ⱼ₎σⱼ(0+)=εᵢ₍₁₎(t₁)[kᵢⱼ(t₁)]⁻¹f*(t₁)⁻¹ 8.39
where these were applied at time tₒ=t=0+.

At time t₁+ let another constant increment in the stresses be applied, the δ₁₍ⱼ₎σⱼ(t₁+), which are unknown. At time t₂>t₁+ the solution for strain from equation 8.32 is,
εᵢ(t₂)=[kᵢⱼ(t₂)]f*(t₂)δₒ₍ⱼ₎σⱼ(0+)+[kᵢⱼ(t₂−t₁)]f*(t₂−t₁)δ₁₍ⱼ₎σⱼ(t₁+) 8.40
where at time t₂,

$$\begin{matrix}{k}_{ij} ( {t}_{2} ) = \frac{{m}_{ij} f {*}^{E} + {n}_{ij} f {*}^{D} ( {t}_{2} )}{f {*}^{E} + f {*}^{D} ( {t}_{2} )} \\ and & 8.41 \\ {k}_{ij} ( {t}_{2} - {t}_{1} ) = \frac{{m}_{ij} f {*}^{E} + {n}_{ij} f {*}^{D} ( {t}_{2} - {t}_{1} )}{f {*}^{E} + f {*}^{D} ( {t}_{2} - {t}_{1} )} & 8.42\end{matrix}$$

Equation 8.40 may also be rewritten as,
εᵢ(t₂)=εᵢ₍₁₎(t₂)+εᵢ₍₂₎(t₂−t₁) 8.43

The values of the initial constant valued δₒ₍ⱼ₎σⱼ(0+) were determined from equation 8.39. Equations 8.36 and 8.37 then yield solutions for the εᵢ₍ₒ₎(t) which continue to increase in value with increasing time unless the asymptotic limit is reached for f*^{D}(t). Knowing the values of the εᵢ(t) at times t₁ and t₂ the solutions for the incremental εᵢ₍₂₎(t₂) are simply,
εᵢ₍₂₎(t₂−t₁)=εᵢ(t₂)−εᵢ₍₁₎(t₂) 8.44
From equation 8.40 the solutions for the incremental δ₁₍ⱼ₎σⱼ(t₁) are then,
δ₁₍ⱼ₎σⱼ(t₁)=[εᵢ(t₂)−εᵢ₍₁₎(t₂)][kᵢⱼ(t₂−t₁)]⁻¹f*(t₂−t₁)⁻¹ 8.45
So, for time t₂ the approximate total stress solutions are,
σⱼ(t₂)=δₒ₍ⱼ₎σⱼ(0+)+δ₁₍ⱼ₎σⱼ(t₁) 8.46
which holds true until the incremental time t₂+ when the next unknown incremental stresses were applied.

Let's iterate once more, after which we may write the generalized solutions. At time t₂+ the unknown incremental stresses δ₂₍ⱼ₎σⱼ(t₂) are applied. The next application of incremental stress was at time t₃+, so we want to evaluate for strain at time t₃. From equation 8.32 the solution for strain in terms of the incremental stresses is,
εᵢ(t₃)=[kᵢⱼ(t₃)]f*(t₃)δₒ₍ⱼ₎σⱼ(0+)+[kᵢⱼ(t₃−t₁)]f*(t₃−t₁)δ₁₍ⱼ₎σⱼ(t₁)+[kᵢⱼ(t₃−t₂)]f*(t₃−t₂)δ₂₍ⱼ₎σⱼ(t₂) 8.47
where at time t₃,

$${k}_{ij} ( {t}_{3} - {t}_{2} ) = \frac{{m}_{ij} f {*}^{E} + {n}_{ij} f {*}^{D} ( {t}_{3} - {t}_{2} )}{f {*}^{E} + f {*}^{D} ( {t}_{3} - {t}_{2} )} \qquad 8.48$$

kᵢⱼ(t₃) and kᵢⱼ(t₃−t₁) are given by equations 8.41 and 8.42 evaluated at time t₃ instead of time t₂. Equation 8.47 may now be rewritten as,
εᵢ(t₃)=εᵢ₍₁₎(t₃)+εᵢ₍₂₎(t₃)+εᵢ₍₃₎(t₃) 8.49

The constant valued δₒ₍ⱼ₎σⱼ(0+) and δ₁₍ⱼ₎σⱼ(t₁) were determined by equations 8.39 and 8.45. The contributions of the εᵢ₍₁₎(t) and the εᵢ₍₂₎(t) continue to increase in value with increasing time. Knowing the εᵢ(t₃) the solutions for the εᵢ₍₃₎(t₃) are,
εᵢ₍₃₎(t₃)=εᵢ(t₃)−εᵢ₍₁₎(t₃)−εᵢ₍₂₎(t₃) 8.50
The corresponding solutions for the δ₂₍ⱼ₎σⱼ(t₂) are then,
δ₂₍ⱼ₎σⱼ(t₂)=εᵢ₍₃₎(t₃)[kᵢⱼ(t₃−t₂)]⁻¹f*(t₃−t₂)⁻¹=[εᵢ(t₃)−εᵢ₍₁₎(t₃)−εᵢ₍₂₎(t₃)][kᵢⱼ(t₃−t₂)]⁻¹f*(t₃−t₂)⁻¹ 8.51
Lastly, for time t₂>t>t₃ the total stress solutions are,
σⱼ(t)=δₒ₍ⱼ₎σⱼ(0+)+δ₁₍ⱼ₎σⱼ(t₁)+δ₂₍ⱼ₎σⱼ₍t₂) 8.52

From the above examples it should be clear that for the finite time interval tₙ₊₁ the solutions for the incremental stresses applied at time tₙ are,

$$\begin{matrix}{δ}_{n ( j )} {σ}_{j} ( {t}_{n} ) = {{ε}_{i ( n + 1 )} ( t ) [ {k}_{ij} ( {t}_{n + 1} - {t}_{n} ) ]}^{- 1} f * {( {t}_{n + 1} - {t}_{n} )}^{- 1} \\ = {[ {ε}_{i} ( {t}_{n + 1} ) - {\sum }_{n = 0} {ε}_{i ( n )} ( {t}_{n + 1} ) ] [ {k}_{ij} ( {t}_{n + 1} - {t}_{n} ) ]}^{- 1} f * {( {t}_{n + 1} - {t}_{n} )}^{- 1}\end{matrix} \qquad 8.53$$

a solution still identical in form to Hooke's law. From equation 8.52 the total stress solutions are given by equation 8.36.

Similar functions may readily be derived for the relaxation functions of equation 8.34 and 8.35. Those derivations are now straight-forward and warrant no further discussion. Obviously we need not confine interest to numerical solution of the hereditary integral functions of the form given by equations 8.8->8.11. Equations 8.12 and 8.13 can be reformulated in a similar fashion. In the end however, the same basic procedures must be followed for obtaining solutions for the hereditary responses, and well as the inversion of those responses.

8.4 Additional Comments

As mentioned previously, we have chosen to increment each stress function at identical tₙ intervals. The reason for this choice being that the resulting kᵢⱼ(t−tₙ) and lᵢⱼ(t−tₙ) are always symmetric. Because of this symmetry the inverse of these matrices, the kᵢⱼ(t−tₙ)⁻¹ and lᵢⱼ(t−tₙ)⁻¹ are also symmetric. Furthermore, the constitutive equations may be written in a form identical to Hooke's law so we automatically know the solutions for the inverse relationships of kᵢⱼ(t−tₙ) and lᵢⱼ(t−tₙ), regardless of the degree of material symmetry. For example, for isotropic materials Hooke's law may be written in the form of,
εᵢ=[Dᵢⱼ]f*^{E}σⱼ 8.54
σᵢ=[Dᵢⱼ]⁻¹f^{E}εⱼ 8.55
and the inversion as,
where f^{E}=1/f*^{E}. For isotropic materials f^{E}=E, which is Young's modulus. The solution for the coefficient matrix Dᵢⱼ is,

$$\vert \begin{matrix}1 & {D}_{12} & {D}_{12} & 0 & 0 & 0 \\ … & 1 & {D}_{12} & 0 & 0 & 0 \\ … & … & 1 & 0 & 0 & 0 \\ … & … & … & {D}_{44} & 0 & 0 \\ … & … & … & … & {D}_{44} & 0 \\ … & … & … & … & … & {D}_{44}\end{matrix} \vert \qquad 8.56$$

The material coefficients D₁₁, D₁₂, and D₄₄ are defined as,

$${D}_{11} = {D}_{22} = {D}_{33} = \frac{α + β}{β ( 3 α + 2 β )} = 1 \\ {D}_{12} = \frac{α}{2 β ( 3 α + 2 β )} = - v \\ {D}_{44} = 2 ( {D}_{11} - {D}_{12} ) = \frac{1}{β} = 2 ( 1 + v ) \qquad 8.57$$

where υ is Poisson's ratio. α and β are the Lame' coefficients defined as,

$$α = \frac{v}{( 1 + v ) ( 1 - 2 v )} β = \frac{1}{2 ( 1 + v )} \qquad 8.58$$

From Hooke's law [Dᵢⱼ]⁻¹ is,

$$\begin{matrix}\vert \begin{matrix}α + 2 β & α & α & 0 & 0 & 0 \\ ⋯ & α + 2 β & α & 0 & 0 & 0 \\ ⋯ & ⋯ & α + 2 β & 0 & 0 & 0 \\ ⋯ & ⋯ & ⋯ & β & 0 & 0 \\ ⋯ & ⋯ & ⋯ & ⋯ & β & 0 \\ ⋯ & ⋯ & ⋯ & ⋯ & ⋯ & β\end{matrix} \vert \\ where & 8.59 \\ α + 2 β = \frac{1 - v}{( 1 + v ) ( 1 - 2 v )} & 8.60\end{matrix}$$

So, by simple extension the solution for the kᵢⱼ(t) for isotropic materials is,

$$\vert \begin{matrix}1 & {k}_{12} ( t ) & {k}_{12} ( t ) & 0 & 0 & 0 \\ ⋯ & 1 & {k}_{12} ( t ) & 0 & 0 & 0 \\ ⋯ & ⋯ & 1 & 0 & 0 & 0 \\ ⋯ & ⋯ & ⋯ & 2 ( 1 - {k}_{12} ( t ) ) & 0 & 0 \\ ⋯ & ⋯ & ⋯ & ⋯ & 2 ( 1 - {k}_{12} ( t ) ) & 0 \\ ⋯ & ⋯ & ⋯ & ⋯ & ⋯ & 2 ( 1 - {k}_{12} ( t ) )\end{matrix} \vert \qquad 8.61$$

and the solution for 1/kᵢⱼ(t) is given by equation 8.59 where,

$$\begin{matrix}α = \frac{- {k}_{12} ( t )}{[ 1 - {k}_{12} ( t ) ] [ 1 + 2 {k}_{12} ( t ) ]} \\ β = \frac{1}{2 ( 1 + {k}_{12} ( t ) )} \\ α + 2 β = \frac{1 + {k}_{12} ( t )}{[ 1 - {k}_{12} ( t ) ] [ 1 + 2 {k}_{12} ( t ) ]}\end{matrix} \qquad 8.62$$

Thermal Effects

In general, the equations for thermodynamic expansion and contraction may be developed in the same manner as the constitutive functions. However, there is one important caveat. Temperature effects operate like a hydrostatic load and there are no shear equivalents. So, if a material has directional singularities to it's constitutive properties, these singularities will dominate the thermal properties in the axial direction of the singularity.

8.5 Discussion of Applications

The simplest possible form of the constitutive equations for linear viscoelastic materials has been unknown. In general, the basic fundamental formulation for the constitutive functions has been assumed to be of the form,
εᵢ(t)=[Dᵢⱼ(t)]σⱼ σᵢ(t)=[Cᵢⱼ(t)]εⱼ 8.63
where the Dᵢⱼ(t) and Cᵢⱼ(t) have been characterized as separate and independent functions, in a fashion analogous to linear elasticity. As we have seen, this assumed independence is a violation of the fundamental physics of material deformation and the fundamentals of strain theory. From earlier discussions we know that the Dᵢⱼ(t) and Cᵢⱼ(t) have solutions of the form,
Dᵢⱼ(t)=[mᵢⱼ]f*^{E}+[nᵢⱼ]f*^{D}(t)
Cᵢⱼ(t)=[aᵢⱼ]f^{E}+[bᵢⱼ]f^{D}(t) 8.64
and are not symmetric in time unless all loads have been applied simultaneously.

Numerous numerical methods and associated computer software have been developed based upon equations 8.63, and associated assumptions regarding material behavior. These methods may be readily adapted and modified for the proper form of the constitutive equations and material properties through the use of equations 8.64 and the methods for solving and inverting the hereditary integrals.

1. A method for solving multi-dimensional scientific and engineering design problems requiring solutions for stress, strain and deformation, and which demand the incorporation of a material constitutive equation into the mathematical solution thereof, comprising:
(a) setting up a multi-dimensional, time dependent form of a governing constitutive equation;
(b) mathematically solving for the simplest form of said governing constitutive equation;
(c) Inserting said governing constitutive equation into equations which require the incorporation of a material constitutive equation for solution, and which are then used to solve a particular engineering or scientific problem; and
(d) determining from laboratory tests the form of the governing material dependent, scalar valued, constitutive function for a particular material, and also solving for the values of all the tensor valued independent constant coefficients associated with a particular degree of material symmetry and isotropy.
